(19) United States
(12) Patent Application Publication
(10) Pub. No.: US 2026/0228164 A1
(43) Pub. Date: Aug. 6, 2026

(54) Translating Between CXL.mem and UALink Facilitating CPU Access to Remote Accelerators and GPU Fabrics

(71) Applicant: UnifabriX Ltd., Haifa (IL)

(72) Inventors: Ronen Aharon Hyatt, Haifa (IL); Gaya Opal Hyatt, Haifa (IL); Ethan Sharon Hyatt, Haifa (IL); Gil Thieberger, Kiryat Tivon (IL)

(73) Assignee: UnifabriX Ltd., Haifa (IL)

(21) Appl. No.: 19/630,185

(22) Filed: Mar. 26, 2026

Related U.S. Application Data
(63) Continuation-in-part of application No. 19/371,779, filed on Oct. 28, 2025, now Pat. No. 12,657,153.
Application No. 19/371,779 is a continuation of application No. 19/017,420, filed on Jan. 11, 2025, now Pat. No. 12,613,826.
Application No. 19/017,420 is a continuation-in-part of application No. 18/981,443, filed on Dec. 13, 2024.
(60) Provisional application No. 63/609,833, filed on Dec. 13, 2023.
(60) Provisional application No. 63/641,404, filed on May 1, 2024.
(60) Provisional application No. 63/652,165, filed on May 27, 2024.
(60) Provisional application No. 63/678,045, filed on Jul. 31, 2024.
(60) Provisional application No. 63/695,957, filed on Sep. 18, 2024.
(60) Provisional application No. 63/701,554, filed on Sep. 30, 2024.
(60) Provisional application No. 63/719,640, filed on Nov. 12, 2024.
(60) Provisional application No. 63/734,031, filed on Dec. 13, 2024.
(60) Provisional application No. 63/743,658, filed on Jan. 10, 2025.
(60) Provisional application No. 63/752,940, filed on Feb. 3, 2025.
(60) Provisional application No. 63/784,089, filed on Apr. 5, 2025.
(60) Provisional application No. 63/811,859, filed on May 25, 2025.
(60) Provisional application No. 63/826,342, filed on Jun. 18, 2025.
(60) Provisional application No. 63/856,653, filed on Aug. 3, 2025.
(60) Provisional application No. 63/874,393, filed on Sep. 2, 2025.
(60) Provisional application No. 63/895,053, filed on Oct. 7, 2025.
(60) Provisional application No. 63/906,709, filed on Oct. 28, 2025.
(60) Provisional application No. 63/931,124, filed on Dec. 4, 2025.
(60) Provisional application No. 63/991,122, filed on Feb. 25, 2026.

(51) Int. Cl. G06F 13/42

(52) U.S. Cl. CPC G06F 13/4221; G06F 2213/0026

(57) ABSTRACT

Enabling CXL hosts to reach memory resources within UALink accelerator fabrics opens new pathways for AI workload orchestration across heterogeneous compute domains. Some implementations describe receiving a CXL.mem M2S request comprising MemRd* and a first physical address from a first entity, translating the CXL.mem M2S request to a UALink UPLI request comprising a read command and a second physical address, sending the UPLI request to a second entity, receiving a UPLI read response comprising data, translating the UPLI read response to a CXL.mem S2M data response, and sending the CXL.mem S2M data response to the first entity. Other implementations describe an RPU comprising a CXL port and a UALink port, wherein the RPU translates between CXL.mem and UPLI. Yet other implementations describe a host, a UALink pod with a switch and accelerators, and an RPU translating CXL.mem requests from the host to UPLI requests directed to accelerators via the switch.

### CROSS-REFERENCE TO RELATED APPLICATIONS

This Application claims priority to: U.S. Provisional Patent Application No. 63/991,122, filed Feb. 25, 2026; U.S. Provisional Patent Application No. 63/931,124, filed Dec. 4, 2025; U.S. Provisional Patent Application No. 63/906,709, filed Oct. 28, 2025; U.S. Provisional Patent Application No. 63/895,053, filed Oct. 7, 2025; U.S. Provisional Patent Application No. 63/874,393, filed Sep. 2, 2025; U.S. Provisional Patent Application No. 63/856,653, filed Aug. 3, 2025; U.S. Provisional Patent Application No. 63/826,342, filed Jun. 18, 2025; U.S. Provisional Patent Application No. 63/811,859, filed May 25, 2025; and U.S. Provisional Patent Application No. 63/784,089, filed Apr. 5, 2025. This Application is also a Continuation-In-Part of U.S. patent application Ser. No. 19/371,779, filed Oct. 28, 2025, which claims priority to: U.S. Provisional Patent Application No. 63/752,940, filed Feb. 3, 2025; U.S. Provisional Patent Application No. 63/743,658, filed Jan. 10, 2025; and U.S. Provisional Patent Application No. 63/734,031, filed Dec. 13, 2024. U.S. patent application Ser. No. 19/371,779 is a Continuation of U.S. patent application Ser. No. 19/017,420, filed Jan. 11, 2025, which claims priority to: U.S. Provisional Patent Application No. 63/719,640, filed 12 Nov. 2024; U.S. Provisional Patent Application No. 63/701,554, filed 30 Sep. 2024; U.S. Provisional Patent Application No. 63/695,957, filed 18 Sep. 2024; U.S. Provisional Patent Application No. 63/678,045, filed 31 Jul. 2024; U.S. Provisional Patent Application No. 63/652,165, filed 27 May 2024; and U.S. Provisional Patent Application No. 63/641,404, filed 1 May 2024. U.S. patent application Ser. No. 19/017,420 is also a Continuation-In-Part of U.S. patent application Ser. No. 18/981,443, filed Dec. 13, 2024, which claims priority to U.S. Provisional Patent Application No. 63/609,833, filed 13 Dec. 2023.

### BACKGROUND

The growth of artificial intelligence workloads, such as Large Language Models (LLMs) and Generative AI (GenAI) applications, alongside High-Performance Computing (HPC) applications, demands massive parallelization across accelerators while maintaining low-latency access to memory. Modern datacenter architectures increasingly rely on clusters of accelerators interconnected by high-speed fabrics to deliver computational throughput for training and inference workloads. These accelerators may be coupled with local memory, such as High Bandwidth Memory (HBM), and may also share access to remote or disaggregated memory pools to accommodate large datasets, model parameters, and intermediate computation results.

Ultra Accelerator Link (UALink) is a high-speed interconnect technology that enables communication among accelerators and switches in high-performance computing environments. UALink defines a Protocol Level Interface (UPLI) that specifies channels, commands, and fields for memory read and write transactions between originator and completer devices. UALink enables accelerators to form pods comprising a switch and accelerators, wherein the switch routes traffic among the accelerators according to the UALink-based protocol.

Compute Express Link (CXL) is an interconnect technology that enables cache-coherent memory access and high-bandwidth communication between hosts and devices. CXL defines sub-protocols including CXL.mem, CXL.io, and CXL. cache, each serving different communication patterns. CXL.mem defines Master-to-Subordinate (M2S) messages and Subordinate-to-Master (S2M) messages for memory access operations between hosts and memory devices. CXL.mem supports different device types, including Type-2 devices that support device-managed coherency via Host-managed Device Memory-Device coherent (HDM-D) memory regions, and Type-3 devices that support host-managed coherency via Host-managed Device Memory-Host coherent (HDM-H) memory regions.

### SUMMARY

Some of the following implementations describe methods and systems for translating between CXL.mem and UALink UPLI to enable a host to access memory resources that reside in a UALink domain through protocol translation. In various implementations, a method comprises communicating with a first entity according to CXL.mem, communicating with a second entity according to UPLI, receiving from the first entity a CXL.mem M2S request comprising a MemRd* and a first physical address, translating the CXL.mem M2S request to a UPLI request comprising a read command and a second physical address, and sending the UPLI request to the second entity. The method further comprises receiving a UPLI read response comprising data from the second entity, translating the UPLI read response to a CXL.mem S2M data response comprising the data, and sending the CXL.mem S2M data response to the first entity. The translation may include address translations between different address spaces, Tag translations, opcode translations, error propagation across protocol boundaries, and coherency state management. The method may be performed by a resource provisioning unit (RPU), a processor, a switch, or other suitable device.

In other implementations, a system comprises an RPU comprising a CXL port configured to communicate with a first entity according to CXL.mem and a UALink port configured to communicate with a second entity according to a UALink-based protocol. The RPU is configured to receive a CXL.mem M2S request from the first entity via the CXL port, translate the CXL.mem M2S request to a UPLI request, and send the UPLI request to the second entity via the UALink port. The RPU may include a cache for storing fetched data and may operate as a CXL Type-2 device or a CXL Type-3 device.

In yet other implementations, a system comprises a host, a UALink pod comprising a UALink switch and accelerators coupled to the UALink switch, and an RPU coupled to the host via CXL.mem and coupled to the UALink switch. The RPU is configured to receive a CXL.mem M2S request from the host, translate the CXL.mem M2S request to a UPLI request, and send the UPLI request to an accelerator of the accelerators via the UALink switch. The RPU may be embedded within one of the accelerators or may be a discrete component separate from the accelerators.

### BRIEF DESCRIPTION OF THE DRAWINGS

FIG. 1A and FIG. 1B illustrate examples of translating between CXL.mem and UALink-based protocol;

FIG. 2A illustrates an example of an RPU comprising a cache, which translates between CXL.mem and UPLI;

FIG. 2B illustrates an example of an RPU without a cache, translates between CXL.mem and UPLI;

FIG. 3 illustrates an example of a host CPU accessing various devices over CXL.mem to UALink;

FIG. 4A illustrates an example of a system comprising an RPU that translates between UALink-based traffic and CXL.mem-based traffic;

FIG. 4B illustrates an example of a TFD demonstrating translations between UPLI request and CXL.mem M2S Req MemRd;

FIG. 5A illustrates an example of a system comprising an RPU that enables UALink-based entities to access CXL-based resources coupled to the RPU;

FIG. 5B illustrates an example of a TFD demonstrating intent-based translation between UPLI and CXL.mem;

FIG. 6A illustrates an example of a system comprising a processor comprising a UALink port enabling external entities to access memory resources mapped to an address space utilized by the processor's coherent interconnect;

FIG. 6B illustrates an example of a TFD demonstrating two UPLI requests forwarded to different memories mapped to an address space utilized by a processor's coherent interconnect;

FIG. 7A illustrates an example of a system comprising a processor comprising a coherent interconnect, a UALink port, and a CXL RP;

FIG. 7B illustrates an example of a TFD demonstrating translating two UPLI requests to a coherent interconnect request and to a CXL.mem request;

FIG. 8A illustrates an example of a system that translates between UALink-based traffic and CXL.mem traffic;

FIG. 8B illustrates an example of a TFD demonstrating translations between UPLI request and CXL.mem request, with an optional speculative memory read;

FIG. 9A illustrates an example of a system that translates between CXL.mem and PCIe;

FIG. 9B illustrates an example of a transaction flow diagram (TFD) demonstrating translations between CXL.mem M2S request and PCIe MRd;

FIG. 9C illustrates an example of a TFD demonstrating translations between CXL.mem M2S request and PCIe UIOMRd;

FIG. 10A illustrates an example of a system comprising first and second entities coupled by a computer that translates between CXL.mem and PCIe;

FIG. 10B illustrates an example of a TFD demonstrating translations between CXL.mem M2S RwD and PCIe MWr;

FIG. 10C illustrates an example of a TFD demonstrating translations between CXL.mem M2S RwD and PCIe UIOMWr;

FIG. 11A illustrates an example of a system comprising a cable that translates between CXL-based traffic and PCIe-based traffic;

FIG. 11B illustrates an example of a TFD demonstrating translations performed by an active cable between CXL.mem transactions and PCIe transactions;

FIG. 12A illustrates an example of a system that translates between first and second CXL.mem;

FIG. 12B illustrates an example of a transaction flow diagram (TFD) demonstrating translations between CXL.mem M2S MemRdData request and CXL.mem M2S MemRd request, with optional speculative memory reads;

FIG. 13A illustrates an example of a system comprising a computer, having a buffer/cache, which translates between first and second CXL.mem;

FIG. 13B illustrates an example of a TFD demonstrating translations between a first CXL.mem M2S MemSpecRd and a second CXL.mem M2S MemSpecRd, with an optional initiation of a third CXL.mem M2S MemSpecRd;

FIG. 13C illustrates an example of a TFD demonstrating translations between CXL.mem M2S MemSpecRd and CXL.mem M2S MemRd*;

FIG. 14A illustrates an example of a system that translates between three CXL.mem interfaces;

FIG. 14B illustrates an example of a TFD demonstrating translations between four CXL.mem M2S requests;

FIG. 15A illustrates an example of a system comprising a processor/switch with a CXL device configured to enable external entities to access resources coupled to the processor;

FIG. 15B illustrates an example of a TFD demonstrating translations between first and second CXL.mem transactions comprising MemRd*;

FIG. 16A illustrates an example of a system comprising a processor configured to communicate with multiple hosts according to CXL.mem;

FIG. 16B illustrates an example of a TFD demonstrating two CXL.mem transactions directed to different memories coupled to a processor;

FIG. 17A illustrates an example of a system enabling an entity to access DRAM and other resources via a CXL device port and a coherent interconnect interface;

FIG. 17B illustrates an example of a TFD showing address translations between CXL.mem M2S Req MemRd and ARM CHI REQ ReadOnce;

FIG. 18A illustrates an example of a system comprising a CXL memory switch appliance comprising a CPU having processing cores and memory controllers;

FIG. 18B illustrates an example of a TFD depicting a multi-host memory access scenario wherein two entities access memory through a shared coherent interconnect infrastructure;

FIG. 19A illustrates an example of a system that translates between CXL.mem and CXL.io;

FIG. 19B illustrates an example of a TFD demonstrating translations between CXL.mem M2S request and CXL.io UIOMRd;

FIG. 19C illustrates an example of a TFD demonstrating translations between CXL.mem M2S request and CXL.io MRd;

FIG. 20A illustrates an example of a system comprising a first host coupled to a first memory, a second host coupled to a second memory, and a computer to translate between CXL.mem and CXL.io;

FIG. 20B illustrates an example of a TFD demonstrating translations between CXL.mem M2S request with data (RwD) and CXL.io Memory Write request (MWr);

FIG. 20C illustrates an example of a TFD demonstrating translations between CXL.mem M2S request with data (RwD) and CXL.io UIO Memory Write request (UIOMWr);

FIG. 21A illustrates an example of a system that translates between CXL protocols, such as between CXL.io and CXL.mem;

FIG. 21B illustrates an example of a TFD demonstrating translations between CXL.io TLPs and CXL.mem messages;

FIG. 21C illustrates an example of a TFD demonstrating translations between CXL.io UIO TLPs and CXL.mem messages;

FIG. 22 illustrates an example of a system wherein inference context data is migrated between accelerator local memory and the CXL memory device across UALink and CXL protocol domains;

FIG. 23A illustrates an example of a system comprising a cable configured to translate between CXL and NVLink;

FIG. 23B illustrates an example of a TFD demonstrating translating between CXL.mem M2S MemRd request and NVLink read request;

FIG. 24A illustrates an example of a system comprising an apparatus that translates between NVLink-based traffic and CXL.mem traffic;

FIG. 24B illustrates an example of a TFD demonstrating translations between NVLink-based traffic and CXL.mem traffic;

FIG. 25A illustrates an example of a system, comprising an RPU having an NVLink interface, which enables a GPU to access resources coupled to the RPU over CXL.mem;

FIG. 25B illustrates an example of a TFD demonstrating translations between an NVLink-based protocol and CXL.mem utilized for communicating with a CXL device or CXL memory;

FIG. 25C illustrates an example of a TFD demonstrating translations between NVLink-based requests and CXL.mem requests;

FIG. 26A illustrates an example of a system that translates between an NVLink-based protocol and a CXL protocol;

FIG. 26B illustrates an example of a system comprising an RPU in an NVLink switch or NVSwitch, coupled to NVLink and CXL.mem entities;

FIG. 26C illustrates an example of a system comprising an xPU with an NVLink Fusion chiplet;

FIG. 27A illustrates an example of a system comprising a processor including a coherent interconnect and an NVLink interface;

FIG. 27B illustrates an example of a TFD demonstrating two NVLink read requests forwarded to different memories via a coherent interconnect;

FIG. 28A illustrates an example of a system comprising a processor comprising an NVLink interface and a CXL RP;

FIG. 28B illustrates an example of a TFD demonstrating translating a first NVLink request to a coherent interconnect protocol, and translating a second NVLink read request to a CXL.mem M2S MemRd request;

FIG. 29A illustrates an example of a system that translates between UALink-based traffic and CXL-based traffic;

FIG. 29B illustrates an example of a TFD demonstrating translations between UPLI request ReqCmd(Read) and CXL.io UIOMRd;

FIG. 29C illustrates an example of a TFD demonstrating translations between UPLI request ReqCmd(Read) and CXL.io MRd;

FIG. 30A illustrates an example of a system comprising an entity that enables UALink-based resource consumers to access CXL-based resources coupled to the entity;

FIG. 30B illustrates an example of a TFD demonstrating translations between UALink UPLI read request and CXL.io UIOMRd;

FIG. 31A illustrates an example of a system that translates between a UALink-based protocol and a PCIe-based protocol;

FIG. 31B illustrates an example of a TFD demonstrating translations between UPLI request ReqCmd(Read) and PCIe MRd;

FIG. 31C illustrates an example of a TFD demonstrating translations between UPLI request ReqCmd(Read) and PCIe UIOMRd;

FIG. 32A illustrates an example of a system comprising an accelerator or an RPU configured to translate between UALink-based traffic and PCIe-based traffic;

FIG. 32B illustrates an example of a TFD demonstrating translations between UALink-based traffic and PCIe-based traffic;

FIG. 33A illustrates an example of a system comprising an accelerator or a processor that translates between a UALink-based port and a PCIe-based port;

FIG. 33B illustrates an example of a TFD demonstrating translations between UALink-based traffic and PCIe-based traffic;

FIG. 34A illustrates an example of a system configured to enable PCIe over UALink;

FIG. 34B illustrates an example of a TFD demonstrating PCIe communications over UALink;

FIG. 35A illustrates an example of a system comprising a processor comprising a UALink port coupled to the processor's coherent interconnect;

FIG. 35B illustrates an example of a TFD demonstrating two UPLI requests forwarded to different memories mapped to an address space utilized by a processor's coherent interconnect;

FIG. 36A illustrates an example of a system comprising an entity that translates between UALink-based traffic and ISoL traffic;

FIG. 36B illustrates an example of a TFD demonstrating translations between UALink-based traffic and Intel UPI traffic;

FIG. 37A illustrates an example of a system comprising a processor/RPU that translates between UALink-based traffic and ISoL traffic;

FIG. 37B illustrates an example of a TFD demonstrating translations between UALink-based traffic and ISoL traffic;

FIG. 38A illustrates an example of a system comprising an RPU that translates between UALink and a Coherent Interconnect Interface;

FIG. 38B illustrates an example of a TFD showing address translation between UALink UPLI and ARM CHI ReadOnce;

FIG. 39A illustrates an example of a system that translates between UALink-based traffic and ARM CHI traffic;

FIG. 39B illustrates an example of an RPU that translates between UALink-based traffic and CHI traffic, utilizing an intermediate protocol based on ARM AMBA ACE-Lite;

FIG. 40A illustrates an example of a system comprising a cable that translates between UALink-based traffic and NVLink-based traffic;

FIG. 40B illustrates an example of a transaction flow diagram (TFD) demonstrating translations performed by a cable between a UALink-based protocol and an NVLink-based protocol;

FIG. 41 illustrates an example of a processor comprising RPUs, NVLink interfaces, and UALink ports;

FIG. 42 illustrates an example of a system demonstrating asymmetric bandwidth configuration between an RPU (comprising NVLink, UALink, and/or CXL ports) and a coherent interconnect;

FIG. 43A illustrates an example of a system optimized for accelerator applications utilizing UALink interfaces, wherein an RPU includes more home nodes than request nodes;

FIG. 43B illustrates an example of a system optimized for a memory pool or a memory switch applications utilizing UALink interfaces, wherein an RPU includes more request nodes than home nodes;

FIG. 44A illustrates an example of a system utilizing NVLink interfaces in an accelerator-optimized configuration;

FIG. 44B illustrates an example of a system configured as an NVLink-based memory pool;

FIG. 45 illustrates an example of a system comprising an IC package comprising an input/output (IO) die coupled to compute dies and RPU dies;

FIG. 46A illustrates an example of a system comprising a memory switch comprising an IC package with an IO die coupled to RPU dies;

FIG. 46B illustrates an example of a TFD demonstrating translations between CXL.mem and CXL.cache relevant to a memory switch;

FIG. 47A illustrates an example of a system comprising a memory switch or a memory pool;

FIG. 47B illustrates an example of a TFD demonstrating translations between CXL.mem and CXL.cache relevant to a memory pool;

FIG. 48A illustrates an example of a system comprising an xPU-based multi-protocol switch;

FIG. 48B illustrates an example of a TFD demonstrating protocol and address translations between UALink and CXL.cache;

FIG. 49A illustrates an example of a system configured to translate between first and second UALink traffic;

FIG. 49B illustrates an example of a TFD demonstrating translations that enable a processor to operate as a UALink-based switch;

FIG. 50 illustrates an example of a scalable GPU interconnect utilizing an xPU-based AI switch;

FIG. 51A illustrates an example of a system comprising an xPU-based switch coupled to memory;

FIG. 51B illustrates an example of a TFD demonstrating two UALink transactions through an xPU-based switch;

FIG. 52 illustrates an example of a CPU with a UALink port;

FIG. 53 illustrates an example of a memory switch or AI switch implementation utilizing two IC packages;

FIG. 54 illustrates an example of a processor comprising CXL endpoint ports and RPUs;

FIG. 55 illustrates an example of a CPU with UALink ports;

FIG. 56A illustrates an example of passing CXL traffic or CXL-related traffic over a PHY based on IEEE 802.3 PMA utilizing carrier protocol encapsulation;

FIG. 56B illustrates an example of a TFD showing the mapping between CXL.mem transaction layer and UPLI transaction layer;

FIG. 57A illustrates an example of a system comprising a host and a device coupled via a bridges that translates between CXL and carrier protocols that utilize PHYs based on IEEE 802.3 PMA;

FIG. 57B illustrates an example of a TFD demonstrating bidirectional CXL communications between a host and a device utilizing UALink as an intermediate protocol;

FIG. 58A illustrates an example of a system configured to enable CXL over UALink, such as via CXL tunneling over UALink;

FIG. 58B illustrates an example of a TFD demonstrating CXL communications over UALink, such as CXL over UALink, or CXL tunneling over UALink;

FIG. 59A illustrates an example of encapsulating 68-byte CXL flits into UPLI transactions comprising Write commands;

FIG. 59B illustrates an example of a TFD depicting translations utilized for encapsulating a 68-byte CXL flit into a UPLI Write command;

FIG. 60A illustrates an example of encapsulating 256-byte CXL flits into UPLI WriteFull commands;

FIG. 60B illustrates an example of a TFD depicting translations utilized for encapsulating or packing of a CXL.mem request message into a 256-byte CXL flit that is further encapsulated into a UPLI WriteFull command;

FIG. 61A illustrates an example of a system that translates CXL flits to UPLI transaction layer messages;

FIG. 61B illustrates an example of a TFD depicting tunneling of CXL flits over UPLI;

FIG. 62A illustrates an example of utilizing a UPLI write message command for tunneling CXL flits;

FIG. 62B illustrates an example of a TFD depicting utilizing UPLI write message commands for tunneling CXL transactions;

FIG. 63A illustrates an example of a system comprising a host having a first CXL port, a retimer, a bridge, and a device having a second CXL port;

FIG. 63B illustrates an example of a TFD demonstrating CXL communications between a host and a device based on a PHY based on IEEE 802.3 PMA utilizing UALink flits;

FIG. 64A illustrates an example of a system comprising a CXL host coupled to a CXL device over two bridges utilizing a UALink PHY;

FIG. 64B illustrates an example of a TFD demonstrating a translations between CXL flits and UALink flits;

FIG. 65A illustrates an example of a system configured to enable UALink over Ethernet-based network, such as UALink over standard Ethernet, UALink over UET, UALink over ESUN, or UALink over SUE; and

FIG. 65B illustrates an example of a TFD demonstrating UALink-based communications over Ethernet, such as UALink over Ethernet, UALink tunneling over Ethernet, UPLI over Ethernet, or UPLI tunneling over Ethernet.

### DETAILED DESCRIPTION

In environments where entities may utilize different protocols while requiring coordinated access to shared resources, there may be scenarios where a first entity communicating according to CXL.mem, such as a CXL host, needs to access memory resources residing in a UALink domain, such as memory coupled to accelerators or accessible via a UALink network. An RPU or other suitable device may translate between CXL.mem and UPLI to facilitate memory operations, data transfers, and resource sharing across different protocol domains while maintaining the requirements of each protocol. The translation may involve converting CXL.mem M2S requests to UPLI requests, and converting UPLI responses to CXL.mem S2M responses, including translations of opcodes, commands, addresses, Tags, and additional fields. The RPU may further perform address translations between different address spaces, such as between a Host Physical Address (HPA) space utilized by CXL-based traffic and a Network Physical Address (NPA) space utilized by UALink-based traffic, or between addresses within the same address space. The RPU may include a cache for storing fetched data and may operate as a CXL Type-2 device, a CXL Type-3 device, or may expose both HDM-D and HDM-H memory regions concurrently.

In various implementations, a method for translating from Compute Express Link (CXL) requests to Ultra Accelerator Link (UALink) Protocol Level Interface (UPLI) requests, comprising: communicating with a first entity according to CXL.mem; communicating with a second entity according to UPLI; receiving, from the first entity, a CXL.mem Master-to-Subordinate (M2S) request comprising a MemRd* and a first physical address; translating the CXL.mem M2S request to a UPLI request comprising a read command and a second physical address; sending the UPLI request to the second entity; receiving, from the second entity, a UPLI read response (RdRsp) comprising data; translating the UPLI RdRsp to a CXL.mem Subordinate-to-Master Data Response (S2M DRS) comprising the data; and sending the CXL.mem S2M DRS to the first entity. The translation may enable entities communicating according to CXL.mem to access memory resources coupled to entities communicating according to UPLI, such as HBM and/or High-Bandwidth Flash (HBF) coupled to an accelerator, or memory accessible via a UALink network. The method may be implemented in hardware, firmware, software, or combinations thereof, and may be performed by various types of devices, such as a processor, a switch, a bridge, an RPU, or a semiconductor device. The first physical address may be associated with a first address space, such as an HPA space, and the second physical address may be associated with a second address space, such as an NPA space, wherein the translating may include translating the first physical address to the second physical address. Additionally or alternatively, the first and second physical addresses may be associated with the same address space, such as a global address space, a partitioned global address space (PGAS), a pod address space, a virtual pod address space, or a fabric address space.

In some implementations of the method, the CXL.mem M2S request further comprises a MemOpcode field comprising the MemRd*, a Tag field, and an Address field comprising the first physical address; and wherein the UPLI request further comprises a ReqCmd field comprising the read command, a ReqAddr field comprising the second physical address, a ReqSrcPhysAccID field, a ReqDstPhysAccID field, a ReqLen field, and a ReqTag field; and further comprising translating the Tag to the ReqTag. The Tag translation may involve maintaining a bidirectional mapping between CXL.mem Tag values and UPLI ReqTag values, enabling proper correlation of UPLI responses with their corresponding CXL.mem requests. The ReqSrcPhysAccID and ReqDstPhysAccID fields may carry identifiers utilized for routing the UPLI request to the target accelerator. When the ReqLen indicates a transfer size exceeding a CXL.mem cacheline size (e.g., 64 Bytes), CXL.mem M2S requests may be consolidated into a UPLI request supporting transfer sizes up to 256 Bytes.

In some implementations of the method, the UPLI RdRsp further comprises a RdRspSrcPhysAccID field, a RdRspDstPhysAccID field, a RdRspTag field, and RdRspData comprising the data; and wherein the CXL.mem S2M DRS further comprises an Opcode field comprising MemData and the Tag. The RdRspDstPhysAccID may correspond to the ReqSrcPhysAccID from the original UPLI request, reflecting the routing path for the response. The RdRspTag may be utilized to retrieve the corresponding CXL.mem Tag from the bidirectional mapping maintained during request translation. In some examples, the UPLI RdRsp may carry data across multiple beats, and the RPU may accumulate the beats before constructing the CXL.mem S2M DRS.

In some implementations of the method, the UPLI RdRsp further comprises a RdRspDataError field, and the CXL.mem S2M DRS further comprises a Poison field; and further comprising translating the RdRspDataError field of the UPLI RdRsp to the Poison field of the CXL.mem S2M DRS. The RdRspDataError field in UPLI may serve as a per-beat data poison indicator. The Poison field in CXL.mem S2M DRS may indicate that the returned data contains an error. The translation of error indications across protocol boundaries may enable the first entity to detect data corruption that originated in the UALink domain, and to take appropriate recovery actions.

In some implementations, the method further comprises storing the data from the UPLI RdRsp in a cache; and sending a CXL.mem Subordinate-to-Master No Data Response (S2M NDR) comprising Cmp-S to the first entity, wherein the Cmp-S indicates a shared cacheline state. By storing the fetched data in the cache, the RPU may maintain a local copy of the cacheline and participate in coherency management with the first entity. The S2M NDR comprising Cmp-S may inform the first entity that the RPU retains a shared copy, enabling both the first entity and the RPU to hold cached copies concurrently. This behavior may correspond to CXL Type-2 device semantics utilizing an HDM-D memory region, wherein the device coherency engine (DCOH) manages cacheline state on behalf of the device.

In some implementations of the method, the CXL.mem M2S request further comprises a SnpType field comprising SnpData, a MetaField field comprising Meta0-State (MS0), and a MetaValue field comprising Shared (S); and wherein the CXL.mem M2S request targets a Host-managed Device Memory (HDM-D) memory region. The SnpType(SnpData), MetaField(MS0), and MetaValue(S) combination may indicate an intent by the first entity to acquire a shared copy of the cacheline. The RPU may utilize these fields to determine the coherency behavior and to select the Cmp-S opcode for the S2M NDR.

In some implementations of the method, the CXL.mem M2S request further comprises a SnpType field comprising No-Op and a MetaField field comprising No-Op; and wherein the CXL.mem S2M DRS is sent to the first entity without sending a CXL.mem Subordinate-to-Master No Data Response (S2M NDR) to the first entity; and wherein the CXL.mem M2S request targets a Host-managed Device Memory (HDM-H) memory region. The No-Op values for SnpType and MetaField may indicate that no snoop or metadata operation is involved, corresponding to CXL Type-3 device semantics. In this flow, the RPU may act as a passthrough that forwards data from the UALink domain to the first entity without maintaining a cached copy and without participating in coherency management.

In some implementations, the method further comprises sending a CXL.mem Subordinate-to-Master No Data Response (S2M NDR) comprising Cmp-S to the first entity without storing the data in a cache. The RPU may respond with Cmp-S even when the RPU does not have a cache or does not store the data. This may be beneficial in scenarios where the first entity does not support CXL Type-3 device flows and only supports CXL Type-2 device flows. By emulating Type-2 behavior, the RPU may maintain compatibility with hosts that lack Type-3 support.

In some implementations of the method, the first physical address is associated with a first address space, the second physical address is associated with a second address space different from the first address space, and the translating further comprises translating the first physical address to the second physical address; and wherein the first address space comprises a Host Physical Address (HPA) space or a System Physical Address (SPA) space, and the second address space comprises a Network Physical Address (NPA) space. The address translation may be implemented utilizing lookup tables, page tables, base-and-offset calculations, range-based mapping, and/or programmable translation functions. The HPA or SPA may represent addresses within the CXL domain, and the NPA may represent addresses within the UALink network that may span multiple accelerators or nodes. In some examples, the first and second address spaces may be the same address space, and the RPU may perform routing without address translation.

In some implementations of the method, the first entity comprises a CXL host, the second entity comprises an accelerator or a UALink switch, and the read command comprises a Read command or a Read Class Vendor Defined Command. Read Class VDCs may correspond to ReqCmd encodings that enable vendor-specific memory access operations extending beyond the standard UPLI read commands. The CXL host may include a CPU or other CXL-capable entity. The accelerator may include a GPU, a TPU, or other processing device coupled to a UALink network.

In some implementations, the method further comprises receiving, from the first entity, a CXL.mem Master-to-Subordinate Request with Data (M2S RwD) comprising MemWr* and write data; translating the CXL.mem M2S RwD to a UPLI request comprising a write command; sending the UPLI request and the write data to the second entity; receiving, from the second entity, a UPLI write response (WrRsp); translating the UPLI WrRsp to a CXL.mem Subordinate-to-Master No Data Response (S2M NDR) comprising Cmp; and sending the CXL.mem S2M NDR to the first entity. MemWr* may refer to MemWr, MemWrPtl, MemWrTEE, MemWrPtlTEE, or other memory write opcode variants defined or to be defined in CXL.mem. The write data may be transferred from the CXL.mem domain to the UPLI domain via the Originator Data Channel, optionally with byte enable manipulation utilizing OrigDataByteEn when the MemWr* refers to MemWrPtl for partial writes. The UPLI write command may include a Write or WriteFull command as defined by the UPLI specification. The UPLI WrRsp may carry a WrRspTag and WrRspStatus indicating the completion status of the write operation.

In some implementations, the method further comprises receiving, from the first entity, a CXL.mem M2S request comprising MemSpecRd; and translating the CXL.mem M2S request comprising MemSpecRd to a UPLI request. The MemSpecRd opcode may indicate a speculative read issued by the first entity before coherence resolution, and the RPU may translate it to a UPLI read request directed to the second entity. When utilizing the MemSpecRd opcode, some of the CXL.mem M2S Req fields, such as MetaField, MetaValue, and SnpType, may be reserved. Additionally or alternatively, the RPU may initiate speculative UPLI requests on its own to prefetch data from the second entity, based on access pattern recognition or configurable prefetch policies.

In some implementations of the method, the method is performed by a device that exposes a first memory region utilizing CXL Type-2 device memory flows associated with a Host-managed Device Memory-Device coherent (HDM-D) region, and a second memory region utilizing CXL Type-3 device memory flows associated with a Host-managed Device Memory-Host coherent (HDM-H) region. The CXL specification allows a device to expose both HDM-D and HDM-H memory regions concurrently. For example, local memory such as HBM and/or HBF coupled to an accelerator may be exposed as an HDM-D region utilizing CXL Type-2 memory flows with coherency management, while remote memory accessible via the UALink network may be exposed as an HDM-H region utilizing CXL Type-3 memory flows. The RPU may select the appropriate memory flow based on the address of the CXL.mem M2S request.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an apparatus configured to operate as a switch, wherein the apparatus comprises switching circuitry and is configured to perform the method.

In computing environments where a host communicating according to CXL.mem may need to access memory resources in a UALink domain, such as memory coupled to accelerators or accessible via a UALink network, an RPU may bridge the two protocol domains by translating between CXL.mem and UPLI. The RPU may include a CXL port for communicating with the host and a UALink port for communicating with accelerators or a UALink switch. The RPU may translate CXL.mem M2S requests to UPLI requests and translate UPLI responses to CXL.mem S2M responses. The RPU may include a cache for storing fetched data and may operate as a CXL Type-2 device or a CXL Type-3 device. The RPU may be a discrete component, an IP block embedded within an accelerator, or a chiplet within an IC package.

In various implementations, a system comprising: a resource provisioning unit (RPU) comprising a Compute Express Link (CXL) port configured to communicate with a first entity according to CXL.mem, and an Ultra Accelerator Link (UALink) port configured to communicate with a second entity according to a UALink-based protocol; wherein the RPU is configured to: receive, from the first entity via the CXL port, a CXL.mem Master-to-Subordinate (M2S) request; translate the CXL.mem M2S request to a UPLI request; and send the UPLI request to the second entity via the UALink port. The RPU may serve as a protocol translation bridge that enables entities in the CXL domain to access resources in the UALink domain. The CXL port may support CXL.mem M2S and S2M channels, while the UALink port may support UPLI request, read response/data, write response, and Originator Data channels. The RPU may translate between CXL.mem and UPLI including translations of opcodes, addresses, Tags, and additional fields. The first entity may include a CXL host such as a CPU, and the second entity may include an accelerator, a UALink switch, or other UALink-capable device. The RPU may be coupled to the first entity directly or via a CXL fabric, and may be coupled to the second entity directly or via a UALink switch. The system may be implemented within an IC package, across IC packages, or as a combination of discrete and integrated components.

In some implementations of the system, the RPU is further configured to: receive a UPLI read response (RdRsp) from the second entity via the UALink port; translate the UPLI RdRsp to a CXL.mem Subordinate-to-Master Data Response (S2M DRS); and send the CXL.mem S2M DRS to the first entity via the CXL port. The RPU may translate UPLI RdRsp fields to CXL.mem S2M DRS fields, including mapping the RdRspTag back to the corresponding CXL.mem Tag and formatting the RdRspData as CXL.mem data. The RPU may accumulate data from multiple UPLI response beats before constructing the S2M DRS.

In some implementations of the system, the RPU further comprises a cache; and wherein the RPU is further configured to store data from the UPLI RdRsp in the cache and send a CXL.mem Subordinate-to-Master No Data Response (S2M NDR) comprising Cmp-S to the first entity. By maintaining the fetched data in its cache, the RPU may participate in coherency management with the first entity and may respond to subsequent accesses to the same cacheline without issuing additional UPLI requests. The RPU with a cache may operate as a CXL Type-2 device.

In some implementations of the system, the first entity comprises a CXL host, the second entity comprises an accelerator; and wherein the RPU is configured to operate as at least one of a CXL Type-2 device or a CXL Type-3 device. The RPU may operate as a CXL Type-2 device utilizing HDM-D memory regions with device-managed coherency, or as a CXL Type-3 device utilizing HDM-H memory regions with host-managed coherency. In some examples, the RPU may expose both HDM-D and HDM-H regions concurrently, operating as a CXL Type-2 device for some memory regions and as a CXL Type-3 device for others.

In some implementations, the system further comprises a UALink switch coupled to the UALink port; wherein the RPU is configured to send the UPLI request to the second entity via the UALink switch. The UALink switch may route the UPLI request to the second entity based on a Destination Accelerator ID carried in the UPLI request. The RPU may appear to entities in the UALink domain as a UALink endpoint identified by an Accelerator ID.

In some implementations of the system, the RPU is further configured to: receive, from the first entity via the CXL port, a CXL.mem Master-to-Subordinate Request with Data (M2S RwD) comprising MemWr*; translate the CXL.mem M2S RwD to a UPLI request comprising a write command; and send the UPLI request and write data to the second entity via the UALink port. The RPU may translate CXL.mem write opcodes to UPLI write commands and transfer the write data from the CXL.mem domain to the UPLI Originator Data Channel. When the MemWr* refers to MemWrPtl for partial writes, the RPU may translate the CXL.mem byte enables to UPLI OrigDataByteEn fields.

In computing environments where a host, such as a CPU, may need to access memory resources residing in a UALink domain, such as HBM and/or HBF coupled to accelerators in a UALink pod, the host may communicate via CXL.mem with an RPU that translates requests to UPLI for delivery to the accelerators via a UALink switch. The UALink pod may include accelerators coupled to a UALink switch, forming a high-bandwidth interconnect fabric for inter-accelerator communication. The RPU may be embedded within one of the accelerators, or may be a discrete component coupled to the UALink switch. In some configurations, the system may include a CXL fabric coupling the host to the RPU and to CXL memory devices such as GFDs, memory expanders, or memory pools, enabling the host to access both CXL domain resources and UALink domain resources. The multi-path topology may enable the host to access different accelerators and memory resources via different translation paths, supporting workloads such as AI inference where data may be staged from CXL memory to accelerator memory.

In various implementations, a system comprising: a host; a UALink pod comprising a UALink switch and accelerators coupled to the UALink switch, wherein the accelerators communicate according to a UALink-based protocol; a resource provisioning unit (RPU) coupled to the host via CXL.mem and coupled to the UALink switch; and wherein the RPU is configured to receive a CXL.mem Master-to-Subordinate (M2S) request from the host, translate the CXL.mem M2S request to a UPLI request, and send the UPLI request to an accelerator of the accelerators via the UALink switch. The system may enable the host to access memory resources residing in the UALink domain, such as HBM and/or HBF coupled to the accelerators, DRAM within the accelerators, or memory accessible via the UALink network. The RPU may translate between CXL.mem and UPLI including translations of opcodes, addresses, Tags, and additional fields. The UALink switch may route the UPLI request to the target accelerator based on a Destination Accelerator ID. The host may utilize CXL.mem M2S requests comprising memory read or write opcodes, and the RPU may translate these to corresponding UPLI read or write commands. The system may support workloads where the host stages data between CXL memory resources and accelerator memory, such as populating KV cache entries into accelerator HBM and/or HBF for AI inference workloads. The RPU may be implemented as a discrete component, as an IP block embedded within one of the accelerators, or as a chiplet within an IC package.

In some implementations of the system, the RPU is embedded within a first accelerator of the accelerators, and the first accelerator is coupled to the host via CXL.mem; and wherein the UPLI request is sent from the first accelerator to a second accelerator of the accelerators via the UALink switch. The embedded RPU may share the first accelerator's silicon die or IC package and may utilize the first accelerator's CXL port for communication with the host. The first accelerator may serve as both an accelerator in the UALink pod and as a translation bridge for the host to reach other accelerators.

In some implementations of the system, the RPU is separate from the accelerators and is coupled to the UALink switch via a UALink port. The discrete RPU may function as a standalone protocol translation component that does not perform accelerator compute functions. This configuration may enable the RPU to be deployed independently of the accelerator design, potentially supporting different generations of accelerators or different UALink pod configurations.

In some implementations, the system further comprises a CXL fabric coupling the host to the RPU; and further comprising a CXL memory device coupled to the host via the CXL fabric, wherein the host is configured to access the CXL memory device via CXL.mem. The CXL fabric may include one or more CXL switches and may provide connectivity between the host, the RPU, and CXL memory devices. The host may access the CXL memory device via CXL.mem without protocol translation, while accessing accelerator memory in the UALink pod via the RPU with protocol translation.

In some implementations of the system, the CXL memory device comprises at least one of: a Global Fabric-Attached Memory Device (GFD), a CXL memory expander, or a CXL memory pool. The GFD may provide large-capacity memory resources accessible via CXL.mem, and may be shared among the host and other CXL entities. The host may stage data between the CXL memory device and accelerator memory via the RPU, such as migrating KV cache entries for AI inference workloads.

In some implementations of the system, the RPU is further configured to receive a UPLI read response (RdRsp) from the accelerator via the UALink switch, translate the UPLI RdRsp to a CXL.mem Subordinate-to-Master Data Response (S2M DRS), and send the CXL.mem S2M DRS to the host; and wherein the host comprises a central processing unit (CPU), and the accelerators comprise graphics processing units (GPUs) or tensor processing units (TPUs). The CPU may utilize the CXL.mem response to populate data structures, migrate data between memory tiers, or perform orchestration tasks on behalf of AI or HPC workloads. The GPUs or TPUs may serve as computational accelerators within the UALink pod.

In some implementations, the system further comprises a second RPU coupled to the host via CXL.mem and coupled to the UALink switch; wherein the RPU is configured to translate CXL.mem M2S requests from the host to UPLI requests targeting a first accelerator of the accelerators, and the second RPU is configured to translate CXL.mem M2S requests from the host to UPLI requests targeting a second accelerator of the accelerators. The RPUs may enable the host to access different accelerators through dedicated translation paths, potentially supporting different address ranges, different coherency policies, or different quality-of-service configurations for each path. The first and second RPUs may be discrete components or may include one embedded RPU and one discrete RPU.

In some implementations of the system, the UALink switch comprises a route table, and the UALink switch routes the UPLI request from the RPU to the accelerator based on a Destination Accelerator ID carried in the UPLI request; and wherein the accelerators communicate with the UALink switch via UPLI request channels and UPLI response channels. The UALink switch may route UPLI traffic based on the ReqDstPhysAccID field in each UPLI request, utilizing the route table to map the Destination Accelerator ID to an egress port coupled to the target accelerator. The route table may be programmed by a Pod Controller or other management entity. The RPU may populate the ReqDstPhysAccID based on the address of the CXL.mem M2S request or based on a preconfigured mapping.

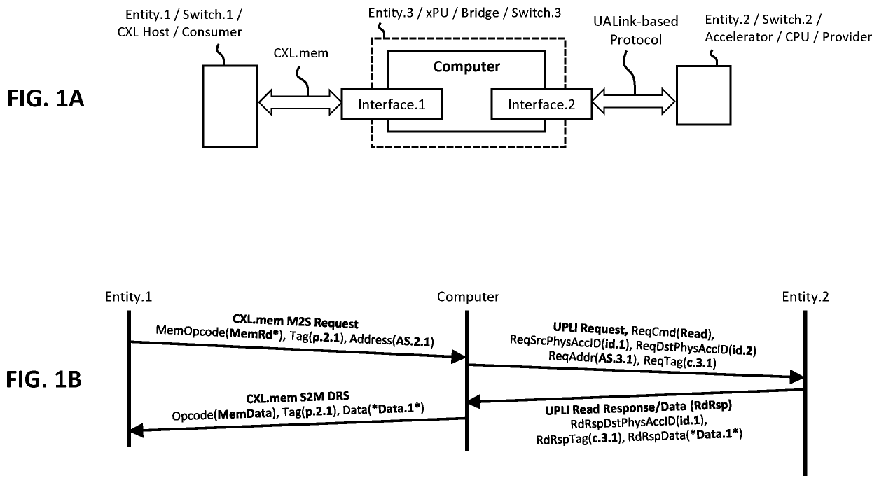

FIG. 1A illustrates an example of a block diagram showing a computer (Entity.3) coupled between a first entity (Entity.1) and a second entity (Entity.2). The first entity communicates with the computer via CXL.mem through a first interface (Interface.1), and the computer communicates with the second entity via a UALink-based protocol through a second interface (Interface.2). The first entity may include a CXL host, a switch, or a consumer of memory resources. The second entity may include an accelerator, a switch, or a provider of memory resources. The computer may include an xPU, a bridge, a switch, or an RPU.

FIG. 1B illustrates an example of a TFD demonstrating translations from a CXL.mem request from Entity.1 to a UPLI request sent to Entity.2, and from a UPLI read response from Entity.2 to a CXL.mem S2M DRS sent to Entity.1. The CXL.mem M2S request carries MemOpcode, Tag, and Address fields, and the UPLI request carries ReqCmd, ReqSrcPhysAccID, ReqDstPhysAccID, ReqAddr, and ReqTag fields. The UPLI read response carries RdRspDstPhysAccID, RdRspTag, and RdRspData fields, and the CXL.mem S2M DRS carries Opcode, Tag, and Data fields.

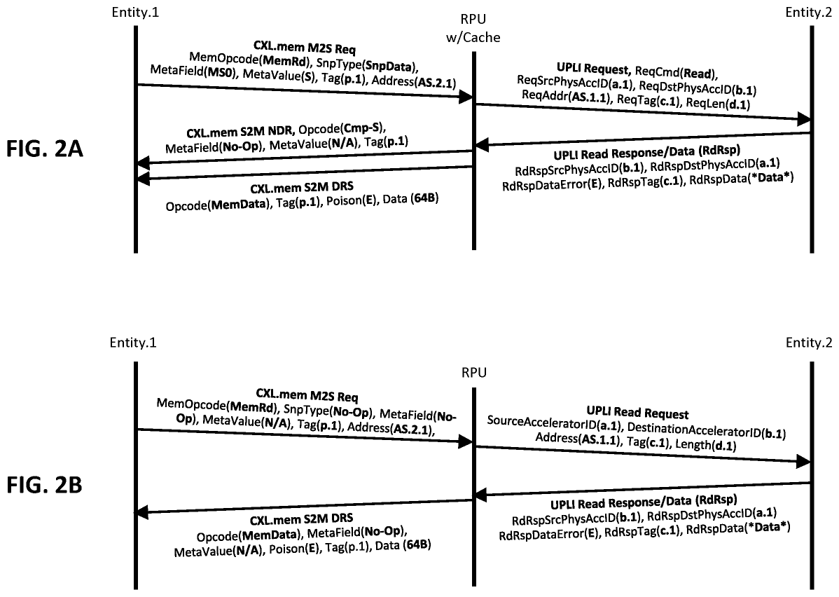

FIG. 2A illustrates an example of a TFD demonstrating an RPU comprising a cache (RPU w/Cache) that exposes a CXL Type-2 device utilizing an HDM-D memory region. Entity.1 sends a CXL.mem M2S request with SnpType(SnpData), MetaField(MS0), and MetaValue(S) to request a shared copy of a cacheline. The RPU translates the request to a UPLI request and receives a UPLI read response from Entity.2. The RPU stores the fetched data in its cache and sends a CXL.mem S2M NDR comprising Cmp-S to Entity.1, indicating a shared cacheline state, followed by a CXL.mem S2M DRS comprising MemData and the data.

FIG. 2B illustrates an example of a TFD demonstrating an RPU without a cache that exposes a CXL Type-3 device utilizing an HDM-H memory region. Entity.1 sends a CXL.mem M2S request with SnpType(No-Op) and MetaField(No-Op). The RPU translates the request to a UPLI request and receives a UPLI read response from Entity.2. The RPU translates the UPLI read response to a CXL.mem S2M DRS comprising MemData and the data, and sends the S2M DRS to Entity.1 without sending an S2M NDR.

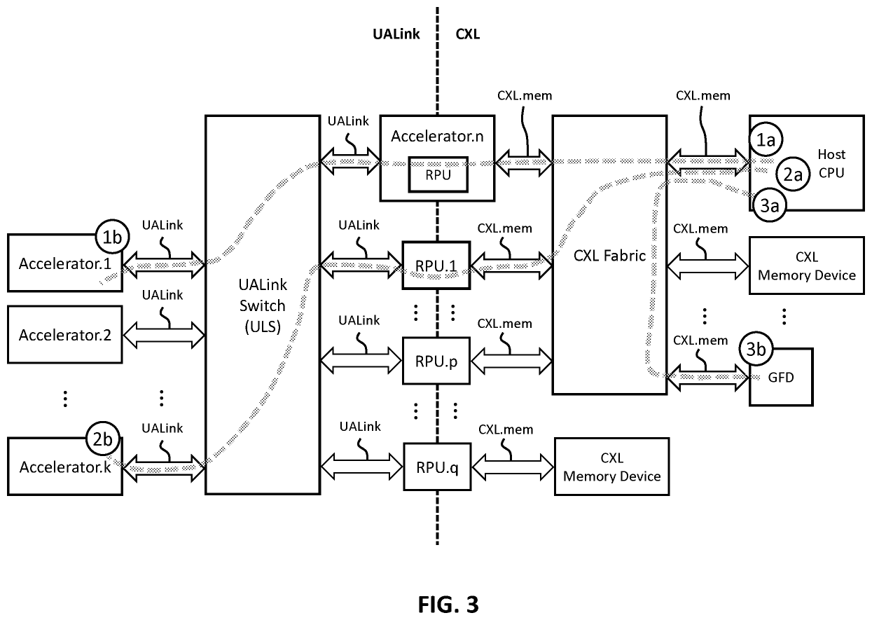

FIG. 3 illustrates an example of a system comprising a host CPU, a CXL fabric, a UALink switch, accelerators, and RPUs. Path 1 (1a to 1b) illustrates the host accessing Accelerator.1 via Accelerator. n that comprises an embedded RPU, wherein the host communicates with Accelerator. n via CXL.mem and Accelerator. n communicates with Accelerator.1 via UALink through the UALink switch. Path 2 (2a to 2b) illustrates the host accessing Accelerator. k via a discrete RPU (RPU.1) coupled to the UALink switch, wherein the host communicates with RPU.1 via CXL.mem and RPU.1 communicates with Accelerator.k via UALink. Path 3 (3a to 3b) illustrates the host accessing a GFD via CXL.mem through the CXL fabric.

In environments where entities may utilize different protocols while requiring coordinated access to shared resources, there may be scenarios where a first entity communicating according to UALink UPLI, such as an accelerator, needs to access memory resources coupled to a second entity communicating according to CXL, such as CXL.mem. An RPU may translate between UPLI and CXL.mem to facilitate memory operations, data transfers, and/or resource sharing across different protocol domains while maintaining the requirements of each protocol. The RPU may translate opcodes, commands, addresses, Tags, and additional fields between UPLI and CXL.mem messages, and may further perform address translations between different address spaces, such as between a Network Physical Address (NPA) space utilized by UALink-based traffic and a Host Physical Address (HPA) space utilized by CXL-based traffic, or between addresses within the same address space, such as a global address space, a partitioned global address space (PGAS), a pod address space, a virtual pod address space, or a fabric address space. The RPU may be implemented as a discrete component, as an IP block embedded in a processor, or as a chiplet within an IC package.

In various implementations, a method for translating from Ultra Accelerator Link (UALink) Protocol Level Interface (UPLI) requests to Compute Express Link (CXL) requests, comprising: communicating with a first entity according to UPLI; communicating with a second entity according to CXL.mem; receiving, from the first entity, a UPLI request comprising a read command and a first physical address; translating the UPLI request to a CXL.mem Master-to-Subordinate request comprising: a MemRd* and a second physical address (CXL.mem M2S Req MemRd*); and sending the CXL.mem M2S Req MemRd* to the second entity. The translation may enable entities communicating according to UPLI to access memory resources coupled to entities communicating according to CXL.mem. The method may be implemented in hardware, firmware, software, or combinations thereof, and may be performed by various types of devices, such as a processor, a switch, a bridge, an RPU, or a semiconductor device. MemRd* may refer to MemRd, MemRdData, MemRdTEE, MemRdDataTEE, or other memory read opcode variants defined or to be defined in CXL.mem. The first physical address may be associated with a first address space, such as an NPA space, and the second physical address may be associated with a second address space, such as an HPA space or an SPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The elements may communicate through one or more intermediary components, such as a switch, a retimer, or other suitable entity that facilitates information transfer.

In some implementations of the method, the UPLI request further comprises a ReqSrcPhysAccID field, a ReqDstPhysAccID field, a ReqLen field, a ReqTag field, a ReqAddr field comprising the first physical address, and a ReqCmd field comprising the read command; and further comprising translating the ReqTag to a Tag associated with the CXL.mem M2S Req. The ReqSrcPhysAccID and ReqDstPhysAccID fields may carry identifiers that may be utilized by the RPU for routing the UPLI request to its target, and may be further utilized for constructing response routing information. The ReqLen field may indicate a transfer size of up to 256 Bytes of data. When the ReqLen indicates a transfer size exceeding a CXL.mem cacheline size (e.g., 64 Bytes), the RPU may translate a UPLI request to multiple CXL.mem M2S requests. The Tag translation may involve maintaining a bidirectional mapping between UPLI ReqTag values and CXL.mem Tag values, enabling proper correlation of CXL.mem responses with their corresponding UPLI requests.

In some implementations, the method further comprises receiving, from the second entity, a CXL.mem Subordinate-to-Master Data Response (S2M DRS) comprising MemData, a Tag, and data; translating the CXL.mem S2M DRS to a UPLI read response (RdRsp) comprising a RdRspSrcPhysAccID field, a RdRspDstPhysAccID field, a RdRspTag field, and RdRspData comprising the data; and sending the UPLI RdRsp to the first entity. The RdRspSrcPhysAccID may correspond to the ReqDstPhysAccID from the original UPLI request, and the RdRspDstPhysAccID may correspond to the ReqSrcPhysAccID, reflecting the routing path for the response. The RdRspTag may be retrieved from the bidirectional mapping maintained by the RPU, enabling the first entity to correlate the response with its original request. In some examples, the RPU may accumulate data from one or more CXL.mem S2M DRS messages before sending the data via the UPLI RdRsp, such as when CXL.mem M2S requests were generated from a UPLI request.

In some implementations of the method, the CXL.mem S2M DRS further comprises a Poison field, and the UPLI RdRsp further comprises a RdRspDataError field; and further comprising translating the Poison field of the CXL.mem S2M DRS to the RdRspDataError field of the UPLI RdRsp. The Poison field in CXL.mem S2M DRS may indicate that the returned data contains an error. The RdRspDataError field in UPLI may serve as a per-beat data poison indicator. The translation of error indications across protocol boundaries may enable the first entity to detect data corruption that originated in the CXL domain, and to take appropriate recovery actions, such as discarding the corrupted data, retrying the request, or reporting the error to system management software.

In some implementations of the method, the read command comprises a Read Class Vendor Defined Command, the first entity comprises an accelerator or a UALink switch, the second entity comprises a CXL device, and the second physical address is a host physical address (HPA) utilized by the second entity. Read Class VDCs may correspond to ReqCmd encodings and may enable vendor-specific memory access operations that extend beyond the standard UPLI read commands. The CXL device may include a CXL memory expander, a CXL memory pool, a Global Fabric-Attached Memory (G-FAM) Device (GFD), or a CXL accelerator. The HPA may represent an address within the address space utilized by the second entity for servicing memory requests.

In some implementations of the method, the UPLI request indicates an I/O-coherent read, and the CXL.mem M2S Req MemRd* further comprises a SnpType field comprising SnpCur, a MetaField field comprising Meta0-State (MS0), and a MetaValue field comprising Invalid (I). The SnpType(SnpCur), MetaField(MS0), and MetaValue(I) combination in the CXL.mem M2S request may indicate an intent to perform an I/O-coherent read by requesting a non-cacheable but current value of the data. This combination may correspond to the I/O-coherency model utilized by UALink, wherein a read from peer memory returns the most recent coherent copy from memory or a cache within the destination's system node. The RPU may select the SnpType, MetaField, and MetaValue values based on a predefined, predetermined, configurable, rule-based, or dynamic intent mapping between the UPLI I/O-coherent read semantics and CXL.mem coherency fields.

In some implementations, the method further comprises sending to the second entity a CXL.mem M2S request comprising MemSpecRd. The speculative memory read may be initiated by the RPU to facilitate data availability from the second entity before, or without, the first entity explicitly requesting that data. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. When utilizing the MemSpecRd opcode, some of the CXL.mem M2S Req fields, such as Tag, MetaField, MetaValue, and SnpType, may be reserved. Additionally or alternatively, the RPU may issue reads (e.g., CXL.mem M2S requests comprising MemRd or MemRdData) to prefetch data from the second entity, and may buffer the returned data for satisfying subsequent demand requests from the first entity.

In some implementations of the method, the first physical address is associated with a first address space, the second physical address is associated with a second address space different from the first address space, and the translating further comprises translating the first physical address to the second physical address. The first address space may include an NPA space utilized by the UALink-based traffic, and the second address space may include an HPA space utilized by CXL-based traffic. The first and second address spaces may have different sizes, different base addresses, different memory layouts, or different granularities, and the translation may accommodate these differences while maintaining the meaning of the memory operations.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In computing environments where external entities, such as accelerators, may access memory resources coupled to a processing unit, there may be scenarios where the processing unit provides access to memory resources via different memory paths. For example, a processing unit may include a first memory path from a UALink port to a first memory via a memory controller, and a second memory path from the UALink port to a second memory via a CXL port. The processing unit may include an RPU that translates between a UALink-based protocol, such as UPLI, and the protocols utilized for accessing the first and second memories. The RPU may perform physical address translations, such as from NPAs to HPAs, to enable external entities to access both memory resources via the UALink port.

In various implementations, a system comprising: a processing unit comprising an Ultra Accelerator Link (UALink) port, a memory controller coupled to a first memory, and a Compute Express Link (CXL) port coupled to a second memory; wherein the UALink port is configured to communicate with an entity according to a UALink-based protocol; wherein the processing unit is configured to provide a first memory path from the UALink port to the first memory via the memory controller, and a second memory path from the UALink port to the second memory via the CXL port; and wherein the processing unit further comprises a resource provisioning unit (RPU) configured to receive a first UALink Protocol Level Interface (UPLI) request from the entity and forward a first translated request to the first memory via the first memory path, and to receive a second UPLI request from the entity and forward a second translated request to the second memory via the second memory path. The processing unit may be implemented as a processor, a system-on-chip (SoC), or as chiplets within an IC package. The first memory may include DRAM coupled to the memory controller, and the second memory may include a CXL memory expander, a CXL memory pool, or a CXL device that exposes memory resources. The RPU may perform physical address translations to determine whether a given UPLI request targets the first memory or the second memory, and may route the translated request to the appropriate memory path accordingly. The entity may include an accelerator, a CPU, or a switch that communicates with the processing unit via the UALink port according to UPLI. In some examples, the requested data may be provided by a cache of the processing unit, such as by LLC, instead of by the first or second memory.

In some implementations of the system, the processing unit further comprises a coherent interconnect, and wherein the first memory path and the second memory path traverse a portion of the coherent interconnect. The coherent interconnect may include a mesh network, a ring interconnect, a crossbar, a Network on Chip (NoC), or other types of interconnect fabrics that maintain cache coherency among processing cores and other components of the processing unit. The first memory path may traverse the coherent interconnect from the RPU to the memory controller, and the second memory path may traverse the coherent interconnect from the RPU to the CXL port. In some examples, the RPU may translate between the UALink-based protocol, such as UPLI, and a protocol utilized by the coherent interconnect. The paths from the RPU to the different memories may traverse other components coupled to the coherent interconnect, such as caching/home agent (CHA) slices, snoop filter (SF) slices, or LLC slices, optionally for resolving coherency.

In some implementations of the system, the CXL port comprises a CXL/PCIe root port (RP) coupled to the coherent interconnect. The CXL/PCIe RP may be a separate component on the coherent interconnect, enabling the processing unit to communicate with CXL devices coupled to the second memory. In other examples, the CXL/PCIe RP may be included within the RPU.

In some implementations of the system, the processing unit further comprises processing cores, caching/home agent (CHA), snoop filter (SF), and Last Level Cache (LLC) slices coupled to the coherent interconnect; and further comprising at least one of: a PCIe root port coupled to an I/O device, or an inter-socket link (ISoL) port coupled to a second processing unit. The processing cores, CHA/SF/LLC slices, and additional ports may be coupled to the coherent interconnect, enabling coordinated access to memory resources. The PCIe RP may be coupled to an I/O device, such as a network controller, an Ethernet NIC, an InfiniBand adapter, or a PCIe GPU. The ISoL port may utilize NVIDIA NVLink-C2C, ARM CHI C2C, or ICPIP for inter-socket or inter-chip communication.

In some implementations of the system, the UALink port, the CXL port, and the memory controller are located in a same integrated circuit (IC) package; and wherein the RPU is further configured to translate physical addresses associated with the UALink-based protocol to physical addresses associated with the processing unit, enabling the entity to access the first memory and the second memory. The IC package may be implemented as a monolithic die or as chiplets within a multi-chip module. The physical address translation may include translating Network Physical Addresses (NPAs) carried in UPLI requests to Host Physical Addresses (HPAs) utilized by the processing unit's address space. The translated addresses may be utilized by the processing unit to determine whether a given request targets the first memory or the second memory, and to route the translated request to the appropriate memory path.

In some implementations of the system, the second translated request comprises a CXL.mem Master-to-Subordinate (M2S) request comprising MemRd*, and the CXL port is configured to send the CXL.mem M2S request to the second memory; and wherein the CXL port is further configured to receive a CXL.mem Subordinate-to-Master Data Response (S2M DRS) comprising MemData and data from the second memory, and the RPU is further configured to translate the CXL.mem S2M DRS to a UPLI read response (RdRsp) comprising the data and send the UPLI RdRsp to the entity. The second memory path may utilize CXL.mem for communication between the CXL port and the second memory, wherein the RPU may translate between UPLI and CXL.mem, including translations of addresses, Tags, and opcodes. The second memory may include a CXL memory expander or a CXL device that responds to CXL.mem M2S requests with CXL.mem S2M DRS messages carrying the requested data.

In computing environments where a cluster of accelerators may be coupled via a switch, the accelerators may need to access memory resources that are external to the UALink domain. For example, memory resources such as CXL memory expanders, CXL memory pools, or GFDs may be coupled to the cluster via an RPU that translates between the UALink-based protocol utilized by the accelerators and CXL.mem utilized by the CXL memory devices. In some configurations, the RPU may be coupled to multiple distinct CXL memory devices, and may route translated requests to different CXL memory devices based on the physical addresses carried in the UPLI requests received from the accelerators. The RPU may thus enable accelerators within the cluster to access a pool of CXL memory resources distributed across devices, while the switch provides the communication fabric among the accelerators and between the accelerators and the RPU.

In various implementations, a system comprising: a switch; accelerators coupled to the switch, wherein the accelerators communicate according to a UALink-based protocol; a resource provisioning unit (RPU) coupled to the switch; a first Compute Express Link (CXL) memory device coupled to the RPU; and a second CXL memory device coupled to the RPU; wherein the RPU is configured to receive a first UALink Protocol Level Interface (UPLI) request and a second UPLI request from a first accelerator of the accelerators via the switch, translate the first UPLI request to a first CXL.mem Master-to-Subordinate (M2S) request and send the first CXL.mem M2S request to the first CXL memory device, and translate the second UPLI request to a second CXL.mem M2S request and send the second CXL.mem M2S request to the second CXL memory device. The system may enable accelerators within a UALink cluster to access CXL memory resources that reside outside the UALink domain, without requiring modifications to the accelerators'UALink interfaces or protocols. The RPU may determine which CXL memory device to target for each translated request based on the physical address carried in the UPLI request, for example by comparing the address against address range registers or translation tables that map address ranges to specific CXL memory devices. The first and second CXL memory devices may have different capacities, different performance characteristics, different address ranges, or different device types. The RPU may be implemented as a discrete component coupled to the switch, as an IP block embedded within one of the accelerators, or as a chiplet within an IC package. The RPU may translate between UPLI and CXL.mem including translations of opcodes, addresses, Tags, and additional fields. In some examples, the RPU may be coupled to more than two CXL memory devices, and may distribute translated requests across the CXL memory devices based on address, load balancing policies, or other criteria. The method may be implemented in hardware, firmware, software, or combinations thereof.

In some implementations of the system, at least one of the first CXL memory device or the second CXL memory device comprises a Global Fabric-Attached Memory Device (GFD); and wherein the RPU is further configured to receive a CXL.mem Subordinate-to-Master Data Response (S2M DRS) from the GFD, translate the CXL.mem S2M DRS to a UPLI read response (RdRsp), and send the UPLI RdRsp to the first accelerator via the switch. The GFD may provide large-capacity memory resources accessible via CXL.mem, and may be shared among requesters including accelerators via the RPU and hosts via direct CXL.mem access. The RPU may translate the CXL.mem S2M DRS, including by translating the Tag back to the original UPLI ReqTag and formatting the data as UPLI RdRspData for delivery to the first accelerator.

In some implementations, the system further comprises a host coupled to at least one of the first CXL memory device or the second CXL memory device via CXL.mem; wherein both the first accelerator, via the RPU, and the host access the at least one of the first CXL memory device or the second CXL memory device. The shared access configuration may enable both accelerators and hosts to access the same CXL memory resources, potentially for data sharing, producer-consumer communication, or tiered memory management. The host may access the CXL memory device via CXL.mem without translation, while the accelerators access the same CXL memory device via the RPU that translates between UPLI and CXL.mem.

In some implementations, the system further comprises a CXL fabric coupling the RPU to the first CXL memory device and the second CXL memory device; wherein at least one of the first CXL memory device or the second CXL memory device comprises at least one of: a CXL memory expander, a CXL memory pool, or a Global Fabric-Attached Memory Device (GFD). The CXL fabric may include one or more CXL switches, and may provide connectivity between the RPU and CXL memory devices. The CXL fabric may enable the RPU to reach CXL memory devices that are not directly coupled to the RPU.

In some implementations of the system, the first UPLI request comprises a first physical address associated with a first address space, and the second UPLI request comprises a second physical address associated with the first address space; wherein the first CXL.mem M2S request comprises a third physical address associated with a second address space, and the second CXL.mem M2S request comprises a fourth physical address associated with the second address space; and wherein the RPU translates the first physical address to the third physical address and the second physical address to the fourth physical address; and wherein the first address space comprises a Network Physical Address (NPA) space or a System Physical Address (SPA) space, and the second address space comprises a Host Physical Address (HPA) space. The address translation may be implemented utilizing lookup tables, page tables, base-and-offset calculations, range-based mapping, and/or programmable translation functions. The RPU may determine which CXL memory device to target based on the translated address, for example by comparing the third or fourth physical address against address ranges assigned to the first and second CXL memory devices. In some examples, the first and second address spaces may be the same address space, such as a global address space or a fabric address space, and the RPU may perform routing without address translation.

In some implementations of the system, the switch comprises a UALink switch comprising a route table, and the UALink switch routes the first UPLI request and the second UPLI request from the first accelerator to the RPU based on a Destination Accelerator ID carried in the first UPLI request and the second UPLI request; and wherein the accelerators communicate with the UALink switch via UPLI request channels and UPLI response channels. The UALink switch may route UPLI traffic based on the ReqDstPhysAccID field in each UPLI request, utilizing the route table to map the Destination Accelerator ID to an egress port coupled to the RPU. The RPU may thus appear to the accelerators as a UALink endpoint identified by an Accelerator ID, enabling the accelerators to send UPLI requests to the RPU using standard UALink routing mechanisms. The route table may be programmed by a Pod Controller or other management entity. The UPLI request channels may carry read, write, atomic, and vendor defined commands, and the UPLI response channels may carry corresponding read responses and write responses.

In environments where entities communicating according to UPLI need to write data to memory resources coupled to entities communicating according to CXL.mem, an RPU or other translating device may translate between UPLI write requests and CXL.mem write requests. The write path involves translating from UPLI request and Originator Data channels to CXL.mem M2S RwD messages, and translating the CXL.mem S2M NDR completion back to a UPLI write response (WrRsp). The RPU may translate opcodes, commands, addresses, Tags, byte enables, and completion status between the two protocol domains. In some examples, the RPU may split a UPLI write request carrying a transfer size exceeding a CXL.mem cacheline size into multiple CXL.mem M2S RwD requests, and may aggregate the corresponding completions before returning the UPLI WrRsp to the originating entity.

In various implementations, a method for translating from Ultra Accelerator Link (UALink) Protocol Level Interface (UPLI) write requests to Compute Express Link (CXL) write requests, comprising: communicating with a first entity according to UPLI; communicating with a second entity according to CXL.mem; receiving, from the first entity, a UPLI request comprising a write command, a first physical address, and write data; translating the UPLI request to a CXL.mem Master-to-Subordinate Request with Data (M2S RwD) comprising a MemWr* and a second physical address; sending the CXL.mem M2S RwD and the write data to the second entity; receiving, from the second entity, a CXL.mem Subordinate-to-Master No Data Response (S2M NDR) comprising Cmp*; translating the CXL.mem S2M NDR to a UPLI write response (WrRsp); and sending the UPLI WrRsp to the first entity. The write translation may enable entities communicating according to UPLI to store data in memory resources coupled to entities communicating according to CXL.mem. The method may be implemented in hardware, firmware, software, or combinations thereof, and may be performed by various types of devices, such as a processor, a switch, a bridge, an RPU, or a semiconductor device. The first physical address may be associated with a first address space, such as an NPA space, and the second physical address may be associated with a second address space, such as an HPA space, wherein the translating may include translating the first physical address to the second physical address. Additionally or alternatively, the first and second physical addresses may be associated with the same address space, such as a global address space, a PGAS, a pod address space, a virtual pod address space, or a fabric address space. The UPLI write command may include a Write, a WriteFull, or a Write Class Vendor Defined Command as defined by the UPLI specification.

In some implementations of the method, the UPLI request further comprises a ReqSrcPhysAccID field, a ReqDstPhysAccID field, a ReqTag field, and a ReqAddr field comprising the first physical address; wherein the write data is received on a UPLI Originator Data (OrigData) channel comprising OrigDataByteEn; and further comprising translating the ReqTag to a Tag associated with the CXL.mem M2S RwD. The ReqSrcPhysAccID and ReqDstPhysAccID fields may carry identifiers utilized for routing the UPLI request and for constructing response routing information. The OrigDataByteEn field may carry per-byte enable bits indicating which bytes of the write data are valid. The Tag translation may involve maintaining a bidirectional mapping between UPLI ReqTag values and CXL.mem Tag values, enabling proper correlation of CXL.mem S2M NDR completions with their corresponding UPLI write requests.

In some implementations of the method, the MemWr* comprises MemWrPtl, and the write data comprises a partial cacheline update; and wherein byte enables associated with a UPLI Originator Data channel are utilized to indicate which bytes of the cacheline are to be written by the second entity. The MemWrPtl opcode may indicate a partial write where only a subset of bytes within a CXL.mem cacheline are updated. The byte enables from the UPLI OrigDataByteEn field may be propagated to the CXL.mem domain, enabling the second entity to update only the specified bytes while preserving the remaining bytes of the cacheline.

In some implementations of the method, the UPLI WrRsp further comprises a WrRspTag field and a WrRspStatus field, and the CXL.mem S2M NDR further comprises a Cmp* completion opcode; and further comprising translating a Tag of the CXL.mem S2M NDR to the WrRspTag of the UPLI WrRsp, and translating a completion status of the CXL.mem S2M NDR to the WrRspStatus of the UPLI WrRsp. The WrRspTag may be retrieved from the bidirectional mapping maintained by the RPU, enabling the first entity to correlate the write response with its original write request. The WrRspStatus may indicate success or failure of the write operation. The translation of completion status across protocol boundaries may enable the first entity to detect write failures that originated in the CXL domain and to take appropriate recovery actions.

In some implementations of the method, the first entity comprises an accelerator, the second entity comprises a CXL device comprising at least one of: a CXL memory expander, a CXL memory pool, or a Global Fabric-Attached Memory Device (GFD); the first physical address is associated with a Network Physical Address (NPA) space; and the second physical address is associated with a Host Physical Address (HPA) space; and wherein the translating further comprises translating the first physical address to the second physical address. The address translation from NPA to HPA may be implemented utilizing lookup tables, page tables, base-and-offset calculations, range-based mapping, and/or programmable translation functions. The GFD may provide large-capacity memory resources accessible via CXL.mem and shared among requesters.

In some implementations of the method, the UPLI request further comprises a ReqLen field indicating a transfer size exceeding a CXL.mem cacheline size; and wherein the translating further comprises generating CXL.mem M2S RwD requests from the UPLI request, each of the CXL.mem M2S RwD requests comprising a respective MemWr* and a respective portion of the write data. UPLI write requests may carry a ReqLen indicating a transfer size of up to 256 bytes, while CXL.mem M2S RwD messages may carry up to 64 bytes of data per request. When the ReqLen exceeds the CXL.mem cacheline size, the RPU may split the UPLI write request into CXL.mem M2S RwD requests, each carrying a respective portion of the write data with a respective translated address. The RPU may aggregate the corresponding CXL.mem S2M NDR completions before returning a UPLI WrRsp to the first entity.

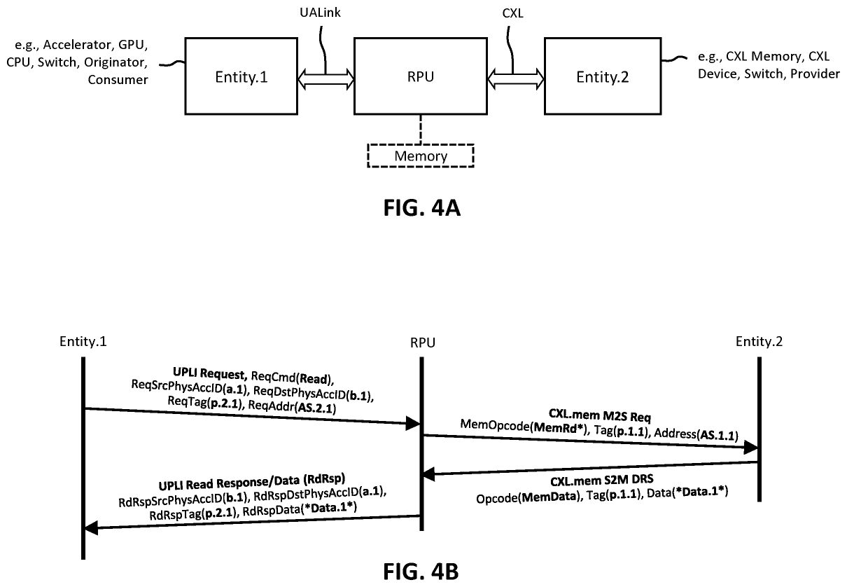

FIG. 4A illustrates an example of a system comprising an RPU, which may be coupled to memory, wherein the RPU may enable external entities to access resources coupled to the RPU. The RPU may translate between a UALink-based protocol (such as UPLI) and a CXL-based protocol (such as CXL.mem). Additionally or alternatively, the RPU may translate between UPLI and CXL.io, and/or between UPLI and CXL.cache. In some examples, the RPU may be implemented as a discrete component, such as on a PCB, coupled to other components such as CPUs, GPUs, accelerators, switches, or CXL devices. In other examples, the RPU may be embedded in another silicon design, such as an IP within a processor, or may be implemented as a chiplet within an IC package. The RPU is coupled to a first entity (Entity.1), which may be an accelerator, a GPU, a CPU, a switch, an originator, or a consumer, wherein the RPU may communicate with the first entity according to a UALink-based protocol, such as UPLI. The RPU is further coupled to a second entity (Entity.2), which may be a CXL memory, a CXL device, a switch, or a provider, wherein the RPU may communicate with the second entity according to a CXL-based protocol, such as at least one of CXL.mem, CXL.io, or CXL.cache. In some examples, the UALink-based traffic, such as UPLI traffic, may be associated with a first address space, such as an NPA space, and the CXL-based traffic, such as CXL.mem traffic, may be associated with a second address space, such as a System Physical Address (SPA) space or a Host Physical Address (HPA) space; wherein the RPU may perform address translations between addresses within the first and second address spaces, respectively, such as between addresses within the NPA space and addresses within the SPA space or the HPA space. In other examples, the UALink-based traffic and the CXL-based traffic may be associated with the same physical address space, such as with a global address space, a partitioned global address space (PGAS), a pod address space, a virtual pod address space, or a fabric address space; wherein the RPU may perform address translations between addresses within the same address spaces. The RPU may perform further translations, such as opcode, command, or TLP translations, e.g., translating between commands in requests conforming to the UALink-based protocol (e.g. UPLI vendor-defined read command) to opcodes in requests conforming to the CXL-based protocol (e.g., CXL.mem MemRd). The RPU may further translate between messages conforming to the UALink-based protocol and messages conforming to the CXL-based protocol, Tag translations, traffic class (TC) translations, and/or cross-field translations such as between CXL.mem Tag and UPLI ReqTag, and/or between UPLI RdRspTag and CXL.mem Tag. Additionally, the RPU may maintain tracking between Tags in the UPLI domain and Tags in the CXL domain, such as in order to associate responses with their corresponding requests. The RPU may further translate error indications, such as poison.

FIG. 4B illustrates an example of a TFD demonstrating translations performed by an RPU, between UALink-based traffic, such as UPLI traffic, utilized for communicating with a first entity (Entity.1), such as an accelerator, a GPU, a CPU, a switch, an originator, or a consumer, and CXL-based traffic, such as CXL.mem traffic, utilized for communicating with a second entity (Entity.2), such as a CXL device, a CXL memory, or a CXL switch. Additionally or alternatively, the RPU may translate between UPLI and CXL.io requests, and/or between UPLI and CXL.cache requests. The first entity may initiate a UPLI transaction that may include a UPLI request (Req) comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Tag (e.g., ReqTag(p.2.1)), and Request Address (e.g., ReqAddr(AS.2.1)). The RPU may translate the UPLI transaction to a CXL.mem transaction that may include a CXL.mem M2S request comprising MemOpcode(MemRd*), Tag(p.1.1), and Address(AS.1.1), and may send the CXL.mem M2S request to the second entity. The asterisks in the translated CXL.mem M2S request MemRd indicate that this could represent any suitable superset combination of read opcodes, commands, or operations, supported by CXL.mem, such as MemRd, MemRdData, MemRdTEE, MemRdDataTEE, etc. The RPU may further translate between other fields of the UPLI transaction and fields of the CXL.mem transaction, such as between address fields, Tag fields, QoS-related fields, or identification (ID) fields that may serve to route the UPLI request to its target.

Upon receiving a response from the second entity, that may include a CXL.mem S2M DRS comprising Opcode(MemData), Tag(p.1.1), and Data(*Data.1*), the RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(p.2.1)), and Read Response Data (e.g., RdRspData(*Data.1*)). Optionally, the RPU may act as an endpoint, or may act as a completer device, and may terminate the UPLI transactions. The RPU may issue the CXL.mem transactions, optionally acting as an independent protocol initiator, such as a CXL host, and may utilize translated fields from the UPLI transaction for constructing the CXL.mem transaction. The RPU may perform further translations, such as opcode or command translations, e.g., translating between vendor-defined read commands in UPLI requests and MemRd in CXL.mem requests. The RPU may further translate between messages conforming to UPLI and messages conforming to CXL.mem, translate Tags, and/or translate error indications, such as poison.

In some examples, the RPU may translate a UPLI transaction to multiple CXL.mem transactions, such as when the UPLI request may include a request length field, such as ReqLen, that may carry values representing a read of up to 256 Bytes of data, wherein the RPU may translate such UPLI requests to CXL.mem M2S requests, such that each may carry up to 64 Bytes of data that may represent a cacheline. The RPU may further translate between CXL.mem responses, such as CXL.mem S2M NDR and/or CXL.mem S2M DRS, and UPLI responses, such as UPLI read response, and may forward read data carried in CXL.mem DRS messages into the UPLI read response. In some examples, the RPU may accumulate data from one or more CXL.mem DRS messages before sending the data via the UPLI read response.

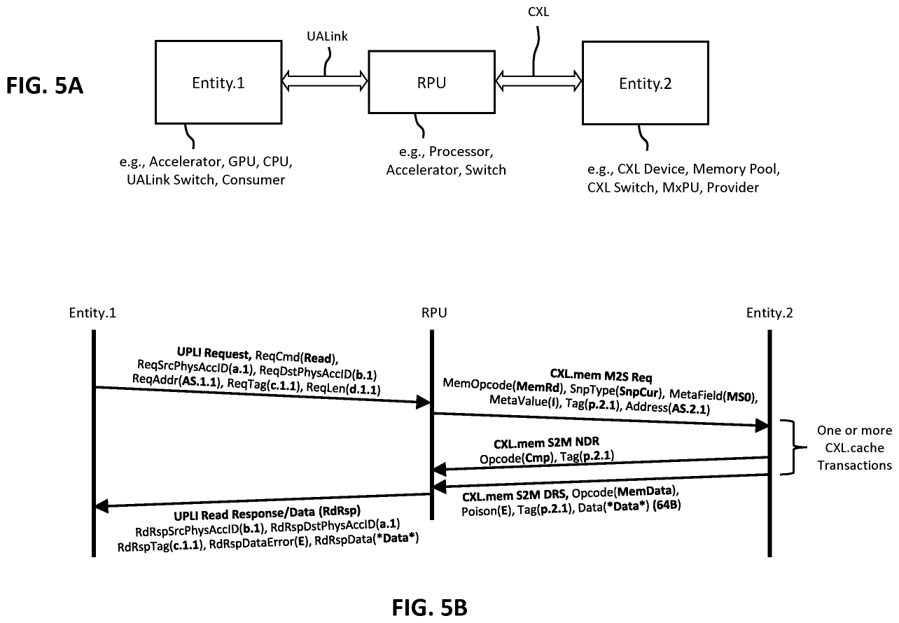

FIG. 5A illustrates an example of a system comprising an RPU (such as a processor, an accelerator, or a switch) that enables external entities to access resources coupled to the RPU, such as CXL devices or CXL memory. The RPU is coupled to a first entity (Entity.1), which may be an accelerator, a GPU, a CPU, a UALink switch, or a consumer, wherein the RPU may communicate with the first entity according to a UALink-based protocol, such as a UPLI. The RPU is further coupled to a second entity (Entity.2), which may be a CXL device, CXL memory, CXL-based memory pool, a CXL switch, an MxPU, or a provider, wherein the RPU may communicate with the second entity according to a CXL-based protocol, such as CXL.mem. In some examples, the UALink-based protocol, such as UPLI, may be associated with a first address space, such as an NPA space, and the CXL-based protocol, such as CXL.mem, may be associated with a second address space, such as an HPA space; wherein the RPU may perform address translations between addresses within the first and second address spaces, respectively, such as between addresses within the NPA space and addresses within the HPA space. In other examples, the UALink-based protocol, such as UPLI, and the CXL-based protocol, such as CXL.mem, may be associated with the same physical address space, such as a global address space; wherein the RPU may perform address translations between addresses within the same address spaces. The RPU may perform further translations, such as opcode or command translations, e.g., translating between Read commands in UPLI requests and MemRd in CXL.mem requests. The RPU may further translate between messages conforming to UPLI and messages conforming to CXL.mem, translate Tags, and/or translate error indications, such as poison.

FIG. 5B illustrates an example of a TFD demonstrating an RPU that may translate between UALink-based traffic, such as UPLI traffic, and CXL-based traffic, such as CXL.mem traffic. Additionally or alternatively, the RPU may translate between UPLI and CXL.io, and/or between UPLI and CXL.cache. The RPU may provide intent-based translation between protocols, such as between UPLI and CXL.mem, identifying the intent of a received transaction, and generating a translated transaction that may convey a corresponding intent, or convey an intent based on a predefined, predetermined, configurable, rule-based, or dynamic mapping between intentions. The RPU may receive from a first entity (Entity.1), such as an accelerator, a UALink UPLI transaction that may include a UPLI request comprising Request Command (e.g., ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)). The received UPLI transaction may indicate an intent to perform an I/O-coherent read, e.g., a request for the most recent copy of the data, corresponding to an I/O-coherency model that may be typical for UALink.

The RPU may translate the UPLI transaction to a CXL.mem transaction, that may include a CXL.mem M2S request comprising Memory Operation (e.g., MemOpcode(MemRd)), Snoop Type (e.g., SnpType(SnpCur)), Metadata Field (e.g., MetaField(MS0)), Metadata Value (e.g., MetaValue(I)), Tag(p.2.1), and Address(AS.2.1). This translation from UPLI to CXL.mem may indicate an intent to perform an I/O-coherent read, via a CXL.mem request for a non-cacheable but current value of the data, wherein the data may be represented as 64 B cachelines that correspond to the Request Length (e.g., ReqLen(d.1.1)) in the UPLI request. The RPU may further translate between other values of the UPLI transaction and the CXL.mem transaction, such as between addresses, Tags, QoS-related values, or identifications (IDs) that may serve to route the UPLI request to its destination.

In some examples, the RPU may translate a UPLI transaction to multiple CXL.mem transaction, such as when the UPLI request comprises a request length field (e.g., ReqLen), which may carry values indicating a read of more than 64 Bytes of data, wherein the RPU may translate such UPLI requests to CXL.mem M2S requests, such that each may carry up to 64 Bytes of data, possibly representing a 64 Byte cacheline. The RPU may further translate between CXL.mem responses, such as CXL.mem S2M NDR and/or CXL.mem S2M DRS, and UPLI responses, such as UPLI read responses, and may forward read data carried in CXL.mem DRS messages via UPLI read responses.

In some examples, the RPU may receive a response from the second entity (Entity.2), which may include a CXL.mem S2M NDR comprising Opcode(Cmp) and Tag(p.2.1), and may further include a CXL.mem S2M DRS comprising Opcode(MemData), Poison(E), Tag(p.2.1), and Data(*Data*). The RPU may translate the CXL.mem S2M DRS to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), Read Response Data Error (e.g., RdRspDataError(E)), and Read Response Data (e.g., RdRspData(*Data*)). This translation demonstrates that the RPU may propagate error responses from the CXL domain to the UPLI domain, such as by translating error indications carried in CXL.mem S2M DRS messages, such as poison, to error indications carried in UPLI RdRsp messages, such as Read Response Data Error (e.g. RdRspDataError). Additionally, the RPU may accumulate data from one or more CXL.mem DRS messages before sending the data via the UPLI read response.

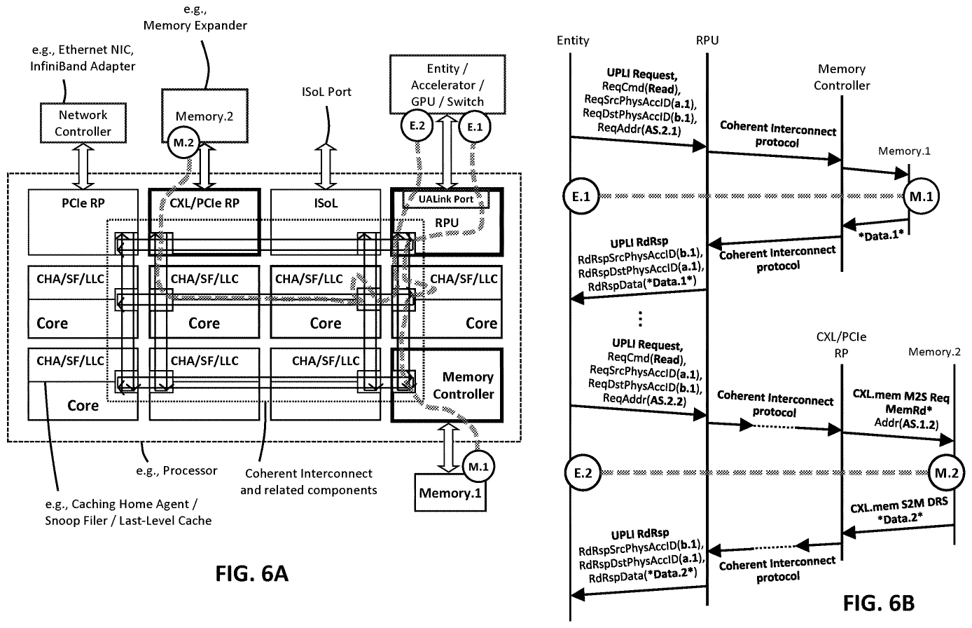

FIG. 6A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a Network Controller, such as an Ethernet NIC or an InfiniBand Adapter, a CXL/PCIe RP, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may be coupled to a second memory (Memory.2), such as a CXL memory expander, and may further include an RPU that includes or is coupled to a UALink port that may communicate with the entity according to a UALink-based protocol, such as UPLI, wherein the RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may be implemented as an IP block embedded into a silicon design, such as a switch or an accelerator. In other examples, the processor may be implemented as a monolithic die, as chiplets within an IC package, or as components on a board, and may utilize a mesh-based coherent interconnect, may utilize a ring, a crossbar, a Network on Chip (NoC) or other types of coherent interconnects.

FIG. 6B illustrates an example of a TFD demonstrating two UPLI requests, such as UPLI read requests, received from an entity, such as a GPU or an accelerator, processed by an RPU and forwarded, possibly using a protocol utilized by a coherent interconnect, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), to enable the entity to access the processor's memories. The processor may have multiple memory resources, such as first memory (Memory.1), which may be a DRAM coupled to a memory controller of the processor, and/or second memory (Memory.2), which may be a CXL memory expander coupled to a CXL/PCIe RP of the processor. The RPU may further perform additional translations, such as protocol translations from a UALink-based protocol, such as UPLI, to a protocol utilized by the coherent interconnect, and may send the optionally translated request to the coherent interconnect, requesting a read from memory. In some examples, the requested data may be provided by a processor cache, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction includes a first UPLI request (Req) comprising physical address (AS.2.1), which may be an NPA, which the RPU translates and forwards via the coherent interconnect protocol and via the memory controller to the first memory (Memory.1), resulting in the retrieval of *Data.1*, that is sent to the entity via the coherent interconnect protocol and via the RPU with the first UPLI RdRsp. The second exemplary transaction includes a second UPLI request comprising physical address (AS.2.2), which may be an NPA, which the RPU may translate to physical address (AS.1.2) and forward to the second memory (Memory.2), via the coherent interconnect protocol and via the CXL/PCIe RP, utilizing a CXL.mem M2S request. *Data.2* is retrieved from the second memory utilizing a CXL.mem S2M DRS, and sent to the RPU via the coherent interconnect protocol. The RPU may then send *Data.2* to the entity via the second UPLI RdRsp. It is noted that the physical addresses (AS.2.1) and (AS.2.2) may refer to different memory regions within an NPA address space exposed via the UALink port, enabling the entity to access memory resources based on the RPU's translation capabilities.

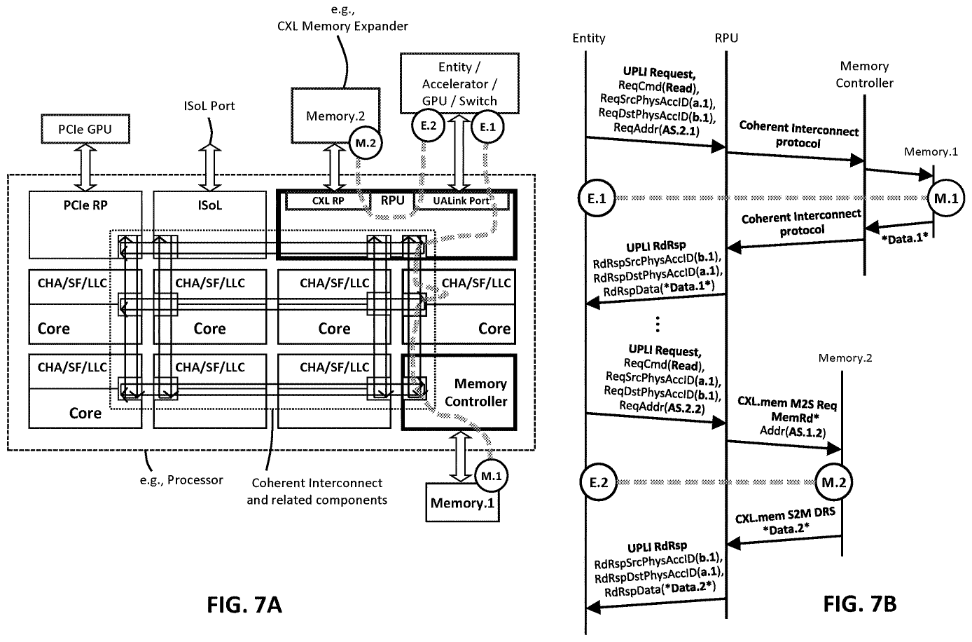

FIG. 7A illustrates an example of a system comprising a processor, including a coherent interconnect, capable of enabling an external entity, such as a GPU or an accelerator, to access memory resources mapped to an address space utilized by the coherent interconnect, such as via one or more of the two illustrated paths denoted as (E.1)-(M.1) and (E.2)-(M.2). The processor may include processing cores, caching/home agent (CHA), snoop filter (SF), and LLC, optionally implemented as distributed slices coupled to the coherent interconnect. The processor may further include a PCIe RP that may be coupled to a PCIe GPU, a memory controller that may be coupled to a first memory (Memory.1), such as DRAM, and an ISoL port, such as a port utilizing NVIDIA NVLink-C2C, ARM CHI C2C, or Intel Coherent Processor Interconnect Protocol (ICPIP), such as Intel UPI. The processor may include an RPU that includes or is coupled to a UALink port that may communicate with the entity according to a UALink-based protocol, such as UPLI, wherein the RPU further includes a CXL RP coupled to a second memory (Memory.2), such as a CXL memory expander. The RPU may perform physical address translations to enable the entity to access the first memory, such as over the path (E.1)-(M.1), and/or access the second memory, such as over the path (E.2)-(M.2). The illustrated RPU may be coupled to the coherent interconnect, and may translate between the UALink-based protocol and a protocol utilized by the coherent interconnect. The processor may utilize a mesh-based coherent interconnect, or in other examples may utilize a ring, a crossbar, a Network on Chip (NoC) or other types of coherent interconnects.

FIG. 7B illustrates an example of a TFD demonstrating two UPLI requests, such as UPLI read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations, such as from Network Physical Addresses (NPAs) to Host Physical Addresses (HPAs), or from NPAs to System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between a UALink-based protocol, such as UPLI, and a protocol utilized by the coherent interconnect, wherein the RPU may send the optionally translated UPLI requests to the coherent interconnect, requesting reads from memory, such as from the first memory or from the second memory. The RPU may further translate between UALink-based traffic, such as UPLI traffic, and CXL-based traffic, such as at least one of CXL.mem, CXL.io, or CXL.cache traffic, wherein the RPU may send the optionally translated UPLI traffic to the second memory via the CXL RP. In some examples, the requested data may be provided by a cache of the processor, such as by an LLC, instead of by the memory. The data may then return over the coherent interconnect to the RPU, wherein the RPU provides UPLI read response/data (RdRsp) to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first UPLI request (Req) comprising physical address (AS.2.1), which may be an NPA, which the RPU may translate and forward via the coherent interconnect protocol and via the memory controller to the first memory, resulting in the retrieval of *Data.1*, that is sent to the entity via the coherent interconnect protocol and via the RPU with the first UPLI RdRsp. The second exemplary transaction corresponds to the memory read path denoted as (E.2)-(M.2), and may include a second UPLI request comprising physical address (AS.2.2), which may be an NPA. The RPU may translate the second UPLI request to a CXL.mem M2S request comprising MemRd* and Address(AS.1.2), wherein the RPU may send the translated request to the second memory via the CXL RP. *Data.2* is retrieved from the second memory utilizing a CXL.mem S2M DRS, and sent to the RPU via the CXL RP, wherein the RPU may send *Data.2* to the entity utilizing the second UPLI RdRsp.

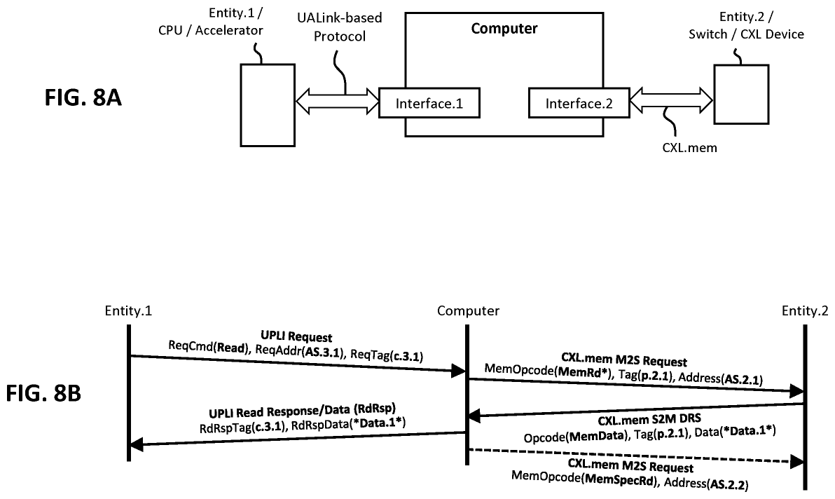

FIG. 8A illustrates an example of a system comprising a computer, that may be included in a switch or in a bridge, comprising a first interface (Interface.1) and a second interface (Interface.2). The first interface may communicate according to a UALink-based protocol, such as UPLI, with a first entity (Entity.1), which may be a CPU or an accelerator. The second interface may communicate according to CXL.mem, with a second entity (Entity.2), such as a switch, or a CXL device which may be a CXL memory expander, a CXL memory pool, a GFD, or a CXL accelerator. The computer may extract addresses from requests received via the first interface, wherein these addresses may refer to a first address space, such as a Network Physical Address (NPA) space utilized by the first entity. The computer may further translate these addresses, and generate requests carrying the translated addresses for transmission via the second interface; wherein these translated addresses may refer to a second address space utilized by the second entity. In other examples, the first address space and the second address space may be associated with the same address space, such as a common address space, a global address space, a pod address space, or a fabric address space, wherein the computer may perform address translations between addresses within the same common address space. The computer may be implemented in an IC package having high-speed differential I/O balls positioned according to a ball grid array layout defined by a retimer specification.

FIG. 8B illustrates an example of a TFD demonstrating translations, such as address translations, performed by a computer, between: (1) first physical addresses, such as Network Physical Addresses (NPAs), carried in UALink-based requests, such as UPLI requests, received from a first entity (Entity.1), which may be a CPU or an accelerator; and (2) second physical addresses, such as Host Physical Addresses (HPAs), carried in CXL requests, such as CXL.mem requests, sent to a second entity (Entity.2), which may be a switch or a CXL device, possibly enabling the first entity to access resources mapped to an address space utilized by the second entity. The first entity may initiate a UPLI transaction that may include a UPLI request comprising ReqCmd(Read), ReqAddr(AS.3.1), and ReqTag(c.3.1). The computer may translate the UPLI transaction to a CXL transaction that may include a CXL.mem M2S request comprising MemOpcode(MemRd*), Tag(p.2.1), and Address(AS.2.1), and may send the CXL.mem M2S request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to a UPLI read response/data (RdRsp) comprising RdRspTag(c.3.1) and RdRspData(*Data.1*), and send the UPLI RdRsp to the first entity.

The computer may further initiate speculative memory reads targeting the second entity, wherein the speculative memory reads may include a CXL.mem M2S request comprising MemOpcode(MemSpecRd) and Address(AS.2.2), and wherein the computer may utilize the speculative memory reads, optionally on behalf of the first entity, to facilitate data prefetches and potentially reduce read latency from the second entity. When utilizing the MemSpecRd opcode, some of the CXL.mem M2S Req fields, such as Tag, MetaField, MetaValue, and SnpType, may be reserved. The computer may perform further translations, such as protocol translations, opcode translations, command translations, TLP type translations, and translations between the UALink-based domain and the CXL domain. In some examples, the computer may issue multiple CXL.mem reads in response to receiving a UPLI request from the first entity. For example, the computer may issue CXL.mem M2S requests comprising MemRd or MemRdData, such as when splitting a UPLI request for a large block of data (e.g., 256 B) to smaller CXL.mem reads (e.g., 64 B each), or when prefetching data from the second entity utilizing CXL.mem reads. The computer may translate requests or transactions initiated from the UALink-based domain to the CXL domain, may translate requests or transactions initiated from the CXL domain to the UALink-based domain, or may translate requests or transactions initiated from both domains.

Heterogeneous computing architectures may incorporate systems wherein entities utilize different protocols while requiring coordinated access to shared resources. In such environments, a first entity operating with CXL.mem may need to access resources coupled to a second entity operating with PCIe. For example, a newer generation server may utilize CXL.mem to access data on a non-CXL server populated with DDR4, where translations between CXL.mem and PCIe enable utilizing the non-CXL server as a memory pool. Translations between CXL.mem messages and PCIe TLPs may facilitate memory operations, data transfers, and resource sharing across different domains while maintaining the requirements of each protocol. Such translations may be performed by a computer, an apparatus, a cable, or other suitable devices positioned between the first entity and the second entity.

In various implementations, a method for translating between Compute Express Link (CXL) messages and Peripheral Component Interconnect Express (PCIe) Transaction Layer Packets (TLPs), comprising: receiving, by a computer from a first entity, a CXL.mem Master-to-Subordinate (M2S) request; translating, by the computer, the CXL.mem M2S request to a PCIe memory request; sending, by the computer to a second entity, the PCIe memory request; receiving, by the computer from the second entity, a PCIe Completion corresponding to the PCIe memory request; translating, by the computer, the PCIe Completion to a CXL.mem Subordinate-to-Master (S2M) response; and sending, by the computer to the first entity, the CXL.mem S2M response. The translation process may encompass various aspects of the protocol messages, including opcodes, addresses, and transaction identifiers, thereby enabling communication between entities that utilize different protocols. The method may be implemented in hardware, firmware, software, or combinations thereof, and may be performed by various types of devices, such as semiconductor devices, RPUs, Fabric Processing Units (FPUs), Fabric NICs, switches, or active cables. The computer may maintain state information, such as pending transaction tables or tracker entries, to correlate incoming PCIe Completions with previously transmitted PCIe memory requests and with pending CXL.mem transactions. Additionally, the elements may communicate through one or more intermediary components, such as a switch, a retimer, or other suitable entity that facilitates information transfer.

In some implementations of the method, the CXL.mem M2S request comprises a first physical address belonging to a first physical address space utilized by the first entity, and wherein translating the CXL.mem M2S request to the PCIe memory request comprises generating the PCIe memory request comprising a second physical address belonging to a second physical address space utilized by the second entity. The address translation may be implemented utilizing lookup tables, page tables, hash tables, base-and-offset calculations, and/or programmable translation functions. The first and second physical address spaces may have different sizes, different base addresses, or different memory layouts, and the translation may accommodate these differences while maintaining the meaning of the memory operations. In some examples, the first physical address space may include an HPA space utilized by a first host, and the second physical address space may include an HPA space utilized by a second host or an address space utilized by a PCIe device.

In some implementations of the method, the CXL.mem M2S request comprises MemRd* and a first Tag, the PCIe memory request comprises a non-UIO Memory Read request comprising a second Tag, the PCIe Completion comprises a Completion with Data (CplD) comprising Data, and the CXL.mem S2M response comprises an S2M Data Response (S2M DRS) comprising MemData, the Data, and the first Tag. The computer may maintain a mapping between the first Tag associated with the CXL.mem transaction and the second Tag associated with the PCIe transaction, wherein this mapping may be stored in a tracker entry, a translation table, or similar data structure. Upon receiving the CplD from the second entity, the computer may utilize the second Tag to identify the corresponding pending transaction and retrieve the first Tag for inclusion in the S2M DRS. The non-UIO Memory Read request may conform to non-UIO PCIe memory read semantics as defined in applicable PCIe specifications.

In some implementations, the method further comprises receiving, by the computer from the first entity, a CXL.mem M2S request with Data (M2S RwD) comprising a MemWr* and write data; translating the CXL.mem M2S RwD to a PCIe non-UIO Memory Write request comprising the write data; sending the PCIe non-UIO Memory Write request to the second entity; and sending a CXL.mem S2M No Data Response (S2M NDR) to the first entity. The PCIe non-UIO Memory Write request may be a posted write that may not require a completion from the second entity. The S2M NDR may include Cmp* indicating successful acceptance of the write request by the computer. The computer may include a DevLoad in the S2M NDR to provide telemetry information or to throttle subsequent requests from the first entity.

In some implementations of the method, the computer sends the CXL.mem S2M NDR to the first entity before sending the non-UIO Memory Write request to the second entity. Sending the S2M NDR before the PCIe Memory Write request may reduce latency observed by the first entity and may allow the first entity to proceed with subsequent operations without waiting for the write to propagate to the second entity. The computer may buffer the write data and transmit the PCIe Memory Write request asynchronously, optionally implementing flow control or ordering mechanisms to maintain consistency guarantees.

In some implementations, the method further comprises receiving, by the computer from the first entity, a CXL.mem M2S request with Data (M2S RwD) comprising a MemWr* and write data; translating the CXL.mem M2S RwD to a PCIe UIO Memory Write request (UIOMWr) comprising the write data; sending the PCIe (UIOMWr) to the second entity; receiving, from the second entity, a PCIe UIO Write Completion (UIOWrCpl); and sending a CXL.mem S2M No Data Response (S2M NDR) comprising Cmp* to the first entity. PCIe UIO may provide enhanced capabilities compared to non-UIO PCIe, including support for non-posted writes that return completions. The UIOWrCpl may indicate successful completion of the write operation by the second entity and may carry additional information.

In some implementations of the method, the CXL.mem S2M NDR comprises a DevLoad, and wherein the computer populates the DevLoad with information derived from at least one of the PCIe UIOWrCpl, or telemetry information. In some revisions of the CXL specification, CXL.mem S2M NDR messages may include a DevLoad. The computer may populate the DevLoad of the CXL.mem S2M NDR with information derived from the UIOWrCpl or with telemetry information generated by the computer.

In some implementations of the method, the PCIe UIOWrCpl comprises a CXL DevLoad (CDL) comprising Quality-of-Service (QoS) telemetry, and wherein the computer translates the QoS telemetry carried in the CDL of the PCIe UIOWrCpl to a DevLoad of the CXL.mem S2M NDR, enabling the first entity to receive QoS information originating from the second entity. The CDL may carry telemetry information, such as device load indicators, queue depth information, or latency metrics generated by the second entity. By translating the CDL to the DevLoad, the computer may propagate QoS telemetry across the protocol boundary, enabling the first entity to make informed decisions regarding request pacing, load balancing, or resource allocation based on conditions at the second entity. The translation may involve copying, scaling, adjusting, or mapping of the telemetry values between the CDL and DevLoad field formats.

In some implementations of the method, the CXL.mem M2S request comprises MemRd* and a first Tag, the PCIe memory request comprises a UIO Memory Read (UIOMRd) request comprising a second Tag, the PCIe Completion comprises a UIO Read Completion with Data (UIORdCplD) comprising Data, and the CXL.mem S2M response comprises an S2M Data Response (S2M DRS) comprising MemData, the Data, and the first Tag. The UIOMRd may provide enhanced semantics compared to non-UIO PCIe memory read operations, such as support for out-of-order completions or additional metadata fields. The UIORdCplD may carry the requested data along with status information or telemetry. The computer may extract the data from the UIORdCplD and format it according to CXL.mem S2M DRS requirements for delivery to the first entity.

In some implementations of the method, the CXL.mem S2M response comprises a DevLoad, wherein the computer populates the DevLoad with telemetry information or utilizes the DevLoad to throttle CXL.mem M2S requests from the first entity, wherein the first entity comprises a first host, and wherein the second entity comprises a second host or a PCIe device. The DevLoad may enable the computer to communicate backpressure, congestion indicators, or performance metrics to the first host. The first host may utilize this information to adjust its request rate, implement adaptive flow control, or make scheduling decisions. The second entity may include various types of devices, such as a server, a memory expander, a GPU, a NIC, a storage device, or other PCIe-attached resources.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, an apparatus comprising: a first interface configured to communicate with a first entity based on CXL.mem, wherein CXL denotes Compute Express Link; a second interface configured to communicate with a second entity based on Peripheral Component Interconnect Express (PCIe); a computer coupled to the first interface and the second interface, the computer configured to: receive, via the first interface, a CXL.mem Master-to-Subordinate (M2S) request comprising a first physical address belonging to a first physical address space utilized by the first entity; translate the CXL.mem M2S request to a PCIe memory request comprising a second physical address belonging to a second physical address space utilized by the second entity; and send, via the second interface, the PCIe memory request to the second entity. The apparatus may be implemented as a semiconductor device, a card, a module, an active cable, or other suitable form factor. The first interface may expose the apparatus to the first entity as a CXL switch, or as a CXL device, such as a CXL Type-2 device or a CXL Type-3 device. The second interface may expose the apparatus to the second entity as a PCIe switch, as a PCIe device, or as a host via a root port. The computer may include logic for address translation, Tag management, protocol conversion, and transaction tracking. Optionally, the apparatus may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and optional PCIe switch(es) may be positioned between the second interface and the second entity.

In some implementations of the apparatus, the computer is further configured to: receive, via the second interface, a PCIe Completion corresponding to the PCIe memory request; translate the PCIe Completion to a CXL.mem Subordinate-to-Master (S2M) response; and send, via the first interface, the CXL.mem S2M response to the first entity; wherein the first interface exposes to the first entity one of the following: a CXL switch, a CXL Type-2 device, or a CXL Type-3 device; and wherein the second interface exposes to the second entity one of the following: a PCIe switch, a PCIe device, or a root port. When the second interface exposes a root port, the apparatus may function as a host toward the second entity, enabling the apparatus to initiate PCIe transactions to downstream PCIe devices. When the second interface exposes a PCIe device, the apparatus may function as an endpoint toward the second entity, such as when coupled to another host.

In some implementations of the apparatus, the first physical address space comprises the second physical address space. The second physical address space may be a PCIe Memory Address Space, a DMA address space, an IO virtual address (IOVA) space, or a system address space, and may further be a subset of the first physical address space or identical to the first physical address space.

In some implementations of the apparatus, the apparatus comprises a cable including a first module coupled to the first interface, a second module coupled to the second interface, and a physical medium coupling the first module and the second module. The cable may be an active cable that includes the computer for performing protocol and address translations. The first module may include electrical or optical components for communicating with the first entity, and the second module may include electrical or optical components for communicating with the second entity. The cable may conform to various industry standards or specifications, such as those defined by the Optical Internetworking Forum (OIF), the Small Form Factor Committee (SFF), or the IEEE.

In some implementations of the apparatus, the physical medium comprises a twinaxial cable, a multimode fiber (MMF), or a single-mode fiber (SMF); and wherein the cable is configured to couple to the first entity or the second entity via a connector selected from Octal Small Form Factor Pluggable Module (OSFP), Octal Small Form Factor eXtra Dense Pluggable Module (OSFP-XD), Quad Small Form-Factor Pluggable (QSFP), or Quad Small Form-Factor Pluggable Double Density (QSFP-DD). The twinaxial cable may be suitable for shorter reach applications within a rack or between adjacent racks, while fiber options may enable longer reach connectivity. The MMF may be utilized for distances up to several hundred meters, while SMF may be utilized for longer distances. The connector type may be selected based on bandwidth requirements, density considerations, and deployment environment. The cable may be implemented as an Active Optical Cable (AOC) or an Active Copper Cable (ACC) depending on the physical medium utilized.

In various implementations, a system comprising: a first entity coupled to a first memory; a second entity coupled to a second memory, wherein the second entity comprises a Central Processing Unit (CPU) configured to support Peripheral Component Interconnect Express (PCIe) but not Compute Express Link (CXL); and a computer coupled between the first entity and the second entity, the computer configured to: receive, from the first entity, a CXL.mem Master-to-Subordinate (M2S) request; translate the CXL.mem M2S request to a PCIe memory request; send, to the second entity, the PCIe memory request to access the second memory; receive, from the second entity, a PCIe Completion; and send, to the first entity, a CXL.mem Subordinate-to-Master (S2M) response corresponding to the PCIe Completion. The system may enable the first entity to access memory resources coupled to CPUs that do not support CXL, thereby extending the reach of CXL-based memory pooling to include legacy and/or non-CXL infrastructure. The CPU of the second entity may be a processor from a generation that predates CXL support, or may be a processor that uses its CXL capabilities for other purposes. The second memory may be attached to the second entity via memory controllers integrated in the CPU, and the computer may enable the first entity to access this memory utilizing PCIe transactions that the CPU can process.

In some implementations of the system, the second entity and the second memory form a memory pool, and wherein the computer is configured to expose the memory pool to the first entity. The memory pool may appear to the first entity as CXL-attached memory, even though the underlying memory is coupled to a non-CXL CPU. The computer may expose the memory pool by responding to CXL.mem initialization and configuration operations from the first entity and by translating subsequent memory access requests to PCIe transactions directed to the second entity. Multiple second entities and their associated memories may be aggregated into a larger memory pool that the computer exposes to one or more first entities.

In some implementations of the system, the second memory comprises DDR4 memory, and wherein the first memory comprises DDR5 memory. The system may enable tiered memory architectures wherein the first entity utilizes higher-performance memory technologies, such as DDR5, for latency-sensitive operations, while utilizing DDR4 memory coupled to the second entity for capacity-oriented workloads. The computer may enable the first entity to transparently access the DDR4 memory tier utilizing CXL.mem, and memory management software executing on the first entity may place data across tiers based on access patterns, SLA requirements, tenant identities, temperature thresholds, or other policies.

In some implementations of the system, The system of claim 20 wherein the CPU comprises a pre-CXL generation CPU, and the pre-CXL generation CPU is installed in a datacenter server. The pre-CXL generation CPU may include processors that were manufactured or designed before CXL became available, or processors that do not include CXL capability. The datacenter server may be a server that has been decommissioned from primary compute duties but retains functional memory and PCIe connectivity. The system may enable repurposing of such servers as memory pool contributors, thereby extending the useful life of datacenter infrastructure and reducing electronic waste while providing additional memory capacity to CXL-enabled first entities.

In multi-host environments, there may be scenarios where first entities operating with CXL.mem need to access memory or other resources coupled to a second entity operating with PCIe. For example, newer generation servers may utilize CXL.mem to access data on a non-CXL server, where translations between CXL.mem and PCIe enable utilizing the non-CXL server as a shared memory pool. Translations between CXL.mem messages and PCIe TLPs may facilitate memory operations, data transfers, and resource sharing across different protocol domains while maintaining the requirements of each protocol and routing responses to the appropriate requesting entities.

In various implementations, a method for translating between Compute Express Link (CXL) messages and Peripheral Component Interconnect Express (PCIe) Transaction Layer Packets (TLPs), comprising: receiving, by a computer, CXL.mem Master-to-Subordinate (M2S) requests from first entities; translating, by the computer, the CXL.mem M2S requests to PCIe memory requests; sending, by the computer to a second entity, the PCIe memory requests; receiving, by the computer from the second entity, PCIe Completions corresponding to the PCIe memory requests; translating, by the computer, the PCIe Completions to CXL.mem Subordinate-to-Master (S2M) responses; and sending, by the computer, each of the CXL.mem S2M responses to a corresponding one of the first entities. The translation process may encompass various aspects of the protocol messages, including opcodes, addresses, and transaction identifiers, thereby enabling communication between CXL.mem-capable entities and a PCIe-capable entity. The method may be implemented in hardware, firmware, software, or combinations thereof, and may be performed by various types of devices, such as semiconductor devices, RPUs, Fabric Processing Units (FPUs), Fabric NICs, switches, or active cables. The computer may maintain state information to correlate incoming PCIe Completions with previously transmitted PCIe memory requests and with the originating first entities, enabling responses to be routed to the correct requester. The first entities may include hosts, accelerators, GPUs, NICs, or other CXL-capable devices that share access to resources coupled to the second entity. Additionally, the elements may communicate through one or more intermediary components, such as a switch, a retimer, or other suitable entity that facilitates information transfer.

In some implementations of the method, the computer maintains separate tracking structures for each of the first entities, and wherein the computer processes CXL.mem M2S requests received from different ones of the first entities in parallel, by storing transaction information in the respective separate tracking structures. The separate tracking structures may enable the computer to manage outstanding transactions from different first entities without interference. Each tracking structure may store information such as CXL.mem Tags, addresses, opcodes, and timestamps associated with transactions from the corresponding first entity. By maintaining separate structures, the computer may support concurrent processing wherein a CXL.mem M2S request from one first entity may be translated and sent while awaiting a PCIe Completion for a request from another first entity. The tracking structures may be implemented as tables, queues, linked lists, content-addressable memories, or other data structures suitable to associate PCIe Completions with their originating CXL.mem transactions and first entities.

In some implementations of the method, the computer sequentially processes the CXL.mem M2S requests received from the first entities by queuing the CXL.mem M2S requests and translating each queued CXL.mem M2S request in order, wherein the computer completes sending one of the PCIe memory requests before translating a subsequent one of the CXL.mem M2S requests. Sequential processing may be utilized in implementations where simplicity, determinism, and/or resource constraints favor processing one request at a time. The computer may queue incoming CXL.mem M2S requests in a first-in-first-out (FIFO) buffer or other queuing structure and may process each request to completion before beginning the next, which may reduce the complexity of tracking concurrent transactions and may provide predictable ordering of memory operations. Sequential processing may be suitable for scenarios where the first entities have relatively low aggregate request rates or where strict ordering guarantees are desired.

In some implementations of the method, a first one of the first entities utilizes a first Host Physical Address (HPA) space, wherein a second one of the first entities utilizes a second HPA space different from the first HPA space, and wherein translating the CXL.mem M2S requests to the PCIe memory requests comprises translating addresses from the first HPA space and addresses from the second HPA space to corresponding addresses in a physical address space utilized by the second entity. The address translation may accommodate scenarios where different first entities operate with independent HPA spaces that may have overlapping address ranges. The computer may maintain separate translation tables or functions for each first entity, mapping addresses from each first entity's HPA space to non-overlapping regions of the second entity's physical address space. Alternatively, the computer may utilize a unified translation mechanism that incorporates first entity identifiers as part of the address mapping. The second entity's physical address space may be a PCIe Memory Address Space, a system address space, or a DMA address space. The translation may involve base-and-offset calculations, page table lookups, or programmable translation functions.

In some implementations of the method, the computer allocates PCIe Tags for the PCIe memory requests, wherein the computer associates the PCIe Tags with identifiers of the corresponding ones of the first entities, and wherein the computer utilizes the PCIe Tags in the PCIe Completions to identify the corresponding ones of the first entities. PCIe Tags serve as transaction identifiers that enable completers to associate completions with their originating requests. The computer may allocate PCIe Tags from a pool and may record, for each allocated Tag, the identifier of the first entity that originated the corresponding CXL.mem M2S request. When a PCIe Completion arrives, the computer may extract the Tag from the completion, look up the associated first entity identifier, and route the translated CXL.mem S2M response to that first entity. The computer may also maintain a mapping between PCIe Tags and CXL.mem Tags to populate the correct Tag in the S2M response.

In some implementations of the method, the computer detects a timeout condition when a PCIe Completion corresponding to one of the PCIe memory requests is not received within a threshold duration, and wherein responsive to detecting the timeout condition, the computer sends a CXL.mem S2M response comprising an error indication to the corresponding one of the first entities. The timeout detection may provide a mechanism for handling non-responsive or failed transactions, preventing indefinite waiting by the first entities. The computer may associate a timestamp or timer with each outstanding PCIe memory request and may periodically check whether any pending transactions have exceeded the threshold duration. The threshold duration may be configurable and may be selected based on expected latencies, system policies, or protocol requirements. Upon detecting a timeout, the computer may release resources associated with the timed-out transaction, such as allocated Tags or tracking structure entries, and may generate an S2M response with an error opcode to notify the first entity of the failure. The timeout mechanism may also trigger logging, alerting, or error recovery procedures.

In some implementations of the method, at least one of the PCIe Completions comprises an error status indicating an Unsupported Request (UR) or a Completer Abort (CA), and wherein the computer translates the error status to an error indication in a corresponding one of the CXL.mem S2M responses. PCIe defines completion status values that indicate error conditions encountered by the completer. An Unsupported Request (UR) status indicates that the completer does not support the request type or that the request targeted an invalid address range. A Completer Abort (CA) status indicates that the completer encountered an error that prevented completion of the request. Other PCIe completion statuses, such as Configuration Request Retry Status (CRS), may also be translated to appropriate CXL.mem error indications. The computer may map these PCIe error statuses to CXL.mem S2M NDR messages with error opcodes or to S2M DRS messages with poison indicators, depending on the nature of the original request and the error encountered. The translation may preserve error semantics to enable the first entity to take appropriate recovery actions.

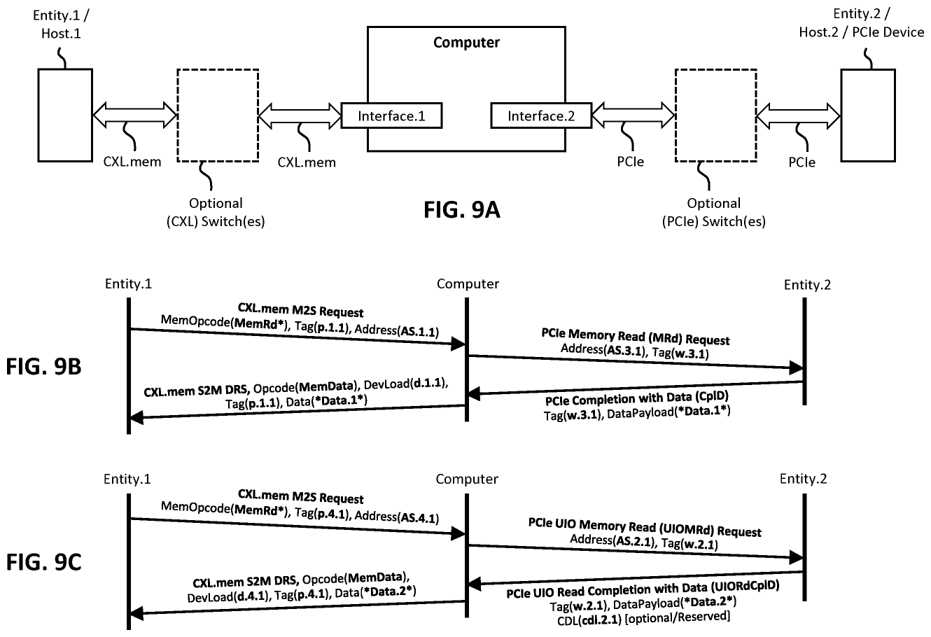

FIG. 9A illustrates an example of a system comprising a computer coupled between a first interface (Interface.1) and a second interface (Interface.2). The first interface may expose a CXL device, such as a CXL type-2 device or a CXL type-3 device, and may communicate according to CXL.mem with a first entity (Entity.1), such as a first host (Host.1). In some examples, the second interface may expose a PCIe device, and may communicate according to PCIe with a second entity (Entity.2), such as a second host (Host.2) or another PCIe device. In other examples, the second interface may expose a root port (RP) and may communicate according to PCIe with a PCIe device. The computer may extract physical addresses within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity. Similarly, optional PCIe switch(es) may be positioned between the second interface and the second entity.

FIG. 9B illustrates an example of a transaction flow diagram (TFD) demonstrating translations, performed by a computer, between CXL.mem requests received from a first entity (Entity.1), such as a first host (Host.1), and PCIe requests sent to a second entity (Entity.2), such as a second host (Host.2) or a PCIe device, possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction that includes a CXL.mem M2S request comprising MemOpcode(MemRd*), Tag(p.1.1), and Address(AS.1.1). The computer may translate the CXL.mem transaction to a PCIe transaction, which may include a PCIe Memory Read (MRd) request comprising Address(AS.3.1) and Tag(w.3.1), and may send the PCIe MRd to the second entity. Upon receiving a response or completion from the second entity, which may include a PCIe Completion with Data (CplD) comprising Tag(w.3.1) and DataPayload(*Data.1*), the computer may translate the PCIe CplD to a CXL.mem S2M DRS comprising Opcode(MemData), DevLoad(d.1.1), Tag(p.1.1), and Data(*Data.1*), and may send the CXL.mem S2M DRS to the first entity. The computer may perform further translations, such as protocol translations, opcode translations, command translations, TLP type translations, or field translations, such as Tag translations, between messages conforming to CXL.mem and TLPs conforming to PCIe. The computer may populate the DevLoad of CXL.mem S2M messages with telemetry information, metadata, or other types of information collected or generated by the computer, or may utilize the DevLoad of CXL.mem S2M messages to throttle CXL.mem requests from the first entity. DevLoad in CXL messages may be optional and may not exist in some revisions of the CXL specification.

FIG. 9C illustrates an example of a TFD demonstrating translations between CXL.mem requests received from a first entity (Entity.1), such as a first host (Host.1), and PCIe requests sent to a second entity (Entity.2), such as a second host (Host.2) or a PCIe device, possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction, which may include a CXL.mem M2S request comprising MemOpcode(MemRd*), Tag(p.4.1), and Address(AS.4.1). The computer may translate the CXL.mem transaction to a PCIe transaction, which may include a PCIe UIO Memory Read (UIOMRd) request comprising Address(AS.2.1) and Tag(w.2.1), and may send the PCIe UIOMRd to the second entity. Upon receiving a response or completion from the second entity, which may include a PCIe UIO Read Completion with Data (UIORdCplD) comprising Tag(w.2.1), DataPayload(*Data.2*), and optionally CDL(cdl.2.1), the computer may translate the PCIe UIORdCplD to a CXL.mem S2M DRS comprising Opcode(MemData), DevLoad(d.4.1), Tag(p.4.1), and Data(*Data.2*) and may send the CXL.mem S2M DRS to the first entity. The optional CDL in the PCIe UIORdCplD, when not reserved, may be populated by the second entity with information such as QoS telemetry. The computer may translate the information carried in the optional CDL of the PCIe UIORdCplD received from the second entity, and populate the translated information in the DevLoad of the CXL.mem S2M DRS sent to the first entity. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity. DevLoad in CXL messages may be optional and may not exist in some revisions of the CXL specification. The computer may perform further translations, such as protocol translations, opcode translations, command translations, TLP type translations, or field translations, such as Tag translations, between messages conforming to CXL.mem and TLPs conforming to PCIe.

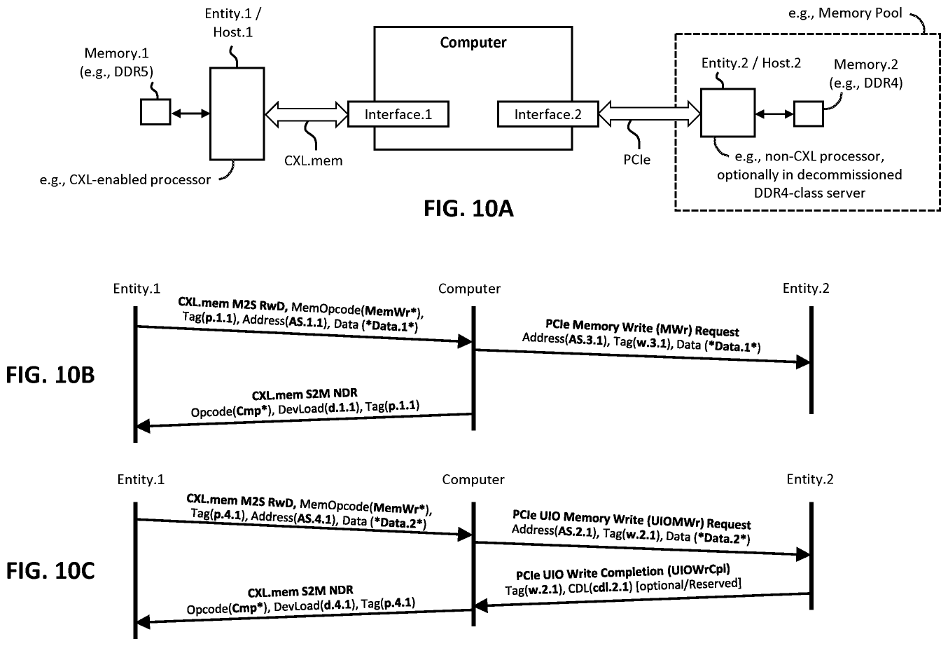

FIG. 10A illustrates an example of a system comprising a computer coupled between a first interface (Interface.1) and a second interface (Interface.2). The first interface may expose a CXL device, such as a CXL type-2 device or a CXL type-3 device, and may communicate according to CXL.mem with a first entity (Entity.1), such as a first host (Host.1). The second interface may expose a PCIe device, and may communicate according to PCIe with a second entity (Entity.2), such as a second host (Host.2). The computer may extract physical addresses carried within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification.

The system may further include a memory pool comprising the second entity and a second memory, such as DDR4, wherein the computer may utilize the memory pool to expose a DDR4 memory tier to the first entity which may be coupled to a first memory, such as DDR5. In some examples, the second entity may not support CXL, or may be configured not to support CXL, potentially preventing the computer from utilizing CXL for accessing the second memory. In some examples, the second entity may include a server, such as a DDR4-class datacenter server, wherein the server may include a non-CXL processor that may not support CXL, such as a pre-CXL generation processor configured to support PCIe but not CXL, and wherein the non-CXL processor may enable the computer to access the second memory by utilizing PCIe.

FIG. 10B illustrates an example of a TFD demonstrating translations, optionally performed by a computer, between CXL.mem requests received from a first entity (Entity.1), such as a first host (Host.1), and PCIe requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction, which may include a CXL.mem M2S request with data (RwD) comprising MemOpcode(MemWr*), Tag(p.1.1), Address(AS.1.1), and Data (*Data.1*). The computer may translate the CXL.mem M2S RwD transaction to a PCIe transaction, which may include a PCIe Memory Write request (MWr) comprising Address(AS.3.1), Tag(w.3.1), and Data (*Data.1*), and may send the PCIe MWr to the second entity. In some examples, the PCIe MWr may be a posted write that may not be followed by a response or completion from the second entity. The computer may respond to the CXL.mem M2S RwD received from the first entity with a CXL.mem S2M NDR comprising Opcode(Cmp*), DevLoad(d.1.1), and Tag(p.1.1), wherein the computer may send the CXL.mem S2M NDR to the first entity before sending the PCIe MWr to the second entity. Alternatively, the computer may send the CXL.mem S2M NDR to the first entity in parallel to sending the PCIe MWr to the second entity, or the computer may send the CXL.mem S2M NDR to the first entity after sending the PCIe MWr to the second entity. The computer may further populate the DevLoad of the CXL.mem S2M NDR with telemetry information, metadata, or other types of information collected or generated by the computer, or may utilize the DevLoad of the CXL.mem S2M NDR to throttle CXL.mem requests from the first entity. DevLoad in CXL messages may be optional and may not exist in some revisions of the CXL specification. The computer may perform further translations, such as protocol translations, opcode translations, command translations, TLP type translations, or field translations, such as Tag translations, between messages conforming to CXL.mem and TLPs conforming to PCIe.

FIG. 10C illustrates an example of a TFD demonstrating translations between CXL.mem requests received from a first entity (Entity.1), such as a first host (Host.1), and PCIe UIO requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe UIO requests sent to the second entity. The first entity may initiate a CXL.mem transaction that may include a CXL.mem M2S request with Data (M2S RwD) comprising MemOpcode(MemWr*), Tag(p.4.1), Address(AS.4.1), and Data (*Data.2*). A computer may translate the CXL.mem M2S RwD transaction to a PCIe transaction, which may include a PCIe UIO Memory Write request (UIOMWr) comprising Address(AS.2.1), Tag(w.2.1), and Data (*Data.2*), and may send the PCIe UIOMWr to the second entity. Upon receiving a response or completion from the second entity, which may include a PCIe UIO Write Completion (UIOWrCpl) comprising Tag(w.2.1) and optionally CDL(cdl.2.1), the computer may translate the PCIe UIOWrCpl to a CXL.mem S2M No Data Response (S2M NDR) comprising Opcode(Cmp*), DevLoad(d.4.1), and Tag(p.4.1), and may send the CXL.mem S2M NDR to the first entity.

The optional CDL in the PCIe UIOWrCpl, when not reserved, may be populated by the second entity with information such as QoS telemetry. The computer may translate the information carried in the optional CDL of the PCIe UIOWrCpl received from the second entity, and populate the translated information in the DevLoad of the CXL.mem S2M NDR sent to the first entity. DevLoad in CXL messages may be optional and may not exist in some revisions of the CXL specification. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity. The computer may perform further translations, such as protocol translations, opcode translations, command translations, TLP type translations, or field translations, such as Tag translations, between messages conforming to CXL.mem and TLPs conforming to PCIe.

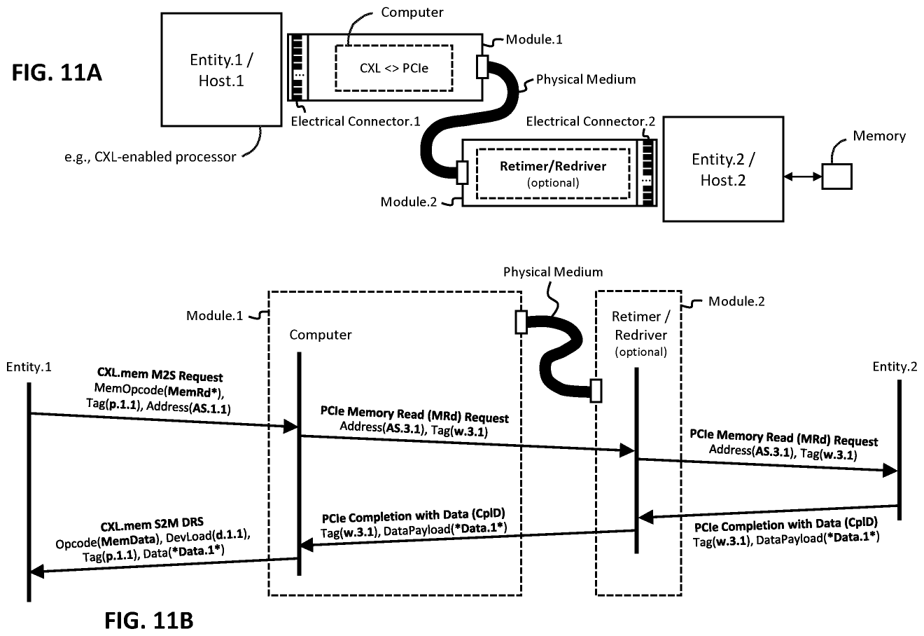

FIG. 11A illustrates an example of a system comprising a cable, such as an active cable, that may include a first module (Module.1), a second module (Module.2), and a physical medium coupling the first module and the second module. The physical medium may include a twinaxial cabling (also known as twinax cable), a multimode fiber (MMF), or a single-mode fiber (SMF). The cable may further include a computer that translates between CXL-based traffic, such as CXL.mem traffic, and a PCIe-based traffic, such as a PCIe or a PCIe-over-Ethernet traffic. The cable may enable a first entity (Entity.1) to access resources coupled to a second entity (Entity.2), such as a second host (Host.2). The first entity (Entity.1), which may be a first host (Host.1), may include a CXL-enabled processor. The access may be via the first module, the physical medium, and the second module. The resources may be memory coupled to the second entity, and the second entity may be a second host that may include a server, such as a DDR4-class datacenter server that may include a non-CXL processor that does not support CXL, such as a pre-CXL generation processor configured to support PCIe.

The cable may communicate with the first entity according to a CXL-based protocol, such as CXL.mem, and may communicate with the second entity according to a PCIe-based protocol. In some examples, messages conforming to the CXL-based protocol, such as CXL.mem, may be associated with a first address space, such as a first Host Physical Address (HPA) space; and messages conforming to the PCIe-based protocol may be associated with a second address space, such as a PCIe Memory Address Space, a DMA address space, an IO virtual address (IOVA) space, a system address space, or a second HPA space; wherein the cable may perform address translations between addresses within the first and second address spaces, respectively, such as between addresses within the first HPA space and addresses within the second HPA space. In other examples, messages conforming to the CXL-based protocol and messages conforming to the PCIe-based protocol may be associated with the same address space, wherein the cable may perform address translations between addresses within the same address space. Additionally, or alternatively, the system may perform further address translations, such as by an I/O Memory Management Unit (IOMMU), a System Memory Management Unit (SMMU), or a DMA address translation. The cable may perform further translations, such as protocol translations, opcode translations, command translations, TLP translations, or field translations between the CXL-based domain and the PCIe-based domain, such as translations of Tags and translations of error indications (e.g. data corruption indications such as poison).

The cable may further include a redriver or a retimer, such as a PCIe retimer, a CXL retimer, a dual-protocol CXL/PCIe retimer, a PAM4 retimer, or a retimer PHY. The cable, such as an OSFP copper cable, an OSFP-XD copper cable, an OSFP Active Optical Cable (AOC), or an OSFP-XD AOC cable, may conform to a standard specification, an industry standard, an implementation agreement (IA), or a multi-source agreement (MSA), such as Octal Small Form Factor Pluggable Module (OSFP), Octal Small Form Factor eXtra Dense Pluggable Module (OSFP-XD), Quad Small Form-Factor Pluggable (QSFP), Quad Small Form-Factor Pluggable Double Density (QSFP-DD), a SNIA SFF standard (such as SFF-8665), an Optical Internetworking Forum (OIF) implementation agreement, or an Institute of Electrical and Electronics Engineers (IEEE) standard. In some examples, the cable may be coupled to the first entity via a first electrical connector (Connector.1) and may be further coupled to the second entity via a second electrical connector (Connector.2), whereas in other examples, the cable may be coupled to the first entity and/or to the second entity via optical connectors.

FIG. 11B illustrates an example of a TFD demonstrating translations performed by a cable, such as an active cable comprising a computer and optionally a retimer or a redriver. The cable may include a first module (Module.1), a second module (Module.2), and a physical medium coupling the first module and the second module. The translations may be between CXL.mem requests received from a first entity (Entity.1), such as a first host (Host.1), and PCIe requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the PCIe requests sent to the second entity. The first entity may initiate a CXL.mem transaction that may include a CXL.mem M2S request comprising MemOpcode(MemRd*), Tag(p.1.1), and Address(AS.1.1). The computer included in the cable may translate the CXL.mem transaction to a PCIe transaction, which may include a PCIe Memory Read (MRd) request comprising Address(AS.3.1) and Tag(w.3.1). The computer may send the PCIe MRd to the second entity, optionally via the second module that may include a retimer or a redriver. Upon receiving a response or completion from the second entity, which may include a PCIe Completion with Data (CplD) comprising Tag(w.3.1) and DataPayload(*Data.1*), the computer may translate the PCIe CplD to a CXL.mem S2M DRS comprising Opcode(MemData), DevLoad(d.1.1), Tag(p.1.1), and Data(*Data.1*). The computer may send the CXL.mem S2M DRS to the first entity. The computer may populate DevLoad of CXL.mem S2M messages with telemetry information, metadata, or other types of information collected or generated by the cable, or may utilize the DevLoad of CXL.mem S2M messages to throttle CXL.mem requests from the first entity, enabling the cable to control, limit, shape, or throttle the rate of data communications between the first entity and the second entity. The computer may perform further translations, such as protocol translations, opcode translations, command translations, TLP type translations, or field translations, such as Tag translations, between messages conforming to CXL.mem and TLPs conforming to PCIe.

Modern data center architectures increasingly utilize disaggregated memory systems wherein multiple compute hosts may require access to shared memory resources through different protocols and address spaces. CXL.mem enables memory access between a CXL host and CXL devices, wherein different CXL device types may utilize different CXL.mem revisions and/or instances. Translations between different CXL.mem messages may enable CXL communications between a CXL device and CXL hosts, may facilitate memory prefetching and speculative read operations to reduce access latency, and/or may enable novel architectures wherein hosts access memory devices without an intervening CXL switch, contrary to standard CXL topologies, which require a CXL switch between hosts and a Single Logical Device (SLD), a Multi-Logical Device (MLD), or a Global Fabric-Attached Memory Device (GFD), when hosts require access to the same device.

In various implementations, a method for translating between Compute Express Link (CXL) messages, comprising: receiving, from a first entity, a first CXL.mem Master-to-Subordinate (M2S) request; translating, by a computer, the first CXL.mem M2S request to a second CXL.mem M2S request, wherein value of at least one field, selected from MemOpcode, Tag, or Address, is different between the first and second CXL.mem M2S requests; and sending the second CXL.mem M2S request to a second entity. The translation between CXL.mem M2S requests may enable communication between a first entity, such as a CXL host, and a second entity, such as a CXL device that utilizes different CXL.mem revisions and/or fields values. The modified fields may affect protocol fields including physical addresses which may be carried in Address fields for address space mapping, opcodes which may be carried in MemOpcode fields for protocol semantic adaptation, or Tags for transaction management. The computer may selectively translate values of one or more of these field types depending on the incompatibility between the CXL host's protocol and the CXL device's protocol. Physical address translation may enable access across different memory domains, opcode translation may enable different operations or device type bridging, and Tag translation may enable transaction tracking across protocol boundaries.

In some implementations of the method, the first entity comprises a CXL host, and the first CXL.mem M2S request comprises a first physical address belonging to a first Host Physical Address (HPA) space utilized by the CXL host; and wherein the second entity comprises a CXL device, and the second CXL.mem M2S request comprises a second physical address within an address space exposed by the second entity. The address translation between HPA spaces may enable a CXL host to access memory resources exposed by a CXL device that utilizes a different HPA space.

In some implementations of the method, the at least one field comprises the Address, the first CXL.mem M2S request comprises a first physical address belonging to a first Host Physical Address (HPA) space utilized by the first entity, and the second CXL.mem M2S request comprises a second physical address belonging to a second HPA space utilized by the second entity. The physical address translation between HPA spaces may involve mapping memory locations from the CXL host's address space to corresponding locations in the address space utilized by the second entity. The computer may maintain address translation tables, implement base-and-offset calculations, or utilize programmable mapping functions to convert between addresses from the different address spaces. The first and second HPA spaces may differ in size, base addresses, memory layouts, or granularity, and the translation algorithm may accommodate these differences while preserving memory operation semantics.

In some implementations of the method, the at least one field comprises the MemOpcode and the Tag, the first CXL.mem M2S request comprises a first opcode and a first Tag, and the second CXL.mem M2S request comprises a second opcode and a second Tag. The first and second opcodes may correspond to different memory access behaviors, and the first and second Tags may belong to different transaction identifier queues.

In some implementations of the method, the first opcode is selected from MemRd, MemRdData, MemRdTEE, MemRdDataTEE, and MemSpecRd; and wherein the second opcode is selected from MemInv, MemRd, MemRdData, MemRdTEE, MemRdDataTEE, MemInvTEE, MemSpecRd, MemInvNT, MemInvP, MemClnEvct, MemInvPTEE, MemSpecRdTEE, MemClnEvctTEE, or MemClnEvctU. Different opcodes are typically associated with different values or different encodings of an opcode field, such as MemOpcode in CXL.mem M2S Req. For example, according to CXL 3.2 specification, MemRdData is associated with the value 0010b of MemOpcode, whereas MemRd is associated with the value 0001b of MemOpcode. The translation from MemRdData to MemRd may enable protocol adaptation between different CXL device types, wherein MemRdData may be associated with CXL Type-3 device operations while MemRd may be associated with CXL Type-2 device operations. The Tag translation may involve maintaining a bidirectional mapping between the host-side and device-side transaction identifiers.

In some implementations, the method further comprises initiating a third CXL.mem M2S request, and sending the third CXL.mem M2S request to the second entity. The computer may generate additional requests, such as speculative memory read requests or predictive read requests that may facilitate data readiness before, or without, the CXL host explicitly requesting it. The decision to initiate the additional operations may be based on pattern recognition algorithms analyzing the CXL host's memory access behavior, statistical models predicting future access locations, configurable prefetch policies defining aggressiveness and scope of speculation, and/or bandwidth availability assessments determining when additional operations that may be speculative, predictive, or performed on a best-effort basis, will not interfere with requests originated by the CXL host.

In some implementations of the method, the third CXL.mem M2S request comprises MemSpecRd; or wherein the third CXL.mem M2S request comprises MemRd*, and further comprising receiving, from the second entity, a CXL.mem S2M DRS comprising MemData. The computer may generate speculative read requests, such as CXL.mem M2S requests comprising MemSpecRd opcodes, to start a memory access before, or without, the CXL host explicitly requesting it. Speculative reads may enable latency savings, such as when the memory resource exhibits long access times, e.g., due to slow memory media, or when the memory read address references remote memory resources over a fabric or a network. Additionally or alternatively, the computer may further generate prefetch read requests, such as CXL.mem M2S requests comprising MemRd* opcodes, to prefetch data before, or without, the CXL host explicitly requesting it. The prefetched data may be stored in the computer's local buffers or caches for rapid delivery when subsequently requested.

In some implementations, the method further comprises detecting sequential access patterns in physical addresses of prior CXL.mem M2S requests received from the first entity, and initiating the third CXL.mem M2S request targeting a next sequential physical address. The computer may track physical addresses from consecutive CXL.mem M2S requests received from the CXL host to identify sequential access patterns indicative of linear memory traversal. Upon detecting that the CXL host has accessed certain addresses in sequence, the computer may speculatively prefetch data from subsequent addresses before the CXL host explicitly requests them. The sequential pattern detection may account for cacheline boundaries, page boundaries, or other memory organization units to optimize prefetch granularity.

In some implementations, the method further comprises detecting strided access patterns in physical addresses of prior CXL.mem M2S requests received from the first entity, calculating a stride distance between accessed addresses, and initiating the third CXL.mem M2S request targeting a physical address offset by the stride distance. The computer may identify non-sequential but regular access patterns wherein the CXL host accesses memory locations separated by a consistent stride distance, such as when processing array elements or matrix columns. For example, if the computer observes accesses to addresses A, A+S, A+2S, where S represents the stride, it may speculatively prefetch from address A+3S. The stride detection algorithm may maintain a history buffer of recent addresses and compute stride patterns using difference calculations or pattern matching algorithms.

In some implementations of the method, the at least one field comprises the Address, the first CXL.mem M2S request comprises a first physical address and first MemSpecRd, and the second CXL.mem M2S request comprises a second physical address and second MemSpecRd; and further comprising translating the first physical address to the second physical address.

In some implementations of the method, the at least one field further comprises the MemOpcode, and the value of the MemOpcode is different between the first and second CXL.mem M2S requests; or wherein the first CXL.mem M2S request conforms to a first CXL specification revision, and the second CXL.mem M2S request conforms to a second CXL specification revision; and further comprising exposing, by the computer, a CXL Type-2 device or CXL Type-3 device to the first entity via a first interface, and exposing a root port to the second entity via a second interface. When the CXL host initiates its own speculative reads using MemSpecRd opcodes, the computer may perform physical address translation while preserving the speculative semantics of the request. The translation enables the host-initiated speculative operations to target the correct memory locations in the address space utilized by the second entity, enabling end-to-end speculative prefetching across different address domains. Additionally or alternatively, the translation between different CXL specification revisions may involve adapting message formats, field encodings, and protocol semantics between the revisions. For example, CXL 1.1 to CXL 2.0 translations may require handling new fields introduced in CXL 2.0, managing deprecated features from CXL 1.1, adjusting field widths or bit positions, and/or converting between different opcode encodings used in each version. The asymmetric interface configuration enables the computer to present different protocol roles to each connected entity. By exposing a CXL Type-2 or Type-3 device to the CXL host, the computer can receive memory requests as a subordinate device. By exposing a root port to the second entity (which may be a CXL device), the computer can initiate memory requests as a master. This dual-role architecture enables the computer to bridge protocols that would otherwise be incompatible due to both entities expecting to communicate with complementary protocol endpoints.

In some implementations of the method, the at least one field comprises the Address and the Tag; wherein the first CXL.mem M2S request comprises MemRd*, a first Tag, and a first physical address; and wherein the second CXL.mem M2S request comprises a second Tag and a second physical address; and further comprising receiving from the second entity a first CXL.mem Subordinate-to-Master Data Response (S2M DRS) comprising the second Tag; translating the first CXL.mem S2M DRS to a second CXL.mem S2M DRS comprising the first Tag; and sending the second CXL.mem S2M DRS to the first entity. The response translation may reverse the Tag mapping performed during request translation, ensuring that the CXL host receives responses with Tags matching its original requests. The computer may maintain a Tag translation table or utilize algorithmic Tag generation to translate between device-side Tags (second Tag) and host-side Tags (first Tag). Additionally, the computer may consolidate or filter response messages, potentially absorbing No Data Response messages while forwarding only Data Response messages to simplify the message flow.

In some implementations of the method, the second entity comprises a Global Fabric-Attached Memory (G-FAM) or a Global Fabric-Attached Memory Device (GFD); and wherein there is no CXL switch positioned between the computer and the second entity; and further comprising receiving, from a third entity, a third CXL.mem M2S request, translating the third CXL.mem M2S request to a fourth CXL.mem M2S request, and sending the fourth CXL.mem M2S request to the second entity; and wherein there is no CXL switch positioned between the computer and the third entity. The CXL specification mandates that GFDs connect through a Virtual CXL Switch (VCS) for proper protocol handling and routing. This implementation bypasses that requirement by having the computer perform the applicable translations and routing functions, eliminating the CXL switch from the topology. Removing the switch traversal delays may reduce latency, reduce cost by eliminating switch hardware, and/or simplify system configuration by reducing the number of CXL components requiring management. The translation of requests from multiple entities to a common destination entity, without an intervening CXL switch, may enable topologies where the computer aggregates traffic from multiple sources. The computer may maintain separate translation contexts for each source entity to preserve transaction isolation and enable independent address mappings.

In some implementations of the method, the third entity comprises a second CXL host, the second entity comprises a CXL device, and there is no CXL switch positioned between the third entity and the second entity. The computer enables multi-host access the same CXL device, without the CXL switch typically required for such multi-host configurations, by implementing separate translation contexts for each host, including independent address mappings, Tag translations, and transaction queues. The computer may also implement arbitration algorithms to fairly schedule requests from multiple hosts, coherency protocols to manage shared memory access, and isolation algorithms to prevent unauthorized cross-host memory access.

In some implementations, the method further comprises receiving, from a third entity, a third CXL.mem M2S request, translating the third CXL.mem M2S request to a fourth CXL.mem M2S request, and sending the fourth CXL.mem M2S request to the second entity; wherein the second entity exposes memory, and there is no CXL switch positioned between the computer and the second entity. The memory-exposing entity, such as a memory-exposing CXL device, may be accessed by hosts through the computer's translations without requiring a CXL switch. The computer may implement memory virtualization to present each host with its own view of the device's memory, memory partitioning to allocate specific regions to each host, or memory pooling to dynamically assign memory resources based on demand. The translation may ensure that each host's memory operations target the appropriate memory regions while maintaining isolation and coherency as required.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In various implementations, a system comprising: first and second entities; a computer configured to: receive a first CXL.mem Master-to-Subordinate (M2S) request from the first entity, wherein CXL denotes Compute Express Link; translate the first CXL.mem M2S request to a second CXL.mem M2S request, wherein value of at least one field, selected from MemOpcode, Tag, or Address, is different between the first and second CXL.mem M2S requests; and send the second CXL.mem M2S request to the second entity. The translation enables communication between components that may utilize different addressing schemes, Tag management conventions, and/or memory operation types, which enables flexible system topologies where entities need not share compatible protocol parameters.

In some implementations of the system, the second entity comprises a second CXL device of a second type, the computer exposes resources associated with the second entity to the first entity via a first CXL device of a first type, and the first type and the second type are different. The translation may further enable abstraction of component identities, such as exposing resources associated with a CXL Type-3 device as a CXL Type-2 device, or exposing resources associated with a CXL Type-2 device as a CXL Type-1 device.

In some implementations of the system, the second entity comprises a CXL Type-3 device, and wherein the computer exposes resources associated with the second entity to the first entity via a CXL Type-2 device. Exposing resources associated with a CXL Type-3 device as a CXL Type-2 device may enable different caching behaviors or coherency models than those natively supported by the Type-3 device.

In some implementations of the system, the second entity comprises a CXL Type-2 device, and wherein the computer exposes memory resources associated with the second entity to the first entity via a CXL Type-3 device. Exposing memory resources associated with a CXL Type-2 device as a CXL Type-3 device may enable simplified memory access semantics for hosts that do not require the full capabilities of Type-2 devices, potentially reducing complexity in system configurations.

In some implementations, the system further comprises a third entity, wherein the computer is further configured to: receive a third CXL.mem M2S request from the third entity; translate the third CXL.mem M2S request to a fourth CXL.mem M2S request, wherein value of at least one field, selected from MemOpcode, Tag, or Address, is different between the third and fourth CXL.mem M2S requests; and send the fourth CXL.mem M2S request to the second entity. The ability of the computer to aggregate and translate requests from multiple sources to a common destination entity enables the multi-host or multi-initiator configuration with the third entity. The computer may perform independent translations for each source entity, enabling per-entity address mapping, Tag namespace management, and/or opcode policies. This enables the second entity, such as a CXL memory device, to serve multiple initiators through the same physical interface while maintaining logical separation of their respective transactions.

In some implementations of the system, the first entity comprises a first host, the third entity comprises a second host, the second entity comprises a CXL device, and there is no CXL switch positioned between the CXL device and the first and second hosts. The CXL specification requires SLDs, MLDs, and GFDs to connect to multiple hosts through a VCS within a CXL switch. This implementation eliminates the requirement for a CXL switch by using the computer to perform the applicable translations, routing decisions, and multi-host coordination functions. The computer may implement the logical equivalent of VCS functionality while operating as a translation unit rather than a switch component, enabling new deployment models and system architectures not contemplated by the standard CXL topology requirements.

In some implementations of the system, the computer is further configured to maintain separate address translation tables for the first and third entities, mapping first and third addresses from first and third address spaces utilized by the first and third entities, respectively, to second addresses within a second address space utilized by the second entity. The separate address translation tables may enable memory isolation between the entities, such as between hosts, preventing unauthorized cross-host memory access. Each translation table may map a host's virtual view of a CXL device to distinct physical regions, implementing hardware-enforced memory protection without requiring CXL switch-based isolation mechanisms. Mapping to non-overlapping regions may enable memory pooling and ensure that memory operations from one host cannot inadvertently or maliciously access another host's allocated memory space, whereas mapping to overlapping regions may enable memory sharing between hosts.

In some implementations of the system, the second entity comprises a second CXL device, and wherein the computer exposes resources associated with the second entity to the first entity via a first CXL device and to the third entity via a third CXL device. The virtualization of the single physical CXL device, such as a memory expander, into multiple virtual devices enables each host to operate as if it has exclusive access to a dedicated memory expander. The computer may present different capacity values, latency characteristics, bandwidth allocations, or feature sets to each host through the virtual device abstraction. This virtualization may include managing separate configuration spaces, capability registers, and control interfaces for each virtual device instance.

In various implementations, a method for enabling multi-host access to a Compute Express Link (CXL) device, comprising: receiving, from a first entity, a first CXL.mem Master-to-Subordinate (M2S) request carrying a first physical address; receiving, from a second entity, a second CXL.mem M2S request carrying a second physical address; translating the first and second physical addresses to third and fourth physical addresses within an address space utilized by a CXL device; generating third and fourth CXL.mem M2S requests comprising the third and fourth physical addresses, respectively; and sending the third and fourth CXL.mem M2S requests to the CXL device. A standard CXL switch typically uses HDM decoders for routing purposes in order to determine which downstream port (DPID/Port ID) should receive the request, and then forwards the original request containing the HPA. Additionally, the standard CXL switch does not perform the HPA-to-DPA translation itself when acting as a router to an endpoint device like an MLD/MHD. This implementation overcomes these limitations by interposing address translation and request routing logic between the CXL hosts and the CXL device. The translation of physical addresses may enable each host to maintain its own memory view while the CXL device may utilize a separate address space, with the translation logic managing the mapping between addresses from the host address spaces and the address space utilized by the CXL device.

In some implementations of the method, the first and second entities comprise first and second CXL hosts, respectively, the CXL device comprises a CXL memory expander, the first and second physical addresses from the first and second CXL hosts target overlapping memory regions, and further comprising implementing coherency control between the first and second CXL hosts for the overlapping memory regions. When hosts access overlapping memory regions, the computer may implement coherency mechanisms including snoop filtering to track which host has cached copies of specific memory lines, invalidation broadcasting to notify hosts when shared data is modified, and/or lock management to serialize concurrent access to the same memory locations. These coherency controls operate independently of CXL switch-based coherency mechanisms, implementing coherency protocols within the translation logic.

In some implementations of the method, the CXL device comprises a CXL memory expander, and further comprising implementing quality-of-service (QoS) policies associated with the first and second entities, wherein the QoS policies comprise bandwidth allocation or latency prioritization for memory accesses to the CXL memory expander. The QoS implementation may prevent an entity (such as a CXL host) from monopolizing the memory expander's resources while guaranteeing minimum performance levels for predetermined workloads. Bandwidth allocation may utilize token bucket algorithms, rate limiting mechanisms, or credit-based flow control to regulate the rate of requests forwarded from each entity. Latency prioritization may involve request reordering based on configured priority levels, deadline scheduling for time-sensitive operations, and/or preferential queue management for high-priority entities.

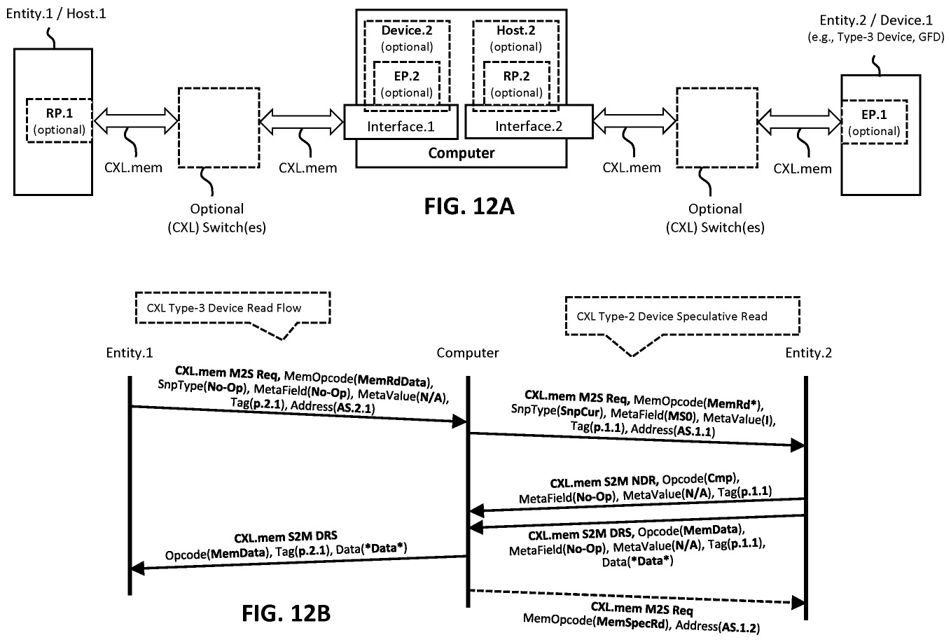

FIG. 12A illustrates an example of a system comprising a computer coupled between a first interface (Interface.1) and a second interface (Interface.2), wherein both the first and second interfaces may communicate according to CXL.mem. The first interface may expose resources associated with a second device (Device.2), such as a CXL type-2 device or a CXL type-3 device, optionally comprising a second endpoint (EP.2), and may communicate according to CXL.mem with a first entity (Entity.1), such as a first host (Host.1), possibly via a first root port (RP.1) of the first host. The second interface may expose a root port (RP.2), via which the computer may communicate as a second host (Host.2) according to CXL.mem with a second entity (Entity.2), such as a first CXL device (Device.1), which may include a first endpoint (EP.1). Additionally or alternatively, the first CXL device may include a Global Fabric-Attached Memory (G-FAM) Device (GFD). The computer may extract physical addresses from messages received via the first interface, wherein these addresses may be from a first HPA space utilized by the first host; translate these addresses; and generate messages carrying the translated physical addresses for transmission via the second interface; wherein these translated addresses may correspond to a physical address space exposed by the computer over the second interface. Optional CXL switch(es) may be positioned between the first interface and the first entity, and/or between the second interface and the second entity. In some examples, the computer and at least one of the first entity and the second entity may be included within the same IC package, optionally coupled via one or more UCIe links.

FIG. 12B illustrates an example of a transaction flow diagram (TFD) demonstrating translations, optionally performed by a computer, between first CXL.mem messages received from a first entity (Entity.1), such as a first host (Host.1), that may utilize a first CXL.mem, and second CXL.mem messages, sent to a second entity (Entity.2), such as a first CXL device (Device.1), that may utilize a second CXL.mem, possibly enabling the computer to abstract resources of the second entity, and possibly enabling the first entity to access resources of the second entity utilizing different memory flow types, such as utilizing optimized type-3 memory flows, instead of type-2 memory flows that may be utilized by the second entity. Additionally or alternatively, the computer may further initiate speculative memory reads targeting the second entity, and may handle memory prefetching on behalf of the first entity, possibly acting as a proxy of the first entity when communicating with the second entity. The first entity may initiate a first CXL.mem transaction that may include a first CXL.mem M2S Req comprising MemOpcode(MemRdData), SnpType(No-Op), MetaField(No-Op), MetaValue(N/A), Tag(p.2.1), and Address(AS.2.1). The computer may translate the first CXL.mem transaction to a second CXL.mem transaction that may include a second CXL.mem M2S Req comprising MemOpcode(MemRd*), SnpType(SnpCur), MetaField(MS0), MetaValue(I), Tag(p.1.1), and Address(AS.1.1), and may send the second CXL.mem M2S Req to the second entity. Upon receiving one or more responses from the second entity, that may include a CXL.mem S2M NDR comprising Opcode(Cmp), MetaField(No-Op), MetaValue(NA), and Tag(p.1.1), and may further include a first CXL.mem S2M DRS comprising Opcode(MemData), MetaField(No-Op), MetaValue(NA), Tag(p.1.1), and Data(*Data*), the computer may translate the one or more responses from the second entity to a second CXL.mem S2M DRS comprising Opcode(MemData), Tag(p.2.1), and Data(*Data*), and may send the second CXL.mem S2M DRS to the first entity.

One example of a speculative memory read targeting the second entity includes a CXL.mem M2S Req comprising MemOpcode(MemSpecRd) and Address(AS.1.2), which may utilize the speculative memory reads, optionally on behalf of the first entity, to facilitate data prefetches and potentially reduce read latency from the second entity. When utilizing MemSpecRd, some of the CXL.mem M2S Req fields, such as Tag, MetaField, MetaValue, and SnpType, may be reserved. The computer may perform further translations, such as opcode translations, e.g., translating between a first CXL.mem M2S Req opcode, such as MemRdData, and a second CXL.mem M2S Req opcode, such as MemRd. The computer may further perform other translations, such as field translations between messages conforming to the first CXL.mem and messages conforming to the second CXL.mem, such as translations between CXL.mem Tags of the two protocols, translations between values of reserved fields of the two protocols, and translations between values of reserved and non-reserved fields of the two protocols. In some examples, the computer may translate between protocols conforming to different CXL revisions, such as translating between transactions of the first CXL.mem conforming to CXL 1.1, which may be utilized by the first entity, and transactions of the second CXL.mem conforming to CXL 2.0, which may be utilized by the second entity.

In some examples, the computer may act as a second device (Device.2), such as a CXL type-3 device or CXL type-2 device optionally comprising a protocol endpoint, and terminate the first CXL.mem transaction. The computer may then issue the second CXL.mem transaction, optionally acting as an independent protocol initiator, such as a second host (Host.2), and may utilize translated fields from the first CXL.mem transaction for constructing the second CXL.mem transaction. In other examples, the computer may maintain, at least partly, an end-to-end transaction context along the path between the first entity and the second entity, optionally without terminating CXL.mem transactions received from the first entity, such as by preserving, at least partly, transaction-related identification fields. In one example, the computer may reuse CXL.mem Tags received from the first entity for constructing CXL.mem Tags sent to the second entity, hence optionally preserving, at least partly, a transaction identifier over the path between the first entity and the second entity, for maintaining, at least partly, an end-to-end transaction context along that path.

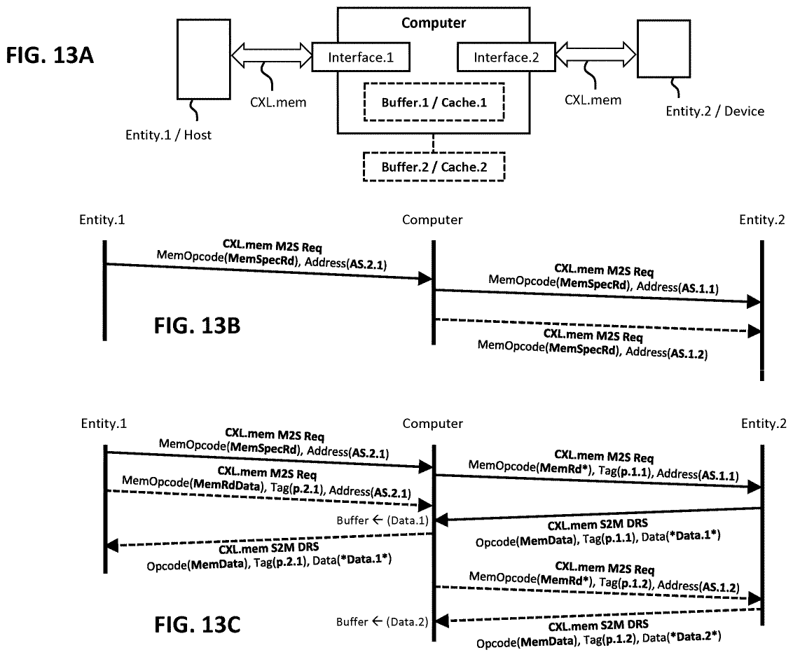

FIG. 13A illustrates an example of a system comprising a computer coupled between a first interface (Interface.1) and a second interface (Interface.2), wherein both the first and second interfaces may communicate according to CXL.mem. The first interface may communicate according to first CXL.mem with a first entity (Entity.1), such as a host. The second interface may communicate according to second CXL.mem with a second entity (Entity.2), such as a device, such as a CXL type-3 device or a Global Fabric-Attached Memory (G-FAM) Device (GFD). The computer may extract field values, such as addresses, opcodes, or Tags, from messages received via the first interface; translate one or more of these field values; and generate messages carrying the translated field values for transmission via the second interface. The computer may include a first buffer (Buffer.1) or a first cache (Cache.1), and may be coupled to a second buffer (Buffer.2) or a second cache (Cache.2). The computer may utilize the buffers or caches for storing data, such as data read from the second entity, data written to the second entity, or data prefetched by the computer from the second entity. Optional CXL switch(es) may be positioned between the first interface and the first entity, and/or between the second interface and the second entity. In some examples, the computer and at least one of the first entity and the second entity may be included within the same IC package, optionally coupled via one or more UCIe links.

FIG. 13B illustrates an example of a TFD demonstrating translations, optionally performed by a computer, between CXL.mem M2S MemSpecRd requests received from a first entity (Entity.1), such as a host, that may utilize a first CXL.mem, and CXL.mem M2S MemSpecRd requests sent to a second entity (Entity.2), such as a CXL device, that may utilize a second CXL.mem, possibly enabling the computer to facilitate data readiness and reduce read latency from the second entity. Additionally or alternatively, the computer may initiate further speculative memory reads targeting the second entity, and may handle memory prefetching on behalf of the first entity, possibly acting as a proxy of the first entity when communicating with the second entity. The first entity may initiate a first CXL.mem transaction that may include a first CXL.mem M2S Req comprising MemOpcode(MemSpecRd) and Address(AS.2.1). When utilizing MemSpecRd, some of the CXL.mem M2S Req fields, such as Tag, MetaField, MetaValue, and SnpType, may be reserved. The computer may translate the first CXL.mem transaction to a second CXL.mem transaction that may include a second CXL.mem M2S Req comprising MemOpcode(MemSpecRd) and Address(AS.1.1), and may send the second CXL.mem M2S Req to the second entity. In some examples, the computer may further translate the first CXL.mem transaction to a third CXL.mem transaction that may include a third CXL.mem M2S Req comprising MemOpcode(MemSpecRd) and Address(AS.1.2), and may send the third CXL.mem M2S Req to the second entity, possibly facilitating the readiness of further data reads that may be expected from the first entity. The computer may further perform other translations, such as translations between messages conforming to the first CXL.mem and messages conforming to the second CXL.mem, translations between reserved fields, and/or translations between reserved and non-reserved fields. In some examples, the computer may translate between protocols conforming to different CXL revisions, such as translating between transactions of the first CXL.mem conforming to CXL 1.1, which may be utilized by the first entity, and transactions of the second CXL.mem conforming to CXL 2.0, which may be utilized by the second entity.

FIG. 13C illustrates an example of a TFD demonstrating translations between CXL.mem messages received from a first entity (Entity.1), such as a host, that may utilize a first CXL.mem, and CXL.mem messages sent to a second entity (Entity.2), such as a CXL device, that may utilize a second CXL.mem, possibly enabling the computer to abstract resources of the second entity and to facilitate data readiness and reduce read latency by prefetching data from the second entity. The first entity may initiate a speculative memory read by initiating a first CXL.mem transaction that may include a first CXL.mem M2S Req comprising MemOpcode(MemSpecRd) and Address(AS.2.1), wherein the first entity may send the first CXL.mem M2S Req to the computer. When utilizing MemSpecRd, some of the CXL.mem M2S Req fields, such as Tag, MetaField, MetaValue, and SnpType, may be reserved. The computer may translate the speculative memory read to a demand read, such as by translating the first CXL.mem transaction to a second CXL.mem transaction that may include a second CXL.mem M2S Req comprising MemOpcode(MemRd*), Tag(p.1.1), and Address(AS.1.1), wherein the computer may send the second CXL.mem M2S Req to the second entity.

Upon receiving one or more responses from the second entity, that may include a first CXL.mem S2M DRS comprising Opcode(MemData), Tag(p.1.1), and Data(*Data.1*), the computer may store *Data.1* in a buffer or a cache, and may further respond to an outstanding read request, if exists, from the first entity, such as a third CXL.mem transaction that may include a third CXL.mem M2S Req comprising MemOpcode(MemRdData), Tag(p.2.1), and Address(AS.2.1), wherein the computer may respond to this request with a second CXL.mem S2M DRS comprising Opcode(MemData), Tag(p.2.1), and Data(*Data.1*), and may send the second CXL.mem S2M DRS to the first entity. Optionally, such as in order to prefetch the next data from the second entity, the computer may further translate the first CXL.mem transaction to a fourth CXL.mem transaction that may include a fourth CXL.mem M2S Req comprising MemOpcode(MemRd*), Tag(p.1.2), and Address(AS.1.2), and may send the fourth CXL.mem M2S Req to the second entity. Upon receiving one or more responses from the second entity, that may include a third CXL.mem S2M DRS comprising Opcode(MemData), Tag(p.1.2), and Data(*Data.2*), the computer may store *Data.2* in the buffer or the cache, wherein the prefetched *Data.2* may be ready for consumption by the first entity, potentially reducing read latency from the second entity as perceived from the first entity. The computer may perform further translations, such as opcode translations, e.g., translating between a first CXL.mem M2S Req opcode, such as MemSpecRd, and a second CXL.mem M2S Req opcode, such as MemRd*.

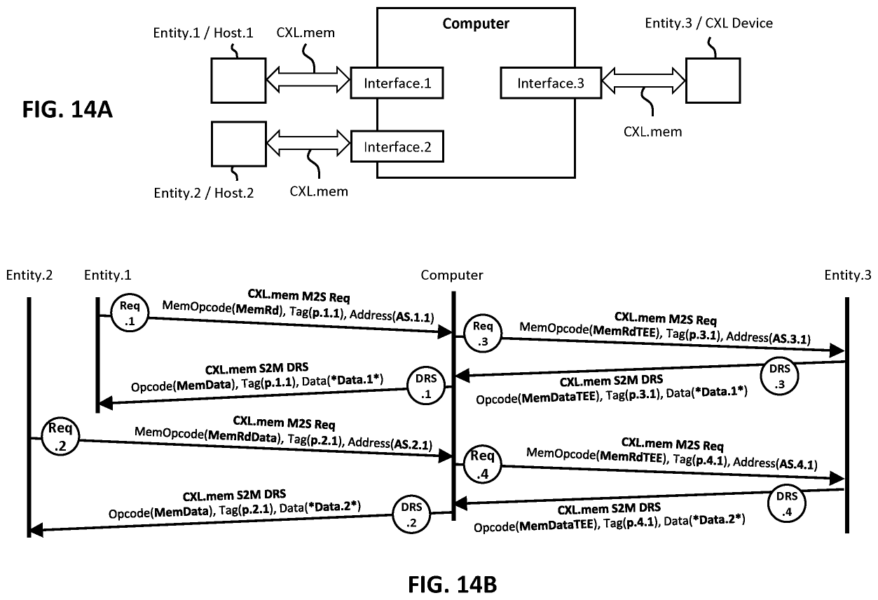

FIG. 14A illustrates an example of a system comprising a computer coupled to a first interface (Interface.1), a second interface (Interface.2), and a third interface (Interface.3). The computer may: (i) receive, via the first interface, a first CXL.mem Master-to-Subordinate request (M2S request) from a first entity (Entity.1), such as a first host (Host.1); (ii) receive, via the second interface, a second CXL.mem M2S request from a second entity (Entity.2), such as a second host (Host.2); (iii) translate the first and second CXL.mem M2S requests to third and fourth CXL.mem M2S requests, respectively; and (iv) send, via the third interface, the third and fourth CXL.mem M2S requests to a third entity (Entity.3), such as a CXL device, that may include an endpoint (EP). Additionally or alternatively, the CXL device may include a Global Fabric-Attached Memory (G-FAM) Device (GFD). In some examples, the computer may further: (i) extract first values of fields, such as first addresses, first opcodes, or first Tags, from messages received via the first interface, translate these first values, and generate messages carrying the translated first values for transmission via the third interface; and/or (ii) extract second values of fields, such as second addresses, second opcodes, or second Tags, from messages received via the second interface, translate these second values, and generate messages carrying the translated second values for transmission via the third interface. In some examples, the computer and at least one of the first entity, the second entity, and the third entity, may be included within the same IC package, optionally coupled via one or more UCIe links.

FIG. 14B illustrates an example of a TFD demonstrating translations, such as translations, optionally performed by a computer, between CXL.mem M2S requests received from a first entity (Entity.1) and a second entity (Entity.2), and CXL.mem M2S requests sent to a third entity (Entity.3), such as a CXL device, possibly enabling the computer to abstract resources of the third entity, such as memory resources, and to expose these resources to the first entity, which may be a first host (Host.1), and to the second entity, which may be a second host (Host.2). In some examples, the translations may enable two hosts to access memory resources of a CXL device. The first entity may initiate a first CXL.mem M2S request (marked as Req.1) comprising MemOpcode(MemRd), Tag(p.1.1), and Address(AS.1.1). The computer may translate the first CXL.mem M2S request to a third CXL.mem M2S request (marked as Req.3) comprising MemOpcode(MemRdTEE), Tag(p.3.1), and Address(AS.3.1), and may send the third CXL.mem M2S request to the third entity. Upon receiving one or more responses from the third entity, which may include a third CXL.mem S2M DRS (marked as DRS.3) comprising Opcode(MemDataTEE), Tag(p.3.1), and Data(*Data.1*), the computer may translate the third CXL.mem S2M DRS to a first CXL.mem S2M DRS (marked as DRS.1) comprising Opcode(MemData), Tag(p.1.1), and Data(*Data.1*), and may send the first CXL.mem DRS to the first entity.

Similarly, the second entity may initiate a second CXL.mem M2S request (marked as Req.2) comprising MemOpcode(MemRdData), Tag(p.2.1), and Address(AS.2.1). The computer may translate the second CXL.mem M2S request to a fourth CXL.mem M2S request (marked as Req.4) comprising MemOpcode(MemRdTEE), Tag(p.4.1), and Address(AS.4.1), and may send the fourth CXL.mem M2S request to the third entity. Upon receiving one or more responses from the third entity, which may include a fourth CXL.mem S2M DRS (marked as DRS.4) comprising Opcode(MemDataTEE), Tag(p.4.1), and Data(*Data.2*), the computer may translate the fourth CXL.mem S2M DRS to a second CXL.mem S2M DRS (marked as DRS.2) comprising Opcode(MemData), Tag(p.2.1), and Data(*Data.2*), and may send the second CXL.mem DRS to the second entity. The computer may perform further translations, such as opcode translations, e.g., translating between CXL.mem M2S request comprising MemRdData, and CXL.mem M2S request comprising MemRdTEE, possibly enabling confidential computing and Trusted Execution Environment (TEE), such as by protecting data-at-rest via encryption. The computer may further perform other translations, such as Tag translations between CXL.mem messages, translations between reserved fields, and/or translations between reserved and non-reserved fields. In some examples, the computer may translate between CXL.mem conforming to different CXL revisions, such as translating between transactions of CXL.mem conforming to CXL 1.1, which may be utilized by the first entity, and transactions of CXL.mem conforming to CXL 4.0, which may be utilized by the third entity.

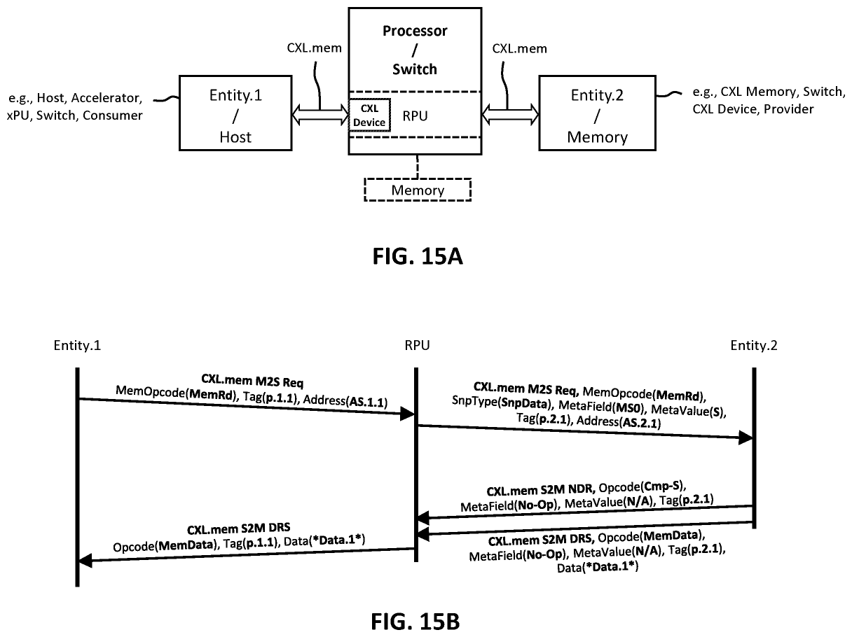

FIG. 15A illustrates an example of a system comprising a processor or a switch, which may include or may be coupled to memory, and may further include an RPU with a CXL device, such as a Global Fabric-Attached Memory (G-FAM) Device (GFD), or a Type-3/2/1 CXL device, enabling external entities to access resources coupled to the processor via the CXL device. The processor is coupled to a first entity (Entity.1), which may be a host, an accelerator, an xPU, or a second switch, wherein the processor may communicate with the first entity according to a first CXL.mem. The processor is further coupled to a second entity (Entity.2), which may be a CXL memory, a CXL device, or a third switch, wherein the processor may communicate with the second entity according to a second CXL.mem. In some examples, the first and second CXL.mem may be associated with first and second physical address spaces, respectively, wherein the RPU may perform address translations between addresses within the first and second physical address spaces, respectively. In other examples, the first and second CXL.mem may be associated with the same physical address space, wherein the RPU may perform address translations between addresses within the same physical address space.

The RPU may perform further translations, such as opcode translations, e.g., translating between MemRd opcodes in requests conforming to the first CXL.mem, to MemRdTEE opcodes in requests conforming to the second CXL.mem, enabling CXL memory accesses with the Trusted Execution Environment (TEE) attribute. The RPU may further perform other translations, such as translations between messages conforming to the first and second CXL.mem, such as Tag translations and traffic class (TC) translations. In some examples, the RPU may translate between protocols conforming to different CXL protocol revisions, such as translating between CXL.mem transactions conforming to CXL 1.1, which may be utilized by the first entity, and CXL.mem transactions conforming to CXL 2.0, which may be utilized by the second entity. In some examples, the RPU may translate between CXL.mem type-3 memory flows and CXL.mem type-2 memory flows, such as CXL.mem transactions that may include CXL.mem S2M NDR responses.

FIG. 15B illustrates an example of a TFD demonstrating translations performed by a processor, a switch, or by an RPU, between a first CXL.mem utilized for communicating with a first entity (Entity.1), such as a host, and a second CXL.mem utilized for communicating with a second entity (Entity.2), such as a CXL device or CXL memory. The first entity may initiate a first CXL.mem transaction that includes a first CXL.mem M2S request comprising MemOpcode(MemRd*), Tag(p.1.1), and Address(AS.1.1). The RPU may translate the first CXL.mem transaction to a second CXL.mem transaction that includes a second CXL.mem M2S request comprising MemOpcode(MemRd), SnpType(SnpData), MetaField(MS0), MetaValue(S), Tag(p.2.1), and Address(AS.2.1), wherein the RPU may send the second CXL.mem M2S request to the second entity. The second entity may respond to the second CXL.mem M2S request with a CXL.mem S2M NDR comprising Opcode(Cmp-S), MetaField(No-Op), MetaValue(NA), and Tag(p.2.1), and may further respond with a first CXL.mem S2M DRS comprising Opcode(MemData), MetaField(No-Op), MetaValue(NA), Tag(p.2.1), and Data(*Data.1*), wherein the RPU may translate the first CXL.mem S2M DRS to a second CXL.mem S2M DRS comprising Opcode(MemData), Tag(p.1.1), and Data(*Data.1*). Optionally, the RPU may act as a protocol endpoint and terminate the first CXL.mem transaction. The RPU may issue the second CXL.mem transaction, optionally acting as an independent protocol initiator, such as a CXL host, and may utilize translated fields from the first CXL.mem transaction for constructing the second CXL.mem transaction. In other examples, the RPU may maintain end-to-end transaction contexts of CXL.mem between the first entity and the second entity, without terminating the CXL.mem transactions, such as by preserving transaction-related identifications such as Tags, and optionally translating other fields such as address fields.

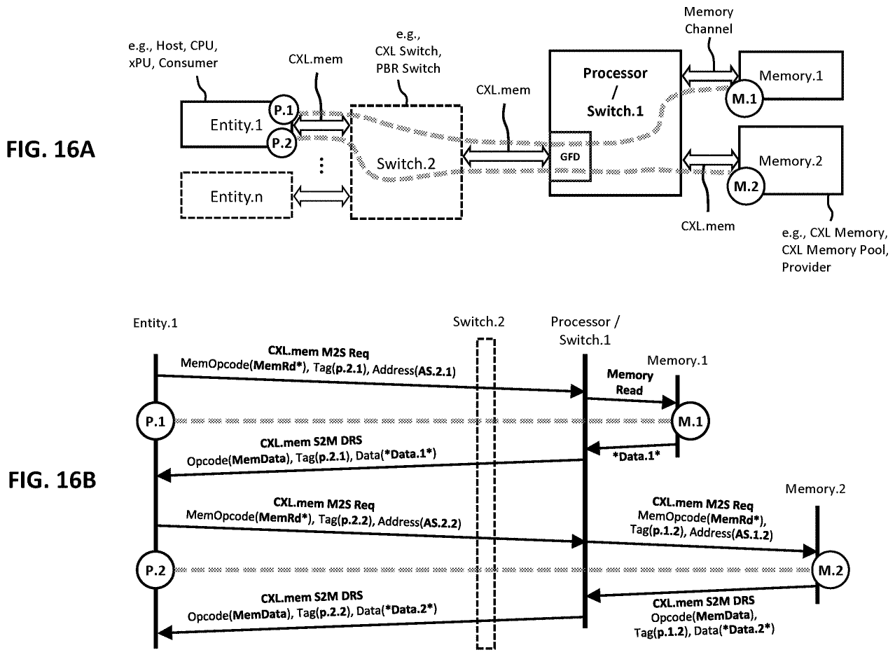

FIG. 16A illustrates an example of a system comprising a processor or a first switch (Switch.1), which may be coupled to a first memory (Memory.1), such as DRAM, via a memory channel, and may be further coupled to a second memory (Memory.2), such as CXL memory, a CXL memory pool, or a CXL-based provider. The processor may include a Global Fabric-Attached Memory (G-FAM) Device (GFD), which may be coupled to one or more entities, such as first entity (Entity.1), optionally via a second switch (Switch.2), such as a CXL switch or a PBR switch, enabling the one or more entities to access, via the GFD, resources coupled to the processor, such as via one or more of the two illustrated paths denoted as (P.1)-(M.1) and (P.2)-(M.2). In some examples, the number of entities, denoted by the parameter n of (Entity.n) may exceed 16. The processor may communicate with the first entity, which may be a host, a CPU, an xPU, or a consumer, according to a first CXL-based protocol, such as a first CXL.mem. The processor may communicate with the second memory, according to a second CXL-based protocol, such as a second CXL.mem.

In some examples, the first and second CXL.mem may be associated with first and second physical address spaces, respectively, such as first and second Host Physical Address (HPA) spaces, wherein the processor may perform address translations between addresses within the first and second physical address spaces, respectively. In other examples, the first and second CXL.mem may be associated with the same physical address space, wherein the processor may perform address translations between addresses within the same physical address space. The processor may perform further translations, such as opcode translations, e.g., translating between MemRd opcodes in requests conforming to the first CXL.mem, to MemRdTEE opcodes in requests conforming to the second CXL.mem, enabling CXL memory accesses with the Trusted Execution Environment (TEE) attribute. The processor may further perform other translations, such as translations between messages conforming to the first and second CXL.mem, traffic class (TC) translations, and/or Tag translations. The processor may maintain tracking between Tags associated with the first CXL.mem and Tags associated with the second CXL.mem, such as in order to associate responses with their corresponding requests. In some examples, the processor may translate between protocols conforming to different CXL protocol revisions, such as translating between CXL.mem transactions conforming to CXL 1.1, which may be utilized by the first entity, and CXL.mem transactions conforming to CXL 2.0, which may be utilized by the second memory.

FIG. 16B illustrates an example of a TFD demonstrating two CXL.mem transactions between a first entity (Entity.1), such as a host, and a processor, or a first switch (Switch.1), corresponding to two distinct memory read paths denoted as (P.1)-(M.1) and (P.2)-(M.2), each associated with a different physical address mapped to different memory resources. The drawing further illustrates translations performed by the processor (or by Switch.1), between a first CXL.mem utilized for communicating with the first entity, and a second CXL.mem utilized for communicating with a second memory (Memory.2), such as a CXL memory, wherein the communication between the processor and the first entity may be performed via a Global Fabric-Attached Memory (G-FAM) Device (GFD) and optionally via a second switch (Switch.2).

The first CXL.mem transaction received by the processor from the first entity includes a first CXL.mem M2S request comprising MemOpcode(MemRd*), Tag(p.2.1), and Address(AS.2.1), which the processor may translate and forward, optionally via an internal interconnect of the processor, via a memory controller, and via a memory channel, to a first memory (Memory.1), resulting in the retrieval of *Data.1*, that the processor sends to the first entity via a first CXL.mem S2M DRS comprising Opcode(MemData), Tag(p.2.1), and Data(*Data.1*).

The second CXL.mem transaction received by the processor from the first entity includes a second CXL.mem M2S request comprising MemOpcode(MemRd*), Tag(p.2.2), and Address(AS.2.2), which the processor may translate to a third CXL.mem transaction that may include a third CXL.mem M2S request comprising MemOpcode(MemRd*), Tag(p.1.2), and Address(AS.1.2), wherein the processor may send the third CXL.mem M2S request to the second memory. Upon receiving a response from the second memory, that may include a second CXL.mem S2M DRS comprising Opcode(MemData), Tag(p.1.2), and Data(*Data.2*), the processor may translate the second CXL.mem S2M DRS to a third CXL.mem S2M DRS comprising Opcode(MemData), Tag(p.2.2), and Data(*Data.2*). The processor may perform further translations, such as opcode translations, e.g., translating between MemRd opcodes in requests conforming to the first CXL.mem, and MemRdTEE opcodes in requests conforming to the second CXL.mem, enabling CXL memory accesses with the Trusted Execution Environment (TEE) attribute.

In some examples, the processor may act as a protocol endpoint and terminate the CXL.mem transactions received from the first entity. The processor may issue CXL.mem transactions to the second memory, optionally acting as an independent protocol initiator, such as a CXL host, and may utilize translated fields from the CXL.mem transactions received from the first entity for constructing the CXL.mem transactions sent to the second memory. In other examples, the processor may maintain end-to-end transaction contexts of the CXL.mem between the first entity and the second memory, without terminating the CXL.mem transactions, such as by preserving transaction-related identification fields such as Tags, and optionally translating other fields such as address.

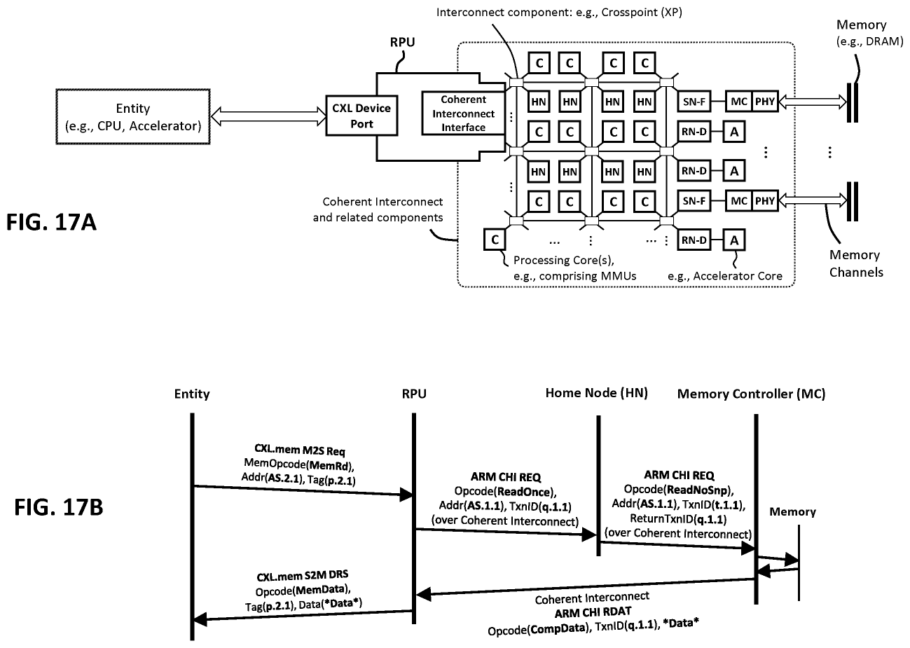

FIG. 17A illustrates an example of a system where an entity, such as a CPU or accelerator, communicates via a CXL device port that is coupled to or included in an RPU. The RPU may further include a Coherent Interconnect Interface that may utilize a protocol based on ARM CHI. The Coherent Interconnect Interface couples the RPU to an interconnect component, such as a crosspoint (XP), within a coherent interconnect. The Coherent Interconnect Interface performs the applicable conversions between a CXL-based domain and a coherent interconnect domain, such as between CXL.mem and ARM CHI, enabling the entity to access the memory (such as DRAM) and other resources coupled to the coherent interconnect. The coherent interconnect may be implemented as a mesh topology connecting various components including processing cores, home nodes (HN), memory controllers (MC), and accelerator cores.

FIG. 17B illustrates an example of a TFD showing address translations between CXL.mem and ARM CHI. An entity, such as a CPU, initiates a CXL.mem M2S request, such as M2S Req comprising a physical address (AS.2.1), MemRd, Addr(AS.2.1), and Tag(p.2.1). The RPU translates the M2S Req to a CHI request, such as ARM CHI REQ carrying ReadOnce, a translated physical address (AS.1.1), and TxnID(q.1.1). The transaction flows through the coherent interconnect to a home node (HN), which may process the request and send the processed request to a memory controller (MC). The HN may translate the received ARM CHI REQ to an ARM CHI REQ carrying ReadNoSnp, Addr(AS.1.1), TxnID(t.1.1), and ReturnTxnID(q.1.1). The memory controller retrieves the data from the memory (such as DRAM) and sends the data to the RPU, such as utilizing ARM CHI RDAT, through the coherent interconnect. For example, the memory controller may utilize ARM CHI RDAT with CompData and TxnID(q.1.1) for sending the data. The wildcard notation *Data* indicates that the data may be encoded, encrypted, or otherwise processed as needed for the transmission. Alternatively, the response and read data paths may be implemented according to other designs, such as wherein the MC may send the data to the HN that sends it to the RPU, or the HN sends a response to the RPU while the MC sends the data to the RPU. The RPU then translates the ARM CHI response back to the CXL.mem domain for delivery to the requesting entity. For example, the RPU may translate the ARM CHI RDAT to CXL.mem S2M DRS comprising MemData, Tag(p.2.1), and the *Data*.

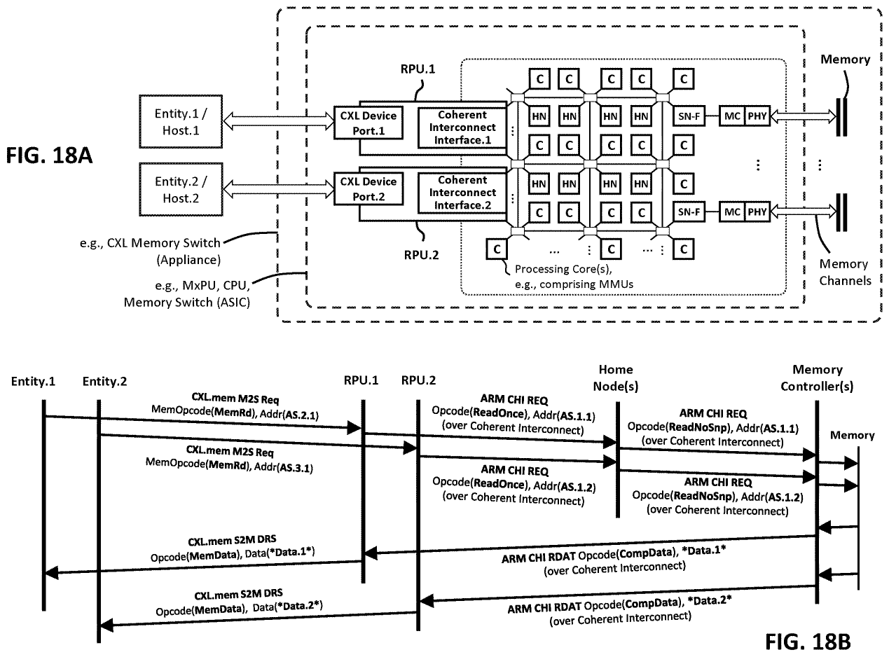

FIG. 18A illustrates an example of a system comprising a CXL memory switch appliance comprising an MxPU, CPU, or a memory switch ASIC, which is coupled to first and second entities denoted as Entity.1/Host.1 and Entity.2/Host.2. The MxPU includes processing cores and memory controllers coupled to a coherent interconnect that in one example utilizes a CHI-based protocol. The MxPU utilizes translations, performed by the RPUs, between CXL-based ports and the MxPU's coherent interconnect. The first RPU (RPU.1) may enable Entity.1/Host.1 to access, via the first CXL device port and the MxPU's coherent interconnect, resources mapped to a physical address space utilized by the MxPU's coherent interconnect, such as memory (e.g., DRAM) resources of the MxPU. Correspondingly, the second RPU (RPU.2) may enable Entity.2/Host.2 to access, via the second CXL device port and the MxPU's coherent interconnect, resources mapped to the physical address space utilized by the MxPU's coherent interconnect, such as the memory resources of the MxPU.

FIG. 18B illustrates an example of a TFD depicting a multi-host memory access scenario wherein two entities access memory through a shared coherent interconnect infrastructure. Entity.1/Host.1 initiates a CXL.mem M2S request comprising MemOpcode(MemRd) and Addr(AS.2.1) from a second physical address space, which RPU.1 translates to ARM CHI REQ carrying Opcode(ReadOnce) and Addr(AS.1.1) from the coherent interconnect's first physical address space. Concurrently or sequentially, Entity.2/Host.2 may initiate a CXL.mem M2S request comprising MemOpcode(MemRd) and Addr(AS.3.1) from a third physical address space, which RPU.2 translates to ARM CHI REQ carrying Opcode(ReadOnce) and Addr(AS.1.2) from the coherent interconnect's first physical address space. Both transactions flow through the coherent interconnect to one or more home nodes, which send respective ARM CHI REQ messages to one or more memory controllers, for example with Opcode(ReadNoSnp) and the addresses Addr(AS.1.1) and Addr(AS.1.2), respectively. The memory controller(s) retrieve the requested data from memory and send ARM CHI RDAT messages with Opcode(CompData) carrying *Data.1* and *Data.2*, representing the data retrieved from the addresses AS.1.1 and AS.1.2, respectively. RPU.1 translates the first response to CXL.mem S2M DRS with Opcode(MemData) and Data(*Data.1*) and sends it to Entity.1/Host.1. RPU.2 translates the second response to CXL.mem S2M DRS with Opcode(MemData) and Data(*Data.2*) and sends it to Entity.2/Host.2. The illustrated example demonstrates how hosts may share access to the same memory resources based on RPUs that perform physical address translations. Additionally or alternatively, the illustrated example may be viewed as two separate transactions that utilize the same processor's coherent interconnect to access the memory, wherein the entities maintain their respective physical address space that are translated to the physical address space utilized by the coherent interconnect.

Depending on system characteristics, such as implementation choices and platform configurations, different physical addresses, such as (AS.1.1) and (AS.1.2), within a physical address space utilized by the coherent interconnect, may be typically partitioned, such as via hashing or interleaving schemes, across a set of home nodes. Such partitioning is typically performed in order to reduce bottleneck effects in the system and spread the load of transaction processing across home nodes of the coherent interconnect, and may result in mapping the different physical addresses, such as (AS.1.1) and (AS.1.2), to the same home node, or to different home nodes. Similarly, different physical addresses may be associated with one memory controller, or with different memory controllers, such as according to a separate mapping scheme, which may be different from the mapping scheme utilized for selecting a home node for processing the request. Alternatively, other examples may co-locate the home node function with a specific memory controller, utilizing a unified mapping scheme that selects both a home node and a memory controller.

In environments comprising hosts and devices that may utilize different CXL domains, while requiring coordinated access to shared resources, there may be scenarios where a first entity that communicates utilizing CXL.mem needs to access resources associated with a second entity that communicates utilizing CXL.io, wherein the first and second entities may operate with different address spaces. Translations between CXL.mem messages and CXL.io messages may facilitate memory reads, memory writes, and data transfers across different domains while enabling interoperability between entities that cannot communicate directly due to protocol limitations or semantic mismatches. Additionally, CXL.io UIO may provide enhanced capabilities for peer-to-peer communication and fabric-based topologies. UIO transactions may include CDLs that carry QoS telemetry, metadata, or other information that may be translated to DevLoad fields in CXL.mem messages, thereby enabling end-to-end propagation of telemetry information across domain boundaries.

In various implementations, a method for translating between Compute Express Link (CXL) messages, comprising: receiving, from a first entity via a first interface, a CXL.mem Master-to-Subordinate (M2S) request comprising a first opcode, a first Tag, and a first address; translating the CXL.mem M2S request to a CXL.io request comprising a second Tag and a second address; sending, via a second interface, the CXL.io request to a second entity; receiving, from the second entity via the second interface, a CXL.io completion comprising the second Tag and a data payload; translating the CXL.io completion to a CXL.mem Subordinate-to-Master Data Response (S2M DRS) comprising a second opcode, the first Tag, and the data payload; and sending, via the first interface, the CXL.mem S2M DRS to the first entity. The translation process may encompass various aspects of the protocol messages, including opcodes, addresses, Tags, and additional fields, thereby enabling communication between entities that operate according to different CXL protocols. The method may be implemented in hardware, firmware, software, or combinations thereof, and may be performed by various types of devices, such as semiconductor devices, switches, bridges, RPUs, Fabric Processing Units (FPUs), Fabric NICs, or other suitable intermediary components. The first interface may expose the computer, which operates as the translating device, as a CXL Type-2 or Type-3 device to the first entity, while the second interface may expose the computer as a CXL device or CXL host to the second entity, depending on system configuration. The elements may communicate through one or more intermediary components, such as a switch, a retimer, or other suitable entity that facilitates information transfer. The Tag translations may involve maintaining a bidirectional mapping between the CXL.mem-side and CXL.io-side transaction identifiers, wherein such mapping may be stored in a translation table, a tracker entry, or similar data structure to enable proper translations of responses with their corresponding requests. The first and second addresses may indicate the same address or indicate different addresses.

In some implementations of the method, the CXL.io request comprises a CXL.io Unordered Input/Output (UIO) Memory Read (UIOMRd) request, the CXL.io completion comprises a CXL.io Unordered Input/Output (UIO) Read Completion with Data (UIORdCplD) comprising a CXL DevLoad (CDL), and the CXL.mem S2M DRS comprises a DevLoad. CXL.io UIO may enable fabric-based topologies with multiple paths between source and destination. UIO may be utilized when the entire path from requester to completer uses Flit Mode, supports UIO, and has UIO enabled. The UIOMRd request type may be selected when the second entity supports UIO capabilities, or when the system topology benefits from the ordering flexibility provided by UIO semantics. The CDL in the UIORdCplD completion may carry information populated by the second entity or by intermediate components along the data path, and this information may be propagated to the first entity via the DevLoad in the CXL.mem S2M DRS message.

In some implementations of the method, translating the CXL.io completion to the CXL.mem S2M DRS comprises translating information carried in the CDL to the DevLoad. The translation of information from the CDL to the DevLoad may involve direct copying, format conversion, or semantic translation depending on the encoding schemes utilized by the CXL.io and CXL.mem. The CDL may utilize a multi-bit encoding that represents various categories of information, and the DevLoad may utilize a corresponding or different encoding scheme. The translation logic may apply mapping functions, lookup tables, or algorithmic transformations to convert between these encodings while preserving the meaning of the carried information.

In some implementations of the method, the information carried in the CDL comprises information selected from at least one of: Quality-of-Service (QoS) telemetry, metadata, or throttling information. The QoS telemetry information may include bandwidth utilization metrics, latency measurements, congestion indicators, or other performance-related data that may assist the first entity in making scheduling or resource allocation decisions. The metadata may include information about the data payload, the second entity, the traversed path, or other contextual information that may be useful for system management or optimization. The throttling information may indicate back-pressure conditions, credit availability, or flow control state that may cause the first entity to modulate its request rate. Additionally or alternatively, the computer may populate the DevLoad with telemetry information, metadata, or throttling information collected or generated by the computer itself, independent of the CDL content received from the second entity.

In some implementations of the method, the first address is associated with a first physical address space utilized by the first entity, the second address is associated with a second physical address space utilized by the second entity, and wherein the method further comprises translating the first address to the second address. The address translation may be implemented utilizing lookup tables, page tables, hash tables, base-and-offset calculations, range-based mapping, and/or programmable translation functions. The first and second address spaces may have different sizes, different base addresses, different memory layouts, or different granularities, and the translation may accommodate these differences while maintaining the meaning of the memory operations.

In some implementations of the method, the first entity comprises a first CXL host, the second entity comprises a second CXL host or a CXL device, the first opcode comprises MemRd*, the CXL.io request comprises a CXL.io Memory Read (MRd) request, and the CXL.io completion comprises a CXL.io Completion with Data (CplD). The standard CXL.io MRd and CplD transaction types may be utilized when the second entity does not support UIO, when UIO is not enabled along the path, or when standard CXL.io is preferred. The CplD completion may not include a CDL, and accordingly the computer may populate the DevLoad in the CXL.mem S2M DRS with locally generated information, or may set the DevLoad to a default or null value.

In some implementations, the method further comprises receiving, from the first entity via the first interface, a CXL.mem M2S request with data (RwD) comprising a third opcode, a third Tag, a third address, and write data; translating the CXL.mem M2S RwD to a CXL.io Memory Write request (MWr) comprising a fourth address and the write data; sending, via the second interface, the CXL.io MWr to the second entity; and sending, via the first interface to the first entity, a CXL.mem S2M No Data Response (NDR) comprising a completion opcode and the third Tag. The CXL.io MWr may be a posted write transaction that does not require a completion from the second entity, per the PCIe and CXL.io specifications. The computer may generate the CXL.mem S2M NDR completion locally without waiting for acknowledgment from the second entity, thereby potentially reducing write latency as observed by the first entity. The fourth address in the CXL.io MWr may be derived from the third address through address translation. The write data may be transferred from the CXL.mem domain to the CXL.io domain with optional format conversion, alignment adjustment, or byte enable manipulation as required by the respective protocol specifications.

In some implementations of the method, the third opcode comprises a MemWr*, the completion opcode comprises Cmp*, and sending the CXL.mem S2M NDR to the first entity occurs before sending the CXL.io MWr to the second entity. Sending the CXL.mem S2M NDR before sending the CXL.io MWr may enable the first entity to receive early acknowledgment of the write operation, potentially allowing the first entity to proceed with subsequent operations without waiting for the write data to reach the second entity. It may be beneficial in scenarios where write latency as observed by the first entity is more significant than end-to-end write completion guarantees. The computer may buffer the write data internally and may implement mechanisms to handle scenarios where the CXL.io MWr encounters errors or back-pressure from the second entity after the S2M NDR has already been sent to the first entity.

In some implementations of the method, the third opcode comprises a MemWr*, the completion opcode comprises Cmp*, and sending the CXL.mem S2M NDR to the first entity occurs in parallel with or after sending the CXL.io MWr to the second entity. Sending the CXL.mem S2M NDR in parallel with or after sending the CXL.io MWr may provide different trade-offs between latency, buffering, and ordering guarantees. When sent in parallel, the first entity may receive acknowledgment with minimal additional delay beyond the transmission time of the MWr. When sent after the MWr, the computer may wait until the write data has been accepted by the downstream interface or by the second entity before acknowledging to the first entity, potentially providing stronger ordering guarantees at the cost of increased latency and possibly added buffering for storing the context required for generating the CXL.mem S2M NDR. The selection between these timing options may be configurable through device registers, may be determined dynamically based on system conditions, or may be fixed by implementation.

In some implementations, the method further comprises receiving, from the first entity via the first interface, a CXL.mem M2S request with data (RwD) comprising a third opcode, a third Tag, a third address, and write data; translating the CXL.mem M2S RwD to a CXL.io Unordered Input/Output (UIO) Memory Write request (UIOMWr) comprising a fourth Tag, a fourth address, and the write data; sending, via the second interface, the CXL.io UIOMWr to the second entity; receiving, from the second entity via the second interface, a CXL.io Unordered Input/Output (UIO) Write Completion (UIOWrCpl) comprising the fourth Tag; and sending, via the first interface to the first entity, a CXL.mem S2M No Data Response (NDR) comprising a completion opcode and the third Tag. The UIOMWr may be a non-posted write transaction that receives a UIOWrCpl from the second entity, in contrast to standard CXL.io MWr transactions which are posted and do not receive completions. The non-posted nature of UIOMWr may provide end-to-end acknowledgment that the write data has been received by the second entity, which may be beneficial for maintaining ordering guarantees or for implementing synchronization mechanisms. The fourth Tag in the UIOMWr may be generated by the computer to track the outstanding write transaction, and may be different from the third Tag used in the CXL.mem domain.

In some implementations of the method, the CXL.io UIOWrCpl further comprises a CXL DevLoad (CDL), and the CXL.mem S2M NDR further comprises a DevLoad populated based on information carried in the CDL. The CDL in the UIOWrCpl may carry information populated by the second entity to indicate write completion status, QoS telemetry, or other metadata associated with the completed write operation. The computer may translate this information to the DevLoad in the CXL.mem S2M NDR, thereby propagating completion-related information back to the first entity. This end-to-end propagation of telemetry information may enable the first entity to make informed decisions about subsequent write operations, resource allocation, or flow control based on conditions observed at the second entity.

In some implementations, the method further comprises receiving, from a third entity via a third interface, a CXL.io request comprising a third Tag and a third address; translating the CXL.io request to a CXL.mem M2S request comprising a third opcode, a fourth Tag, and a fourth address; sending, via a fourth interface, the CXL.mem M2S request to a fourth entity; receiving, from the fourth entity via the fourth interface, a CXL.mem S2M DRS comprising the fourth Tag and a second data payload; translating the CXL.mem S2M DRS to a CXL.io completion comprising the third Tag and the second data payload; and sending, via the third interface, the CXL.io completion to the third entity. The bidirectional translation capability may enable the computer to serve as a multi-port bridge between CXL.mem and CXL.io domains, supporting transactions initiated from either protocol domain. In some examples, the third and fourth entities may be the same as or different from the first and second entities, depending on system topology and configuration. In some examples, the first interface may communicate with CXL.mem-capable entities, and the second interface may communicate with CXL.io-capable entities, wherein the computer may handle translations in both directions. The bidirectional capability may be particularly beneficial in fabric-attached memory architectures where devices and hosts with different protocol capabilities require mutual access to shared resources.

In computing systems utilizing CXL protocols, a computer may translate between CXL.mem and CXL.io to enable interoperability, such as between entities that communicate according to different CXL protocols, or between entities that may not be able to communicate according to CXL.mem due to protocol limitations (e.g., communication between two hosts). The computer may include translation logic, tracker entries, and interface circuitry configured to perform protocol translations while maintaining transaction integrity and proper Tag correlation. The computer may be implemented as a standalone device, as part of a switch, as part of a bridge, or as a component within a larger system-on-chip.

In various implementations, a system comprising: a computer coupled to a first interface and a second interface; wherein the first interface is configured to communicate with a first entity according to CXL.mem; wherein the second interface is configured to communicate with a second entity according to CXL.io; and wherein the computer is configured to: receive, via the first interface, a CXL.mem Master-to-Subordinate (M2S) request comprising a first opcode, a first Tag, and a first address; translate the CXL.mem M2S request to a CXL.io request comprising a second Tag and a second address; send, via the second interface, the CXL.io request to the second entity; receive, via the second interface, a CXL.io completion comprising the second Tag and a data payload; translate the CXL.io completion to a CXL.mem Subordinate-to-Master Data Response (S2M DRS) comprising a second opcode, the first Tag, and the data payload; and send, via the first interface, the CXL.mem S2M DRS to the first entity. The system may enable a first entity that utilizes CXL.mem for memory access to communicate with a second entity that utilizes CXL.io. The computer may function as a bridge, a switch component, an RPU, an FPU, or a dedicated translation unit that maintains the applicable state to translate incoming CXL.mem requests to outgoing CXL.io requests, and to translate returning CXL.io completions to the appropriate CXL.mem responses. The first interface may expose the computer as a CXL Type-2 or Type-3 device to the first entity, enabling the first entity to direct CXL.mem transactions to the computer. The second interface may expose the computer as a CXL device or CXL host to the second entity, depending on system requirements. Both interfaces may operate over CXL links, UCIe links, or other suitable interconnects that support the respective protocols.

In some implementations of the system, the CXL.io request comprises a CXL.io Unordered Input/Output (UIO) Memory Read (UIOMRd) request, the CXL.io completion comprises a CXL.io Unordered Input/Output (UIO) Read Completion with Data (UIORdCplD) comprising a CXL DevLoad (CDL), the CXL.mem S2M DRS comprises a DevLoad, and the computer is further configured to translate information carried in the CDL to the DevLoad. The CDL-to-DevLoad translation may propagate QoS telemetry, metadata, or throttling information from the CXL.io domain to the CXL.mem domain.

In some implementations of the system, the computer comprises tracker entries, each configured to store state information for a pending transaction including a mapping between the first Tag from the CXL.mem M2S request and the second Tag for the CXL.io request; and wherein the first interface exposes the computer as a CXL Type-2 device or a CXL Type-3 device to the first entity. The tracker entries may enable the computer to correlate incoming CXL.io completions with their corresponding CXL.mem M2S requests, enabling correct restoration of Tags when translating completions back to the CXL.mem domain. The tracker entries may support concurrent transactions, with each entry tracking a separate pending operation. Each tracker entry may additionally store address information, transaction type, expected completion size, and other state information utilized for proper translation and error handling. Moreover, exposing the computer as a CXL Type-2 or Type-3 device may enable the first entity to direct CXL.mem transactions to the computer utilizing standard device enumeration and addressing mechanisms. A CXL Type-2 device exposure may be utilized when the computer also supports CXL.cache transactions, while a CXL Type-3 device exposure may be utilized when the computer functions primarily as a memory expander or a memory pool from the perspective of the first entity.

In some implementations of the system, the computer is further configured to: receive, via the first interface, a CXL.mem M2S request with data (RwD) comprising a third opcode, a third Tag, a third address, and write data; translate the CXL.mem M2S RwD to a CXL.io Unordered Input/Output (UIO) Memory Write request (UIOMWr) comprising a fourth Tag, a fourth address, and the write data; send, via the second interface, the CXL.io UIOMWr to the second entity; receive, via the second interface, a CXL.io Unordered Input/Output (UIO) Write Completion (UIOWrCpl) comprising the fourth Tag and a CXL DevLoad (CDL); translate the CXL.io UIOWrCpl to a CXL.mem S2M No Data Response (NDR) comprising a completion opcode, the third Tag, and a DevLoad populated based on information carried in the CDL; and send, via the first interface, the CXL.mem S2M NDR to the first entity. The UIO write path may provide end-to-end acknowledgment and telemetry propagation for write transactions.

In heterogeneous computing systems, devices such as GPUs, NICs, DMA engines, and accelerators may initiate memory transactions based on CXL.io to access memory resources managed by other devices such as memory expanders, memory pools, or Global Fabric-Attached Memory Devices (GFDs) that communicate based on CXL.mem. Translations between CXL.io requests and CXL.mem requests may enable such device-to-device communication while accommodating differences in transaction granularity, ordering, and protocol capabilities. The translation from CXL.io to CXL.mem may involve splitting larger CXL.io transactions into cacheline-sized CXL.mem transactions, aggregating data from CXL.mem responses into CXL.io completions, or trimming data payloads to match requested lengths. Additionally, the computer may initiate speculative memory reads to data that the first entity is likely to request, thereby potentially reducing read latency and improving overall system throughput.

In various implementations, a method for translating between Compute Express Link (CXL) messages, comprising: receiving, from a first entity via a first interface, a CXL.io request comprising a first Tag and a first address; translating the CXL.io request to a CXL.mem Master-to-Subordinate (M2S) request comprising a second Tag and a second address; sending, via a second interface, the CXL.mem M2S request to a second entity; receiving, from the second entity via the second interface, a CXL.mem Subordinate-to-Master Data Response (S2M DRS) comprising the second Tag and data; translating the CXL.mem S2M DRS to a CXL.io completion comprising the first Tag and the data; and sending, via the first interface, the CXL.io completion to the first entity. The translation process may enable entities that utilize CXL.io for memory access to communicate with entities that expose memory resources utilizing CXL.mem. The computer may function as a bridge, a switch component, or a dedicated translation unit that maintains the applicable state to translate incoming CXL.io requests to outgoing CXL.mem requests, and to translate returning CXL.mem responses to the appropriate CXL.io completions. The first interface may communicate with the first entity based on CXL.io, while the second interface may communicate with the second entity based on CXL.mem, wherein both interfaces may operate over CXL links, UCIe links, or other suitable interconnects. The method may be implemented in hardware, firmware, software, or combinations thereof, and may be performed by various types of devices comprising a computer, such as CXL switches, bridges, or semiconductor devices incorporating translation logic. The Tag translations may involve maintaining a mapping between CXL.io Tags utilized by the first entity and CXL.mem Tags utilized for communication with the second entity.

In some implementations of the method, the CXL.io request comprises a CXL.io Unordered Input/Output (UIO) Memory Read (UIOMRd) request, and the CXL.io completion comprises a CXL.io Unordered Input/Output (UIO) Read Completion with Data (UIORdCplD). The UIO transaction types may be utilized when the first entity supports UIO capabilities and when the path between the first entity and the computer has UIO enabled. The UIOMRd request type may provide ordering flexibility that enables more efficient utilization of fabric bandwidth in topologies with multiple paths between source and destination. The UIORdCplD completion may include a CDL that the computer may populate with information collected from the CXL.mem domain, from the computer itself, or from intermediate components.

In some implementations, the method further comprises sending to the second entity, via the second interface, a CXL.mem M2S request comprising MemSpecRd. The speculative memory read may be initiated by the computer to facilitate the readiness of data from the second entity before, or without, the first entity explicitly requesting that data. The decision to initiate speculative reads may be based on pattern recognition algorithms analyzing the first entity's memory access behavior, statistical models predicting future access locations, configurable prefetch policies defining aggressiveness and scope of speculation, and/or bandwidth availability assessments determining when speculative operations will not interfere with demand requests. MemSpecRd may indicate to the second entity that the request is speculative in nature, which may affect caching behavior, priority handling, and/or error reporting at the second entity. Additionally or alternatively, the computer may issue prefetch read targeting the second entity. Data returned in response to prefetch reads may be buffered by the computer and may be utilized to satisfy subsequent requests from the first entity, potentially reducing observed read latency.

In some implementations of the method, the first address is associated with a first physical address space utilized by the first entity, the second address is associated with a second physical address space utilized by the second entity, and wherein the method further comprises translating the first address to the second address. The address translation may accommodate scenarios where the first entity and the second entity utilize different physical address spaces. The translation may be implemented utilizing lookup tables, page tables, base-and-offset calculations, or programmable translation functions.

In some implementations of the method, the first entity comprises at least one of a GPU, a Network Interface Card (NIC), or a DMA engine; wherein the second entity comprises at least one of a CXL memory expander, a CXL memory pool, or a Global Fabric-Attached Memory Device (GFD); wherein the CXL.io request comprises a CXL.io Memory Read (MRd) request; and wherein the CXL.io completion comprises a CXL.io Completion with Data (CplD). GPUs may utilize CXL.io memory reads to access large memory pools for workloads such as graphics rendering, machine learning inference, or general-purpose GPU computing workloads. NICs may utilize CXL.io memory reads to access memory buffers for network packet processing, RDMA, or storage traffic handling. DMA engines may utilize CXL.io memory reads to transfer data between memory regions on behalf of other system components. The second entity may expose memory resources that are implemented using various memory technologies such as DDR5, DDR4, HBM, persistent memory, or combinations thereof. A GFD may provide fabric-attached memory resources that are accessible by multiple devices in the system.

In some implementations of the method, translating the CXL.io request to the CXL.mem M2S request comprises translating the CXL.io request to CXL.mem M2S requests, and wherein the method further comprises aggregating data from CXL.mem S2M DRS responses into the CXL.io completion. CXL.io transactions may request data payloads larger than the cacheline size supported by CXL.mem transactions. For example, a CXL.io request for a 256-byte data payload may be translated to four CXL.mem requests each carrying a 64-byte cacheline-sized payload. The computer may track the outstanding CXL.mem requests and may aggregate the returned data into a CXL.io completion, or into CXL.io completions as permitted by CXL.io. The aggregation may involve buffering data from multiple responses, ordering the data according to address sequence, and formatting the aggregated data according to CXL.io completion requirements.

In some implementations, the method further comprises receiving, from a third entity via a third interface, a CXL.mem M2S request comprising a first opcode, a third Tag, and a third address; translating the CXL.mem M2S request to a CXL.io request comprising a fourth Tag and a fourth address; sending, via a fourth interface, the CXL.io request to a fourth entity; receiving, from the fourth entity via the fourth interface, a CXL.io completion comprising the fourth Tag and a data payload; translating the CXL.io completion to a CXL.mem S2M DRS comprising a second opcode, the third Tag, and the data payload; and sending, via the third interface, the CXL.mem S2M DRS to the third entity. The bidirectional translation capability may enable the computer to serve as a multi-port bridge between CXL.io and CXL.mem domains, supporting transactions initiated from either protocol domain. In some examples, the third and fourth entities may be the same as or different from the first and second entities, depending on system topology and configuration. In some examples, the first interface may communicate with CXL.io-capable entities, and the second interface may communicate with CXL.mem-capable entities, wherein the computer may handle translations in both directions. The bidirectional capability may be particularly beneficial in fabric-attached memory architectures where devices and hosts with different protocol capabilities require mutual access to shared resources.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In computing systems utilizing CXL protocols, a computer may translate between CXL.io and CXL.mem to enable interoperability between entities that communicate according to different CXL protocols. The computer may include translation logic, tracker entries, aggregation logic, and interface circuitry configured to perform protocol translations while maintaining transaction integrity and proper Tag correlation. The computer may be implemented as a standalone device, as part of a switch, as part of a bridge, or as a component within a larger system-on-chip.

In various implementations, a system comprising: a computer coupled to a first interface and a second interface; wherein the first interface is configured to communicate with a first entity according to CXL.io; wherein the second interface is configured to communicate with a second entity according to CXL.mem; and wherein the computer is configured to: receive, via the first interface, a CXL.io request comprising a first Tag and a first address; translate the CXL.io request to a CXL.mem Master-to-Subordinate (M2S) request comprising a second Tag and a second address; send, via the second interface, the CXL.mem M2S request to the second entity; receive, via the second interface, a CXL.mem Subordinate-to-Master Data Response (S2M DRS) comprising the second Tag and data; translate the CXL.mem S2M DRS to a CXL.io completion comprising the first Tag and the data; and send, via the first interface, the CXL.io completion to the first entity. The system may enable a first entity that utilizes CXL.io for memory access to communicate with a second entity that exposes memory resources utilizing CXL.mem. The computer may function as a bridge, a switch component, an RPU, an FPU, or a dedicated translation unit that maintains the applicable state to translate incoming CXL.io requests to outgoing CXL.mem requests, and to translate returning CXL.mem responses to the appropriate CXL.io completions. The first interface may communicate with the first entity based on CXL.io, supporting standard MRd/CplD transactions or UIO transactions such as UIOMRd/UIORdCplD. The second interface may communicate with the second entity based on CXL.mem, supporting M2S requests and S2M DRS messages. Both interfaces may operate over CXL links, UCIe links, or other suitable interconnects that support the respective protocols. The computer may be included in a switch, a bridge, or a standalone translation device.

In some implementations of the system, the CXL.io request comprises a CXL.io Unordered Input/Output (UIO) Memory Read (UIOMRd) request, the CXL.io completion comprises a CXL.io Unordered Input/Output (UIO) Read Completion with Data (UIORdCplD) comprising a CXL DevLoad (CDL), the CXL.mem S2M DRS comprises a DevLoad, and the computer is further configured to translate information carried in the DevLoad to the CDL. The DevLoad-to-CDL translation may propagate QoS telemetry, metadata, or throttling information from the CXL.mem domain to the CXL.io domain.

In some implementations of the system, the second entity is coupled to a first memory comprising a first DDR version, wherein the first entity is coupled to a second memory comprising a second DDR version different from the first DDR version, and wherein the computer is configured to translate addresses between a first address space associated with the first entity and a second address space associated with the second entity. The system may enable memory tiering across different DDR generations, wherein a host coupled to a higher-performance memory tier may access a lower-performance memory tier through the translation provided by the computer. The address translation may map addresses within the first entity's address space to corresponding addresses within the second entity's address space, enabling transparent access to the tiered memory resources. The memory tiering may be utilized for capacity expansion, cost optimization, Total Cost of Ownership (TCO) reduction, or workload-specific memory allocation strategies. The computer may expose the second entity's memory resources as an additional memory tier accessible by the first entity, potentially extending the total addressable memory capacity available to the first entity without requiring direct support for the second DDR version.

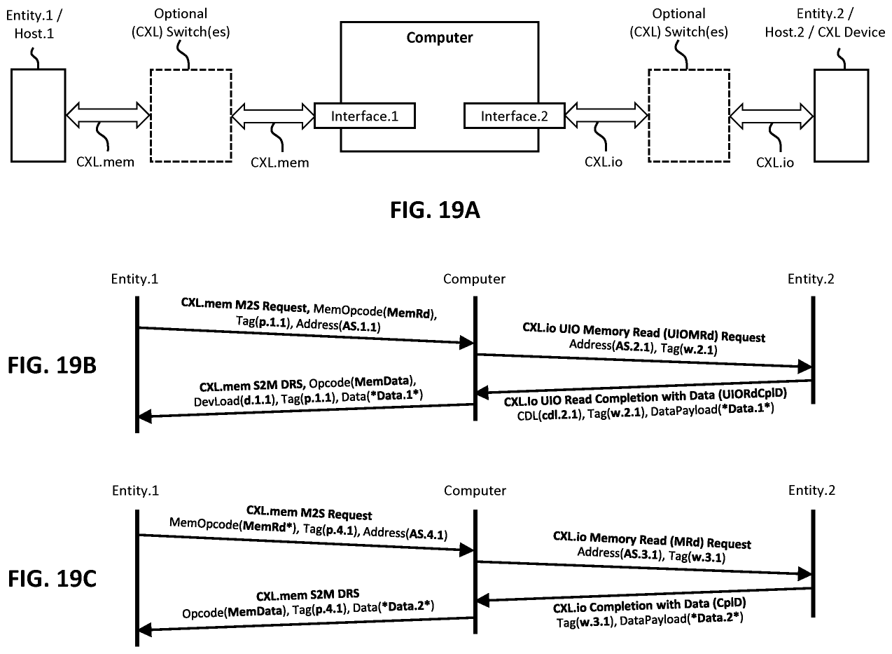

FIG. 19A illustrates an example of a system comprising a computer coupled between first and second interfaces. The first interface (Interface.1) may expose a CXL device, such as a CXL type-2 device or a CXL type-3 device, and communicate according to CXL.mem with a first entity (Entity.1), such as a first host (Host.1). The second interface may expose a CXL device, such as a CXL type-1/2/3 device, and communicate according to CXL.io with a second entity (Entity.2), such as a second host (Host.2). Alternatively, the second interface may expose a CXL host, and may further communicate according to CXL.io with a CXL device. The computer may extract physical addresses within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification. Additionally, optional CXL switch(es) may be positioned between the first interface and the first entity, and/or between the second interface and the second entity.

FIG. 19B illustrates an example of a TFD demonstrating translations, optionally performed by a computer, between CXL.mem requests received from a first entity (Entity.1), such as a first host (Host.1), and CXL.io requests sent to a second entity (Entity.2), such as a second host (Host.2) or a CXL device, possibly enabling the first entity to access resources mapped to an address space utilized by the second entity. The translations may further include address translations between physical addresses carried in the CXL.mem requests received from the first entity and physical addresses carried in the CXL.io requests sent to the second entity. The first entity may initiate a CXL.mem transaction, which may include a CXL.mem M2S request comprising MemOpcode(MemRd), Tag(p.1.1), and Address(AS.1.1). The computer may translate the CXL.mem transaction to a CXL.io transaction, which may include a CXL.io Unordered Input/Output Memory Read (UIOMRd) request comprising Address(AS.2.1) and Tag(w.2.1), and may send the CXL.io UIOMRd to the second entity. Upon receiving a response or completion from the second entity, which may include a CXL.io UIO Read Completion with Data (UIORdCplD) comprising CDL(cdl.2.1), Tag(w.2.1), and DataPayload(*Data.1*), the computer may translate the CXL.io UIORdCplD to a CXL.mem S2M DRS comprising Opcode(MemData), DevLoad(d.1.1), Tag(p.1.1), and Data(*Data.1*) and may send the CXL.mem S2M DRS to the first entity. The CDL in the CXL.io UIORdCplD may be populated, by the second entity, with information related to QoS, such as QoS telemetry value or values. The computer may translate the information carried in the CDL of the UIORdCplD completion received from the second entity, and populate the translated information in the DevLoad of the CXL.mem S2M DRS message sent to the first entity. Additionally or alternatively, the computer may populate DevLoad of CXL.mem S2M messages with telemetry information, metadata, or other types of information collected by the computer, or may utilize the DevLoad of CXL.mem S2M messages to throttle CXL.mem requests from the first entity. The computer may perform further translations, such as protocol translations, opcode translations, command translations, TLP type translations, or field translations, such as Tag translations, between messages conforming to CXL.mem and TLPs conforming to CXL.io.

FIG. 19C illustrates an example of a TFD demonstrating translations between CXL.mem requests received from a first entity (Entity.1), such as a first host (Host.1), and CXL.io requests sent to a second entity (Entity.2), such as a second host (Host.2) or a CXL device. The translations may enable the first entity to access resources mapped to an address space utilized by the second entity. The translations may further include address translations between physical addresses carried in the CXL.mem requests received from the first entity and physical addresses carried in the CXL.io requests sent to the second entity. The first entity may initiate a CXL.mem transaction that includes a CXL.mem M2S request comprising MemOpcode(MemRd*), Tag(p.4.1), and Address(AS.4.1). The computer may translate the CXL.mem transaction to a CXL.io transaction, which may include a CXL.io Memory Read (MRd) request comprising Address(AS.3.1) and Tag(w.3.1), and may send the CXL.io MRd to the second entity. Upon receiving a response or completion from the second entity, which may include a CXL.io Completion with Data (CplD) comprising Tag(w.3.1) and DataPayload(*Data.2*), the computer may translate the CXL.io CplD to a CXL.mem S2M DRS comprising Opcode(MemData), Tag(p.4.1), and Data(*Data.2*), and may send the CXL.mem S2M DRS to the first entity. The computer may perform further translations, such as protocol translations, opcode translations, command translations, TLP type translations, or field translations, such as Tag translations, between messages conforming to CXL.mem and TLPs conforming to CXL.io.

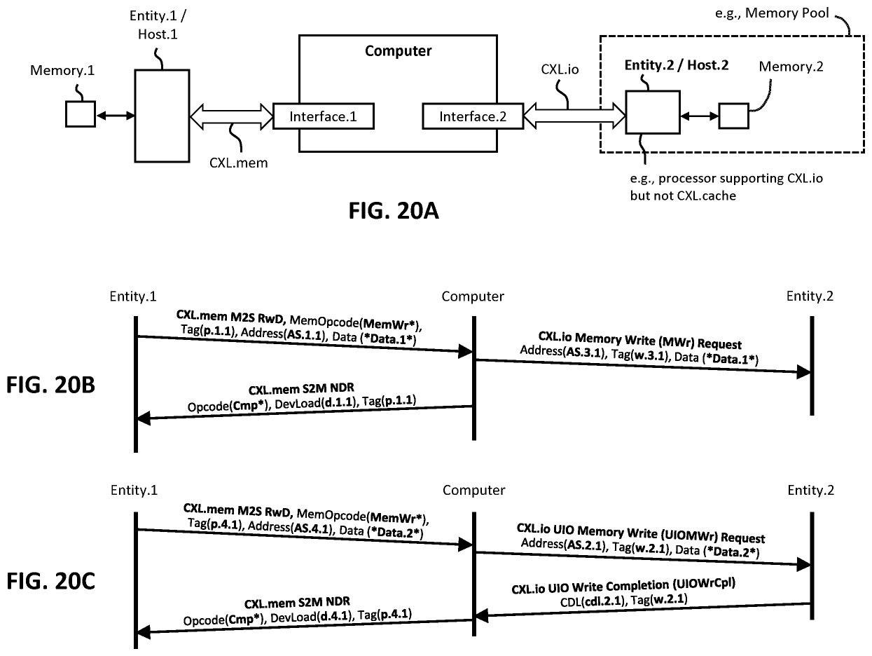

FIG. 20A illustrates an example of a system comprising a computer coupled between a first interface (Interface.1) and a second interface (Interface.2). The first interface may expose a CXL device, such as a CXL type-2 device or a CXL type-3 device, and may further communicate according to CXL.mem with a first entity (Entity.1), such as a first host (Host.1). The second interface may expose a CXL device, and may further communicate according to CXL.io with a second entity (Entity.2), such as a second host (Host.2). The computer may extract physical addresses carried within messages received via the first interface, wherein these addresses may refer to a first HPA space utilized by the first entity; translate these addresses; and generate messages carrying the translated physical addresses for transmission via the second interface; wherein these translated addresses may correspond to a second HPA space utilized by the second entity. Optionally, the computer may be implemented in an IC package having high-speed differential I/O balls positioned according to a ball grid array layout defined by a PCIe Retimer Supplemental Features and Standard BGA Footprint Specification.

The system may further include a memory pool comprising the second entity and a second memory, wherein the computer may utilize the memory pool to expose the second memory to the first entity which may be coupled to a first memory. In some examples, the second entity may not support CXL.cache, or may be configured not to support CXL.cache, potentially preventing the computer from utilizing CXL.cache for accessing the second memory. In some examples, the second entity may include a CXL-enabled processor that does not support CXL.cache, such as an early-generation processor configured to support a subset of CXL protocols such as CXL.io and CXL.mem, but not CXL.cache, wherein the CXL-enabled processor may enable the computer to access the second memory by utilizing CXL.io.

FIG. 20B illustrates an example of a TFD demonstrating translations between CXL.mem requests received from a first entity (Entity.1), such as a first host (Host.1), and CXL.io requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the CXL.io requests sent to the second entity. The first entity may initiate a CXL.mem transaction, which may include a CXL.mem M2S request with data (RwD) comprising MemOpcode(MemWr*), Tag(p.1.1), Address(AS.1.1), and Data (*Data.1*). The computer may translate the CXL.mem M2S RwD transaction to a CXL.io transaction, which may include a CXL.io Memory Write request (MWr) comprising Address(AS.3.1), Tag(w.3.1), and Data (*Data.1*), and may send the CXL.io MWr to the second entity. In some examples, the CXL.io MWr may be a posted write that may not be followed by a response or completion from the second entity.

The computer may respond to the CXL.mem M2S RwD received from the first entity with a CXL.mem S2M NDR comprising Opcode(Cmp*), DevLoad(d.1.1), and Tag(p.1.1), wherein the computer may send the CXL.mem S2M NDR to the first entity before sending the CXL.io MWr to the second entity. Alternatively, the computer may send the CXL.mem S2M NDR to the first entity in parallel to sending the CXL.io MWr to the second entity, or the computer may send the CXL.mem S2M NDR to the first entity after sending the CXL.io MWr to the second entity. The computer may further populate the DevLoad of the CXL.mem S2M NDR with telemetry information, metadata, or other types of information collected or generated by the computer, or may utilize the DevLoad of the CXL.mem S2M NDR to throttle CXL.mem requests from the first entity. The computer may perform further translations, such as protocol translations, opcode translations, command translations, TLP type translations, or field translations, such as Tag translations, between messages conforming to CXL.mem and TLPs conforming to CXL.io.

FIG. 20C illustrates an example of a TFD demonstrating translations between CXL.mem requests received from a first entity (Entity.1), such as a first host (Host.1), and CXL.io UIO requests sent to a second entity (Entity.2), such as a second host (Host.2), possibly enabling the first entity to access resources mapped to an address space utilized by the second entity. The translations may further include address translations between physical addresses carried in the CXL.mem requests received from the first entity and physical addresses carried in the CXL.io UIO requests sent to the second entity. The first entity may initiate a CXL.mem transaction that may include a CXL.mem M2S request with Data (M2S RwD) comprising MemOpcode(MemWr*), Tag(p.4.1), Address(AS.4.1), and Data (*Data.2*). The computer may translate the CXL.mem M2S RwD transaction to a CXL.io transaction, which may include a CXL.io UIO Memory Write request (UIOMWr) comprising Address(AS.2.1), Tag(w.2.1), and Data (*Data.2*). The computer may send the CXL.io UIO UIOMWr to the second entity. Upon receiving a response or completion from the second entity, which may include a CXL.io UIO Write Completion (UIOWrCpl) comprising CDL(cdl.2.1) and Tag(w.2.1), the computer may translate the CXL.io UIO UIOWrCpl to a CXL.mem S2M No Data Response (S2M NDR) comprising Opcode(Cmp*), DevLoad(d.4.1), and Tag(p.4.1), and may send the CXL.mem S2M NDR to the first entity.

The CDL in the CXL.io UIO UIOWrCpl may be populated by the second entity with information such as QoS telemetry. The computer may translate the information carried in the CDL of the CXL.io UIOWrCpl received from the second entity, and populate the translated information in the DevLoad of the CXL.mem S2M NDR sent to the first entity. Additionally or alternatively, the computer may populate DevLoad of CXL.mem S2M messages with telemetry information, metadata, or other types of information collected or generated by the computer, or may utilize the DevLoad of CXL.mem S2M messages to throttle CXL.mem requests from the first entity.

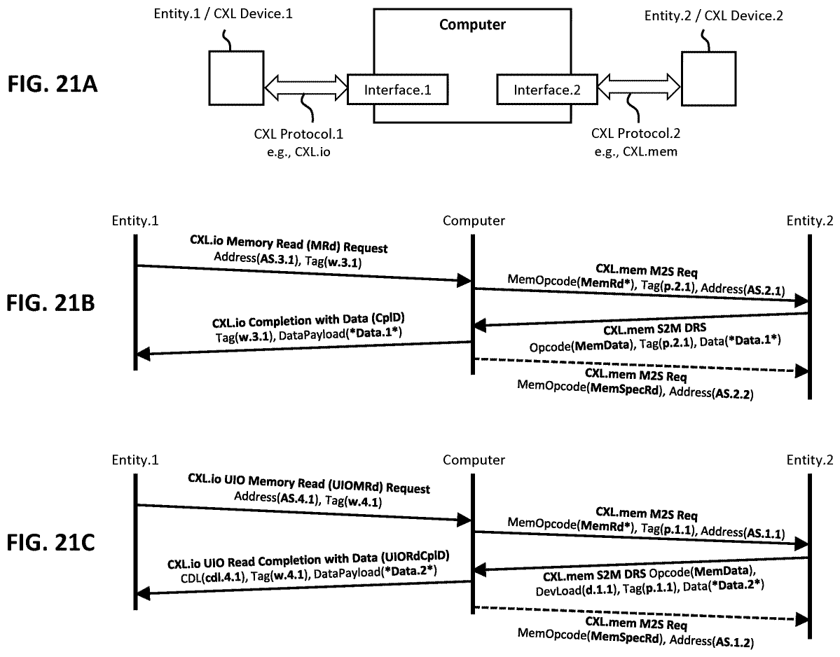

FIG. 21A illustrates an example of a system comprising a computer coupled between a first interface (Interface.1) and a second interface (Interface.2). The first interface may communicate according to a first CXL protocol, such as CXL.io, with a first entity (Entity.1), such as a first CXL device (Device.1) which may be a GPU, an RDMA NIC, an NVMe storage device, or a CXL device that may utilize DMA transfers larger than a cacheline over CXL.io. The second interface may communicate according to a second CXL protocol, such as CXL.mem, with a second entity (Entity.2), such as a second CXL device (Device.2), which may be a CXL memory expander, a CXL memory pool, a GFD, or a CXL device that may utilize cacheline-sized memory transfers over CXL.mem. The computer may be included in a switch (such as a CXL switch) or a bridge. The computer may extract physical addresses from messages received via the first interface, wherein these addresses may refer to a first Physical Address (PA) space utilized by the first entity; translate these addresses; and generate messages carrying the translated physical addresses for transmission via the second interface; wherein these translated addresses may refer to a second PA space utilized by the second entity. In some examples, the first PA space and the second PA space may be the same PA space, wherein the computer may perform address translations between addresses within the same PA space. The computer may perform further translations between the first CXL domain and the second CXL domain, such as translating between CXL.io TLP types (e.g., MRd, UIOMRd) and CXL.mem opcodes (e.g., MemRd, MemRdData, MemRdTEE). The computer may be implemented as a monolithic die, as one or more chiplets within an IC package, or as one or more components on a board. In some examples, the computer, and at least one of the first or second entities may be included within the same IC package, optionally coupled by one or more UCIe links.

FIG. 21B illustrates an example of a TFD demonstrating translations, performed by a computer, between CXL.io TLPs that may be utilized for communicating with a first entity (Entity.1), and CXL.mem messages that may be utilized for communicating with a second entity (Entity.2), possibly enabling the first entity to access resources mapped to an address space utilized by the second entity. The first entity, such as a first CXL device (Device.1) which may be a GPU, may initiate a CXL.io transaction that may include a CXL.io Memory Read (MRd) request comprising Address(AS.3.1) and Tag(w.3.1). The computer may translate the CXL.io transaction to a CXL.mem transactions that may include a CXL.mem M2S request comprising MemOpcode(MemRd*), Tag(p.2.1), and Address(AS.2.1), and may send the CXL.mem M2S request to the second entity, such as a second CXL device (Device.2) which may be a CXL memory expander. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to a CXL.io Completion with Data (CplD) comprising Tag(w.3.1) and DataPayload(*Data.1*), and send the CXL.io CplD to the first entity.

In some examples, depending on the length of the requested data payload in the CXL.io transaction, the computer may translate the CXL.io transaction to one or more CXL.mem transactions that each may carry a cacheline-sized data payload, wherein the computer may aggregate data from CXL.mem responses into one or more CXL.io completions, or may trim data carried in CXL.mem responses to match the CXL.io request. Thus, for example, the computer may translate a CXL.io transaction requesting a 256 B data payload to four CXL.mem transactions each carrying a 64 B payload, wherein the computer may aggregate the four 64 B responses into a CXL.io completion carrying 256 B. In another example, the computer may translate a CXL.io transaction requesting a data payload smaller than a cacheline size (e.g., 1 B), to a single CXL.mem transaction, and may trim the data payload returned by the CXL.mem response to the requested length in the CXL.io request, optionally aligning the data to native boundaries required by the specifications, such as aligning to DW boundaries.

Furthermore, the computer may perform translations, such as protocol translations, opcode translations, command translations, TLP translations, or PDU translations, e.g., translating between CXL.io TLPs and CXL.mem messages, wherein these translations may include field translations, such as translating between CXL.io Tags and CXL.mem Tags, translating between reserved fields, and translating between reserved and non-reserved fields. The computer may further initiate speculative memory reads targeting the second entity, wherein the speculative memory reads may include a CXL.mem M2S Req comprising MemOpcode(MemSpecRd) and Address(AS.2.2), and wherein the computer may utilize the speculative memory reads, optionally on behalf of the first entity, to facilitate data prefetches and potentially reduce read latency from the second entity.

FIG. 21C illustrates an example of a TFD demonstrating translations between CXL.io UIO TLPs that may be utilized for communicating with a first entity (Entity.1), and CXL.mem messages that may be utilized for communicating with a second entity (Entity.2), possibly enabling the first entity to access resources mapped to an address space utilized by the second entity. The first entity, such as a first CXL device (Device.1) which may be a GPU, a Network Interface Card (NIC), or a DMA engine, may initiate a CXL.io UIO transaction that may include a CXL.io UIO Memory Read (UIOMRd) request comprising Address(AS.4.1) and Tag(w.4.1). The computer may translate the CXL.io UIO transaction to a CXL.mem transaction that may include a CXL.mem M2S request comprising MemOpcode(MemRd*), Tag(p.1.1), and Address(AS.1.1), and may send the CXL.mem M2S request to the second entity, such as a second CXL device (Device.2) which may be a CXL memory expander, a memory pool, a GFD, or a CXL accelerator. Upon receiving one or more responses from the second entity, which may include a CXL.mem S2M DRS comprising Opcode(MemData), DevLoad(d.1.1), Tag(p.1.1), and Data(*Data.2*), the computer may translate the one or more responses, such as translating the CXL.mem S2M DRS to a CXL.io UIO Read Completion with Data (UIORdCplD) comprising CDL(cdl.4.1), Tag(w.4.1) and DataPayload(*Data.2*), and send the CXL.io UIORdCplD to the first entity.

The second entity may populate DevLoad of CXL.mem S2M messages, such as CXL.mem S2M DRS messages, with telemetry information, metadata, or other types of information collected or generated by the second entity, or may utilize the DevLoad of CXL.mem S2M messages to throttle CXL.mem requests from the computer, possibly enabling the second entity to control, limit, shape, or throttle the rate of data communications between the computer and the second entity. The computer may translate the information carried in DevLoad of CXL.mem S2M messages received from the second entity, and may populate the translated information in the CDL of the CXL.io UIORdCplD sent to the first entity. Additionally or alternatively, the computer may populate the CDL of the CXL.io UIORdCplD with telemetry information, metadata, or other types of information collected or generated by the computer, or may utilize the CDL to throttle requests from the first entity.

In some examples, depending on the length of the requested data payload in the CXL.io UIO transaction, the computer may translate the CXL.io UIO transaction to one or more CXL.mem transactions that each may carry a cacheline-sized data payload, wherein the computer may aggregate data from multiple CXL.mem responses into one or more CXL.io UIO completions, or may trim data carried in CXL.mem responses to match the CXL.io UIO request. Thus, for example, the computer may translate a CXL.io UIO transaction requesting a 256 B data payload to four CXL.mem transactions each carrying a 64 B payload, wherein the computer may aggregate four 64 B responses into a CXL.io UIO completion carrying 256 B. In another example, the computer may translate a CXL.io UIO transaction requesting a data payload smaller than a cacheline size (e.g., 1 B), to a single CXL.mem transaction, and may trim the data payload returned by the CXL.mem response to the requested length in the CXL.io UIO request, optionally aligning the data to native boundaries required by the specifications, such as aligning to DW boundaries. The computer may perform further translations, such as protocol translations, opcode translations, command translations, TLP translations, or PDU translations, e.g., translating between CXL.io UIO TLPs and CXL.mem messages, wherein these translations may include field translations. The computer may further initiate speculative memory reads targeting the second entity, wherein the speculative memory reads may include a CXL.mem M2S Req comprising MemOpcode(MemSpecRd) and Address(AS.1.2), and wherein the computer may utilize the speculative memory reads, optionally on behalf of the first entity, to facilitate data prefetches and potentially reduce read latency from the second entity.

In AI inference systems, accelerators such as GPUs or TPUs may generate and consume large volumes of inference context data, including key-value (KV) cache data, model weight parameters, activation tensors, and embedding vectors. When the volume of inference context data exceeds the capacity of the accelerator's local memory, such as HBM, the data may be staged to external memory resources that provide larger capacity at lower cost, such as CXL memory devices, CXL memory pools, or GFDs. In environments where accelerators are coupled via a UALink switch and the CXL memory devices are accessible via CXL.mem, an RPU may translate between UPLI and CXL.mem to enable the accelerators to migrate inference context data between their local memory and the CXL memory devices across the UALink and CXL protocol domain boundaries. The accelerator may initiate migration by sending UPLI requests to the RPU via the UALink switch, and the RPU may translate these requests to CXL.mem M2S requests targeting the CXL memory device. The migration may be bidirectional: the accelerator may write inference context data to the CXL memory device when evicting data from local memory, and may read inference context data from the CXL memory device when the data is needed for active computation. The RPU may perform address translations between address spaces utilized by the UALink domain and the CXL domain, such as between NPA or SPA addresses and HPA addresses, and may further perform Tag and opcode translations between UPLI and CXL.mem message formats.

In various implementations, a method for migrating inference context data across protocol domain boundaries, comprising: sending, by an accelerator coupled to an Ultra Accelerator Link (UALink) switch, a UALink Protocol Level Interface (UPLI) request via the UALink switch to a resource provisioning unit (RPU), the UPLI request associated with the inference context data stored in a local memory of the accelerator, the UPLI request comprising a first physical address; translating, by the RPU, the UPLI request to a Compute Express Link (CXL) CXL.mem Master-to-Subordinate (M2S) request comprising a second physical address; and sending, by the RPU, the CXL.mem M2S request to a CXL memory device; wherein the inference context data is migrated between the local memory of the accelerator and the CXL memory device across a UALink protocol domain and a CXL protocol domain. The method may be utilized in AI inference systems where accelerator working memory, such as HBM, is insufficient to retain all inference context data simultaneously. The RPU may translate between UPLI and CXL.mem including translations of opcodes, commands, addresses, Tags, and additional fields. The migration may be performed by the accelerator without host intervention, such as when the accelerator determines that certain inference context data is no longer actively needed and may be offloaded to a lower-cost memory tier. Alternatively, the migration may be coordinated by a host or a scheduler that directs the accelerator to evict or fetch specific data. The UPLI request may include a write command when data is being evicted from local memory to the CXL memory device, carrying the inference context data on the UPLI Originator Data Channel. The UPLI request may alternatively comprise a read command when data is being fetched from the CXL memory device to local memory, in which case the data is returned via the CXL.mem S2M data response path and translated to a UPLI read response. The method may be implemented in hardware, firmware, software, or combinations thereof, and may be performed by various types of devices, such as a processor, a switch, a bridge, an RPU, or a semiconductor device.

In some implementations of the method, the inference context data comprises key-value (KV) cache data generated during attention computation in a transformer-based inference model, the KV cache data comprising key tensors and value tensors associated with one or more attention layers of the transformer-based inference model. The KV cache data may grow proportionally to the sequence length and the number of attention layers. As context lengths increase, the KV cache may consume a substantial portion of accelerator HBM, motivating migration of less-recently-accessed KV cache entries to CXL memory.

In some implementations of the method, the transformer-based inference model utilizes at least one of: (i) grouped query attention (GQA) wherein a plurality of query heads share a reduced number of key-value heads, or (ii) multi-latent attention (MLA) wherein the key tensors and the value tensors are compressed into a low-rank latent representation; and wherein the KV cache data corresponds to the reduced number of key-value heads or to the low-rank latent representation, respectively. GQA may reduce KV cache size by sharing key-value heads across multiple query heads, as utilized in models such as Llama. MLA may further compress the KV cache by projecting key and value tensors into a lower-dimensional latent space, as utilized in models such as DeepSeek. The reduced KV cache size per token may affect staging granularity and transfer efficiency.

In some implementations of the method, the inference context data comprises at least one of: model weight parameters, activation tensors generated during inference computation, or embedding vectors associated with an input sequence. Model weight parameters may be staged when different models or model components are loaded on demand, such as in multi-tenant serving or model-switching scenarios. Activation tensors may be checkpointed to CXL memory during long inference sequences. Embedding vectors, such as token embeddings or positional embeddings, may be pre-staged from CXL memory before inference begins.

In some implementations of the method, the accelerator executes a mixture-of-experts (MoE) inference model comprising a gating network and expert sub-networks, and wherein the inference context data comprises weight parameters of at least one expert sub-network of the expert sub-networks; and wherein the UPLI request is sent based on a routing decision of the gating network indicating that the at least one expert sub-network is to be activated or deactivated. In MoE models, only a subset of expert sub-networks may be active for any given input token. Inactive expert weights may be offloaded to CXL memory to free accelerator HBM capacity, and activated expert weights may be fetched from CXL memory when the gating network routes tokens to those experts. This dynamic staging may enable serving MoE models that are larger than the available HBM capacity.

In some implementations, the method further comprises sending, by the accelerator, a second UPLI request comprising a read command and a third physical address via the UALink switch to the RPU; translating, by the RPU, the second UPLI request to a second CXL.mem M2S request comprising a fourth physical address; sending, by the RPU, the second CXL.mem M2S request to the CXL memory device; receiving, by the RPU, a CXL.mem Subordinate-to-Master Data Response (S2M DRS) comprising second inference context data from the CXL memory device; translating, by the RPU, the CXL.mem S2M DRS to a UPLI read response (RdRsp) comprising the second inference context data; and sending, by the RPU, the UPLI RdRsp to the accelerator via the UALink switch; wherein the second inference context data is stored in the local memory of the accelerator. The fetch direction may be utilized when inference context data that was previously offloaded to the CXL memory device is needed again for active computation. The RPU may translate the CXL.mem S2M DRS, including by translating the Tag back to the original UPLI ReqTag and formatting the data as UPLI RdRspData. In some examples, the RPU may accumulate data from CXL.mem S2M DRS messages before sending a UPLI RdRsp, such as when the CXL.mem cacheline size differs from the UPLI transfer size.

In some implementations of the method, the CXL memory device comprises a Global Fabric-Attached Memory Device (GFD), the local memory comprises at least one of high-bandwidth memory (HBM) or High-Bandwidth Flash (HBF), the first physical address refers to a Network Physical Address (NPA) or a System Physical Address (SPA), and the second physical address refers to a Host Physical Address (HPA); and wherein the translating comprises translating the first physical address to the second physical address. The GFD may provide large-capacity memory accessible by both accelerators via the RPU and hosts via direct CXL.mem access. The address translation between NPA or SPA and HPA may be performed utilizing lookup tables, base-and-offset calculations, or programmable translation functions within the RPU.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In AI inference systems, a host such as a CPU may orchestrate the staging of inference context data between CXL memory devices and accelerators that reside in the UALink domain. The host may read inference context data from a CXL memory device via CXL.mem and write the data to an accelerator by sending a CXL.mem M2S request to an RPU, which translates the request to a UPLI request and forwards it to the accelerator via a UALink port. This host-initiated staging may be utilized in scenarios where the host manages a tiered memory hierarchy, determines which inference context data to pre-stage to accelerators based on scheduling policies, inference request queues, or predicted workload patterns, and coordinates data movement between the CXL and UALink protocol domains. The host may also orchestrate reading inference context data from accelerators via the RPU and writing it to CXL memory devices for longer-term retention. This bidirectional host-orchestrated staging may support a variety of inference architectures and model types, including transformer models with large KV caches, mixture-of-experts models with dynamic expert activation, disaggregated prefill and decode architectures, speculative decoding, hybrid attention and state-space models, multimodal models, and retrieval-augmented generation pipelines. In each case, the CXL memory device may serve as an intermediate staging area that bridges the capacity gap between accelerator working memory and the volume of inference context data associated with the workload.

In various implementations, a method for staging inference context data across protocol domain boundaries, comprising: reading, by a host, inference context data from a Compute Express Link (CXL) memory device via CXL.mem; sending, by the host, a CXL.mem Master-to-Subordinate (M2S) request to a resource provisioning unit (RPU), the CXL.mem M2S request associated with the inference context data and comprising a first physical address; translating, by the RPU, the CXL.mem M2S request to an Ultra Accelerator Link (UALink) Protocol Level Interface (UPLI) request comprising a second physical address; and sending, by the RPU, the UPLI request to an accelerator via a UALink port; wherein the inference context data is staged from the CXL memory device to a local memory of the accelerator across a CXL protocol domain and a UALink protocol domain. The host-initiated staging may enable the host to manage a tiered memory hierarchy comprising accelerator local memory as a working memory tier, host memory as an intermediate tier, and CXL memory devices as a capacity tier. The host may determine which inference context data to stage based on scheduling policies, inference request queues, or predictions about upcoming workload requirements. The RPU may be a discrete component, an IP block embedded in an accelerator, or a chiplet within an IC package. The CXL.mem M2S request may include a write command carrying the inference context data, and the translated UPLI request may carry the data on the UPLI Originator Data Channel to the accelerator. The RPU may perform address translations between HPA addresses utilized by the host and NPA or SPA addresses utilized by the UALink domain, and may further perform Tag and opcode translations between CXL.mem and UPLI message formats. The host may access the CXL memory device via CXL.mem without translation, and may access the accelerator via the RPU that translates between CXL.mem and UPLI. The method may be implemented in hardware, firmware, software, or combinations thereof.

In some implementations, the method further comprises reading, by the host, second inference context data from the accelerator, wherein the reading comprises the host sending a second CXL.mem M2S request to the RPU, the RPU translating the second CXL.mem M2S request to a second UPLI request comprising a read command and sending the second UPLI request to the accelerator via the UALink port, the RPU receiving a UPLI read response (RdRsp) comprising the second inference context data from the accelerator, and the RPU returning the second inference context data to the host; and writing, by the host, the second inference context data to the CXL memory device via CXL.mem. This direction may enable the host to evict inference context data from accelerator local memory to the CXL memory device when the data is no longer actively needed or when the local memory capacity is exceeded. The host may coordinate both staging and eviction to maintain a working set of inference context data in accelerator local memory that matches the current workload.

In some implementations of the method, the accelerator executes a mixture-of-experts (MoE) inference model comprising a gating network and expert sub-networks, and the second inference context data comprises weight parameters of an inactive expert sub-network of the expert sub-networks, the inactive expert sub-network identified based on a routing decision of the gating network. Evicting inactive expert weights to CXL memory may free accelerator HBM capacity for the active experts, enabling the system to serve MoE models whose total expert weight parameters exceed the HBM capacity.

In some implementations of the method, the second inference context data comprises key-value (KV) cache entries that have been evicted from the local memory of the accelerator based on at least one of: an access frequency, an access recency, or the KV cache entries exceeding a capacity of the local memory. Long-context inference models may generate KV cache entries that exceed the accelerator HBM capacity. Eviction policies based on access frequency or recency may retain the most relevant KV cache entries in HBM while offloading less-accessed entries to CXL memory for potential later retrieval.

In some implementations of the method, the inference context data comprises key-value (KV) cache data associated with a transformer-based inference model, and wherein the host stages the KV cache data from the CXL memory device to the local memory of the accelerator based on a scheduled inference request or a predicted inference request. The host may maintain a scheduling queue of inference requests and may pre-stage KV cache data associated with upcoming requests to reduce latency when the request is dispatched to the accelerator. Prediction of upcoming requests may be based on session affinity, user activity patterns, or model serving policies.

In some implementations of the method, the accelerator comprises a decode accelerator, the inference context data comprises key-value (KV) cache data generated during a prefill phase of an inference operation by a prefill accelerator, and the KV cache data is staged from the CXL memory device to the local memory of the decode accelerator for use in a decode phase of the inference operation; and wherein the CXL memory device serves as an intermediate storage between the prefill accelerator and the decode accelerator. In disaggregated inference architectures, the prefill phase and the decode phase may be performed by different accelerators to optimize resource utilization. The prefill accelerator may write the generated KV cache data to the CXL memory device, and the host may subsequently stage the KV cache data from the CXL memory device to the decode accelerator. The CXL memory device may thus serve as a shared staging area that decouples the prefill and decode phases across protocol domain boundaries.

In some implementations of the method, the accelerator performs speculative decoding comprising a draft model generating candidate token sequences and a verification model accepting or rejecting the candidate token sequences, and wherein the inference context data comprises at least one of: draft model weight parameters, draft model KV cache data, or verification context data associated with the speculative decoding. Speculative decoding may utilize a smaller draft model to generate candidate tokens that a larger verification model subsequently accepts or rejects. The draft model weight parameters or the draft model KV cache data may be staged from CXL memory to accelerator HBM when speculative decoding is activated for a given inference session.

In some implementations of the method, the inference context data comprises state data associated with a hybrid inference model, the hybrid inference model comprising attention layers that generate key-value (KV) cache data and state-space model layers that maintain recurrent state vectors; and wherein the staging comprises staging at least one of the KV cache data or the recurrent state vectors from the CXL memory device to the local memory of the accelerator. Hybrid models, such as those combining attention layers with Mamba-style state-space model (SSM) layers, may maintain both KV cache data for attention layers and recurrent state vectors for SSM layers. The staging may include both data types, which may have different sizes, access patterns, and staging priorities.

In some implementations of the method, the inference context data comprises visual embeddings generated by an image encoder or a video encoder of a multimodal inference model; and wherein the staging comprises staging the visual embeddings from the CXL memory device to the local memory of the accelerator for processing alongside text token embeddings by the multimodal inference model. Multimodal inference models may process both visual and textual inputs. Visual embeddings generated by an image or video encoder may be large and may be pre-computed and stored in CXL memory, then staged to the accelerator when a multimodal inference request is dispatched.

In some implementations of the method, the inference context data comprises pre-computed embeddings associated with retrieved documents in a retrieval-augmented generation (RAG) pipeline; and wherein the staging comprises staging the pre-computed embeddings from the CXL memory device to the local memory of the accelerator for concatenation with an input query during inference. In RAG pipelines, retrieved document embeddings may be pre-computed and stored in the CXL memory device as a large-capacity embedding store. When a query triggers retrieval, the relevant embeddings may be staged from the CXL memory device to the accelerator for concatenation with the query tokens before the generation phase.

In some implementations of the method, the inference context data comprises key-value (KV) cache entries associated with token positions in an input sequence, and the staging comprises staging a subset of the KV cache entries from the CXL memory device to the local memory of the accelerator, the subset selected based on the token positions being predicted to be accessed during a subsequent inference step; and wherein remaining KV cache entries associated with remaining token positions are retained in the CXL memory device. For long-context inference, the host may stage only the KV cache entries associated with token positions predicted to be attended during the next decoding step, retaining the remaining entries in CXL memory. This selective staging may reduce transfer volume and accelerator memory pressure while maintaining the full context available for on-demand retrieval.

In some implementations of the method, an active cable comprising first and second pluggable modules coupled by a physical medium; wherein the active cable further comprises hardware circuitry, integrated into the active cable, configured to perform the method. In some implementations of the method, an apparatus configured to operate as a switch, wherein the apparatus comprises switching circuitry and is configured to perform the method.

In AI inference deployments, a system may include a cluster of accelerators coupled via a UALink switch, one or more CXL memory devices providing large-capacity memory, an RPU that translates between UPLI and CXL.mem, and a host that orchestrates workload scheduling and data movement. Such a system may be configured to migrate inference context data between accelerator local memory and the CXL memory devices across the UALink and CXL protocol domain boundaries, enabling the system to serve inference workloads whose aggregate inference context data exceeds the capacity of any single accelerator's local memory. The host may access the CXL memory devices via CXL.mem, while the accelerators access the same CXL memory devices via the RPU that translates between UPLI and CXL.mem. This architecture may support tiered memory management, where inference context data is staged between accelerator HBM, HBF, host memory, and CXL memory based on access patterns, scheduling policies, or memory capacity constraints.

In various implementations, a system comprising: an Ultra Accelerator Link (UALink) switch; accelerators coupled to the UALink switch, each accelerator of the accelerators comprising a local memory; a Compute Express Link (CXL) memory device; a resource provisioning unit (RPU) coupled to the UALink switch and to the CXL memory device, the RPU configured to translate between UALink Protocol Level Interface (UPLI) and CXL.mem; and a host coupled to the CXL memory device via CXL.mem; wherein the system is configured to migrate inference context data between the local memory of at least one accelerator of the accelerators and the CXL memory device across a UALink protocol domain and a CXL protocol domain. The system may enable both accelerator-initiated and host-initiated data migration across the protocol domain boundaries. The accelerators may communicate with one another and with the RPU via the UALink switch utilizing UPLI, while the host may communicate with the CXL memory device utilizing CXL.mem. The RPU may be implemented as a discrete component coupled to the UALink switch, as an IP block embedded within one of the accelerators, or as a chiplet within an IC package. The system may support various inference workloads, and the inference context data may include KV cache data, model weight parameters, activation tensors, embedding vectors, or other data generated or consumed during inference computation. The CXL memory device may include a CXL memory expander, a CXL memory pool, or a GFD.

In some implementations of the system, the at least one accelerator is configured to initiate migration of the inference context data by sending a UPLI request via the UALink switch to the RPU, and the RPU is configured to translate the UPLI request to a CXL.mem M2S request and send the CXL.mem M2S request to the CXL memory device. The accelerator may determine when to migrate inference context data based on local memory capacity utilization, access patterns, or workload scheduling signals received from the host or from other accelerators.

In some implementations of the system, the local memory comprises a first memory tier, the system further comprises host memory coupled to the host, the host memory comprising a second memory tier, and the CXL memory device comprises a third memory tier; and wherein the inference context data is migrated between the first memory tier and the third memory tier based on at least one of: access frequency, access recency, a capacity of the first memory tier, or a scheduling policy of the host. The tiered memory hierarchy may enable the system to retain actively-accessed inference context data in the highest-bandwidth tier (accelerator local memory) while staging less-accessed data to lower-cost, higher-capacity tiers (CXL memory). The second memory tier (host memory) may serve as an intermediate staging buffer.

In some implementations, the system further comprises a second CXL memory device and a CXL fabric coupling the RPU to the CXL memory device and the second CXL memory device; wherein at least one of the CXL memory device or the second CXL memory device comprises at least one of: a CXL memory expander, a CXL memory pool, or a Global Fabric-Attached Memory Device (GFD). The CXL fabric may include one or more CXL switches and may provide connectivity between the RPU and CXL memory devices. The RPU may route translated requests to specific CXL memory devices based on the physical addresses carried in the UPLI requests.

In some implementations of the system, the inference context data comprises key-value (KV) cache data associated with a transformer-based inference model, the local memory comprises high-bandwidth memory (HBM), and the at least one accelerator comprises at least one of: a graphics processing unit (GPU) or a tensor processing unit (TPU). GPUs and TPUs are accelerators commonly utilized for transformer-based inference workloads that generate substantial KV cache data. HBM provides the high-bandwidth, low-latency access needed for active inference computation, while the CXL memory device may provide the additional capacity needed for KV cache entries that are not actively accessed.

In environments where accelerators communicate utilizing NVLink-based protocols, such as GPUs coupled via NVLink or NVSwitches, the accelerators may similarly need to migrate inference context data to CXL memory devices that reside in a different protocol domain. An RPU may translate between NVLink-based protocol messages and CXL.mem messages to enable accelerators in the NVLink domain to stage inference context data to and from CXL memory devices. The RPU may be integrated into an active cable, an NVSwitch, or a discrete bridge device, and may perform address translations between NVLink addresses and CXL.mem addresses, as well as command and Tag translations between the two protocol domains. This NVLink-to-CXL.mem translation path may enable heterogeneous computing environments where different clusters of accelerators utilize different interconnect protocols while sharing access to common CXL memory resources.

In various implementations, a method for migrating inference context data across protocol domain boundaries, comprising: sending, by an accelerator, a request conforming to an NVLink-based protocol to a resource provisioning unit (RPU), the request associated with the inference context data stored in a local memory of the accelerator, the request comprising a first physical address; translating, by the RPU, the request to a Compute Express Link (CXL) CXL.mem Master-to-Subordinate (M2S) request comprising a second physical address; and sending, by the RPU, the CXL.mem M2S request to a CXL memory device; wherein the inference context data is migrated between the local memory of the accelerator and the CXL memory device across an NVLink protocol domain and a CXL protocol domain. The method may enable accelerators communicating according to an NVLink-based protocol to access CXL memory resources for staging inference context data. The RPU may translate between NVLink-based protocol messages and CXL.mem messages, including translations of addresses, commands, and identifiers. The first physical address may be an NVLink Network Address, and the second physical address may be an HPA utilized by the CXL memory device. The RPU may be integrated into an active cable, an NVSwitch, or a discrete bridge device. In some examples, the RPU may be positioned closer to the CXL port to optimize signal integrity, since CXL runs over PCIe electricals designed for shorter-reach connectivity while NVLink may incorporate signaling characteristics compatible with longer-reach interconnects.

In some implementations of the method, the accelerator is coupled to the RPU via an NVLink switch (NVSwitch), and the request conforming to the NVLink-based protocol is sent via the NVSwitch to the RPU. The NVSwitch may route the NVLink-based request from the accelerator to the RPU based on routing information carried in the request. The NVSwitch may couple accelerators to the RPU, enabling accelerators within the NVLink domain to access the CXL memory device for inference context data staging.

In some implementations of the method, the inference context data comprises key-value (KV) cache data generated during attention computation in a transformer-based inference model, and the local memory comprises high-bandwidth memory (HBM). KV cache data generated by NVLink-coupled accelerators during transformer-based inference may be staged to CXL memory devices when the KV cache exceeds the HBM capacity.

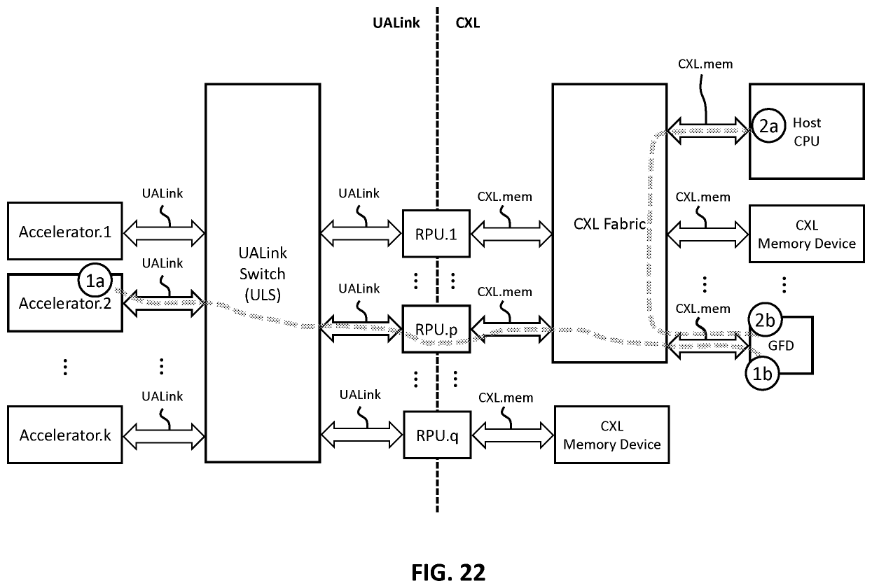

FIG. 22 illustrates an example of a system comprising a cluster of accelerators (e.g., GPUs or TPUs) interconnected by a UALink switch, an RPU coupled to the UALink switch, CXL memory devices coupled to the RPU via a CXL fabric, and a host coupled to the CXL memory devices via CXL.mem. Path 1a to 1b illustrates an accelerator-initiated data migration path. Accelerator.2 sends a UPLI request via the UALink switch to RPU.p. RPU. p translates the UPLI request to a CXL.mem M2S request and sends the CXL.mem M2S request to a GFD via the CXL fabric. The RPU may translate addresses between the UALink address space (e.g., NPA or SPA) and the CXL address space (e.g., HPA), and may translate opcodes, Tags, and additional fields between UPLI and CXL.mem message formats. In the write direction, the accelerator may evict inference context data from its local memory, such as HBM and/or HBF, to the GFD by sending a UPLI write request carrying the data on the Originator Data Channel. In the read direction, the accelerator may fetch inference context data from the GFD by sending a UPLI read request, and the RPU may receive a CXL.mem S2M DRS from the GFD, translate the CXL.mem S2M DRS to a UPLI RdRsp, and return the data to the accelerator via the UALink switch.

Path 2a to 2b illustrates a host-initiated access path. The host accesses the GFD via CXL.mem, without translation by the RPU. The host may read inference context data from the GFD via CXL.mem, and may subsequently write the inference context data to an accelerator by sending a CXL.mem M2S RwD to the RPU, which translates the CXL.mem M2S request to a UPLI request and sends the UPLI request to the accelerator via the UALink switch. Conversely, the host may read inference context data from an accelerator by sending a CXL.mem M2S request to the RPU, which translates the request to a UPLI read request, receives a UPLI RdRsp from the accelerator, and returns the data to the host; the host may then write the data to the GFD via CXL.mem. The host may thus orchestrate bidirectional data staging between the CXL memory devices and the accelerators across the CXL and UALink protocol domain boundaries.

In one example, the host may bring inference context data, such as KV cache data, from storage (e.g., NVMe or remote storage) into a CXL memory device such as the GFD. The accelerator may then fetch the KV cache data from the GFD to its local memory (e.g., HBM and/or HBF) for active inference computation. When the KV cache data is no longer actively accessed, or when the local memory capacity is exceeded, the accelerator may migrate the colder KV cache data from its HBM back to the GFD. In this manner, the system may maintain a tiered memory hierarchy where the accelerator HBM serves as a working memory tier for actively-accessed inference context data, and the CXL memory device serves as a capacity tier for less-frequently-accessed inference context data. The RPU may enable the data migration between these tiers by translating between UPLI and CXL.mem across the protocol domain boundaries.

The CXL memory devices shown in FIG. 22 may include CXL memory expanders, CXL memory pools, or GFDs, and may be coupled to the RPU via the CXL fabric, which may include one or more CXL switches. The RPU may route translated requests to specific CXL memory devices based on the physical addresses carried in the translated CXL.mem M2S requests. The system may support various types of inference context data, including KV cache data associated with transformer-based models, model weight parameters associated with mixture-of-experts models, activation tensors, embedding vectors, and other data generated or consumed during inference computation.

In computing environments where a host, such as a CPU, accesses memory resources on a device, such as an accelerator, the device may expose memory regions to the host via CXL. Different memory regions may have different coherency requirements and may be backed by different types of memory. For example, a first memory region may be backed by local memory coupled to the device, such as HBM and/or High-Bandwidth Flash (HBF), and may benefit from device coherency where the device participates in cache coherency with the host. A second memory region may be backed by memory accessible via a UALink network, such as memory residing on remote accelerators, and may not require device coherency participation. The CXL specification defines different HDM types and device type flows that correspond to different coherency models, and a device may expose concurrent HDM regions utilizing different device type flows. An RPU or translation logic within the device may translate between CXL protocol messages received from the host and UPLI messages for accessing memory in the UALink domain, while maintaining the appropriate coherency semantics for each memory region.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an Ultra Accelerator Link (UALink)-based protocol; and translating, by the device, between a protocol based on CXL and UALink Protocol Level Interface (UPLI) for at least one of the first memory region or the second memory region. The method may be implemented in hardware, firmware, software, or combinations thereof, and may be performed by various types of devices, such as an accelerator, an RPU, a semiconductor device, or a chiplet within an IC package. The first and second CXL device type flows may correspond to any combination of CXL Type-2 and Type-3 device flows, and may further include CXL Type-1 device flows in some examples. The device may expose additional memory regions beyond the first and second memory regions, each utilizing different or the same CXL device type flows. Translations between the protocol based on CXL and UPLI may include translations of opcodes, addresses, Tags, and additional fields, and may further include address translations between different address spaces such as a Host Physical Address (HPA) space and a Network Physical Address (NPA) space. The first memory may include memory coupled to the device, such as HBM, HBF, DRAM, or GDDR, while the second memory may include memory accessible via a UALink switch, a UALink network, or remote accelerators within a UALink domain. The elements may communicate through one or more intermediary components, such as a switch, a retimer, or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to utilize both CXL.mem and CXL.cache protocols for the HDM-D region, allowing the device to maintain cached copies of data and participate in coherency negotiations with the host. The CXL Type-3 device flow may utilize CXL.mem without CXL.cache for the HDM-H region, where the host manages coherency without device cache participation.

In some implementations, the method further comprises receiving, from the host, a CXL.mem Master-to-Subordinate (M2S) request comprising MemRd* and an address targeting the first memory region, wherein the CXL.mem M2S request further comprises a SnpType field, a MetaField field, and a MetaValue field; translating the CXL.mem M2S request to a UPLI request; receiving a UPLI response comprising data; and sending to the host a CXL.mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. The SnpType, MetaField, and MetaValue fields in the CXL.mem M2S request may indicate the cacheline state intent of the host, such as requesting a shared copy (SnpData) or an exclusive copy (SnpInv). The device may utilize these fields to determine the appropriate coherency response. The device coherency engine (DCOH) may select Cmp-S when the device retains a cached copy of the data, or Cmp-E when the device relinquishes its cached copy. The device may translate the CXL.mem M2S request to a UPLI request to fetch the data from the UALink domain before responding.

In some implementations of the method, the device comprises a cache; and wherein the device stores the data from the UPLI response in the cache and sends the CXL.mem S2M NDR comprising Cmp-S indicating that the device retains a cached copy of the cacheline at the address. By caching the fetched data and responding with Cmp-S, the device may enable subsequent accesses to the same cacheline to be served from its local cache without requiring another UPLI transaction. A device with cache, or a device that controls or utilizes a cache, may include a cache memory, a cache controller, or cache allocation and eviction logic.

In some implementations of the method, the UPLI request comprises a ReqSrcPhysAccID field, a ReqDstPhysAccID field, a ReqTag field, a ReqAddr field, and a ReqCmd field comprising a read command; and further comprising translating a Tag of the CXL.mem M2S request to the ReqTag of the UPLI request. The ReqSrcPhysAccID and ReqDstPhysAccID fields may carry identifiers utilized by the UALink network for routing the UPLI request. The Tag translation may involve maintaining a bidirectional mapping between CXL.mem Tag values and UPLI ReqTag values, enabling proper correlation of UPLI responses with their corresponding CXL.mem requests.

In some implementations, the method further comprises receiving, from the host, a CXL.mem Master-to-Subordinate (M2S) request comprising MemRd* and an address targeting the second memory region; translating the CXL.mem M2S request to a UPLI request; receiving a UPLI response comprising data; and sending to the host a CXL.mem Subordinate-to-Master Data Response (S2M DRS) comprising MemData and the data. For the second memory region, the device may operate as a passthrough translator that fetches data from the UALink domain and returns it to the host without maintaining cached copies or participating in coherency negotiations. The CXL.mem S2M DRS may carry MemData without an accompanying S2M NDR indicating Cmp-S or Cmp-E, because the device does not track cache state for this memory region.

In some implementations of the method, the UPLI response further comprises a RdRspDataError field indicating a data error; and further comprising translating the RdRspDataError field to a Poison field of the CXL.mem S2M DRS sent to the host. The RdRspDataError field in the UPLI response may serve as a per-beat data poison indicator. The translation of error indications across protocol boundaries may enable the host to detect data corruption that originated in the UALink domain and to take appropriate recovery actions.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region. RdOwn may acquire exclusive ownership, RdShared may acquire a shared copy, RdCurr may request a non-cacheable current value, and RdAny may accept any coherency state.

In some implementations of the method, the first memory comprises at least one of High Bandwidth Memory (HBM) or High-Bandwidth Flash (HBF) coupled to the device, the second memory comprises memory accessible via a UALink switch or a UALink network, and the device comprises an accelerator. The accelerator may be a GPU, a TPU, or other processing unit with HBM and/or HBF that may benefit from device coherency for its local memory. The UALink switch or fabric may couple the accelerator to remote accelerators, and the second memory may reside on the remote accelerators or on other memory resources within the UALink domain.

In some implementations, the method further comprises translating, by the device, between a first address associated with a first address space utilized by the host and a second address associated with a second address space utilized by the UALink-based protocol; wherein the first address space comprises a Host Physical Address (HPA) space, and the second address space comprises a Network Physical Address (NPA) space or a System Physical Address (SPA) space. The address translation may be implemented utilizing lookup tables, page tables, base-and-offset calculations, or programmable translation functions. The HPA space may represent the host's view of the memory, while the NPA or SPA space may represent the address used by the UALink network for routing and accessing memory resources.

In some implementations of the method, at least one of the first memory region or the second memory region comprises a Host-managed Device Memory with Back-Invalidate (HDM-DB) region; and wherein the device sends a CXL.mem Subordinate-to-Master Back-Invalidate Snoop (S2M BISnp) to the host, and the host responds with a CXL.mem Master-to-Subordinate Back-Invalidate Response (M2S BIRsp). The HDM-DB region may enable the device to snoop the host's cache when the device needs to modify or evict cached data. The S2M BISnp may carry opcodes such as BISnpInv, BISnpData, or BISnpCur, and the M2S BIRsp may carry opcodes such as BIRspI, BIRspS, or BIRspE indicating the resulting host cache state. HDM-DB may be utilized with either CXL Type-2 or CXL Type-3 device flows.

In some implementations, the method further comprises receiving, from the host, a CXL.mem Master-to-Subordinate Request with Data (M2S RwD) comprising MemWr* and write data; translating the CXL.mem M2S RwD to a UPLI request comprising a write command and the write data; and sending a CXL.mem Subordinate-to-Master No Data Response (S2M NDR) to the host. The write command in the UPLI request may include Write or WriteFull commands. The device may send the S2M NDR before or after the UPLI write completes, depending on ordering requirements and system configuration.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

In computing systems where a host accesses memory resources on a device coupled via CXL, the device may expose memory regions with different coherency characteristics to the host. A first memory region associated with local memory, such as HBM, may be exposed via a CXL device type flow that supports device coherency, enabling the host and device to maintain coherent cached copies of data. A second memory region associated with memory accessible via a UALink port may be exposed via a different CXL device type flow that does not require device coherency participation. The device may include an RPU or translation logic configured to translate between CXL protocol messages and UPLI messages for memory access operations targeting the UALink-accessible memory. A UALink switch may couple the device to one or more remote accelerators whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an Ultra Accelerator Link (UALink) port of the device; and wherein the device is configured to translate between a protocol based on CXL and UALink Protocol Level Interface (UPLI) for requests targeting at least one of the first memory region or the second memory region. The system may enable a host to access both local and remote memory resources on the device through a CXL link, with differentiated coherency semantics for different memory regions. The device may include an RPU, translation logic, or a combination of hardware and firmware that performs the translations between CXL and UPLI. The device may configure the boundaries between the first and second memory regions dynamically or statically, for example utilizing HDM decoder registers or programmable address range registers.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region. In some examples, the assignment of HDM types to memory regions may be configurable at system initialization or runtime.

In some implementations of the system, for CXL.mem requests targeting the first memory region, the device is configured to send a CXL.mem Subordinate-to-Master No Data Response (S2M NDR) comprising Cmp-S or Cmp-E indicating a cache state; and for CXL.mem requests targeting the second memory region, the device is configured to translate the CXL.mem requests to UPLI requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state of the cacheline at the device. For the second memory region, the device may translate the request to UPLI, fetch the data from the UALink domain, and return the data.

In some implementations of the system, the host communicates with the device via CXL.mem and CXL.cache for the first memory region, and the host communicates with the device via CXL.mem without CXL.cache for the second memory region. The use of CXL.cache for the first memory region may enable the device to initiate coherency transactions and respond to host snoops, supporting scenarios where the device and host may both cache data from the first memory region. The absence of CXL.cache for the second memory region may simplify the memory access path for remote memory.

In some implementations of the system, the device comprises an accelerator comprising a resource provisioning unit (RPU), and the first memory comprises at least one of High Bandwidth Memory (HBM) or High-Bandwidth Flash (HBF) coupled to the accelerator; and further comprising a UALink switch coupling the UALink port of the device to one or more remote accelerators, wherein the second memory is accessible via the UALink switch. The RPU may be implemented as an IP block embedded within the accelerator, or as a chiplet within an IC package containing the accelerator. The UALink switch may route UPLI traffic based on destination accelerator identifiers carried in the UPLI requests. The one or more remote accelerators may each have their own HBM, HBF, or other memory that collectively forms the second memory accessible from the device.

In computing environments where a host, such as a CPU, accesses memory resources on a device coupled via CXL, the device may expose memory regions to the host with different connectivity. A first memory region may be backed by local memory coupled to the device, while a second memory region may be backed by memory accessible via an NVLink fabric, such as memory residing on GPUs or other NVLink-connected devices. NVLink provides high-bandwidth communication between GPUs and accelerators, and may support distributed memory models where devices access memory via other devices. The device may translate between CXL protocol messages received from the host and NVLink messages for accessing memory in the NVLink domain, while exposing different CXL device type flows for different memory regions to provide appropriate coherency semantics. NVLink messages may carry fields such as source and destination identifiers for routing, addresses for memory location, transaction tags for response correlation, length fields for transfer size, and data payloads.

In various implementations, a method comprising: exposing, by a device coupled to a host via a Compute Express Link (CXL) link, a first memory region via a first CXL device type flow and a second memory region via a second CXL device type flow, wherein the first CXL device type flow is different from the second CXL device type flow; wherein the first memory region is associated with a first memory; wherein the second memory region is associated with a second memory accessible via an NVLink-based protocol; and translating, by the device, between a protocol based on CXL and the NVLink-based protocol for at least one of the first memory region or the second memory region. The method may be implemented in hardware, firmware, software, or combinations thereof, and may be performed by various types of devices, such as an accelerator, an RPU, a semiconductor device, an active cable, or a chiplet within an IC package. The first and second CXL device type flows may correspond to any combination of CXL Type-2 and Type-3 device flows. Translations between CXL and NVLink may include translations of opcodes, addresses, transaction identifiers, and additional fields. NVLink messages may carry functional fields corresponding to source identifiers, destination identifiers, addresses, transaction tags, transfer lengths, and data payloads; the specific field names may vary across NVLink versions or implementations, and the translation may accommodate such variations. The first memory may include memory coupled to the device, such as HBM and/or HBF, while the second memory may include memory accessible via GPUs or other NVLink-connected devices. The device may be positioned in an active cable, in a module coupled to a CXL port, or within a computing platform, and may provide a bridge between the CXL domain and the NVLink domain. The elements may communicate through one or more intermediary components, such as an NVLink switch or other suitable entity that facilitates information transfer.

In some implementations of the method, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region; and wherein the device participates in cache coherency with the host for the first memory region and does not participate in cache coherency with the host for the second memory region. The CXL Type-2 device flow may enable the device to maintain cached copies of data from the first memory and to participate in coherency negotiations with the host via CXL.cache. The CXL Type-3 device flow for the HDM-H region may enable simpler passthrough access to NVLink-accessible memory without device coherency overhead.

In some implementations, the method further comprises receiving, from the host, a CXL.mem Master-to-Subordinate (M2S) request comprising MemRd* and a first address targeting the second memory region; translating the CXL.mem M2S request to an NVLink read request comprising a SourceID, a DestinationID, a second address, a Tag, and a Length; receiving an NVLink read response comprising *Data*; and sending to the host a CXL.mem Subordinate-to-Master Data Response (S2M DRS) comprising MemData and data from the NVLink read response. The SourceID may identify the device or RPU that originated the NVLink read request, while the DestinationID may identify the target entity, such as a GPU, in the NVLink fabric. The second address may be an NVLink network address that may be utilized to route the NVLink read request to its destination, and may go through additional address translation phases facilitated by one or more Link TLBs in the NVLink domain. The Tag may be a transaction identifier maintained by the device for correlating the NVLink read response with the original CXL.mem M2S request. The Length may indicate the requested transfer size. The *Data* in the NVLink read response may represent data carried in one or more response packets. Different NVLink versions or implementations may use different naming conventions for these functional fields; for example, a source identifier may alternatively be referred to as a requester identifier, a source node identifier, or a similar designation, and a destination identifier may alternatively be referred to as a target identifier, a destination node identifier, or a similar designation.

In some implementations, the method further comprises receiving, from the host, a CXL.mem Master-to-Subordinate (M2S) request comprising MemRd* and an address targeting the first memory region; accessing the first memory to obtain data; and sending to the host a CXL.mem Subordinate-to-Master No Data Response (S2M NDR) comprising Cmp-S or Cmp-E indicating a cache state of a cacheline at the address, and a CXL.mem Subordinate-to-Master Data Response (S2M DRS) comprising MemData and the data. For the first memory region, the device may access local memory, such as HBM and/or HBF, without performing protocol translation to NVLink. The device may respond with Cmp-S or Cmp-E based on the device's caching policy and the host's requested coherency state as indicated by SnpType and MetaValue fields in the M2S request.

In some implementations of the method, for the first memory region, the device communicates with the host via CXL.cache; and wherein the device issues CXL.cache Device-to-Host (D2H) requests to the host comprising an opcode selected from RdOwn, RdShared, RdCurr, or RdAny. The CXL.cache D2H requests may enable the device to initiate coherency transactions with the host for data in the first memory region, such as when the device needs to read or modify data that the host may have cached.

In some implementations, the method further comprises translating, by the device, between a first address associated with a Host Physical Address (HPA) space utilized by the host and a second address associated with an NVLink network address space utilized by the NVLink-based protocol. The address translation may be implemented utilizing lookup tables, page tables, base-and-offset calculations, or programmable translation functions. The NVLink network address may be utilized to route NVLink transactions to specific GPUs or memory resources within the NVLink fabric.

In some implementations of the method, a non-transitory computer-readable medium comprising instructions which, when executed by a processor, cause the processor to perform the method.

In computing systems where a host accesses memory resources on a device coupled via CXL, the device may expose memory regions with different connectivity and coherency models. A first memory region may be backed by local memory coupled to the device, and may be exposed via a CXL device type flow that supports device coherency. A second memory region may be backed by memory accessible via an NVLink port, such as memory residing on GPUs or other NVLink-connected devices, and may be exposed via a different CXL device type flow. The device may include an RPU or translation logic configured to translate between CXL protocol messages and NVLink messages for memory access operations targeting the NVLink-accessible memory. An NVLink switch, such as NVSwitch, may couple the device to one or more GPUs whose memory resources form the second memory region.

In various implementations, a system comprising: a host; a device coupled to the host via a Compute Express Link (CXL) link; and a first memory coupled to the device; wherein the device is configured to expose to the host a first memory region via a first CXL device type flow and a second memory region via a second CXL device type flow, wherein the first CXL device type flow is different from the second CXL device type flow; wherein the first memory region is associated with the first memory; wherein the second memory region is associated with a second memory accessible via an NVLink port of the device; and wherein the device is configured to translate between a protocol based on CXL and an NVLink-based protocol for requests targeting at least one of the first memory region or the second memory region. The system may enable a host to access both local and NVLink-domain memory resources on the device through a CXL link, with differentiated coherency semantics for different memory regions. The device may include an RPU, translation logic, or a combination of hardware and firmware that translate between CXL and the NVLink-based protocol. The device may be an accelerator, an RPU, a bridge device, or a component within an active cable positioned between the CXL domain and the NVLink domain. The device may configure the boundaries between the first and second memory regions dynamically or statically, for example utilizing HDM decoder registers or programmable address range registers. The system may be deployed in datacenter environments where CXL-enabled CPUs participate with NVLink GPUs in inference or training of AI models.

In some implementations of the system, the first CXL device type flow comprises a CXL Type-2 device flow and the first memory region comprises a Host-managed Device Memory with Device coherency (HDM-D) region, and the second CXL device type flow comprises a CXL Type-3 device flow and the second memory region comprises a Host-managed Device Memory with Host-only coherency (HDM-H) region. The CXL Type-2 device flow may enable the device to negotiate CXL.io, CXL.cache, and CXL.mem for the HDM-D region, while the CXL Type-3 device flow may negotiate CXL.io and CXL.mem for the HDM-H region.

In some implementations of the system, for CXL.mem requests targeting the first memory region, the device is configured to send a CXL.mem Subordinate-to-Master No Data Response (S2M NDR) comprising Cmp-S or Cmp-E indicating a cache state; and for CXL.mem requests targeting the second memory region, the device is configured to translate the CXL.mem requests to NVLink read requests and send a CXL.mem Subordinate-to-Master Data Response (S2M DRS) comprising MemData. The differentiated response behavior may reflect the different coherency models of the first and second memory regions. For the first memory region, the Cmp-S or Cmp-E indication may inform the host of the cache state maintained by the device. For the second memory region, the device may translate the request to an NVLink read request, receive data from the NVLink domain, and return the data to the host.

In some implementations of the system, the device comprises an accelerator or a resource provisioning unit (RPU), and the first memory comprises at least one of High Bandwidth Memory (HBM) or High-Bandwidth Flash (HBF) coupled to the device; and further comprising an NVLink switch coupling the NVLink port of the device to one or more GPUs, wherein the second memory is accessible via the NVLink switch. The NVLink switch may be an NVSwitch or similar switch device that provides high-bandwidth routing between the device and GPUs within an NVLink fabric. The one or more GPUs may each have their own HBM, HBF, or other memory that collectively forms the second memory accessible from the device via the NVLink port.

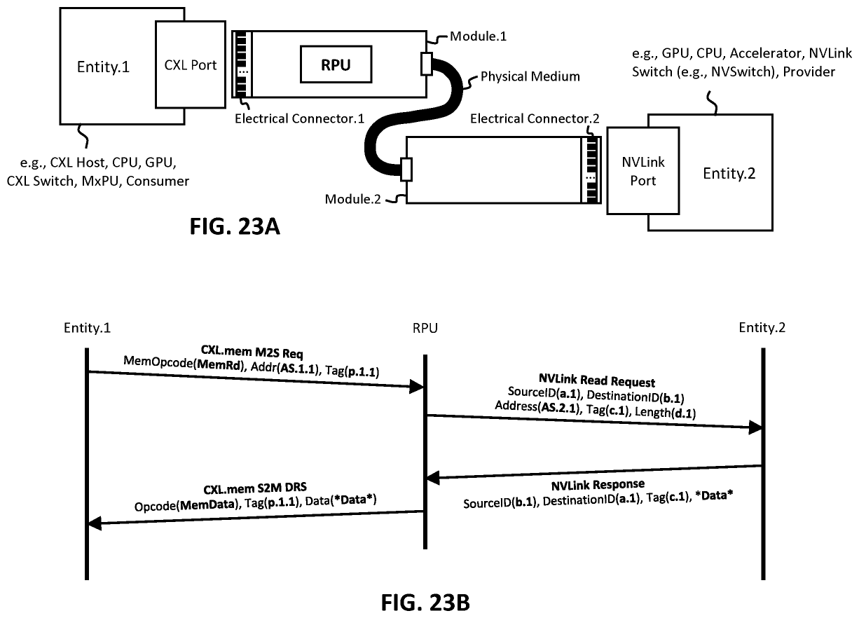

FIG. 23A illustrates an example of a system comprising an active cable that includes an RPU. The cable comprises a first pluggable module (Module.1) and a second pluggable module (Module.2) coupled by a Physical Medium. Module.1 includes the RPU and is coupled via a first electrical connector (Electrical Connector.1) to a CXL Port of a first entity (Entity.1). Module.2 is coupled via a second electrical connector (Electrical Connector.2) to an NVLink Port of a second entity (Entity.2). Entity.1 may be a CXL Host, CPU, GPU, CXL Switch, MxPU, or Consumer. Entity.2 may be a GPU, CPU, Accelerator, NVLink Switch (e.g., NVSwitch), or Provider. The RPU may be placed in various locations as a function of the requirements. In one example, the RPU is placed in Module.1 closer to the CXL Port of Entity.1, since CXL, which runs over PCIe electricals, is designed as a shorter-reach interface utilized for connecting devices to CPUs within a compute platform. Some versions of NVLink incorporate electrical signaling characteristics compatible with Ethernet and/or InfiniBand connectivity, designed for longer-reach interconnects that fit rack-level deployments and beyond. Placing the RPU closer to the CXL port may improve signal integrity. Additionally, NVLink typically utilizes a signaling rate higher than CXL, and consequently NVLink may require fewer lanes than CXL for the same bandwidth, which may allow for reducing the amount of copper wires or optical fibers in the Physical Medium.

FIG. 23B illustrates an example of a TFD demonstrating an RPU that translates between CXL.mem requests and NVLink requests. The TFD shows three entities: Entity.1/Consumer on the left, the RPU in the center, and Entity.2/Provider on the right. Entity.1 may send a CXL.mem M2S Req comprising MemOpcode(MemRd), Addr(AS.1.1), and Tag(p.1.1) to the RPU. Address (AS.1.1) may be an HPA of a Host, such as a CXL-enabled CPU coupled to the RPU. The RPU may translate the CXL.mem M2S Req to an NVLink Request Read comprising SourceID(a.1), DestinationID(b.1), Address(AS.2.1), Tag(c.1), and Length(d.1). Address (AS.2.1) may be an NVLink Network Address utilized to route the NVLink request to its destination on the NVLink fabric. In the response direction, Entity.2 may send an NVLink Response comprising SourceID(b.1), DestinationID(a.1), Tag(c.1), and *Data* to the RPU. The RPU may translate the NVLink Response to a CXL.mem S2M DRS comprising Opcode(MemData), Tag(p.1.1), and Data(*Data*), and may send the CXL.mem S2M DRS to Entity.1. The RPU may map the Tag from the NVLink response back to the original CXL.mem Tag (p.1.1) to enable proper transaction completion at Entity.1. In some examples, the NVLink Network Address may go through additional address translation phases, which may be facilitated by one or more Link TLBs residing on the transaction path. For example, in a GPU, a Link TLB may translate an NVLink Network Address to a GPU Physical Address that may reference memory resources integrated in or adjacent to the destination GPU. The RPU may perform another address translation to translate the HPA utilized by CXL.mem to the NVLink Network Address before the NVLink request is sent. Moreover, NVLink provides a distributed memory model where GPUs may access memory via other GPUs. This example provides a generic CXL.mem bridge/gateway for other, possibly non-NVLink compute elements, such as CPUs, to access memory residing on the NVLink Fabric, for example, where x86 GP-CPUs participate with NVLink GPUs in inference or training of AI models.

In some implementations, a computer, such as an RPU, may be coupled between an NVLink interface and a CXL interface, and may translate between NVLink-based traffic and CXL.mem traffic. The computer may receive NVLink-based requests from a first entity, such as a GPU or an accelerator, and may translate the NVLink-based requests to CXL.mem M2S requests for transmission to a second entity, such as a CXL device, a CXL memory expander, or a CXL memory pool. The translation may include address translation between physical address spaces, opcode translation between NVLink commands and CXL.mem memory opcodes, and Tag translation between NVLink transaction identifiers and CXL.mem Tags. The computer may be implemented as a discrete component, as a chiplet within an IC package, as an IP block within a processor, or may be integrated into an active cable or an NVLink switch. The translation may enable NVLink-coupled accelerators to access CXL memory resources for GPU memory disaggregation, capacity expansion, AI model parameter storage, key-value (KV) cache offloading, and other memory-intensive AI workloads.

In various implementations, a method comprising: receiving, by a computer from a first entity via a first interface that communicates according to an NVLink-based protocol, an NVLink-based request comprising a first physical address associated with a first address space; translating, by the computer, the first physical address to a second physical address associated with a second address space; generating, by the computer, a CXL.mem Master-to-Subordinate (M2S) request comprising a read-class memory opcode and the second physical address, wherein CXL denotes Compute Express Link; sending, by the computer via a second interface, the CXL.mem M2S request to a second entity; receiving, by the computer from the second entity, a CXL.mem Subordinate-to-Master Data Response with Status (S2M DRS) comprising data; and sending, by the computer to the first entity, an NVLink-based response comprising the data. The computer may translate the NVLink-based request by terminating the NVLink transaction and initiating a corresponding CXL.mem transaction. For example, the read-class memory opcode may include MemRd, MemRdData, or other read-class opcodes defined by CXL.mem. The address translation may be implemented utilizing lookup tables, page tables, base-and-offset calculations, or programmable translation functions. The computer may translate requests initiated from the NVLink-based domain to the CXL domain, may translate requests initiated from the CXL domain to the NVLink-based domain, or may translate requests initiated from both domains.

In some implementations of the method, the NVLink-based request is associated with a data payload size exceeding a maximum CXL.mem data payload size, and wherein generating the CXL.mem M2S request comprises generating CXL.mem M2S requests corresponding to the NVLink-based request. For example, an NVLink-based read request for 256 Bytes of data may be translated to four CXL.mem M2S requests, each targeting a 64-Byte cacheline. The computer may generate the CXL.mem M2S requests with sequential or non-sequential addresses derived from the first physical address.

In some implementations, the method further comprises accumulating data from CXL.mem S2M DRS responses corresponding to the CXL.mem M2S requests before sending the NVLink-based response to the first entity. The computer may buffer partial data from individual S2M DRS responses and assemble the complete data payload before generating the NVLink-based response. The S2M DRS responses may arrive out of order, and the computer may utilize Tag mappings to associate each response with the corresponding CXL.mem M2S request.

In some implementations, the method further comprises maintaining, by the computer, a mapping between a first Tag associated with the NVLink-based request and a second Tag associated with the CXL.mem M2S request, and utilizing the mapping to associate the CXL.mem S2M DRS with the NVLink-based request. The mapping may be stored in a tracker entry, a translation table, or a content-addressable memory. The first Tag may include an NVLink Tag or TransactionID, and the second Tag may be a CXL.mem Tag allocated from a Tag space utilized by the computer toward the second entity.

In some implementations, the method further comprises generating, by the computer, a second CXL.mem M2S request comprising a MemSpecRd opcode and a third physical address; and sending the second CXL.mem M2S request to the second entity. The computer may generate speculative read requests to prefetch data from the second entity before, or without, the first entity explicitly requesting it. The speculative reads may reduce read latency when the second entity exhibits long access times, such as when accessing slow memory media or remote memory resources over a fabric.

In some implementations of the method, the first address space comprises an NVLink-based network address space or a GPU physical address space, and the second address space comprises a Host Physical Address (HPA) space; and wherein the first entity comprises a GPU, an accelerator, or an NVLink switch, and the second entity comprises a CXL device, a CXL memory expander, or a CXL memory pool. The NVLink-based network address space may be utilized for routing NVLink requests across the NVLink fabric. The HPA space may be utilized by a CXL host or CXL device for memory access operations. The address translation may accommodate differences in size, base addresses, or memory layouts between the address spaces.

In some implementations of the method, the CXL.mem S2M DRS further comprises a Poison indication, and the NVLink-based response further comprises an error indication translated from the Poison indication. The Poison indication in CXL.mem S2M DRS may signal that the data contains an error. The computer may translate the Poison indication to an equivalent error indication in the NVLink-based response to propagate the error status to the first entity.

In some implementations, the method further comprises receiving, from the first entity via the first interface, an NVLink-based write request comprising write data; generating, by the computer, a CXL.mem Master-to-Subordinate Request with Data (M2S RwD) comprising MemWr* and the write data; sending the CXL.mem M2S RwD to the second entity via the second interface; receiving, from the second entity, a CXL.mem Subordinate-to-Master No Data Response (S2M NDR); and sending an NVLink-based write response to the first entity. For example, MemWr* may include MemWr, MemWrPtl, or other memory write opcode variants defined by CXL.mem. The write data may be transferred from the NVLink domain to the CXL.mem domain with optional byte enable manipulation when the write is partial. The S2M NDR may include a Cmp opcode indicating completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to an NVLink-based protocol and a second interface configured to communicate according to CXL, with a computer coupled between the interfaces. The computer may be implemented in various form factors, such as an IC package conforming to a retimer BGA specification, an NVLink Fusion chiplet within a processor IC package, a discrete bridge device, or a component integrated into an active cable or an NVLink switch. The system may include optional NVLink switches and CXL switches to support multi-entity topologies. The computer may translate between physical address spaces and between NVLink-based requests and CXL.mem M2S requests, enabling NVLink-coupled entities to access CXL memory resources.

In various implementations, a system comprising: a first interface configured to communicate according to an NVLink-based protocol with a first entity; a second interface configured to communicate according to Compute Express Link (CXL) with a second entity; and a computer coupled between the first and second interfaces, configured to: translate physical addresses associated with the NVLink-based protocol to physical addresses associated with CXL; and translate between NVLink-based requests received via the first interface and CXL.mem Master-to-Subordinate (M2S) requests transmitted via the second interface. The computer may further translate CXL.mem S2M responses received via the second interface to NVLink-based responses transmitted via the first interface. The computer may include logic for address translation, Tag management, protocol conversion, and transaction tracking. The system may be deployed in datacenters, HPC environments, or AI training and inference clusters to enable NVLink-coupled accelerators to access CXL-attached memory resources such as CXL memory expanders or CXL memory pools.

In some implementations of the system, the computer is packaged in an integrated circuit (IC) package comprising input/output (I/O) connection points arranged according to a retimer ball grid array (BGA) specification. The retimer BGA form factor may enable the computer to be deployed in existing retimer sockets within server platforms, optionally facilitating adoption without requiring board-level redesign.

In some implementations, the system further comprises at least one of: an NVLink switch coupled between the first interface and the first entity, the NVLink switch configured to route NVLink-based requests from NVLink entities to the first interface; or a CXL switch coupled between the second interface and the second entity, the CXL switch configured to route CXL.mem M2S requests to CXL devices or CXL memory pools. The NVLink switch may be an NVSwitch that aggregates traffic from accelerators/GPUs toward the computer. The CXL switch may enable the computer to access multiple CXL memory devices or memory pools via a CXL interface, expanding the addressable memory capacity.

In some implementations of the system, the computer comprises an NVLink Fusion chiplet within an integrated circuit (IC) package of a processor, the NVLink Fusion chiplet comprising the first interface and coupled to the processor via a die-to-die (D2D) interface, the D2D interface utilizing a Universal Chiplet Interconnect Express (UCIe) PHY or a proprietary chip-to-chip PHY. The NVLink Fusion chiplet may enable integration of NVLink connectivity into processors that may not have native NVLink support. The D2D interface may couple the chiplet to a coherent interconnect within the processor, such as an on-chip ring or mesh interconnect.

In some implementations of the system, the NVLink-based protocol and CXL are associated with a same physical address space, the same physical address space comprising a global address space, a pod address space, or a fabric address space. When both protocols are associated with the same physical address space, the computer may perform address translations between addresses within the same space, such as range adjustments or offset calculations, rather than translations between fundamentally different address spaces.

In some implementations, a computer may translate CXL.mem requests to NVLink-based requests, enabling CXL hosts or CPUs to access memory residing on an NVLink fabric via NVLink-coupled entities such as accelerators/GPUs. NVLink provides a distributed memory model where GPUs may access memory via other GPUs. This translation may provide a CXL.mem bridge or gateway for non-NVLink compute elements, such as CPUs, to access memory on the NVLink fabric. The computer may be implemented as a discrete component, integrated into an active cable, or included in an NVLink switch.

In various implementations, a method comprising: receiving, by a computer from a first entity via a first interface that communicates according to Compute Express Link (CXL), a CXL.mem Master-to-Subordinate (M2S) request comprising a read-class memory opcode and a first physical address associated with a first address space; translating, by the computer, the first physical address to a second physical address associated with a second address space; generating, by the computer, an NVLink-based request comprising the second physical address; sending, by the computer via a second interface that communicates according to an NVLink-based protocol, the NVLink-based request to a second entity; receiving, by the computer from the second entity, an NVLink-based response comprising data; and generating, by the computer, a CXL.mem Subordinate-to-Master Data Response with Status (S2M DRS) comprising the data, and sending the CXL.mem S2M DRS to the first entity. The computer may translate the CXL.mem M2S request by terminating the CXL.mem transaction and initiating a corresponding NVLink transaction. The read-class memory opcode in the CXL.mem M2S request may include opcodes such as MemRd, MemRdData, or MemSpecRd. The computer may translate the HPA from the CXL.mem M2S request to an NVLink network address utilized for routing the NVLink request to its destination on the NVLink fabric. The CXL.mem S2M DRS may carry a MemData opcode and the data retrieved from the second entity.

In some implementations, the method further comprises maintaining, by the computer, a mapping between a first Tag associated with the CXL.mem M2S request and a second Tag associated with the NVLink-based request, and utilizing the mapping to associate the NVLink-based response with the CXL.mem M2S request. Upon receiving the NVLink-based response, the computer may utilize the second Tag to retrieve the first Tag from the mapping and include the first Tag in the CXL.mem S2M DRS for transaction completion at the first entity.

In some implementations of the method, the first address space comprises a Host Physical Address (HPA) space, and the second address space comprises an NVLink-based network address space; and wherein the NVLink-based request further comprises a DestinationID derived from the first physical address, the DestinationID identifying a target entity on an NVLink fabric coupled to the second interface. The computer may derive the DestinationID from the translated address, from a routing table, or from address-range-to-destination mappings. The DestinationID may be utilized for routing the NVLink request through NVLink switches to the target entity on the NVLink fabric.

In some implementations of the method, the first entity comprises a CXL host or a CPU, and the second entity comprises a GPU, an NVLink switch, or an accelerator; and wherein the NVLink-based response comprises data retrieved from a memory accessible via the second entity on an NVLink fabric. The translation may enable CPUs to access GPU-attached memory, such as HBM and/or High-Bandwidth Flash (HBF), via the CXL.mem-to-NVLink bridge, facilitating scenarios where CPUs participate alongside NVLink GPUs in AI inference or training workloads.

In some implementations, the method further comprises receiving, from the second entity, a second NVLink-based response that does not carry data; and generating a CXL.mem Subordinate-to-Master No Data Response (S2M NDR) based on the second NVLink-based response, and sending the CXL.mem S2M NDR to the first entity. The S2M NDR may carry a Cmp opcode to indicate completion of a write or invalidation operation. The computer may translate NVLink completion indications to the corresponding CXL.mem S2M NDR opcode.

In some implementations, the method further comprises receiving, from the first entity via the first interface, a CXL.mem Master-to-Subordinate Request with Data (M2S RwD) comprising MemWr* and write data; generating, by the computer, an NVLink-based write request comprising the write data; sending the NVLink-based write request to the second entity via the second interface; receiving, from the second entity, an NVLink-based write response; and generating a CXL.mem Subordinate-to-Master No Data Response (S2M NDR), and sending the CXL.mem S2M NDR to the first entity. MemWr* may include MemWr, MemWrPtl, or other memory write opcode variants. The computer may translate the CXL.mem write data and byte enables to corresponding NVLink write request formats. The S2M NDR may be sent after the NVLink-based write response is received, or may be sent before the NVLink write completes as an early completion.

In some implementations of the method, a non-transitory computer-readable medium comprising instructions which, when executed by a processor, cause the processor to perform the method. In some implementations of the method, one or more integrated circuits configured to perform the method, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages. In some implementations of the method, an active cable comprising first and second pluggable modules coupled by a physical medium; wherein the active cable further comprises hardware circuitry, integrated into the active cable, configured to perform the method.

Some implementations of the following system may include a first interface configured to communicate according to CXL and a second interface configured to communicate according to an NVLink-based protocol, with a computer coupled between the interfaces to translate CXL.mem M2S requests to NVLink-based requests. The computer may be integrated into an active cable, included in an NVLink switch, or implemented as a discrete bridge device. The system may position the computer closer to the CXL interface for signal integrity, since CXL runs over PCIe electricals designed for shorter-reach connectivity, while NVLink may incorporate signaling compatible with longer-reach deployments.

In various implementations, a system comprising: a first interface configured to communicate according to Compute Express Link (CXL) with a first entity; a second interface configured to communicate according to an NVLink-based protocol with a second entity; and a computer coupled between the first and second interfaces, configured to: translate physical addresses associated with CXL to physical addresses associated with the NVLink-based protocol; and translate between CXL.mem Master-to-Subordinate (M2S) requests received via the first interface and NVLink-based requests transmitted via the second interface. The computer may further translate NVLink-based responses received via the second interface to CXL.mem S2M responses transmitted via the first interface. The system may enable CXL hosts or CPUs to access memory on an NVLink fabric, such as GPU-attached HBM and/or HBF, via the NVLink-based protocol. The computer may maintain transaction tracking structures for matching NVLink responses to pending CXL.mem requests.

In some implementations, the system further comprises an active cable comprising a first pluggable module coupled to the first interface, a second pluggable module coupled to the second interface, and a physical medium coupling the first and second pluggable modules; wherein the computer is integrated into the active cable and converts between CXL signaling conforming to PCIe electrical specifications at the first interface and NVLink signaling at the second interface. The physical medium may include twinaxial cable, multimode fiber, or single-mode fiber. The active cable may be implemented as an Active Optical Cable (AOC) or an Active Copper Cable (ACC). The signaling conversion within the cable may simplify system integration by presenting standard CXL and NVLink interfaces at each end.

In some implementations of the system, the second interface utilizes fewer lanes than the first interface, and wherein the NVLink-based protocol operates at a higher per-lane signaling rate than CXL, such that the second interface achieves a bandwidth comparable to the first interface utilizing the fewer lanes. The lane reduction may simplify cable design by reducing the number of copper wires or optical fibers, which may reduce cost and complexity of the interconnect while maintaining bandwidth parity between the two interfaces.

In some implementations of the system, the computer is positioned closer to the first interface than to the second interface; and wherein the first interface communicates via electrical signaling conforming to PCIe physical layer specifications designed for shorter-reach connectivity, and the second interface communicates via electrical signaling compatible with longer-reach interconnect deployments. Positioning the computer closer to the CXL interface may improve signal integrity for the shorter-reach CXL signaling, while the longer-reach NVLink signaling may tolerate the additional distance to the second entity.

In some implementations of the system, the computer is included in an NVLink switch, the NVLink switch coupled to NVLink entities via the second interface; and wherein the computer translates CXL.mem M2S requests from the first entity to NVLink-based requests directed to at least one of the NVLink entities. The NVLink switch may route the translated NVLink-based requests to the appropriate NVLink entity based on destination identifiers or address-based routing. Integrating the computer into the NVLink switch may enable a CXL host to access memory across multiple NVLink-coupled accelerators/GPUs.

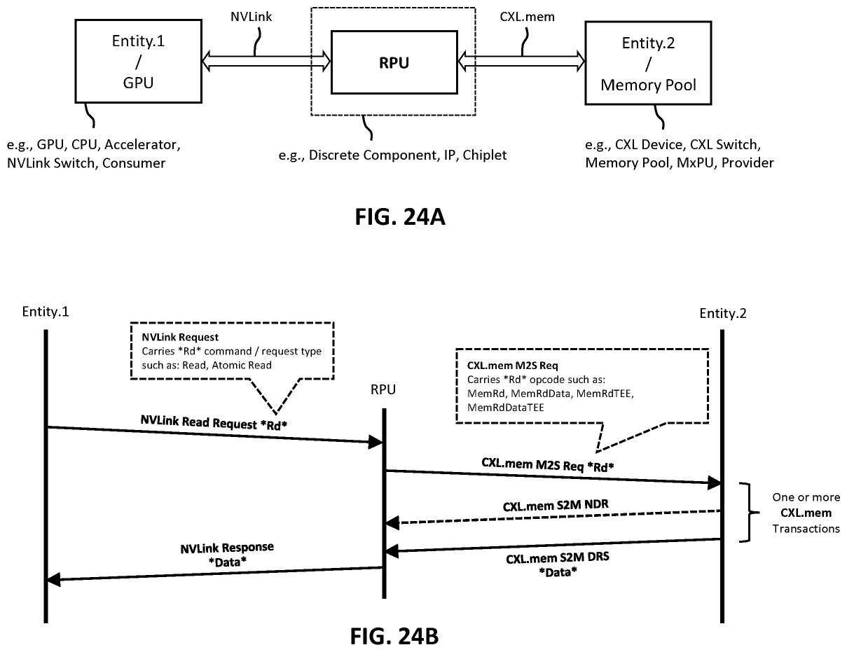

FIG. 24A illustrates an example of a system comprising an apparatus, such as an RPU, coupled between a first entity (Entity.1) and a second entity (Entity.2). The RPU may translate between NVLink-based traffic and CXL-based traffic, such as CXL.mem traffic. Entity.1, shown as a GPU, may communicate with the RPU according to an NVLink-based protocol, and may include a GPU, CPU, Accelerator, NVLink Switch (NVSwitch), or other resource consumer. Entity.2, shown as a Memory Pool, may communicate with the RPU according to CXL.mem, and may include a CXL Device, CXL Switch, Memory Pool, MxPU, or other resource provider. The RPU may be implemented as a discrete component, an IP block within a processor, or a chiplet within an IC package. Additionally or alternatively, the RPU may translate between the NVLink-based traffic and CXL.io traffic, and/or between the NVLink-based traffic and CXL.cache traffic.

FIG. 24B illustrates an example of a Transaction Flow Diagram (TFD) demonstrating an apparatus, such as an RPU, that may translate between NVLink-based traffic and CXL-based traffic, such as CXL.mem traffic. The TFD shows three entities: Entity.1 (a GPU or Consumer) on the left, the RPU in the center, and Entity.2 (a CXL Device or Provider) on the right. The first entity may send an NVLink Read Request carrying a *Rd* command or request type, such as Read or Atomic Read, to the RPU. The RPU may translate the NVLink Read Request to a CXL.mem M2S Req carrying a *Rd* opcode, such as MemRd, MemRdData, MemRdTEE, or MemRdDataTEE, and may send the CXL.mem M2S Req to the second entity. The second entity may respond with one or more CXL.mem transactions, including a CXL.mem S2M NDR and/or a CXL.mem S2M DRS carrying *Data*. The RPU may translate the CXL.mem S2M DRS to an NVLink Response carrying *Data* and send the NVLink Response to the first entity. In some examples, the RPU may translate an NVLink-based request to multiple CXL.mem request, such as when splitting an NVLink request for a data payload of 256 Bytes to CXL.mem M2S requests each carrying 64 Bytes. The RPU may accumulate data from one or more CXL.mem S2M DRS messages before sending the data via an NVLink-based response.

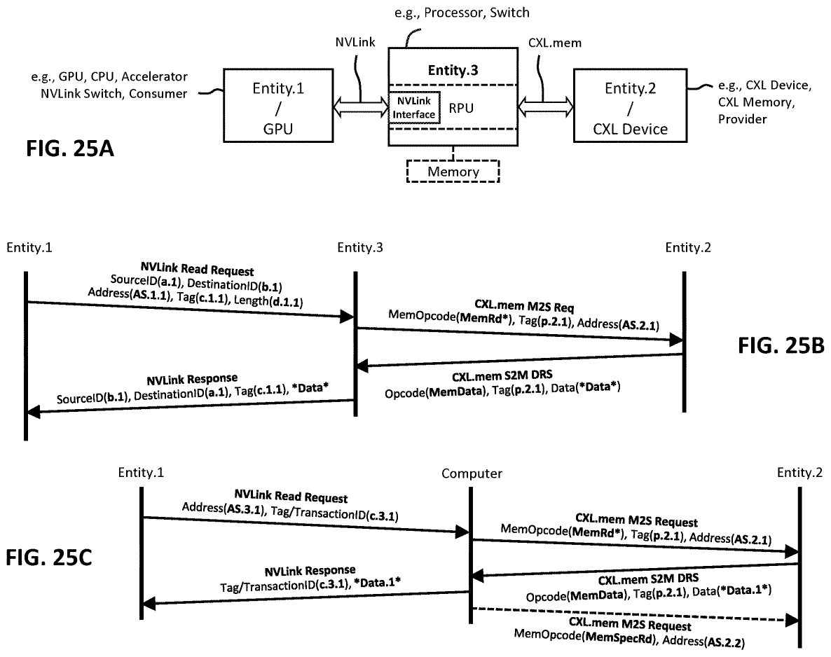

FIG. 25A illustrates an example of a system comprising a third entity (Entity.3), such as a processor or a switch. Entity.3 includes an NVLink Interface and an RPU, and includes or is coupled to an optional Memory. Entity.3 is coupled to a first entity (Entity.1), which may be a GPU, CPU, Accelerator, NVLink Switch (NVSwitch), or resource consumer, via an NVLink-based protocol. Entity.3 is further coupled to a second entity (Entity.2), which may be a CXL Device, CXL Memory, or resource provider, via CXL.mem. In some examples, messages conforming to the NVLink-based protocol may be associated with a first physical address (PA) space, such as a GPU physical address space or an NVLink-based network address space, and messages conforming to CXL.mem may be associated with a second PA space, such as HPA space. The RPU may perform address translations between addresses within the first PA space and addresses within the second PA space. In other examples, messages conforming to the NVLink-based protocol and messages conforming to CXL.mem may be associated with the same PA space, such as a global address space. Optionally, the RPU may perform further translations between the NVLink-based domain and CXL.mem domain, such as protocol translations, opcode translations, command translations, and field translations.

FIG. 25B illustrates an example of a TFD demonstrating translations performed by a third entity (Entity.3), such as a processor, a switch, or an RPU, between messages conforming to an NVLink-based protocol utilized for communicating with a first entity (Entity.1), such as a GPU, a CPU, or an accelerator, and messages conforming to CXL.mem utilized for communicating with a second entity (Entity.2), such as a CXL device or CXL memory. The first entity may initiate an NVLink Read Request comprising SourceID(a.1), DestinationID(b.1), Address(AS.1.1), Tag(c.1.1), and Length(d.1.1), wherein SourceID(a.1) may denote the NVLink interconnect address utilized by the requesting entity, and DestinationID(b.1) may denote the NVLink interconnect address utilized by the target of the NVLink request. The third entity may translate the NVLink request to a CXL.mem M2S Req comprising MemOpcode(MemRd*), Tag(p.2.1), and Address(AS.2.1), and may send the CXL.mem M2S Req to the second entity. Upon receiving a response from the second entity, which may include a CXL.mem S2M DRS comprising Opcode(MemData), Tag(p.2.1), and Data(*Data*), the third entity may translate the CXL.mem S2M DRS to an NVLink Response comprising SourceID(b.1), DestinationID(a.1), Tag(c.1.1), and *Data*. The third entity may perform further translations, such as protocol translations, opcode translations, command translations, or translations between PDUs conforming to the NVLink-based protocol and messages conforming to CXL.mem, such as translations of Tags and translations of error indications, such as poison.

FIG. 25C illustrates an example of a TFD demonstrating translations, such as address translations, optionally performed by a computer, between NVLink-based requests received from a first entity (Entity.1), which may be a CPU or a GPU, and CXL.mem requests sent to a second entity (Entity.2), which may be a CXL device. The first entity may initiate an NVLink Read Request comprising Address(AS.3.1) and Tag/TransactionID(c.3.1). The Tag/TransactionID may denote a Tag, a transaction Tag, a transaction identifier, or another field or set of fields carried in NVLink requests and/or NVLink responses, which may serve to associate the NVLink responses with the NVLink requests. The computer may translate the NVLink request to a CXL.mem M2S Request comprising MemOpcode(MemRd*), Tag(p.2.1), and Address(AS.2.1), and may send the CXL.mem M2S Request to the second entity. Upon receiving one or more responses from the second entity, which may include a CXL.mem S2M DRS comprising Opcode(MemData), Tag(p.2.1), and Data(*Data.1*), the computer may translate the one or more responses, such as translating the CXL.mem S2M DRS to an NVLink response comprising Tag/TransactionID(c.3.1) and *Data.1*, and send the NVLink response to the first entity. The computer may further initiate speculative memory reads targeting the second entity, such as a CXL.mem M2S request comprising MemOpcode(MemSpecRd) and Address(AS.2.2), to facilitate data prefetches and potentially reduce read latency from the second entity. Optionally, the computer may utilize the speculative memory reads on behalf of the first entity. When utilizing MemSpecRd, some of the CXL.mem M2S Req fields, such as Tag, MetaField, MetaValue, and SnpType, may be reserved. In some examples, the computer may issue multiple CXL.mem reads in response to receiving an NVLink request from the first entity, such as when splitting an NVLink request for a large block of data (e.g., 256 B) to smaller CXL.mem reads (e.g., 64 B each), or when prefetching data from the second entity utilizing CXL.mem reads. The computer may translate requests or transactions initiated from the NVLink-based domain to the CXL domain, and/or may translate requests or transactions initiated from the CXL domain to the NVLink-based domain.

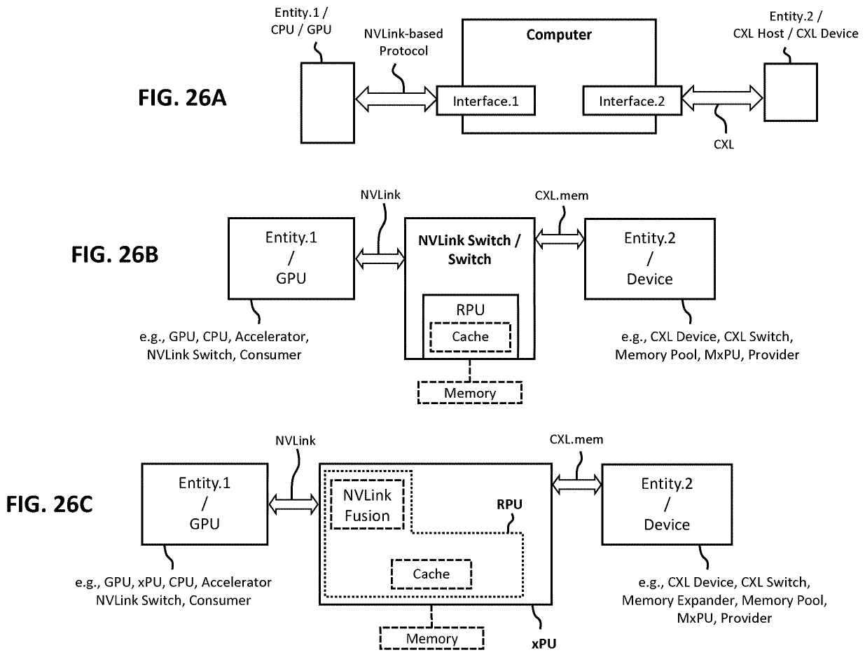

FIG. 26A illustrates an example of a system comprising a computer coupled between a first interface (Interface.1) and a second interface (Interface.2). Interface.1 may communicate according to an NVLink-based Protocol with a first entity (Entity.1), which may be a CPU or a GPU. Interface.2 may communicate according to CXL with a second entity (Entity.2), which may be a CXL host or a CXL device. The computer may extract addresses from requests received via the first interface, wherein these addresses may refer to a first address space, such as an NVLink-based address space, an NVLink-based network address space, or a GPU address space utilized by the first entity. The computer may further translate these addresses and generate requests carrying the translated addresses for transmission via the second interface, wherein the translated addresses may refer to a second address space utilized by the second entity. In other examples, the first address space and the second address space may be associated with the same address space, such as a common address space, a global address space, a pod address space, or a fabric address space. The computer may be implemented in an IC package having high-speed differential I/O balls positioned according to a ball grid array layout defined by a retimer specification. Optional switch(es), such as NVLink switches, may be positioned between the first interface and the first entity. Similarly, optional switch(es), such as CXL switches, may be positioned between the second interface and the second entity.

FIG. 26B illustrates an example of a system comprising an NVLink Switch, or Switch that includes an RPU and a Cache. The switch is coupled to a first entity (Entity.1), shown as a GPU, via an NVLink-based protocol, and to a second entity (Entity.2), shown as a Device, via CXL.mem. Entity.1 may be a GPU, CPU, Accelerator, NVLink Switch, or Consumer. Entity.2 may be a CXL Device, CXL Switch, Memory Pool, MxPU, or Provider. The switch may further be coupled to a Memory. The RPU within the switch may translate between NVLink-based requests received from the first entity and CXL.mem M2S requests transmitted to the second entity. The Cache within the switch may store data for reducing latency or accumulating data from multiple CXL.mem responses.

FIG. 26C illustrates an example of a system comprising a processor, such as an xPU, that includes an RPU that may include an NVLink Fusion chiplet or IP block. The RPU may further include a Cache, and may be coupled to a Memory. The RPU may be coupled, via the NVLink Fusion component, to a first entity (Entity.1) that may be a GPU, xPU, CPU, Accelerator, NVLink Switch, or Consumer. The RPU is coupled via CXL.mem to a second entity (Entity.2), shown as a Device. Entity.2 may be a CXL Device, CXL Switch, Memory Expander, Memory Pool, MxPU, or Provider. The NVLink Fusion chiplet may include the NVLink interface and may be part of the RPU, such that protocol translation between NVLink-based traffic and CXL.mem traffic may be performed within the NVLink Fusion chiplet. The NVLink Fusion chiplet may also include an NVLink PHY. In other examples, the NVLink interface and the RPU may be implemented as functional blocks on the same die with the xPU, or split between silicon dies or chiplets inside the IC package of the xPU.

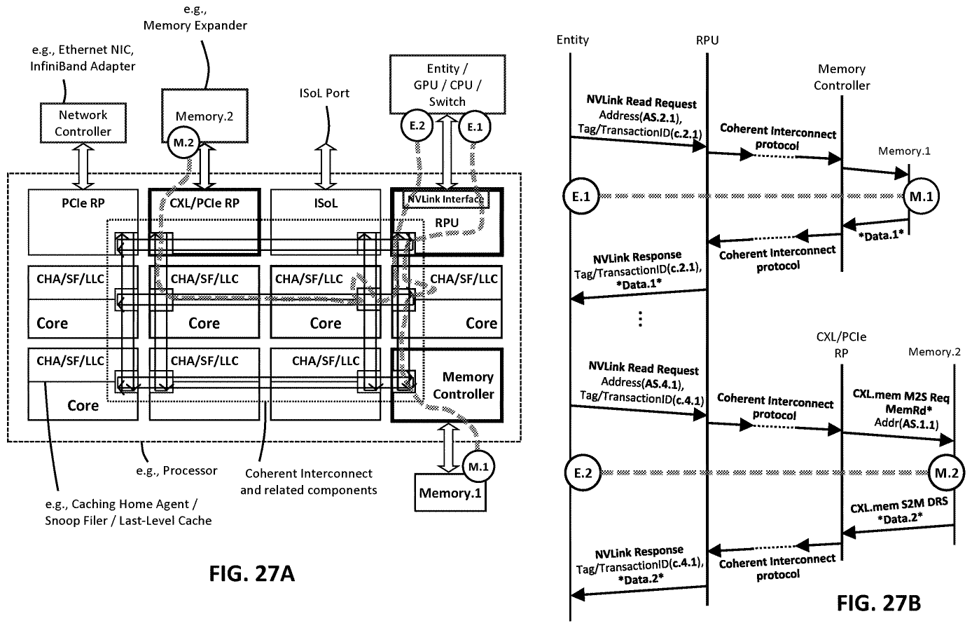

FIG. 27A illustrates an example of a system comprising a processor including a coherent interconnect, which may enable an external entity, such as a GPU, CPU, or Switch, to access memory resources mapped to an address space utilized by the coherent interconnect, such as via one or more of the two illustrated paths denoted as (E.1)-(M.1) and (E.2)-(M.2). The processor may include processing cores, and coherent interconnect, and related components, such as Caching Home Agent/Snoop Filter/Last-Level Cache (CHA/SF/LLC) slices. The processor may further include a PCIe RP coupled to a Network Controller (e.g., Ethernet NIC, InfiniBand Adapter), a CXL/PCIe RP coupled to a second memory (Memory.2, such as a Memory Expander), a memory controller coupled to a first memory (Memory.1), such as DRAM, and an ISoL port (e.g., utilizing NVIDIA NVLink-C2C, ARM CHI C2C, or Intel Coherent Processor Interconnect Protocol (ICPIP)). The processor includes an RPU coupled to an NVLink interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL/PCIe RP, such as over path (E.2)-(M.2). The illustrated RPU may be coupled to the coherent interconnect, and may translate between the NVLink-based protocol and a protocol utilized by the coherent interconnect. The processor may be implemented as a monolithic die, as chiplets within an IC package, or as components on a board, and may utilize a mesh-based coherent interconnect, or other types of coherent interconnects such as a ring, a crossbar, or a Network on Chip (NoC).

FIG. 27B illustrates an example of a TFD demonstrating two NVLink requests, such as NVLink read requests, received from an entity, such as a GPU or a CPU, processed by an RPU and forwarded, possibly using a protocol utilized by a coherent interconnect of a processor, to different memories that may be mapped to an address space utilized by the coherent interconnect. The paths from the RPU to the different memories may traverse other components, such as CHA/SF/LLC slices, memory controllers, or in other examples a home agent or a home node, optionally for resolving coherency. The RPU may perform physical address translations between first physical addresses, such as from GPU physical addresses or NVLink-based network addresses that may be carried in the NVLink requests, and second physical addresses, such as Host Physical Addresses (HPAs), which may refer to an address space utilized by the coherent interconnect, wherein the physical address translations may enable the entity to access the processor's memories. The processor may have multiple memory resources, such as first memory (Memory.1), which may be DRAM coupled to a memory controller of the processor, and/or second memory (Memory.2), which may be a CXL memory expander coupled to a CXL/PCIe RP of the processor. The RPU may further translate between NVLink-based requests and requests based on a protocol utilized by the coherent interconnect, and send the translated requests to the coherent interconnect, requesting read from memory. In some examples, the requested data may be provided by a processor cache, such as by an LLC, instead of by the memory. The data may then return over the coherent interconnect to the RPU, wherein the RPU may provide the data to the requesting entity via an NVLink response.

The TFD illustrates two exemplary transactions between the entity and the RPU, (Entity/GPU/CPU/Switch), processed by an RPU and forwarded via the coherent interconnect protocol to different memories. The TFD illustrates two exemplary transactions corresponding to two distinct memory read paths denoted as (E.1)-(M.1) and (E.2)-(M.2), each associated with a different physical address mapped to different memory resources. The first exemplary transaction (E.1) includes a first NVLink Read Request comprising Address(AS.2.1) and Tag/TransactionID(c.2.1). The RPU may translate the first NVLink request and forward the translated request via the Coherent Interconnect protocol, resulting in the retrieval of *Data.1* from the first memory (Memory.1) via the Memory Controller, wherein *Data.1* may be sent to the entity via the Coherent Interconnect protocol and via the RPU with the first NVLink Response comprising Tag/TransactionID(c.2.1) and *Data.1*.

The second exemplary transaction (E.2) includes a second NVLink Read Request comprising Address(AS.4.1) and Tag/TransactionID(c.4.1). The RPU may translate the second NVLink read request and may further translate the physical address (AS.4.1) carried in the second NVLink read request to a translated physical address (AS.1.1) which may refer to an address space utilized by the coherent interconnect. The RPU may forward the translated request, that may include the translated physical address (AS.1.1), via the coherent interconnect protocol, resulting in the retrieval of *Data.2* from the second memory (Memory.2) via the CXL/PCIe RP, utilizing a CXL.mem M2S request comprising MemRd* and Address(AS.1.1). The second memory (Memory.2) may respond with a CXL.mem S2M DRS comprising *Data.2*, which may be sent to the RPU via the coherent interconnect protocol. The RPU may then send *Data.2* to the entity via the second NVLink response. It is noted that the physical addresses (AS.2.1) and (AS.4.1) may refer to different memory regions within an address space, such as a GPU physical address space or an NVLink-based network address space, which may be exposed via an NVLink interface, enabling the entity to access memory resources based on the translation capabilities of the RPU.

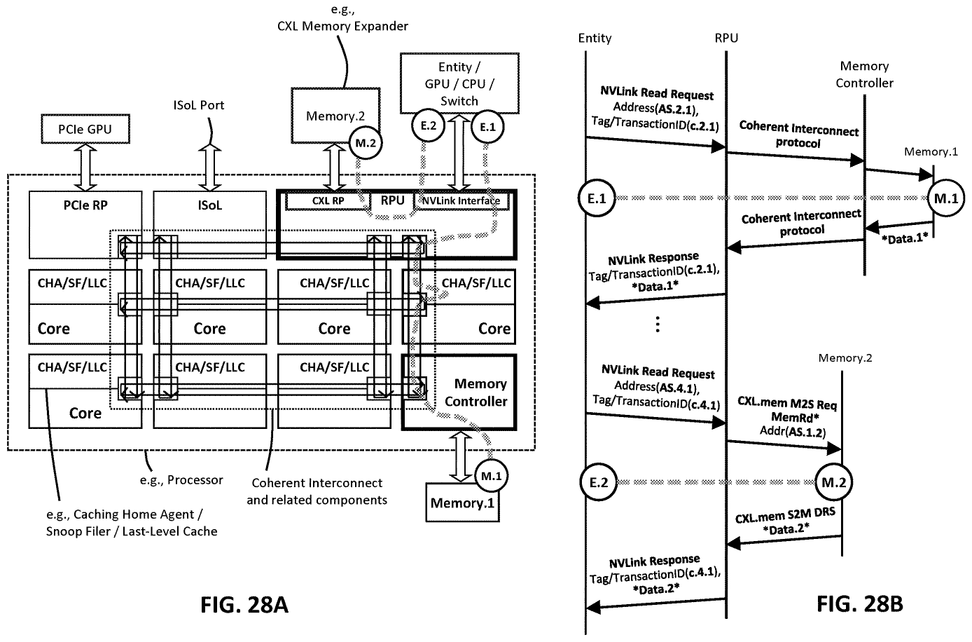

FIG. 28A illustrates an example of a system comprising a processor, including a coherent interconnect, capable of enabling an external entity, such as a GPU, CPU, or accelerator, to access memory resources mapped to an address space utilized by the coherent interconnect, such as via one or more of the two illustrated paths denoted as (E.1)-(M.1) and (E.2)-(M.2). The processor may include processing cores and CHA/SF/LLC, optionally implemented as distributed slices coupled to the coherent interconnect. The processor may further include a PCIe RP that may be coupled to a PCIe GPU, an ISoL port (e.g., utilizing NVLink-C2C, CHI C2C, or Intel Coherent Processor Interconnect Protocol (ICPIP), e.g., Intel UPI), and a Memory Controller coupled to a first memory (Memory.1). The processor includes an RPU that comprises a CXL RP, wherein the CXL RP is coupled to a second memory (Memory.2), such as a CXL Memory Expander. The RPU further includes an NVLink Interface that may communicate with the entity according to an NVLink-based protocol. The RPU may perform physical address translations to enable the entity to access the first memory (Memory.1) via the coherent interconnect, such as over path (E.1)-(M.1), and/or access the second memory (Memory.2) via the CXL RP within the RPU, such as over path (E.2)-(M.2). The illustrated RPU and NVLink Interface are coupled to the coherent interconnect, and may translate between the NVLink-based protocol and a protocol utilized by the coherent interconnect. The processor may utilize a mesh-based coherent interconnect, or other types of coherent interconnects such as a ring, a crossbar, or a Network on Chip (NoC).

FIG. 28B illustrates an example of a TFD demonstrating two NVLink requests, such as NVLink read requests, received from an entity, such as a GPU or an accelerator, processed by an RPU and forwarded, possibly using a protocol utilized by a coherent interconnect of a processor, to different memories mapped to an address space utilized by the coherent interconnect. The paths from the RPU to the different memories may traverse other components, such as CHA/SF/LLC slices, memory controllers, or in other examples traverse a home agent or a home node, optionally for resolving coherency. The RPU may perform physical address translations between first physical addresses, such as NVLink-based physical addresses, NVLink-based network addresses, or GPU physical addresses, and second physical addresses, such as Host Physical Addresses (HPAs) or System Physical Addresses (SPAs), to enable the entity to access memory resources of the processor. The processor may have multiple memory resources, such as first memory (Memory.1), which may be a DRAM coupled to a memory controller of the processor, and/or second memory (Memory.2), which may be a CXL memory expander coupled to a CXL RP of the processor, wherein the CXL RP may be included in the RPU. The RPU may further perform additional translations, such as protocol translations, between an NVLink-based protocol, such as a protocol utilizing an NVLink interconnect, and a protocol utilized by the coherent interconnect, wherein the RPU may send the optionally translated NVLink requests to the coherent interconnect, requesting reads from memory, such as from the first memory or from the second memory. Additionally or alternatively, the RPU may translate NVLink-based traffic to CXL-based traffic (e.g., CXL.mem), and send the translated NVLink traffic to the second memory via the CXL RP. In some examples, the requested data may be provided by a cache of the processor, such as by an LLC, instead of by the memory. The data may then return over the coherent interconnect to the RPU, wherein the RPU may provide an NVLink response to the requesting entity.

The TFD illustrates two exemplary transactions between the entity and the RPU, corresponding to two distinct memory read paths denoted as (E.1)-(M.1) and (E.2)-(M.2), each associated with a different physical address mapped to different memory resources. The first exemplary transaction corresponds to the memory read path denoted as (E.1)-(M.1), and may include a first NVLink request comprising Address(AS.2.1) and Tag/TransactionID(c.2.1). The Tag/TransactionID may denote a Tag, a transaction Tag, a transaction identifier, or another field or set of fields carried in NVLink requests and/or NVLink responses, which may serve to associate the NVLink responses with the NVLink requests. The RPU may translate the first NVLink request and forward the translated request via the coherent interconnect protocol, resulting in the retrieval of *Data.1* from the first memory (Memory.1) via the memory controller, wherein *Data.1* may be sent to the entity via the coherent interconnect protocol and via the RPU with the first NVLink response. The second exemplary transaction corresponds to the memory read path denoted as (E.2)-(M.2), and may include a second NVLink request comprising Address(AS.4.1) and Tag/TransactionID(c.4.1). The RPU may translate the second NVLink request to a CXL.mem M2S request comprising MemRd* and translated Address(AS.1.2), wherein the RPU may send the translated request to the second memory (Memory.2) via the CXL RP. *Data.2* is retrieved from the second memory utilizing a CXL.mem S2M DRS, and sent to the RPU via the CXL RP, wherein the RPU may send *Data.2* to the entity via the second NVLink response.

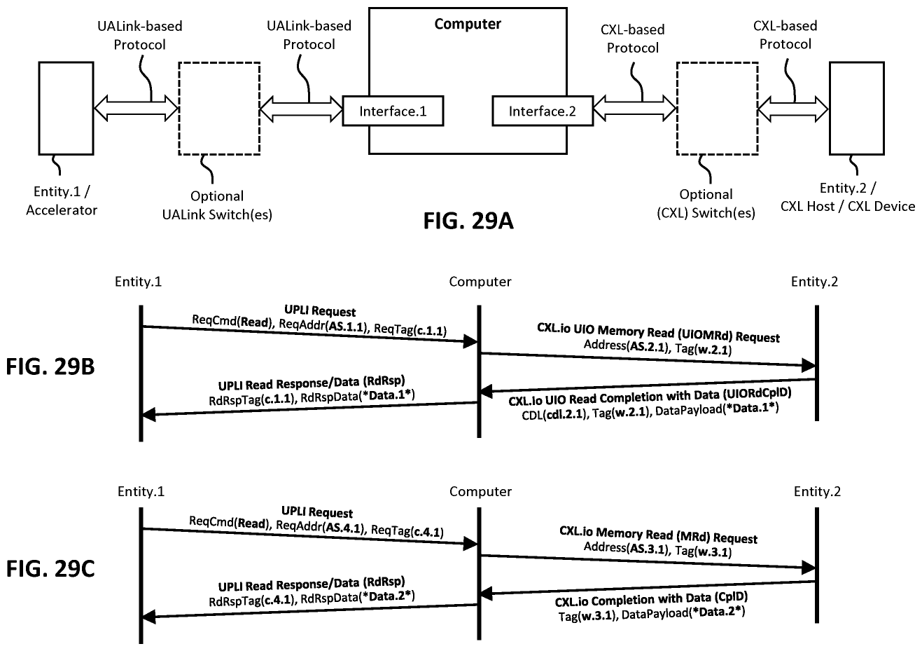

FIG. 29A illustrates an example of a system comprising a computer coupled between a first interface (Interface.1) and a second interface (Interface.2). The first interface may communicate according to a UALink-based protocol, such as UPLI, with a first entity (Entity.1), which may be an accelerator. The second interface may communicate according to a CXL-based protocol, such as CXL.io, with a second entity (Entity.2), which may be a CXL host or a CXL device. The computer may be implemented in an IC package having high-speed differential I/O balls positioned according to a ball grid array layout defined by a retimer specification, such as the PCIe 5.0, 6.0, or 7.0 Retimer Supplemental Features and Standard BGA Footprint Specification. The computer may extract physical addresses from requests received via the first interface, wherein these addresses may refer to a Network Physical Address (NPA) space utilized by the first entity. The computer may further translate these addresses, and generate requests carrying the translated physical addresses for transmission via the second interface; wherein these translated addresses may correspond to a Host Physical Address (HPA) space utilized by the second entity. Optional switches, such as UALink switch(es), may be positioned between the first interface and the first entity. Similarly, optional CXL switch(es) may be positioned between the second interface and the second entity.

FIG. 29B illustrates an example of a TFD demonstrating translations, optionally performed by a computer, between physical addresses carried in UALink-based requests, such as UPLI requests, received from a first entity (Entity.1), and physical addresses carried in CXL.io UIO TLPs sent to a second entity (Entity.2), possibly enabling the first entity to access resources mapped to an address space utilized by the second entity. The first entity may initiate a UPLI transaction that includes a UPLI request comprising ReqCmd(Read), ReqAddr(AS.1.1), and ReqTag(c.1.1). The computer may translate the UPLI transaction to a CXL.io UIO transaction that includes a CXL.io UIO Memory Read (UIOMRd) request comprising Address(AS.2.1) and Tag(w.2.1), and may send the CXL.io UIOMRd to the second entity. Upon receiving a completion from the second entity, which may include a CXL.io UIO Read Completion with Data (UIORdCplD) comprising CDL(cdl.2.1), Tag(w.2.1), and DataPayload(*Data.1*), wherein the CDL may be populated, by the CXL device (or alternatively by the CXL host), with information related to QoS, such as QoS telemetry value or values. The computer may translate the CXL.io UIORdCplD to a UPLI read response/data (RdRsp) comprising RdRspTag(c.1.1) and RdRspData(*Data.1*), and may send the UPLI RdRsp to the first entity. In some examples, the computer may issue multiple CXL.io UIO transactions in response to receiving a UPLI request from the first entity, such as when splitting a UPLI read request for a large block of data to smaller CXL.io UIO memory read requests, or when prefetching data from the second entity. The computer may translate requests or transactions initiated from the UALink-based domain to the CXL domain, may translate requests or transactions initiated from the CXL domain to the UALink-based domain, or may translate requests or transactions initiated from both the UALink-based domain and the CXL domain.

FIG. 29C illustrates an example of a TFD demonstrating translations between UALink-based requests, such as UPLI requests, received from a first entity (Entity.1), such as an accelerator, and CXL.io TLPs sent to a second entity (Entity.2), such as a CXL host or a CXL device, possibly enabling the first entity to access resources mapped to an address space utilized by the second entity. The first entity may initiate a UPLI transaction that includes a UPLI request comprising Request Command (e.g. ReqCmd(Read)), Request Address (e.g., ReqAddr(AS.4.1)), and Request Tag (e.g., ReqTag(c.4.1)). The computer may translate the UPLI transaction to a CXL transaction that includes a CXL.io Memory Read (MRd) request comprising Address(AS.3.1) and Tag(w.3.1), and may send the CXL.io MRd to the second entity. Upon receiving a completion from the second entity, which may include a CXL.io Completion with Data (CplD) comprising Tag(w.3.1) and DataPayload(*Data.2*), the computer may translate the CXL.io CplD to a UPLI RdRsp comprising Read Response Transaction Tag (e.g., RdRspTag(c.4.1)) and Read Response Data (e.g., RdRspData(*Data.2*)), and send the UPLI RdRsp to the first entity. The computer may perform further translations, such as protocol translations, opcode translations, command translations, TLP type translations, and translations between messages conforming to the UALink-based protocol (e.g., UPLI messages) and protocol data units (PDUs) of the CXL-based Protocol (e.g., CXL.io TLPs), Tag translations, traffic class (TC) translations, and/or cross-field translations. The computer may maintain tracking between Tags associated with the UALink-based protocol and Tags associated with the CXL-based protocol, such as in order to associate responses with their corresponding requests. In some examples, the computer may issue multiple CXL transactions in response to receiving a UPLI request from the first entity, such as when splitting a UPLI read request for a large block of data to smaller CXL.io memory read requests, or when prefetching data from the second entity. Moreover, the computer may translate requests or transactions initiated from the UALink-based domain to the CXL domain, may translate requests or transactions initiated from the CXL domain to the UALink-based domain, or may translate requests or transactions initiated from both the UALink-based domain and the CXL domain.

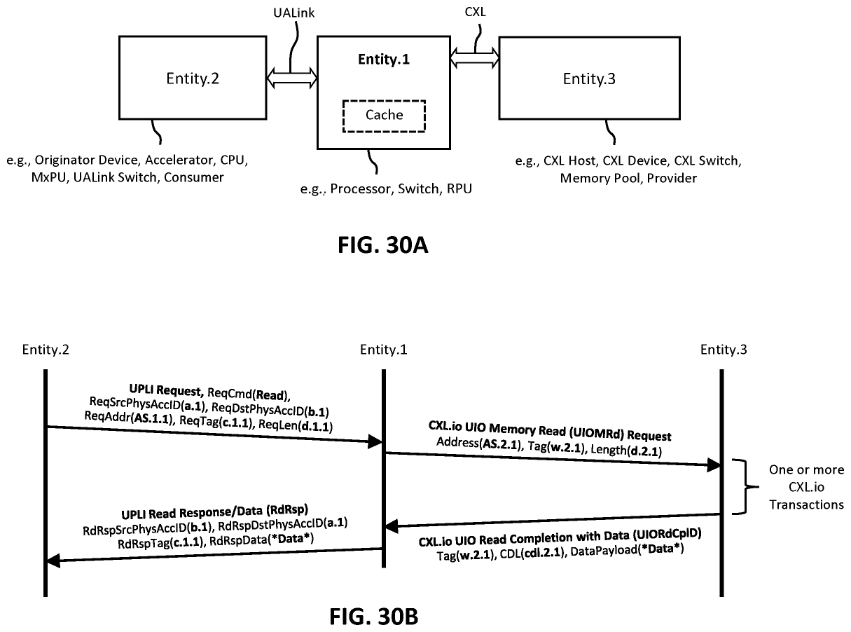

FIG. 30A illustrates an example of a system comprising a first entity (Entity.1), such as a processor, a switch, or an RPU, optionally comprising a cache, which enables UALink-based resource consumers to access resources coupled to the first entity, such as CXL hosts, CXL devices, or CXL memory. The first entity is coupled to a second entity (Entity.2), which may be a UALink-based originator device, an accelerator, a GPU, a CPU, an MxPU, a UALink switch, or a consumer, wherein the first entity may communicate with the second entity according to a UALink-based protocol, such as a UPLI. The first entity is further coupled to a third entity (Entity.3), which may be a CXL host, a CXL device, a CXL switch, a CXL-based memory pool, CXL memory, or a provider, wherein the first entity may communicate with the third entity according to a CXL-based protocol, such as at least one of CXL.io, CXL.mem, or CXL.cache. In some examples, the UALink-based protocol, such as UPLI, may be associated with a first address space, such as an NPA space, and the CXL-based protocol, such as CXL.io, may be associated with a second address space, such as a System Physical Address (SPA) space or a Host Physical Address (HPA) space; wherein the first entity may perform address translations between addresses within the first and second address spaces, respectively, such as between addresses within the NPA space and addresses within the SPA space or the HPA space.

In other examples, the UALink-based protocol, such as UPLI, and the CXL-based protocol, such as CXL.io, may be associated with the same physical address space, such as a global address space, a pod address space, or a fabric address space; wherein the first entity may perform address translations between addresses within the same address spaces. The first entity may perform further translations, such as opcode, command, or TLP translations, e.g., translating between Read commands in UPLI requests and MRd/UIOMRd TLPs in CXL.io requests. The first entity may further translate between messages conforming to UPLI and messages conforming to CXL, translate Tags, and/or translate error indications, such as data corruption indications or poison.

FIG. 30B illustrates an example of a TFD demonstrating a first entity (Entity.1), such as a processor, a switch, or an RPU, that may translate between UALink-based traffic, such as UPLI traffic, and CXL-based traffic, such as CXL.io traffic. Additionally or alternatively, the first entity, may translate between UPLI and CXL.mem traffic, and/or between UPLI and CXL.cache traffic. The first entity may receive from a second entity (Entity.2), which may be a UALink-based originator device, an accelerator, a GPU, a CPU, an MxPU, a UALink switch, or a consumer, a UALink UPLI transaction that may include a UPLI request comprising Request Command (e.g. ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)). The first entity may translate the UPLI transaction to a CXL.io transaction that may include CXL.io Memory Read (MRd) request or CXL.io UIO Memory Read (UIOMRd) request comprising Address(AS.2.1), Tag(w.2.1), and Length(d.2.1). Alternatively or additionally, the first entity may translate the UPLI transaction to a PCIe transaction that may include a PCIe MRd TLP or a PCIe UIOMRd TLP. The first entity may further translate between other fields of the UPLI transaction and fields of the CXL.io transaction, such as between addresses, Tags, QoS-related fields, or identifications (IDs), which may serve to route the UPLI request to its destination. In some examples, the first entity may translate a UPLI transaction to multiple CXL.io transaction, such as in order to split a large data read request (e.g., splitting a large 256 B UPLI read request to smaller 64 B CXL.io read requests), or in order to prefetch data, optionally into a cache that may be included in or coupled to the first entity.

The first entity (Entity.1) may further translate between CXL.io responses or completions, such as CXL.io Completion with Data (CplD) or CXL.io UIO Read Completion with Data (UIORdCplD), and UPLI responses, such as UPLI read responses, and may forward data carried in CXL.io completions into UPLI read responses. Alternatively or additionally, the first entity may further translate between PCIe responses or completions, such as a PCIe CplD TLP or a PCIe UIORdCplD TLP, and UPLI responses, such as UPLI read responses, and may forward data carried in PCIe completions into UPLI read responses. In some examples, upon receiving a response from the second entity, that may include a CXL.io UIORdCplD comprising Tag(w.2.1), CDL(cdl.2.1), and DataPayload(*Data*), the first entity may translate the CXL.io UIORdCplD to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), and Read Response Data (e.g., RdRspData(*Data*)). The CDL that may be included in the CXL.io UIORdCplD may be populated with information related to Quality-of-Service (QoS), such as QoS telemetry value or values. The first entity may translate information carried in the CDL and send it via one or more fields of the UPLI RdRsp, such as vendor-defined fields, custom fields, or reserved fields.

In some examples, the first entity (Entity.1) may accumulate data from one or more CXL.io TLPs, such as CplD TLPs or UIORdCplD TLPs, before sending the data via the UPLI read response. Optionally, the first entity may propagate error responses from the CXL domain to the UPLI domain, such as by translating error indications carried in CXL.io TLPs, such as poison, to error indications carried in UPLI RdRsp messages, such as Read Response Data Error (e.g., RdRspDataError). In some examples, the CXL protocol may support error forwarding (that may also be known as data poisoning), via indications such as an Error Poisoned (EP) bit in TLPs, or additionally, in some examples, through the use of Physical Layer Logical Block mechanisms.

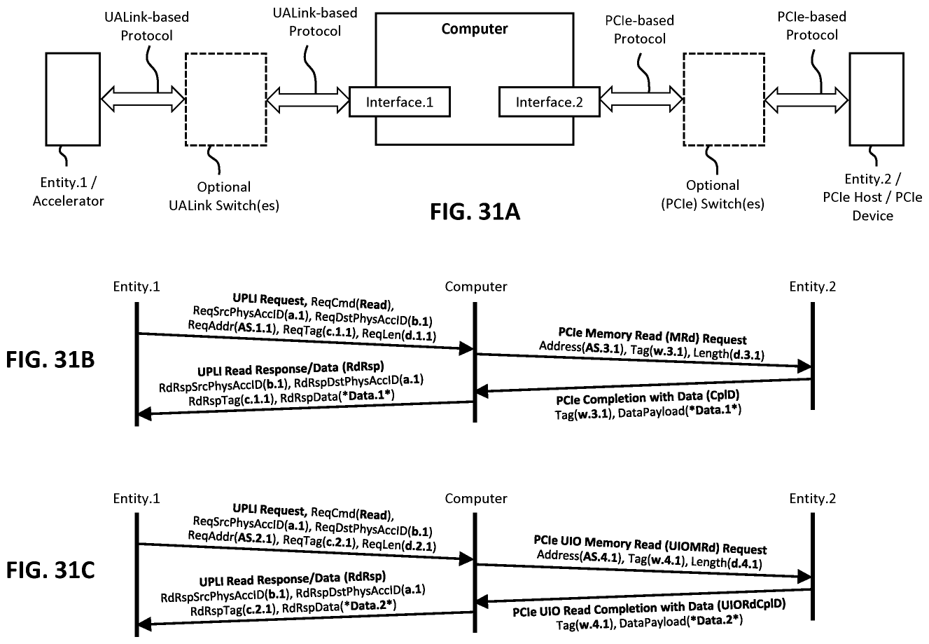

FIG. 31A illustrates an example of a system comprising a computer coupled between first and second interfaces. The first interface (Interface.1) may communicate according to a UALink-based protocol, such as UPLI, with a first entity (Entity.1), which may be an accelerator. The second interface (Interface.2) may communicate according to a PCIe-based protocol, such as a protocol conforming to PCI Express Base Specification Revision 6.2, with a second entity (Entity.2), which may be a PCIe host or a PCIe device. The computer may be implemented in an IC package having high-speed differential I/O balls positioned according to a ball grid array layout defined by a retimer specification, such as the PCIe 5.0, 6.0, or 7.0 Retimer Supplemental Features and Standard BGA Footprint Specification. The computer may extract physical addresses from requests received via the first interface, wherein these addresses may refer to a Network Physical Address (NPA) space utilized by the first entity. The computer may further translate these addresses, and generate requests carrying the translated physical addresses for transmission via the second interface; wherein these translated addresses may correspond to a Host Physical Address (HPA) space utilized by the second entity. Optional switches, such as UALink switch(es), may be positioned between the first interface and the first entity. Similarly, optional PCIe switch(es) may be positioned between the second interface and the second entity.

FIG. 31B illustrates an example of a TFD demonstrating translations between UALink-based requests, such as UPLI requests, received from a first entity (Entity.1), such as an accelerator, and PCIe TLPs sent to a second entity (Entity.2), such as a PCIe host or a PCIe device, possibly enabling the first entity to access resources mapped to an address space utilized by the second entity. The first entity may initiate a UPLI transaction that includes a UPLI request (Req) comprising Request Command (e.g. ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., physical addresses, such as NPAs ReqAddr(AS.1.1)), Request Tag (e.g., ReqTag(c.1.1)), and Request Length (e.g., ReqLen(d.1.1)). The computer may translate the UPLI transaction to a PCIe transaction that includes a PCIe Memory Read (MRd) request comprising physical addresses, such as Host Physical Addresses (HPAs), Address(AS.3.1), Tag(w.3.1), and Length(d.3.1), and may send the PCIe MRd to the second entity. Upon receiving a completion from the second entity, which may include a PCIe Completion with Data (CplD) comprising Tag(w.3.1) and DataPayload(*Data.1*), the computer may translate the PCIe CplD to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), and Read Response Data (e.g., RdRspData(*Data.1*)), and send the UPLI RdRsp to the first entity.

The computer may perform further translations, such as protocol translations, opcode translations, command translations, TLP type translations, and translations between messages conforming to the UALink-based protocol (e.g., UPLI messages) and protocol data units (PDUs) of the PCIe-based Protocol (e.g., PCIe TLPs), Tag translations, traffic class (TC) translations, and/or cross-field translations. The computer may maintain tracking between Tags associated with the UALink-based protocol and Tags associated with the PCIe-based protocol, such as in order to associate responses with their corresponding requests. In some examples, the computer may issue multiple PCIe transactions in response to receiving a UPLI request from the first entity, such as when splitting a UPLI read request for a large block of data to smaller PCIe memory read requests, or when prefetching data from the second entity.

In some examples, PCIe MRd and PCIe CplD TLPs may be utilized by legacy PCIe hosts or devices, whereas recent PCIe hosts or PCIe devices may utilize PCIe UIO Memory Read (UIOMRd) request and PCIe UIO Read Completion with Data (UIORdCplD) TLPs, leveraging the PCIe Unordered IO (UIO) optional capability, that is intended to address the limitations of the PCI/PCIe fabric-based ordering rules, and enables fabrics with multiple paths between a source and destination to be supported, optionally enabling higher-bandwidth communication. The computer may translate requests or transactions initiated from the UALink-based domain to the PCIe domain, may translate requests or transactions initiated from the PCIe domain to the UALink-based domain, or may translate requests or transactions initiated from both the UALink-based domain and the PCI domain.

FIG. 31C illustrates an example of a TFD demonstrating translations between physical addresses carried in UALink-based requests, such as UPLI requests, received from a first entity (Entity.1), and physical addresses carried in PCIe UIO TLPs sent to a second entity (Entity.2), possibly enabling the first entity to access resources mapped to an address space utilized by the second entity. The first entity may initiate a UPLI transaction that includes a UPLI request (Req) comprising ReqCmd(Read), ReqSrcPhysAccID(a.1), ReqDstPhysAccID(b.1), ReqAddr(AS.2.1), ReqTag(c.2.1), and ReqLen(d.2.1). The computer may translate the UPLI transaction to a PCIe UIO transaction that includes a PCIe UIOMRd comprising Address(AS.4.1), Tag(w.4.1), and Length(d.4.1), and may send the PCIe UIOMRd to the second entity. Upon receiving a completion from the second entity, which may include a PCIe UIORdCplD comprising Tag(w.4.1) and DataPayload(*Data.2*), the computer may translate the PCIe UIORdCplD to a UPLI RdRsp comprising RdRspSrcPhysAccID(b.1), RdRspDstPhysAccID(a.1), RdRspTag(c.2.1), and RdRspData(*Data.2*), and may send the UPLI RdRsp to the first entity. In some examples, the computer may issue multiple PCIe UIO transactions in response to receiving a UPLI request from the first entity, such as when splitting a UPLI read request for a large block of data to smaller PCIe UIO memory read requests, or when prefetching data from the second entity. The computer may translate requests or transactions initiated from the UALink-based domain to the PCIe domain, may translate requests or transactions initiated from the PCIe domain to the UALink-based domain, or may translate requests or transactions initiated from both the UALink-based domain and the PCI domain.

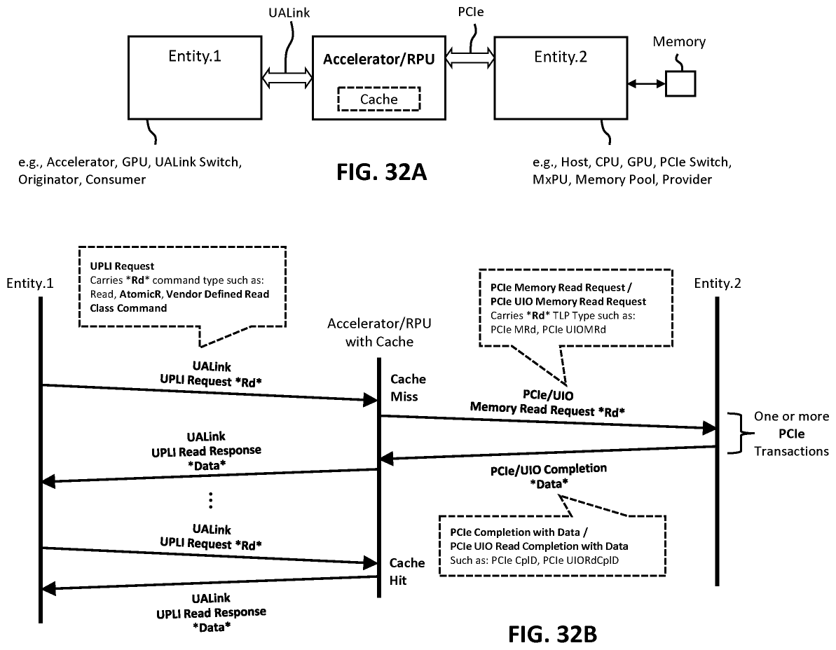

FIG. 32A illustrates an example of a system comprising an accelerator or an RPU, denoted as Accelerator/RPU, which may include a cache, wherein the Accelerator/RPU may translate between a UALink-based protocol, such as UPLI, and a PCIe-based protocol, such as a PCIe protocol. The Accelerator/RPU may be coupled to a first entity (Entity.1), which may be an accelerator, a GPU, a first processor, a UALink Switch, a UALink-based originator, or a resource consumer, wherein the Accelerator/RPU may communicate with the first entity according to a UALink-based protocol, such as UPLI. The Accelerator/RPU may be further coupled to a second entity (Entity.2), which may be a host, a CPU, a GPU, a second processor, a PCIe switch, a memory pool, or a resource provider, wherein the second entity may be coupled to a memory, and wherein the Accelerator/RPU may communicate with the second entity according to a PCIe-based protocol. The Accelerator/RPU may translate between the UALink-based protocol, such as UPLI, and the PCIe-based protocol, enabling the first entity to access resources coupled to the second entity, such as the memory.

The Accelerator/RPU may cache data retrieved from the second entity and may respond to UPLI requests received from the first entity with data from the cache, instead of issuing read requests to the second entity. Additionally or alternatively, the Accelerator/RPU may prefetch data from the second entity into the cache. The Accelerator/RPU may perform further translations between the UALink-based domain and the PCIe-based domain, such as protocol translations, e.g., UALink to PCIe or UPLI to PCIe translations. The Accelerator/RPU may further perform opcode translations, command translations, TLP translations, and translations between messages conforming to the UALink-based protocol and PDUs conforming to the PCIe-based Protocol, Tag translations, traffic class (TC) translations, and/or cross-field translations; wherein the Accelerator/RPU may maintain tracking between Tags associated with the UALink-based protocol and Tags associated with the PCIe-based protocol, such as in order to associate responses with their corresponding requests.

FIG. 32B illustrates an example of a TFD demonstrating translations performed by an accelerator or by an RPU, denoted as Accelerator/RPU, that may include a cache, between a UALink-based protocol, such as UPLI, utilized for communicating with a first entity (Entity.1), and a PCIe-based protocol, utilized for communicating with a second entity (Entity.2) that may be coupled to memory, such as DRAM, wherein the memory may be mapped to a physical address space (PAS) utilized by the Accelerator/RPU. The Accelerator/RPU may translate between the UALink-based domain and the PCIe-based domain, such as translate between messages conforming to the UALink-based protocol and messages conforming to the PCIe-based protocol, e.g., translate between UALink and PCIe, or between UPLI and PCIe. The TFD illustrates two exemplary transactions between the first entity and the Accelerator/RPU. The first exemplary transaction may include a UPLI request that may carry a *Rd* command type, such as Read, AtomicR, or a Vendor Defined Read Class Command, wherein the Accelerator/RPU may look up the data associated with the request address in the cache before issuing a PCIe request to the second entity. The lookup of the data may result in a cache miss, wherein the Accelerator/RPU may translate the UALink UPLI request (Req) to a PCIe Memory Read request or a PCIe UIO Memory Read request that may carry a *Rd* TLP Type such as PCIe MRd or PCIe UIOMRd, wherein the Accelerator/RPU may send the PCIe/UIO memory read request to the second entity. Upon receiving a response from the second entity, which may include a PCIe Completion with Data or a PCIe UIO Read Completion with Data such as PCIe CplD or PCIe UIORdCplD, the Accelerator/RPU may translate the PCIe/UIO completion comprising *Data* (e.g., CplD TLP or UIORdCplD TLP) to a UPLI read response comprising *Data*, wherein the Accelerator/RPU may store the data retrieved from the second entity in the cache.

The second exemplary transaction may similarly include a UPLI request that may carry a *Rd* command type, such as Read, AtomicR, or a Vendor Defined Read Class Command, wherein the Accelerator/RPU may look up the data associated with the request address in the cache before issuing a PCIe request to the second entity. The lookup of the data may result in a cache hit, wherein the Accelerator/RPU may respond to the request from the first entity with a UPLI read response comprising *Data*, without sending a translated PCIe/UIO memory read request to the second entity. In some examples, the Accelerator/RPU may issue multiple PCIe transactions in response to receiving a UPLI request from the first entity, such as when splitting a UPLI read request for a large block of data to smaller PCIe/UIO memory read requests, or when prefetching data from the second entity.

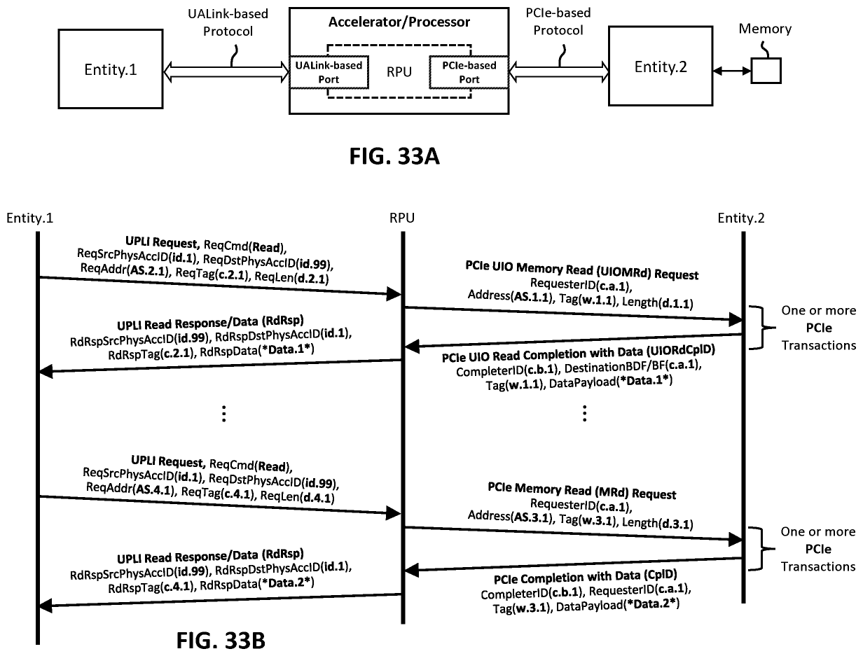

FIG. 33A illustrates an example of a system comprising an accelerator or a processor, denoted as Accelerator/Processor, which may include an RPU, and may further include a UALink-based port and a PCIe-based port, optionally coupled to or included in the RPU. The Accelerator/Processor may translate between a UALink-based protocol, such as UPLI, and a PCIe-based protocol. The Accelerator/Processor may be coupled, via the UALink-based port, to a first entity (Entity.1), which may be an accelerator, a GPU, a second processor, a UALink Switch, a UALink-based originator, or a resource consumer, wherein the Accelerator/Processor may communicate with the first entity according to a UALink-based protocol, such as UPLI. The Accelerator/Processor may be further coupled, via the PCIe-based port, to a second entity (Entity.2), which may be a host, a CPU, a GPU, a third processor, a PCIe switch, a PCIe device, a memory pool, or a resource provider, wherein the second entity may be coupled to a memory, and wherein the Accelerator/Processor may communicate with the second entity according to a PCIe-based protocol. The Accelerator/Processor may translate between the UALink-based domain and the PCIe-based domain, such as between UALink to PCIe or between UPLI to PCIe, enabling the first entity to access resources coupled to the second entity, such as the memory. The Accelerator/Processor may further perform opcode translations, command translations, TLP translations, and translations between messages conforming to the UALink-based protocol and PDUs conforming to the PCIe-based Protocol, Tag translations, traffic class (TC) translations, and/or cross-field translations; wherein the Accelerator/Processor may maintain tracking between Tags associated with the UALink-based protocol and Tags associated with the PCIe-based protocol, such as in order to associate responses with their corresponding requests.

FIG. 33B illustrates an example of a TFD demonstrating translations performed by an accelerator or by a processor, denoted as Accelerator/Processor, between UALink-based traffic, such as UPLI requests, utilized for communicating with a first entity (Entity.1), and PCIe-based traffic, utilized for communicating with a second entity (Entity.2) that may be coupled to memory, such as DRAM, wherein the memory may be mapped to a physical address space (PAS) utilized by the Accelerator/Processor. The Accelerator/Processor may include an RPU, and may translate between messages conforming to the UALink-based protocol and messages conforming to the PCIe-based protocol. The TFD illustrates two exemplary transactions between the first entity and the Accelerator/Processor. The first exemplary transaction may include a first UPLI request (Req) comprising Request Command (e.g. ReqCmd(Read)), Request Source Physical Accelerator ID (e.g., ReqSrcPhysAccID(id.1)), Request Destination Physical Accelerator ID (e.g., ReqDstPhysAccID(id.99)), Request Address (e.g., ReqAddr(AS.2.1)), Request Tag (e.g., ReqTag(c.2.1)), and Request Length (e.g., ReqLen(d.2.1)). The Accelerator/Processor may translate the first UALink UPLI request to a PCIe UIO Memory Read (UIOMRd) request, such as UIOMRd TLP, comprising RequesterID(c.a.1), Address(AS.1.1), Tag(w.1.1), and Length(d.1.1), wherein the Accelerator/Processor may send the PCIe UIOMRd to the second entity. Upon receiving a first response from the second entity, which may include a PCIe UIO Read Completion with Data (UIORdCplD), such as UIORdCplD TLP, comprising CompleterID(c.b.1), DestinationBDF/BF(c.a.1), Tag(w.1.1), and DataPayload(*Data.1*), the Accelerator/Processor may translate the PCIe UIORdCplD to a first UPLI read response/data (RdRsp) comprising Read Response Source Physical Accelerator ID (e.g., RdRspSrcPhysAccID(id.99)), Read Response Destination Physical Accelerator ID (e.g., RdRspDstPhysAccID(id.1)), Read Response Transaction Tag (e.g., RdRspTag(c.2.1)), and Read Response Data (e.g., RdRspData(*Data.1*)).

The second exemplary transaction may include a second UPLI request comprising Request Command (e.g. ReqCmd(Read)), Request Source Physical Accelerator ID (e.g., ReqSrcPhysAccID(id.1)), Request Destination Physical Accelerator ID (e.g., ReqDstPhysAccID(id.99)), Request Address (e.g., ReqAddr(AS.4.1)), Request Tag (e.g., ReqTag(c.4.1)), and Request Length (e.g., ReqLen(d.4.1)). The Accelerator/Processor may translate the second UALink UPLI request to a PCIe Memory Read (MRd) request, such as MRd TLP, comprising RequesterID(c.a.1), Address(AS.3.1), Tag(w.3.1), and Length(d.3.1), wherein the Accelerator/Processor may send the PCIe MRd to the second entity. Upon receiving a second response from the second entity, which may include a PCIe Completion with Data (CplD), such as CplD TLP, comprising CompleterID(c.b.1), RequesterID(c.a.1), Tag(w.3.1), and DataPayload(*Data.2*), the Accelerator/Processor may translate the PCIe CplD to a second UPLI RdRsp comprising Read Response Source Physical Accelerator ID (e.g., RdRspSrcPhysAccID(id.99)), Read Response Destination Physical Accelerator ID (e.g., RdRspDstPhysAccID(id.1)), Read Response Transaction Tag (e.g., RdRspTag(c.4.1)), and Read Response Data (e.g., RdRspData(*Data.2*)).

In some examples, one or more fields of the PCIe transactions such as RequesterID, CompleterID, and DestinationBDF/BF, may be set during enumeration or initialization phases of the Accelerator/Processor, or during enumeration or initialization phases of peer components coupled to the Accelerator/Processor, that may affect the PCIe topology and IDs assigned to PCIe components in the system. Additionally or alternatively, at least some of the fields in the PCIe transactions such as RequesterID, CompleterID, and DestinationBDF/BF, may be preconfigured, such as in a security-hardened system, e.g., in order to reduce the attack surface of the system. Optionally, the Accelerator/Processor may issue multiple PCIe transactions in response to receiving a UPLI request from the first entity, such as when splitting a UPLI read request for a large block of data to smaller PCIe memory read requests, or when prefetching data from the second entity.

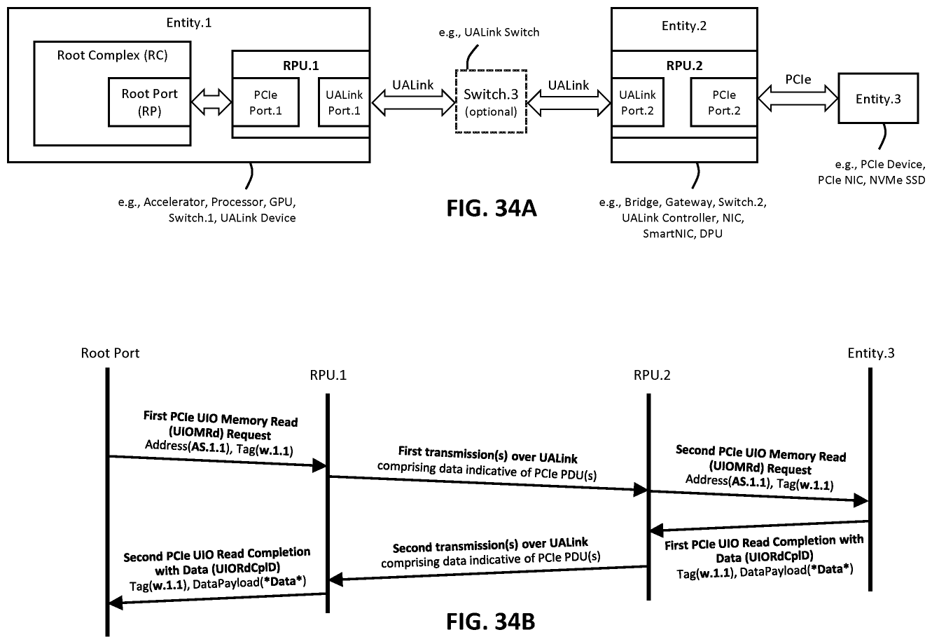

FIG. 34A illustrates an example of a system comprising a first entity (Entity.1), such as an accelerator, a processor, a GPU, a first switch (Switch.1), or a UALink device, wherein the first entity may include a Root Complex (RC) comprising a root port (RP), and may further include a first RPU (RPU.1) comprising a first PCIe port (PCIe Port.1) and a first UALink port (UALink Port.1). The system may further include an optional third switch (Switch.3), such as a UALink switch, and a second entity (Entity.2), such as a bridge, a gateway, a second switch (Switch.2), a UALink controller, a Network Interface Card (NIC), e.g., a UALink NIC, a SmartNIC, e.g., a UALink SmartNIC, or a Data Processing Unit (DPU), e.g., a UALink DPU. The second entity may include a second RPU (RPU.2) comprising a second PCIe port (PCIe Port.2) and a second UALink port (UALink Port.2). The system further includes a third entity (Entity.3), such as a PCIe device, a PCIe NIC, or an NVMe SSD. The first and second RPUs may enable the first entity to communicate with the third entity according to a PCIe-based protocol, via the second entity and optionally via the third switch, such as by translating between PCIe-based PDUs (such as PCIe TLPs, requests, messages, or flits) and transmissions comprising data indicative of PCIe PDUs, such as transmissions comprising data indicative of PCIe TLP types and physical addresses, wherein the transmissions utilize UALink PDUs (such as UPLI messages or UALink flits, e.g., TL Flits, DL Flits, or Payload Flits), which may be sent and received via the first and second UALink ports, optionally enabling the first entity to access resources of the third entity, such as registers or memory. In some examples, translating between the PCIe-based PDUs and the transmissions utilizing UALink PDUs may enable PCIe over UALink, such as via PCIe tunneling over UALink, e.g., tunneling of PCIe requests and completions over UALink, tunneling of PCIe TLPs over UALink, tunneling of PCIe-based PDUs over UALink, or tunneling of PCIe transactions over UALink.

In some examples, the first UALink port and the second UALink port may utilize the same physical layer technology, such as a physical layer based on IEEE 802.3 PMA (e.g., UALink 200 PHY based on 802.3 Ethernet PHY), or a physical layer based on PCIe (e.g., UALink 128G based on PCIe 6.3). In other examples, the first UALink port and the second UALink port may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in a UALink switch. In some examples, the first entity may be a first switch, such as a first PCIe switch comprising the first UALink port, the second entity may be a second switch, such as a second PCIe switch comprising the second UALink port, wherein the PCIe traffic between the first PCIe switch and the second PCIe switch may be tunneled over UALink, and wherein the first PCIe switch and the second PCIe switch may be coupled by a the third switch, that may be a UALink switch. In other examples, the first entity may be a first switch comprising the first PCIe Port (PCIe Port.1), the second entity may be a second switch comprising the second PCIe Port (PCIe Port.2), and the PCIe traffic between the RP and the third entity (e.g., a PCIe device) may be tunneled over UALink via the second switch and optionally via the third switch.

FIG. 34B illustrates an example of a TFD demonstrating a PCIe communication between a first entity (Entity.1), such as a processor comprising a root port (RP), and a third entity (Entity.3), such as a PCIe device, wherein the PCIe communication may be tunneled over UALink. The first entity may initiate a read from the third entity, such as by sending a first PCIe UIO Memory Read (UIOMRd) request comprising Address(AS.1.1) and Tag(w.1.1) via the RP. The first RPU (RPU.1), which may reside in the first entity, may receive the first PCIe UIOMRd and translate it to first transmission(s) comprising data indicative of PCIe PDU, such as transmission(s) comprising data indicative of TLP types and physical addresses, wherein the first RPU may send the first transmission(s) which may utilize one or more UALink PDUs (such as UPLI messages or UALink flits, e.g., TL Flits, DL Flits, or Payload Flits), to a second RPU (RPU.2), which may reside in a second entity, such as a bridge or a gateway. The first RPU may further translate the first PCIe UIOMRd to the first transmission(s) in a manner that enables reconstruction of the first PCIe UIOMRd at the second RPU with minimal (or no) modifications, effectively tunneling the first PCIe UIOMRd over UALink. For example, the first RPU may encapsulate the first PCIe UIOMRd into a UPLI write message, and send the UPLI write message to the second RPU, wherein the PCIe request may be extracted from the UPLI write message such as by decapsulation. Additionally or alternatively, the first RPU may encapsulate a PCIe flit comprising the first PCIe UIOMRd into a UPLI write message, and send the UPLI write message to the second RPU, wherein the PCIe flit comprising the first PCIe UIOMRd may be extracted from the UPLI write message such as by decapsulation.

The second RPU may receive the first transmission(s) and translate it to a second PCIe UIOMRd comprising Address(AS.1.1) and Tag(w.1.1), and send the second PCIe UIOMRd to the third entity. In some examples, the first PCIe UIOMRd and the second PCIe UIOMRd may be identical, whereas in other examples the second RPU may construct the second PCIe UIOMRd based on the first PCIe UIOMRd with variations such as utilizing a different TLP type (e.g., MRd instead of UIOMRd), utilizing a different Tag namespace, e.g., Tag(q.2.1) instead of Tag (w.1.1), or utilizing address translations, e.g., Address(AS.2.1) instead of Address(AS.1.1). The third entity may respond to the second PCIe UIOMRd by sending a first PCIe UIO Read Completion with Data (UIORdCplD) comprising Tag(w.1.1) and DataPayload(*Data*) to the second RPU, wherein the second RPU may translate the first PCIe UIORdCplD to second transmission(s) comprising data indicative of PCIe PDU, and send the second transmission(s) to the first RPU. The first RPU may further receive the second transmission(s) and translate it to a second PCIe UIORdCplD comprising Tag(w.1.1) and DataPayload(*Data*), and send the second PCIe UIORdCplD to the RP.

In some examples, the first PCIe UIORdCplD and the second PCIe UIORdCplD may be identical, whereas in other examples the first RPU may construct the second PCIe UIORdCplD based on the first PCIe UIORdCplD with variations, such as updating fields, e.g., reserved fields or fields treated as reserved, such as CDL that may represent CXL device load for QoS telemetry, where this field may be treated as reserved for use cases not covered by CXL. Additionally or alternatively, the first RPU may alter the structure of the second PCIe UIORdCplD compared to the original first PCIe UIORdCplD, such as by adding a TLP trailer, such as for supporting Transaction Layer end-to-end 32-bit CRC (ECRC) that may cover the path between the second RPU and the RP.

In some examples, the second PCIe UIOMRd may be different from the first PCIe UIOMRd due to differences in protocol revisions, such as when the first RPU communicates with the RP according to a first PCIe specification revision, whereas the second RPU communicates with the third entity according to a second PCIe specification revision (that may be different than the first PCIe specification revision), or such as when translation is required between Flit Mode (FM) and Non-Flit Mode (NFM) TLP formats. Similarly, the second PCIe UIORdCplD may be different from the first PCIe UIORdCplD due to differences in protocol revisions, or such as when translation is required between FM and NFM TLP formats. In some examples, the first RPU and the second RPU may be coupled by a switch, such as a UALink switch.

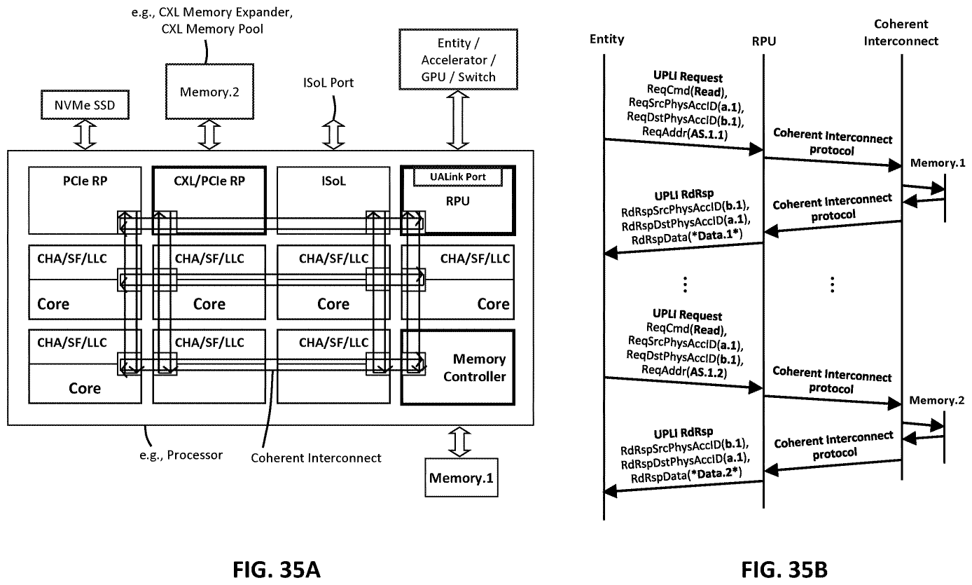

FIG. 35A illustrates an example of a system comprising a processor including a coherent interconnect, capable of enabling an external entity to access memory resources mapped to an address space utilized by the coherent interconnect. Optionally, the processor is an MxPU derived from an established processor design that may include processing cores, caching/home agent (CHA), snoop filter (SF), and LLC, optionally implemented as slices distributed across tiles on the coherent interconnect mesh. The processor may further include a memory controller that may be coupled to a first memory (Memory.1), such as DRAM, a PCIe RP that may be coupled to an NVMe SSD, a CXL/PCIe RP that may be coupled to a second memory (Memory.2), such as a CXL memory expander or a CXL-based memory pool, and an ISoL port, such as a port utilizing NVIDIA NVLink-C2C, ARM CHI C2C, or Intel Coherent Processor Interconnect Protocol (ICPIP), such as Intel UPI. The processor may further include an RPU that includes or coupled to a UALink port that may communicate with an entity, such as an accelerator, according to a UALink-based protocol, such as UPLI, wherein the RPU may perform physical address translations to enable the entity to access the first memory and/or the second memory. The illustrated RPU may be coupled to the coherent interconnect, and may translate between the UALink-based protocol and a protocol utilized by the coherent interconnect. The processor may be implemented as a monolithic die, as chiplets within an IC package, such as by utilizing separate compute die(s) and I/O die(s), or as components on a board, and may utilize a mesh-based coherent interconnect, or in other examples may utilize a ring, a crossbar, or other types of coherent interconnects.

FIG. 35B illustrates an example of a transaction flow diagram (TFD) demonstrating two UPLI requests, such as UPLI read requests, received from an entity and forwarded to different memories mapped to an address space utilized by the coherent interconnect. The RPU may perform physical address translations, such as from Network Physical Address (NPA) to Host Physical Address (HPA), to enable the entity to access the processor's memories. The processor may have multiple memory resources, such as first memory (Memory.1), which may be DRAM coupled to a memory controller of the processor, and/or second memory (Memory.2) that may be memory expanders that may be coupled to CXL RPs of the processor. The RPU may further perform additional translations, such as protocol translations from a UALink-based protocol, such as UPLI, to a protocol utilized by the coherent interconnect, and may send the optionally translated request to the coherent interconnect, requesting a read from memory. In some examples, the requested data may be provided by a processor cache, such as by an LLC, instead of by the memory. The data may then return over the coherent interconnect to the RPU, wherein the RPU provides UPLI read response/data (RdRsp) to the requesting entity. The TFD illustrates two exemplary transactions carrying different physical addresses mapped to different memory resources. The first exemplary transaction includes a UPLI request (Req) comprising physical address (AS.1.1), which may be an NPA, which the RPU translates and forwards via the coherent interconnect protocol to the first memory, resulting in the retrieval of *Data.1* that is returned to the entity with the first UPLI RdRsp. The second exemplary transaction includes a UPLI request comprising physical address (AS.1.2), which may be an NPA, which the RPU translates and forwards via the coherent interconnect protocol to the second memory, resulting in the retrieval of *Data.2* that is returned to the entity with the second UPLI RdRsp. The physical addresses (AS.1.1) and (AS.1.2) may refer to different memory regions within an NPA address space exposed via the UALink port, enabling the entity to access memory resources based on the RPU's translation capabilities.

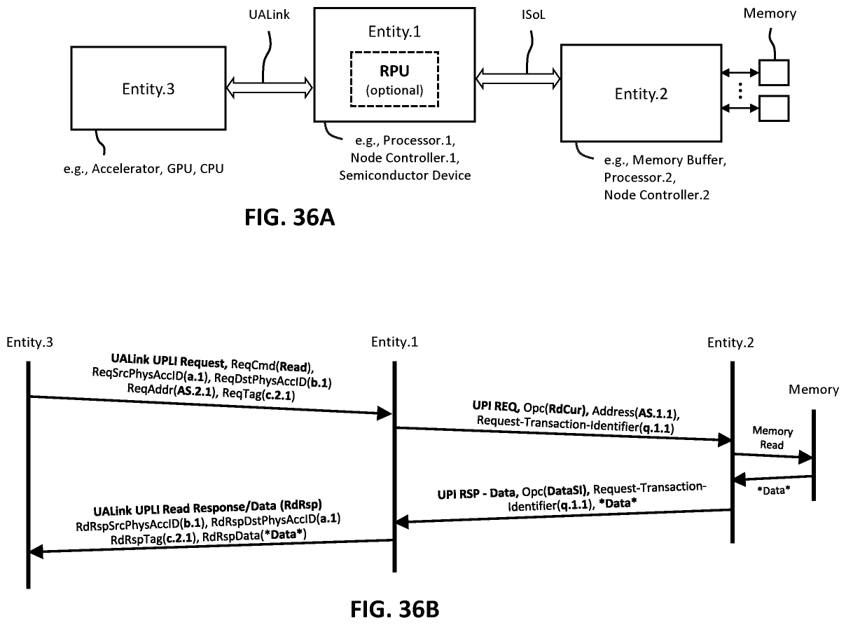

FIG. 36A illustrates an example of a system comprising a first entity (Entity.1), such as a first processor (Processor.1), a first node controller (Node Controller.1), or a semiconductor device, which may include an RPU. The first entity may be coupled to a third entity (Entity.3), which may be an accelerator, a GPU, a CPU, a UALink switch, or a UALink-based originator, wherein the first entity may communicate with the third entity according to a UALink-based protocol, such as UPLI. The first entity may be further coupled to a second entity (Entity.2), which may be a second processor (Processor.2), a memory buffer, or a second node controller (Node Controller.2), wherein the second entity may be coupled to a memory, and wherein the first entity may communicate with the second entity according to an ISoL protocol, such as ARM CHI C2C, a protocol utilizing an NVIDIA NVLink-C2C interconnect, or an Intel Coherent Processor Interconnect Protocol (ICPIP), such as Intel UPI. The first node controller (Node Controller.1) and the second node controller (Node Controller.2) may each include an ICPIP node controller, such as a UPI node controller (UNC), or an external node controller (e.g., XNC). The first entity, optionally via the RPU, may translate between the UALink-based protocol (such as UPLI) and the ISoL protocol (such as ICPIP), enabling the third entity to access resources coupled to the first entity, such as the memory that may be coupled to the second entity.

In some examples, the UALink-based protocol, such as UPLI, may be associated with a first address space, such as an NPA space, and the ISoL protocol, such as ICPIP, may be associated with a second address space, such as a System Physical Address (SPA) space or a Host Physical Address (HPA) space; wherein the first entity, optionally via the RPU, may perform address translations between addresses within the first and second address spaces, respectively, such as between addresses within the NPA space and addresses within the SPA space or the HPA space. In other examples, the UALink-based protocol, such as UPLI, and the ISoL protocol, such as ICPIP, may be associated with the same physical address space, such as with a global address space, a partitioned global address space (PGAS), a pod address space, a virtual pod address space, or a fabric address space; wherein the first entity, optionally via the RPU, may perform address translations between addresses within the same address spaces.

The first entity (Entity.1), optionally via the RPU, may perform further translations, such as opcode, command, or TLP translations, e.g., translating between commands in requests conforming to the UALink-based protocol (e.g. UPLI vendor-defined read command) to opcodes in requests conforming to the ISoL Protocol (e.g., Intel UPI RdCur opcode). The first entity, optionally via the RPU, may further translate between messages conforming to the UALink-based protocol and PDUs conforming to the ISoL Protocol, translate Tags, translate traffic class (TC), and/or perform cross-field translations. The first entity, optionally via the RPU, may maintain tracking between Tags associated with the UALink-based protocol and Tags associated with the ISoL protocol, such as in order to associate responses with their corresponding requests.

FIG. 36B illustrates an example of a TFD demonstrating translations between UALink-based traffic and ISoL traffic, such as ICPIP traffic. The translations are performed by a first entity (Entity.1), such as a first processor (Processor.1), a first node controller (Node Controller.1), or a semiconductor device, optionally via an RPU. The UALink-based protocol may be utilized for communicating with a third entity (Entity.3), such as an accelerator, and the ISoL protocol may be utilized for communicating with a second entity (Entity.2), such as a second processor (Processor.2), or a second node controller (Node Controller.2). The second entity may be coupled to memory, such as DRAM, which may be mapped to a physical address space (PAS) utilized by the first processor. The third entity may initiate a UPLI transaction that may include a UPLI request (Req) comprising Request Command (e.g., ReqCmd(Read)), Request Source Physical Accelerator ID (e.g., ReqSrcPhysAccID(a.1)), Request Destination Physical Accelerator ID (e.g., (ReqDstPhysAccID(b.1)), Request Tag (e.g., ReqTag(c.2.1)), and Request Address (e.g., ReqAddr(AS.2.1)). The first entity, optionally via the RPU, may translate the UPLI transaction to an ISoL (e.g., ICPIP) transaction, such as an Intel UPI transaction that may include a UPI request (REQ message class) comprising Opc(RdCur), Address(AS.1.1), and Request-Transaction-Identifier(q.1.1), wherein the Request-Transaction-Identifier (e.g., RTID) may denote a Tag, a transaction Tag, a transaction identifier, or another field or set of fields carried in UPI transactions which may serve to associate responses with their corresponding requests.

The first entity (Entity.1) may send the UPI request (REQ) to the second entity. Upon receiving a response from the second entity, that may include a UPI data response (“RSP-Data” message class, which may also be denoted by “RSP4-Data”) comprising Opc(DataSI), Request-Transaction-Identifier(q.1.1), and *Data*, the first entity, optionally via the RPU, may translate the UPI response (RSP-Data) to a UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.2.1)), and Read Response Data (e.g., RdRspData(*Data*)). In some examples, the requested data may be provided by a processor cache instead of by the memory, such as wherein the requested data may be provided by an LLC that may be included in the first entity, or by an LLC that may be included in the second entity. In other examples, the first entity, optionally via the RPU, may translate the UPLI transaction to an ICPIP transaction, such as an Intel UPI transaction, that may include message classes such as REQ, SNP, WB, RSP (such as RSP2 or RSP4), NCB, or NCS, that may include commands, operations, or opcodes (e.g., Opc), such as RdCode, RdCur, RdData, RdInv, RdInvOwn, SnpCode, SnpCur, SnpData, SnpInv, WbMtoS, WcWr, WcWrPtl, DataE, DataSI, or DataM_CmpO. The first entity, optionally via the RPU, may perform further translations, such as opcode, command, or TLP translations, e.g., translating between commands in requests conforming to the UALink-based protocol (e.g. UPLI vendor-defined read command) and opcodes in requests conforming to the ISoL Protocol (e.g., Intel UPI RdCur).

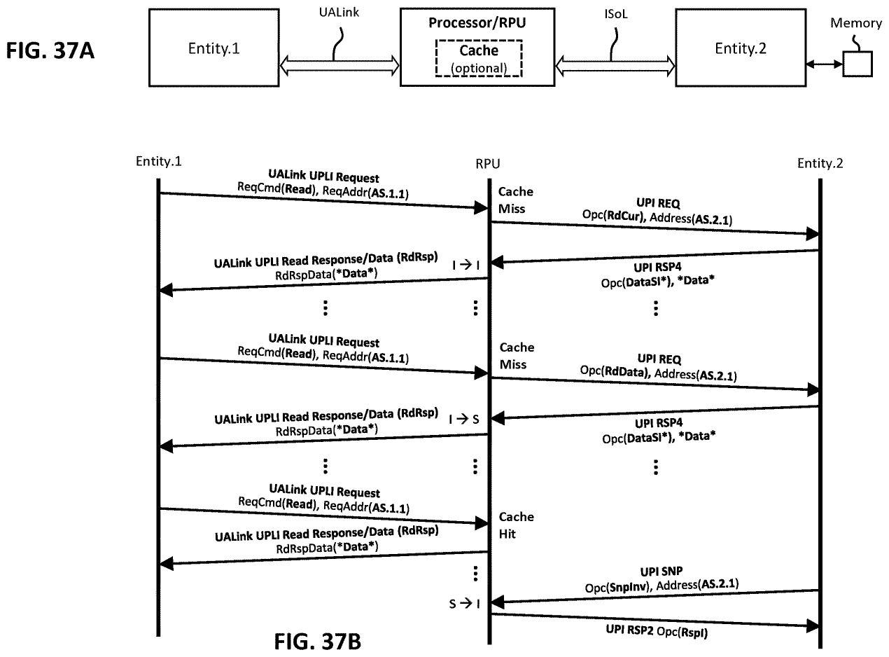

FIG. 37A illustrates an example of a system comprising a processor or an RPU, denoted as Processor/RPU, which may include a cache. The Processor/RPU may be coupled to a first entity (Entity.1), which may be an accelerator, a GPU, a second processor, a UALink Switch, or a resource consumer, wherein the Processor/RPU may communicate with the first entity according to a UALink-based protocol, such as UPLI. The Processor/RPU may be further coupled to a second entity (Entity.2), which may be a third processor, a node controller, or a memory buffer, wherein the second entity may be coupled to a memory, and wherein the Processor/RPU may communicate with the second entity according to an ISoL protocol, such as NVIDIA NVLink-C2C, ARM CHI C2C, or Intel Coherent Processor Interconnect Protocol (ICPIP), such as Intel UPI. The Processor/RPU may translate between the UALink-based protocol, such as UPLI, and the ISoL protocol, such as ICPIP, enabling the first entity to access resources coupled to the second entity, such as the memory. The Processor/RPU may cache data retrieved from the second entity and may respond to UPLI requests received from the first entity with data from the cache, instead of issuing read requests to the second entity. Additionally or alternatively, the Processor/RPU may prefetch data from the second entity into the cache. Moreover, the Processor/RPU may perform further translations between the UALink-based domain and the ISoL domain, such as protocol translations, address translations, opcode translations, command translations, TLP translations, and translations between messages conforming to the UALink-based protocol and PDUs conforming to the ISoL Protocol, Tag translations, traffic class (TC) translations, and/or cross-field translations. The Processor/RPU may maintain tracking between Tags associated with the UALink-based protocol and Tags associated with the ISoL protocol, such as in order to associate responses with their corresponding requests.

FIG. 37B illustrates an example of a TFD demonstrating translations performed by a processor or an RPU, denoted as Processor/RPU, that may include a cache, between UALink-based traffic, such as UPLI traffic, utilized for communicating with a first entity (Entity.1), and ISoL traffic, such as ICPIP traffic, utilized for communicating with a second entity (Entity.2) that may be coupled to memory, such as DRAM, wherein the memory may be mapped to a physical address space (PAS) utilized by the Processor/RPU. The Processor/RPU may translate between the UALink-based domain and the ISoL domain, such as translate between messages conforming to the UALink-based protocol (e.g., UPLI) and messages conforming to the ISoL protocol (e.g., Intel UPI). The TFD illustrates three exemplary transactions between the first entity and the Processor/RPU. The first exemplary transaction may include UALink UPLI request (Req) comprising ReqCmd(Read) and ReqAddr(AS.1.1), wherein the Processor/RPU may translate the request address (AS.1.1) to a translated address (AS.2.1) and may look up the data associated with the address and/or with the translated address in the cache before issuing a UPI request to the second entity. The lookup of the data may result in a cache miss, wherein the Processor/RPU may translate the UALink UPLI request to UPI REQ comprising Opc(RdCur) and Address(AS.2.1), wherein the Processor/RPU may send the UPI REQ to the second entity. Upon receiving a response from the second entity, which may include UPI RSP4 comprising Opc(DataSI*) and *Data*, the Processor/RPU may translate the UPI RSP4 to a UALink UPLI read response/data (RdRsp) comprising RdRspData(*Data*), without storing the data retrieved from the second entity in the cache, denoted in the drawing by “I-to-I”, indicating that the cache state associated with the cacheline address remains invalid.

The second exemplary transaction may include UALink UPLI request comprising ReqCmd(Read) and ReqAddr(AS.1.1), referencing the same address as the first exemplary transaction, wherein the Processor/RPU may translate the request address (AS.1.1) to a translated address (AS.2.1) and may look up the data associated with the address and/or with the translated address in the cache before issuing a UPI request to the second entity. The lookup of the data may result in a cache miss, wherein the Processor/RPU may translate the UALink UPLI request to UPI REQ comprising Opc(RdData) and Address(AS.2.1), wherein the Processor/RPU may send the UPI REQ to the second entity. Upon receiving a response from the second entity, which may include UPI RSP4 comprising Opc(DataSI*) and *Data*, the Processor/RPU may translate the UPI RSP4 to a UALink UPLI RdRsp comprising RdRspData(*Data*), and may store the data retrieved from the second entity in the cache, denoted in the drawing by “I-to-S”, indicating that the cache state associated with the cacheline address transitioned from invalid to shared, possibly indicating that the cacheline data is shared between the Processor/RPU and the second entity.

The third exemplary transaction may include UALink UPLI request comprising ReqCmd(Read) and ReqAddr(AS.1.1), referencing the same address as the first and the second transaction, wherein the Processor/RPU may translate the request address (AS.1.1) to a translated address (AS.2.1) and may look up the data associated with the address and/or with the translated address in the cache before issuing a UPI request to the second entity. The lookup of the data may result in a cache hit, wherein the Processor/RPU may respond to the request from the first entity with UALink UPLI RdRsp comprising RdRspData(*Data*) from the cache, without sending a translated UPI REQ to the second entity. Following the third transaction, the second entity may invalidate the cacheline address (AS.2.1) associated with the UPI domain, which may be stored in the Processor/RPU cache. The second entity may send to the Processor/RPU a UPI SNP comprising Opc(SnpInv) and Address(AS.2.1), wherein the Processor/RPU may respond to the UPI SNP by sending to the second entity a UPI RSP (e.g., UPI RSP2) comprising Opc(RspI), indicating that the Processor/RPU invalidated the associated cacheline address from the cache, denoted in the drawing by “S-to-I”, indicating that the cache state associated with the cacheline address transitioned from shared to invalid.

In some examples, the Processor/RPU may perform cache lookups before performing translations related to the UPLI request received from the first entity, or may perform cache lookups after performing some or all of the translations related to the UPLI request received from the first entity. In some examples, the Processor/RPU may further organize the cache and perform cache lookups according to addresses associated with the UALink-based domain (e.g., UPLI domain). Additionally or alternatively, the Processor/RPU may further organize the cache and perform cache lookups according to translated addresses associated with the ISoL domain (e.g., UPI domain).

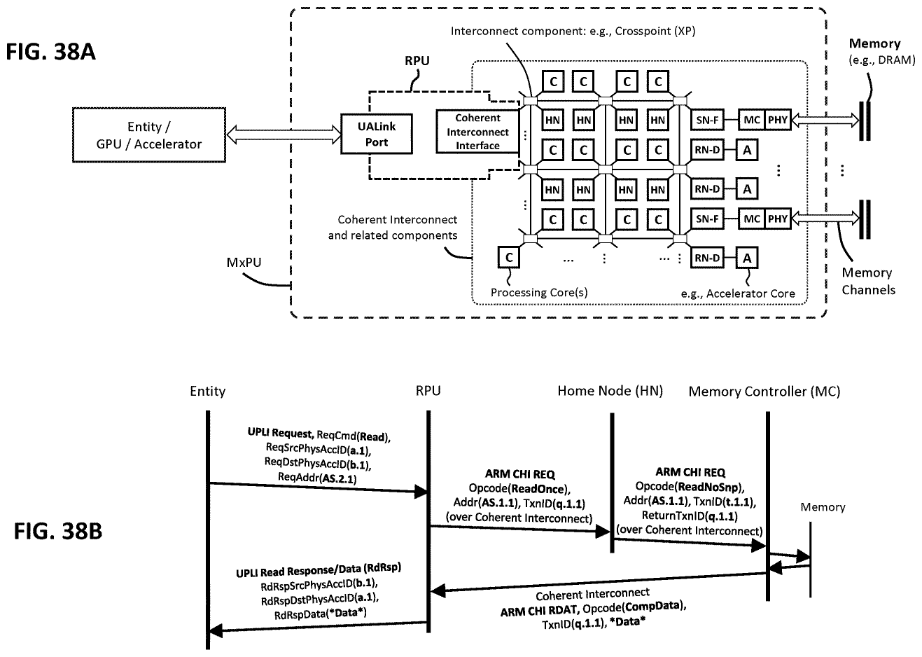

FIG. 38A illustrates an example of a system where an entity, such as a GPU or accelerator, communicates via a UALink port included in an RPU that further includes a Coherent Interconnect Interface that may utilize a protocol based on ARM CHI. The Coherent Interconnect Interface couples the RPU to an interconnect component, such as a crosspoint (XP), within a coherent interconnect. The Coherent Interconnect Interface performs the applicable protocol conversions between a UALink domain and a coherent interconnect domain, such as between UPLI and ARM CHI, enabling the entity to access memory and other resources coupled to the coherent interconnect. The coherent interconnect may be implemented as a mesh topology connecting various components including processing cores, home nodes (HN), memory controllers (MC), and accelerator cores.

FIG. 38B illustrates an example of a TFD showing address translation between UALink UPLI and CHI. An entity, such as a GPU, initiates a UPLI request comprising a physical address (AS.2.1), which the RPU translates to a CHI request carrying ReadOnce with a translated physical address (AS.1.1). The transaction flows through the coherent interconnect via a home node to a memory controller, which retrieves the data and returns it, through the coherent interconnect, to the RPU that translates the response back to the UPLI domain for delivery to the requesting entity.

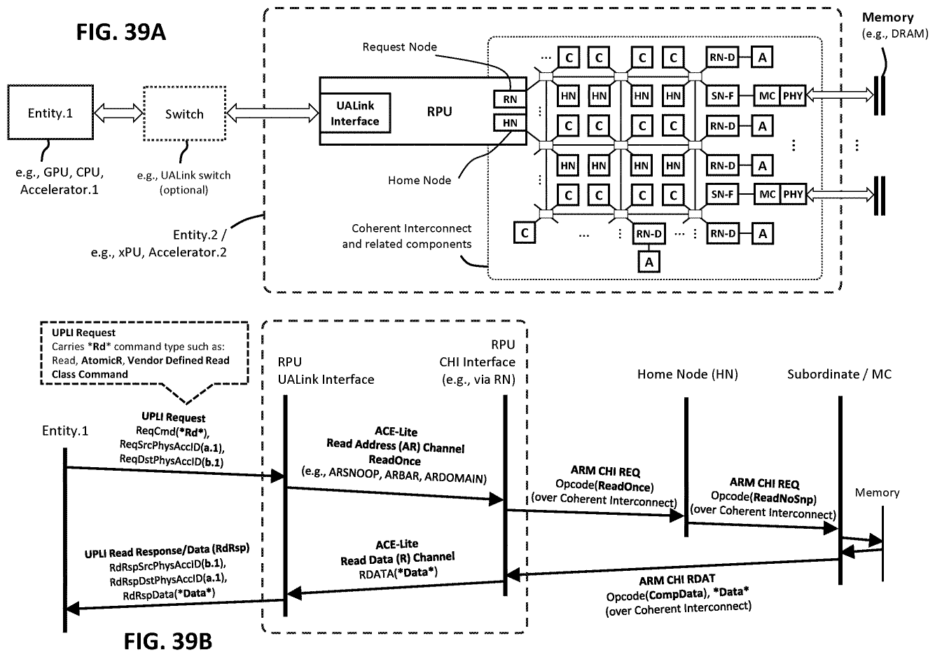

FIG. 39A illustrates an example of a system that translates between UALink-based traffic and CHI-based traffic. The system may include a first entity (Entity.1), such as a GPU, a CPU, or a first accelerator (Accelerator.1), which may be coupled to an RPU comprising a UALink port. The UALink port may be coupled to a coherent interconnect, such as a CHI-based coherent interconnect, via an interconnect component, such as a crosspoint (XP). The RPU may include request nodes (e.g., RNs), such as I/O-coherent RN-I nodes and/or RN-D, and/or home nodes (e.g., HNs), such as non-coherent HN-I nodes. This example may enable the first entity to access resources, such as memory, coupled to the coherent interconnect, utilizing appropriate translations and routing, such as by an RPU that translates between UALink traffic utilized by the first entity, and CHI traffic traveling via a crosspoint (XP) component of the coherent interconnect, wherein a request node or a home node provides the CHI interface for connecting to the XP. An optional switch, such as a UALink switch, may reside between the first entity and the UALink interface. In some examples, the coherent interconnect and the UALink port may be included within a second entity (Entity.2), such as an xPU or a second accelerator (Accelerator.2).

FIG. 39B illustrates an example of an RPU that translates between UALink-based traffic and CHI traffic, optionally utilizing an intermediate protocol based on ARM Advanced Microcontroller Bus Architecture (AMBA) Advance Extensible Interface (AXI) Coherency Extensions Lite (ACE-Lite). A first entity (Entity.1), such as a GPU, a CPU, or an accelerator, may issue a UPLI request (Req) comprising ReqCmd(*Rd*), ReqSrcPhysAccID(a.1), and ReqDstPhysAccID(b.1), wherein *Rd* denotes a read command type such as Read, AtomicR, or Vendor Defined Read Class Command. The RPU may receive the UPLI request (Req) via a UALink interface, and may process and translate the UPLI request (Req) to an intermediate transaction, such as ACE-Lite ReadOnce transaction, that may be encoded using a combination of ARSNOOP, ARBAR, and ARDOMAIN signals, wherein the ACE-Lite ReadOnce transaction may be carried on Read Address (AR) Channel. The RPU may process and send the ACE-Lite transaction to a CHI interface of the RPU that may be coupled to a coherent interconnect, optionally via a request node (e.g., RN), that may provide the CHI interface for connecting to the coherent interconnect, and may translate the ACE-Lite transaction to a first CHI request, such as CHI REQ comprising Opcode(ReadOnce) destined to a home node (e.g., HN). The home node may process the first CHI REQ (ReadOnce) and may issue a second CHI REQ comprising Opcode(ReadNoSnp) destined to a memory controller (MC) for servicing the original UPLI request received from the first entity via the UALink interface.

The memory controller may read the requested data from memory, and may respond with CHI RDAT comprising Opcode(CompData) and *Data*, sending the requested data via the coherent interconnect to the CHI interface of the RPU, wherein the RPU may further process and translate the CHI RDAT to an intermediate ACE-Lite RDATA comprising the *Data*, that may be carried on Read Data (R) channel. The RPU may further process and translate the ACE-Lite RDATA to a UPLI read response/data (RdRsp) comprising RdRspSrcPhysAccID(b.1), RdRspDstPhysAccID(a.1), and RdRspData(*Data*), and may send the UPLI read response/data (RdRsp) to the first entity. The RPU may further translate physical addresses associated with the UALink-based traffic, such as Network Physical Addresses (NPAs), to physical addresses associated with the CHI traffic. In some examples, the coherent interconnect and the UALink port may be included within a second entity (Entity.2), such as an xPU or a second accelerator (Accelerator.2).

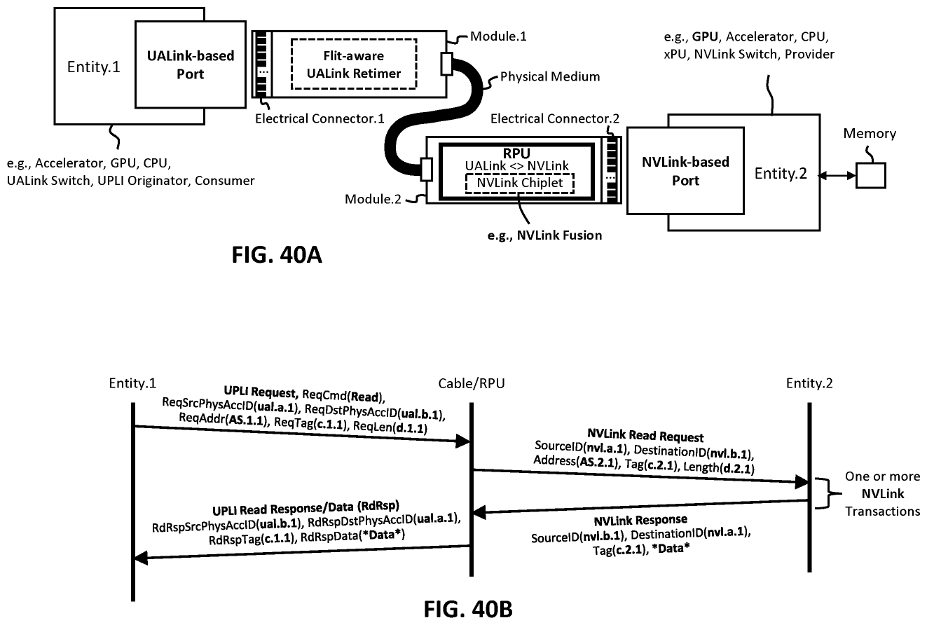

FIG. 40A illustrates an example of a system comprising a cable, referred to as Cable/RPU, which may translate between UALink-based requests and NVLink-based requests. The Cable/RPU enables a first entity (Entity.1), which may be an accelerator, a GPU, a CPU, a UALink switch, a UPLI originator, or a resource consumer, to access, via a UALink-based port, via the Cable/RPU, and via an NVLink-based interface, resources, such as memory, coupled to a second entity (Entity.2), which may be a GPU, an accelerator, a CPU, an xPU, an NVLink switch, an NVSwitch, or a resource provider. The Cable/RPU, which may include an RPU, may communicate with the first entity according to a UALink-based protocol, and may communicate with the second entity according to an NVLink-based protocol. In some examples, messages conforming to the UALink-based protocol, such as UPLI, may be associated with a first address space, such as an NPA space; and messages conforming to the NVLink-based protocol may be associated with a second address space, such as an NVLink-based address space or an NVLink-based network address space; wherein the Cable/RPU may perform address translations between addresses within the first and second address spaces, respectively, such as between addresses within the NPA space and addresses within the NVLink-based network address space. In other examples, the UALink-based protocol, such as UPLI, and the NVLink-based protocol, may be associated with the same address space, such as an NVLink-based common address space, a global address space, a pod address space, or a fabric address space; wherein the Cable/RPU may perform address translations between addresses within the same common address spaces.

The Cable/RPU may perform further translations, such as protocol translations, opcode translations, command translations, or TLP translations, e.g., translating between commands in UPLI requests and request types utilized by the NVLink-based protocol. The Cable/RPU may further translate between messages conforming to the UALink-based protocol and PDUs conforming to the NVLink-based protocol, translate Tags, and/or translate error indications, such as data corruption indications or poison. In some examples, the Cable/RPU may further include a first module (Module.1), which may include a flit-aware UALink retimer, and may further include a second module (Module.2), which may include the RPU, optionally comprising an NVLink chiplet, such as NVLink Fusion. In some examples, the Cable/RPU may be coupled to the UALink-based port via a first electrical connector (Electrical Connector.1) and may be further coupled to the NVLink-based interface via a second electrical connector (Electrical Connector.2). Whereas in other examples, the Cable/RPU may be coupled to the UALink-based port and/or the NVlink-based interface via optical connectors. The Cable/RPU may further include a physical medium that may include a copper wire or an optical fiber.

FIG. 40B illustrates an example of a transaction flow diagram (TFD) demonstrating translations performed by a cable, denoted as Cable/RPU, between a UALink-based protocol utilized for communicating with a first entity (Entity.1), such as UALink switch, and an NVLink-based protocol utilized for communicating with a second entity (Entity.2), such as an NVLink switch. The first entity may initiate a UPLI transaction that may include a UPLI request comprising Request Command (e.g., ReqCmd(Read)), Request Source Physical Accelerator ID (e.g., ReqSrcPhysAccID(ual.a.1)), Request Destination Physical Accelerator ID (e.g., (ReqDstPhysAccID(ual.b.1)), Request Address (e.g., ReqAddr(AS.1.1)), Request Tag (e.g., ReqTag(c.1.1)), and Request Length (e.g., ReqLen(d.1.1)). The Cable/RPU, which may include an RPU, may translate the UPLI request to an NVLink request or an NVLink read request that may include SourceID(nvl.a.1), such as source GPU ID, DestinationID(nvl.b.1), such as destination GPU ID, Address(AS.2.1), such as a network address or a GPU physical address, Tag(c.2.1), and Length(d.2.1), wherein the Cable/RPU may send the NVLink request to the second entity. Upon receiving a response from the second entity, that may include an NVLink response that may include SourceID(nvl.b.1), such as source GPU ID, DestinationID(nvl.a.1), such as destination GPU ID, Tag(c.2.1), and *Data*, the Cable/RPU may translate the NVLink response to a UPLI read response/data (RdRsp) comprising Read Response Source Physical Accelerator ID (e.g., RdRspSrcPhysAccID(ual.b.1)), Read Response Destination Physical Accelerator ID (e.g., RdRspDstPhysAccID(ual.a.1)), Read Response Transaction Tag (e.g., RdRspTag(c.1.1)), and Read Response Data (e.g., RdRspData(*Data*)). In some examples, the Cable/RPU may issue multiple NVLink requests in response to receiving a UPLI request from the first entity, such as when splitting a UPLI request for a large block of data to smaller NVLink requests, or when prefetching data from the second entity.

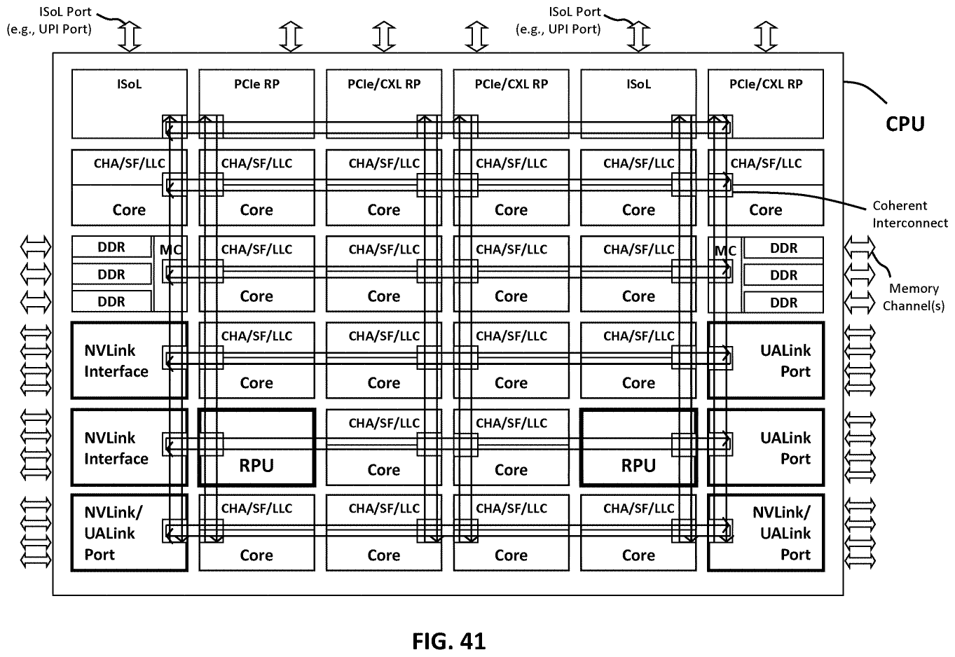

FIG. 41 illustrates an example of a processor, such as a CPU, comprising a coherent interconnect, processing cores, caching/home agent (CHA), snoop filter (SF), and last-level cache (LLC), optionally implemented as slices distributed across tiles on the coherent interconnect mesh. The processor may further include ISoL ports (such as ports utilizing Intel Coherent Processor Interconnect Protocol (ICPIP), e.g., UPI ports), one or more PCIe RPs, CXL/PCIe RPs, and memory controllers that may be coupled to memory such as DRAM. The processor may further include one or more RPUs, NVLink interfaces and/or UALink ports, wherein the RPUs may perform physical address translations to enable external entities (not shown in the figure), such as GPUs and accelerators, to access the memory. The illustrated RPUs may be coupled to the coherent interconnect, and may translate between an NVLink-based protocol or a UALink-based protocol and a protocol utilized by the coherent interconnect. Optionally, the RPUs may further enable the processing cores to access resources exposed by the external entities, such as HBM and/or HBF resources. In some examples, the processor may further include one or more multi-protocol ports, such as NVLink/UALink ports, which may be configured, either independently or as a group of ports, to communicate according to an NVLink-based protocol or according to a UALink-based protocol, utilizing a physical layer (PHY) such as an Ethernet-based PHY or a PHY based on IEEE 802.3 PMA. The processor may be implemented as a monolithic die, as chiplets within an IC package, such as by utilizing separate compute die(s) and I/O die(s), or as components on a board. In other examples, the NVLink interface may reside on a separate chiplet, such as NVLink Fusion, and may be coupled to the coherent interconnect via a UCIe interface or a proprietary chip-to-chip or die-to-die interface.

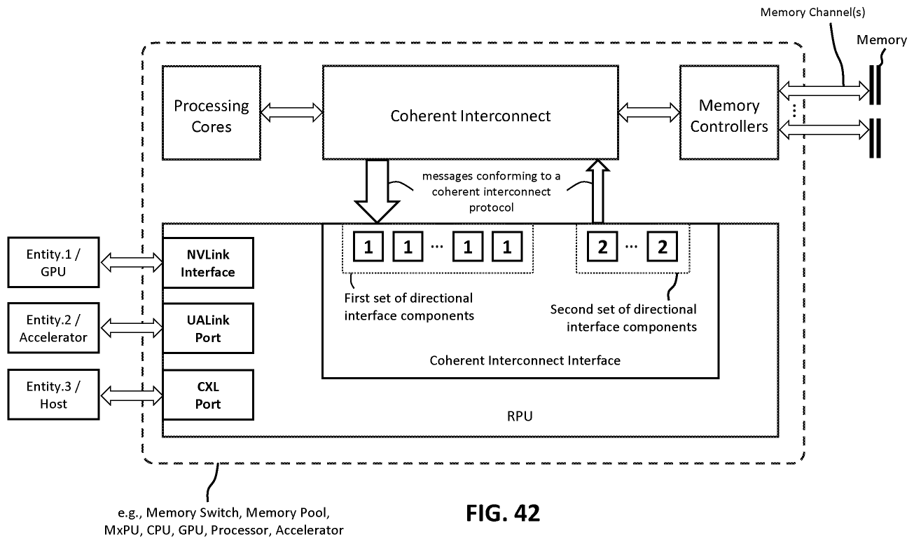

FIG. 42 illustrates an example of a system demonstrating asymmetric bandwidth configuration between an RPU and a coherent interconnect, wherein the RPU includes a first set of interface components (denoted ‘1’) for one direction of traffic flow, and a second set of interface components (denoted ‘2’) for another direction of traffic flow. The unequal number of interface components between the two sets creates an asymmetric bandwidth characteristic that may be optimized for specific workload patterns, wherein the interface components may be implemented as request nodes (RNs) and home nodes (HNs) in ARM CHI-based implementations, with the specific ratio and types of nodes selected based on whether the system prioritizes requests from external entities to internal resources, or prioritizes requests from internal processing cores to external resources.

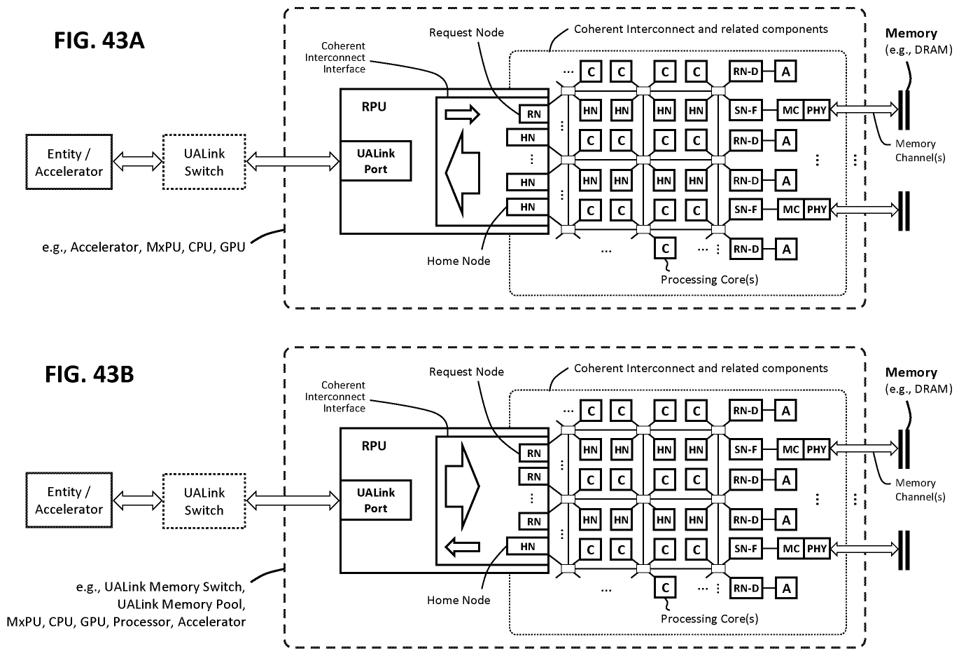

FIG. 43A illustrates an example of a system optimized for accelerator applications utilizing UALink interfaces, wherein an RPU includes more home nodes (HN) than request nodes (RN) coupled between one or more UALink ports and a coherent interconnect comprising crosspoints (XPs) and memory controllers (MCs) that are coupled to memory. The example with more home nodes than request nodes provides greater bandwidth for transactions initiated by processing cores within the coherent interconnect targeting external entities through the UALink ports, while providing more limited bandwidth for transactions initiated by external entities requesting access to internal memory resources, making this architecture suitable for accelerator implementations wherein the accelerator may initiate substantial outbound request traffic but may receive fewer inbound requests.

FIG. 43B illustrates an example of a system optimized for a memory pool or a memory switch applications utilizing UALink interfaces, wherein an RPU includes more request nodes (RN) than home nodes (HN) coupled between one or more UALink ports and a coherent interconnect comprising processing cores. The example with more request nodes than home nodes provides greater bandwidth for transactions initiated by external entities through the UALink ports requesting access to the internal memory resources, while providing more limited bandwidth for transactions initiated by processing cores targeting external resources, making this architecture suitable for memory pooling implementations wherein external entities frequently read from or write to the shared memory resources.

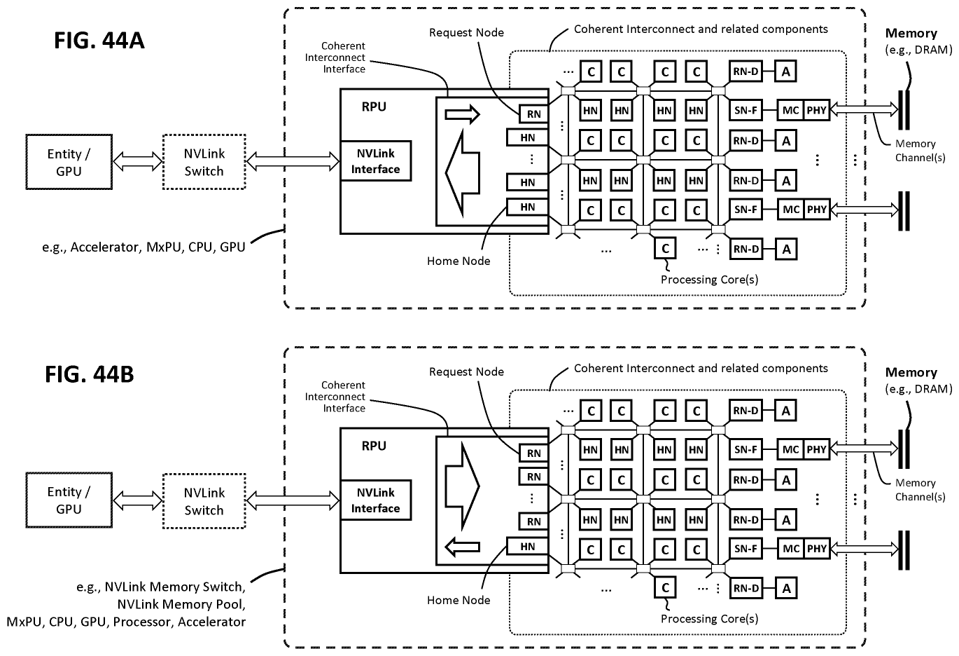

FIG. 44A illustrates an example of a system utilizing NVLink interfaces in an accelerator-optimized configuration, wherein an RPU includes more home nodes (HN) than request nodes (RN) coupled between at least one NVLink interface and a coherent interconnect comprising crosspoints (XPs) and memory controllers (MCs) that are coupled to memory. The asymmetric example with more home nodes (serving outbound request traffic) than request nodes (handling inbound request traffic) creates bandwidth characteristics optimized for accelerator workloads utilizing NVLink, wherein the accelerator prioritizes requests to external resources over serving requests from external entities. The Request Nodes may include I/O-coherent request nodes (RN-I) or I/O-coherent request nodes with DVM support (RN-D), while the Home Nodes may include I/O-coherent Home Node (HN-I). The entity, which may be a GPU such as NVIDIA Rubin GPU, is coupled through an optional NVLink switch, such as NVIDIA NVSwitch, to the RPU's NVLink interface. This asymmetric configuration may be beneficial for read-heavy workloads, such as wherein the accelerator requires high bandwidth capacity for receiving data from memory associated with the entity, such as an HBM of a GPU.

Optionally, the bandwidth capacity of a set of interface components refers to the maximum sustained data throughput that the set of interface components can collectively support for transferring messages in a given direction through the coherent interconnect interface. The bandwidth capacity may be determined by multiple factors including the number of interface components within the set, the aggregate width of physical connections allocated to those components, the processing capabilities of the individual components, and/or the degree to which the components can operate in parallel. For example, a first set comprising a larger number of Home Nodes coupled to the coherent interconnect through wider physical connections may provide greater bandwidth capacity than a second set comprising fewer Request Nodes with narrower connections. In examples wherein the first set of interface components is configured to send messages to the coherent interconnect and the second set of interface components is configured to receive messages from the coherent interconnect, each set may have a different bandwidth capacity, creating an asymmetric configuration wherein data throughput in one direction through the coherent interconnect interface differs from data throughput in the opposite direction. This asymmetry may be implemented by allocating different numbers of interface components to each set, assigning different physical connection widths to each set, and/or providing different levels of access to shared resources such as memory controllers, wherein such design choices may optimize the apparatus for workload patterns that exhibit directional preferences in data traffic.

FIG. 44B illustrates an example of a system configured as an NVLink-based memory pool, wherein an RPU includes more request nodes (RN) than home nodes (HN) coupled between one or more NVLink interfaces and a coherent interconnect comprising crosspoints (XPs), memory controllers (MCs), and memory. The example with more request nodes (handling inbound NVLink request traffic) than home nodes (managing outbound request traffic) optimizes the system for memory pooling scenarios wherein external accelerators frequently access the shared memory resources through NVLink interfaces, providing high bandwidth for external memory access requests while limiting bandwidth for internally-initiated transactions targeting external resources. The Request Nodes may handle read operations, write operations, command submissions, or other transactions initiated by the entity, while the fewer Home Nodes may be sufficient for coordinating read requests from the apparatus to the entity. The entity, which may be a GPU such as NVIDIA Rubin GPU, is coupled through an optional NVLink switch, such as NVIDIA NVSwitch, to the RPU's NVLink interface. This asymmetric configuration may be beneficial for memory-intensive workloads wherein the entity generates substantial data traffic to and from the memory of the apparatus.

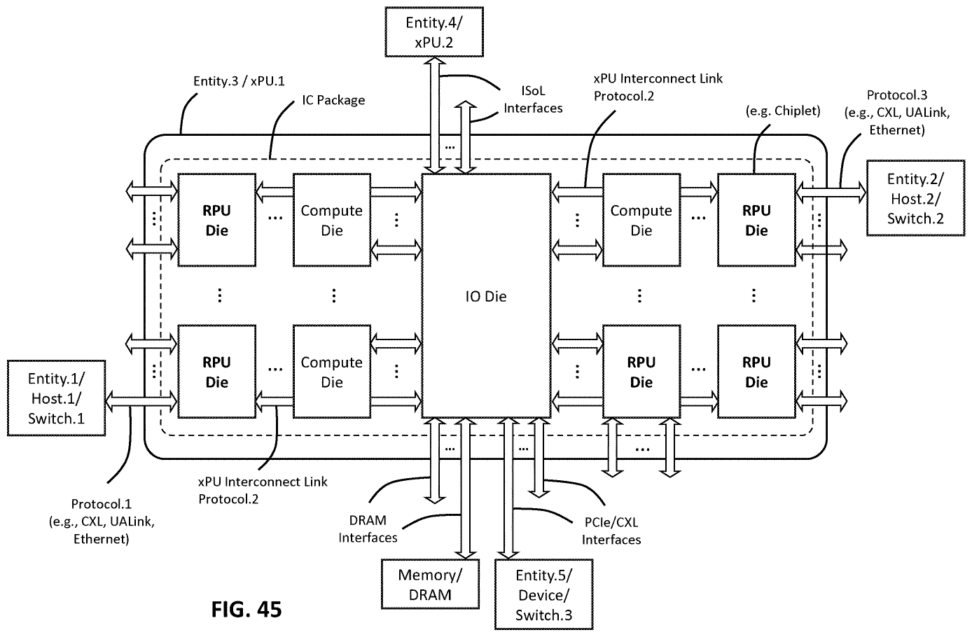

FIG. 45 illustrates an example of a system comprising an IC package comprising an input/output (IO) die coupled to compute dies and RPU dies via xPU interconnect links. The IC package may be representative of a modified AMD server-grade processor such as a modified EPYC processor or a modified consumer-grade processor such as a modified RYZEN processor. The IO die is positioned essentially centrally within the IC package and provides external interfaces including inter-socket link (ISoL) interfaces for multi-processor configurations, DRAM interfaces for memory connectivity, and PCIe/CXL interfaces for peripheral device connectivity. The xPU interconnect links may utilize high-bandwidth die-to-die interconnect protocols to enable communication between the various dies and the IO die within the IC package. The compute dies and RPU dies are arranged around the IO die, wherein the RPU dies are positioned at peripheral locations within the IC package. Entity.1/Host.1/Switch.1 is coupled to a first RPU die utilizing Protocol.1, which may be CXL, UALink, or Ethernet. Entity.2/Host.2/Switch.2 is coupled to a second RPU die utilizing Protocol.3, which may be CXL, UALink, or Ethernet. The IO die utilizes Protocol.2 for internal communications with both the compute dies and the RPU dies via the xPU interconnect links, wherein Protocol.2 may be ISoL protocol. Entity.3/MxPU.1 is the apparatus that includes the IO die, compute dies and RPU dies. Entity.4/MxPU.2 is coupled to the IC package via ISoL interfaces. The IO die may further provide connectivity to Memory/DRAM via DRAM interfaces and to Entity.5/Device/Switch.3 via PCIe/CXL interfaces. The RPU dies may enable translations between the external protocols (Protocol.1 and Protocol.3) utilized by the coupled entities and the internal protocol (Protocol.2) utilized by the coherent interconnect in the IC package.

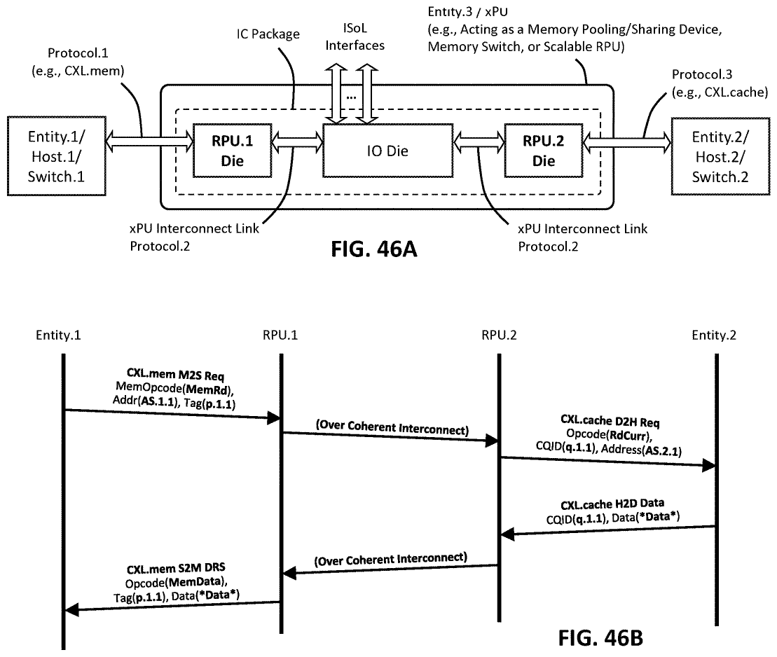

FIG. 46A illustrates an example of a system comprising a memory switch comprising an IC package with an IO die coupled to at least first and second RPU dies. The coherent interconnect of the xPU utilizes Protocol.2 for communications between the IO die and the RPU dies, wherein Protocol.2 may be based on Intel Intra-Die Interconnect (IDI) or AMD Infinity Fabric. The coherent interconnect may be implemented as AMD Infinity Fabric or Intel Ring/Mesh Interconnect. RPU.1 is configured to translate between Protocol.1 and Protocol.2, and RPU.2 is configured to translate between Protocol.2 and Protocol.3. The memory switch may support various translation scenarios including: (a) translations from CXL.mem to Intel UPI to CXL.cache, (b) translations from CXL.mem to Infinity Fabric to CXL.cache, (c) translations from CXL.io Unordered IO (UIO) to Infinity Fabric to CXL.io UIO, (d) translations from PCIe UIO to Infinity Fabric to PCIe UIO, or (e) translations from UALink to Infinity Fabric to UALink.

FIG. 46B illustrates an example of a TFD demonstrating protocol and address translation relevant to a memory switch. Entity.1 (which may be a host or a switch) initiates a CXL.mem M2S request comprising MemRd, a physical address (AS.1.1) within a first physical address space, and a Tag (p.1.1). RPU.1 receives the CXL.mem M2S request and translates it for transmission over the xPU/processor coherent interconnect. RPU.2 receives the translated M2S request from the coherent interconnect and generates a CXL.cache D2H request comprising RdCurr, a translated physical address (AS.2.1) within a second physical address space, and a translated identifier (q.1.1) that may be a CQID. Entity.2 (which may be a host or a switch) processes the CXL.cache request and returns a CXL.cache H2D Data response comprising the CQID (q.1.1) and the requested data. The response traverses back through RPU.2 and the coherent interconnect to RPU.1, which translates it to a CXL.mem S2M DRS comprising MemData, the original Tag (p.1.1), and the data for delivery to Entity.1.

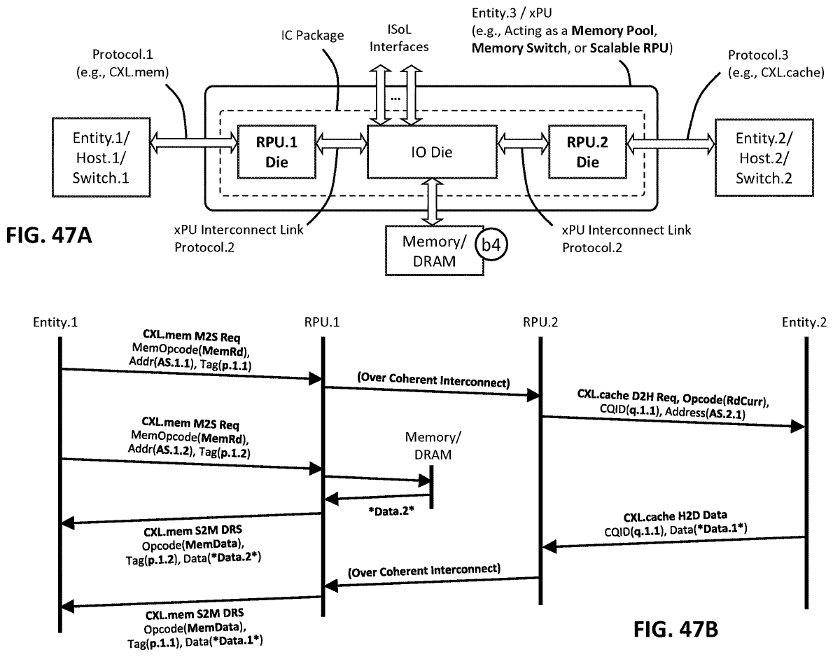

FIG. 47A illustrates an example of a system comprising an IC package with an IO die coupled to at least first and second RPU dies. Entity.3/MxPU may function as a memory pool, a memory switch, or a scalable RPU. The memory switch functionality enables two distinct transaction paths: a host-to-host transaction from Entity.1 to Entity.2, and a host-to-memory transaction path from Entity.1 to Memory/DRAM. RPU.1 Die communicates with Entity.1/Host.1/Switch.1 utilizing Protocol.1, such as CXL.mem. RPU.2 Die communicates with Entity.2/Host.2/Switch.2 utilizing Protocol.3, such as CXL.cache. The IO die utilizes Protocol.2 for internal communications with the RPU dies via xPU interconnect links, which may be a coherent interconnect. The Memory/DRAM is coupled to the IO die, enabling memory access for the host-to-memory transactions. ISoL interfaces on the IO die may provide connectivity to additional processors or coherent interconnects.

FIG. 47B illustrates an example of a TFD demonstrating two transactions relevant to a memory switch. The first CXL transaction is a host-to-host transaction, wherein Entity.1 initiates a CXL.mem M2S Req comprising MemRd, physical address (AS.1.1), and Tag (p.1.1, bubble a1). RPU.1 receives the request and translates it for transmission over the processor's coherent interconnect. RPU.2 receives the translated request and generates a CXL.cache D2H Req comprising RdCurr, corresponding physical address (AS.2.1), and CQID (q.1.1) for delivery to Entity.2. The response path includes a CXL.cache H2D comprising CQID (q.1.1) and Data.1, which traverses back through the coherent interconnect to RPU.1, wherein it is translated to a CXL.mem S2M DRS comprising MemData, Tag(p.1.1), and Data.1.

The second CXL transaction is a host-to-memory transaction, which may be a host to fabric-attached memory, host to switch-attached memory, or host to memory pool transaction. The request path includes Entity.1 that initiates a CXL.mem M2S Req comprising MemRd, physical address (AS.1.2), and Tag (p.1.2, bubble b1). RPU.1 processes this request and forwards it to Memory/DRAM via the IO die. The response path includes Data.2 being retrieved from Memory/DRAM and sent to RPU.1, which encapsulates it in a CXL.mem S2M DRS comprising MemData, Tag (p.1.1), and Data.2 for delivery to Entity.1.

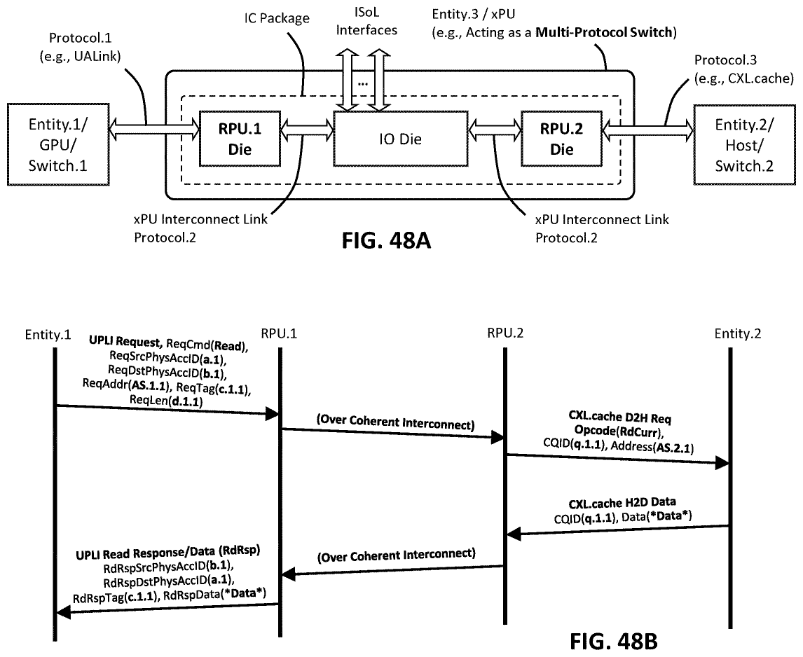

FIG. 48A illustrates an example of a system comprising an xPU-based multi-protocol switch comprising an IC package with an IO die coupled to at least first and second RPU dies. Entity.3/MxPU functions as an xPU-based multi-protocol switch. Entity.1/GPU/Switch.1 is coupled to RPU.1 Die utilizing Protocol.1, such as UALink. Entity.2/Host/Switch.2 is coupled to RPU.2 Die utilizing Protocol.3, such as CXL.cache. The IO die utilizes Protocol.2 for internal communications with the RPU dies via xPU interconnect links. ISoL interfaces on the IO die may provide connectivity to additional processors or xPU-based multi-protocol switches. The xPU-based multi-protocol switch enables translation between three or more distinct protocols.

FIG. 48B illustrates an example of a TFD demonstrating protocol and address translation relevant to an xPU-based multi-protocol switch. Entity.1 initiates a UPLI request (Req) comprising ReqCmd(Read), ReqSrcPhysAccID(a.1), ReqDstPhysAccID(b.1), ReqAddr(AS.1.1), ReqTag(c.1.1), and ReqLen(d.1.1). RPU.1 receives the UPLI request and translates it for transmission over the xPU/Processor Coherent Interconnect. RPU.2 receives the translated request and generates a CXL.cache D2H Req comprising RdCurr, CQID (q.1.1), and translated physical address (AS.2.1) for delivery to Entity.2/Host/Switch.2. The response path includes a CXL.cache H2D Data comprising CQID (q.1.1) and the requested data, which traverses back through the xPU/Processor Coherent Interconnect to RPU.1. RPU.1 translates the response to a UPLI read response/data (RdRsp) comprising RdRspSrcPhysAccID(b.1), RdRspDstPhysAccID(a.1), RdRspTag(c.1.1), and RdRspData for delivery to Entity.1/GPU/Switch.1. Protocol.2, utilized by the xPU/processor's coherent interconnect, may enable communication between the IO die and the RPUs. The xPU-based multi-protocol switch may support various translation scenarios, including: (a) UALink to in-die interconnect to CXL.cache, (b) UALink to Infinity Fabric to CXL.cache, (c) CXL.mem to on-die coherent fabric to CXL.cache, (d) CXL.mem to Infinity Fabric to CXL.cache, (e) CXL.io UIO to Infinity Fabric to CXL.io UIO, or (f) PCIe UIO to Infinity Fabric to PCIe UIO.

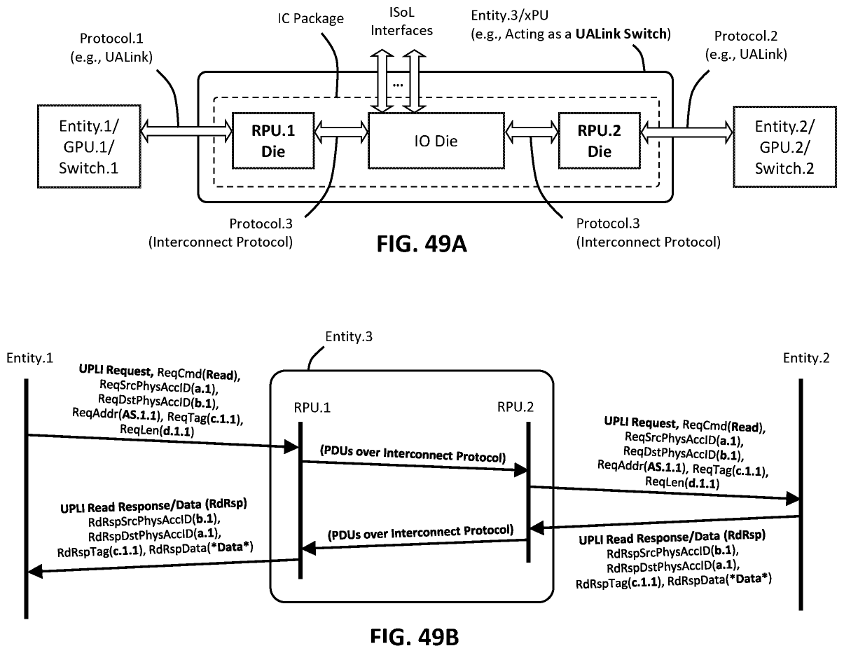

FIG. 49A illustrates an example of a system comprising a third entity (Entity.3), which may be an xPU, comprising an I/O die, that may communicate, via a first RPU (RPU.1) die, with a first entity (Entity.1), which may be a first GPU, or a first switch, according to a first protocol (Protocol.1), which may be a UALink-based protocol, such as UPLI. The I/O die may further communicate, via a second RPU (RPU.2) die, with a second entity (Entity.2), which may be a second GPU, or a second switch, according to a second protocol (Protocol.2), which may be a UALink-based protocol, such as UPLI. The I/O die may include an interconnect configured to switch traffic associated with an interconnect protocol (protocol.3) that may be based on ARM CHI, NVIDIA NVLink, Intel ICPIP, or AMD Infinity Fabric. The first RPU may translate between messages conforming to the first protocol and messages conforming to the third protocol (Protocol.3), such as between a UALink-based protocol, which may be UPLI, and the interconnect protocol; the second RPU may translate between messages conforming to the second protocol and messages conforming to the third protocol, such as between a UALink-based protocol (e.g., UPLI) and the interconnect protocol, enabling the first entity to communicate with the second entity according to a UALink-based protocol, such as UPLI; and the third entity may operate as a UALink switch, or a UALink-based switch. In some examples, the first protocol and the second protocol may conform to the same UALink-based protocol revision. In other examples, the first protocol and the second protocol may conform to different protocol revisions, wherein the first and second RPUs may translate between messages conforming to different protocol revisions.

FIG. 49B illustrates an example of a TFD demonstrating translations performed by a third entity (Entity.3), which may be an xPU, such as translations between protocols, that may enable the third entity to operate as a UALink-based switch. The third entity may receive from a first entity (Entity.1), via the first RPU (RPU.1), a first UPLI request (Req) comprising Request Command (e.g. ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)). The third entity may translate, optionally via the first RPU, the first UPLI request, to a first set of one or more Protocol Data Units (PDUs) of an interconnect protocol utilized by the third entity. The third entity may further translate, optionally via the second RPU (RPU.2), the first set of one or more PDUs of the interconnect protocol to a second UPLI request, comprising Request Command (e.g. ReqCmd(Read)), Request Source Physical Accelerator ID (e.g., ReqSrcPhysAccID(a.1)), Request Destination Physical Accelerator ID (e.g., ReqDstPhysAccID(b.1)), Request Address (e.g., ReqAddr(AS.1.1)), Request Tag (e.g., ReqTag(c.1.1)), and Request Length (e.g., ReqLen(d.1.1)), wherein the third entity may send the second UPLI request to a second entity (Entity.2). Optionally, the second UPLI request may be equivalent to the first UPLI request.

Upon receiving a response from the second entity, the third entity may translate, optionally via the second RPU, the response to a second set of one or more PDUs of the interconnect protocol. Wherein the response from the second entity may include a first UPLI read response/data (RdRsp) comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), and Read Response Data (e.g., RdRspData(*Data*)). The third entity may further translate, optionally via the first RPU, the second set of one or more PDUs of the interconnect protocol to a second UPLI RdRsp comprising Read Response Source Physical Accelerator ID (e.g., RdRspSrcPhysAccID(b.1)), Read Response Destination Physical Accelerator ID (e.g., RdRspDstPhysAccID(a.1)), Read Response Transaction Tag (e.g., RdRspTag(c.1.1)), and Read Response Data (e.g., RdRspData(*Data*)), wherein the third entity may send the second UPLI RdRsp to the first entity. In some examples, the second UPLI RdRsp may be equivalent to the first UPLI RdRsp. In some examples, the first UPLI request, the second UPLI request, the first UPLI RdRsp, and the second UPLI RdRsp, may correspond to the same protocol revision; whereas in other examples the first UPLI request and the second UPLI RdRsp may correspond to different protocol revisions than the second UPLI request and the first UPLI RdRsp.

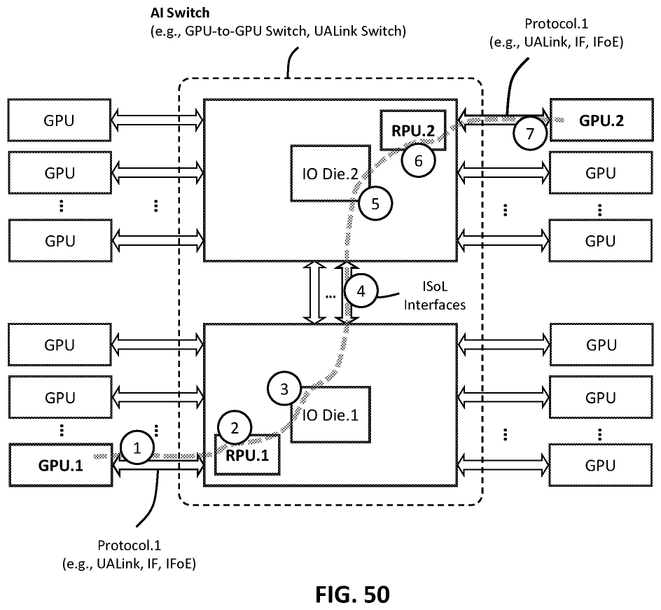

FIG. 50 illustrates an example of a scalable GPU interconnect utilizing an xPU-based AI switch, comprising at least first and second xPU-based switches coupled via one or more ISoL interfaces. The AI switch may function as a GPU-to-GPU Switch. GPUs on the left side of the switch are coupled to RPU.1 and additional RPUs that are coupled to IO Die.1, while GPUs on the right side are coupled to RPU.2 and additional RPUs (not shown) that are coupled to IO Die.2. The numbered bubbles 1 through 7 illustrate a transaction path from GPU.1 to GPU.2. Modern CPUs comprise one or more high-bandwidth coherent interconnects that couple elements such as compute cores, caching elements such as LLC slices, and port modules such as PCIe and CXL. The total bandwidth provided by the coherent interconnect of current advanced CPUs (in year 2025) may exceed 1 TB/s (>8 Tbps), and may reach several TB/s in current advanced CPU architectures that utilize MCR-DIMMs or MR-DIMMs. The two xPU-based switches, coupled via the ISoL interface denoted as bubble 4, enable memory transactions between GPU.1 and GPU.2 in a manner similar to a UALink switch when the GPUs communicate according to UPLI. When GPUs communicate according to UPLI, the transaction path follows: GPU.1 sends a UPLI request to RPU.1 (bubbles 1-2), RPU.1 translates the UPLI request to the coherent interconnect protocol utilized by IO Die.1 (bubble 3), the translated request traverses through the ISoL interface to IO Die.2 (bubble 4), IO Die.2 forwards the request to RPU.2 (bubbles 5-6), and RPU.2 translates the request back to UPLI for delivery to GPU.2 (bubble 7). In another example, when the GPUs communicate according to Infinity Fabric, the RPUs may translate between Infinity Fabric and the coherent interconnect protocol of the IO dies, enabling GPU-to-GPU communication through the ISoL-coupled switches. In still another example, when the GPUs communicate according to Infinity Fabric over Ethernet (IFoE) protocol, the RPUs may extract Infinity Fabric messages from Ethernet frames, translate them to the coherent interconnect protocol, and re-encapsulate them for delivery to the destination GPU.

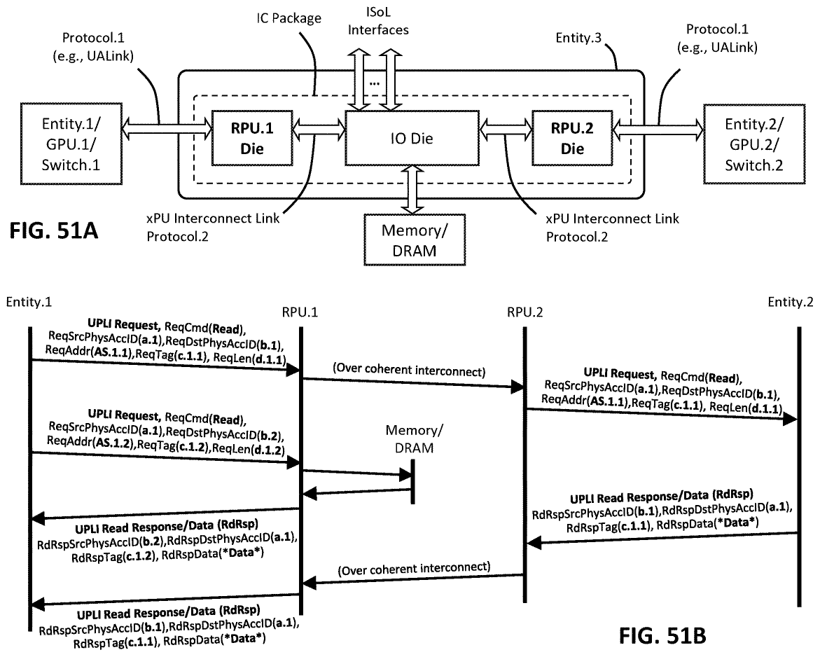

FIG. 51A illustrates an example of a system comprising an xPU-based switch coupled to memory. The xPU-based switch comprises an IC package with an IO die coupled to at least first and second RPU dies. Entity.3 functions as a switch coupled to memory. Entity.1 (such as a first GPU or a first switch) is coupled to RPU.1 Die via Protocol.1, such as UALink. Entity.2 (such as a second GPU or a second switch) is coupled to RPU.2 Die via Protocol.1, which may also be UALink. Memory/DRAM is coupled to the IO die, enabling Entity.3 to function as at least one of a switch for GPU-to-GPU transactions or a memory resource for GPU-to-memory transactions. This example supports at least two distinct transaction paths: a GPU-to-GPU transaction path from Entity.1 to Entity.2, and a GPU-to-memory transaction path from Entity.1 to the Memory/DRAM. The IO die utilizes Protocol.2 for internal communications with the RPU dies via xPU interconnect links. ISoL interfaces on the IO die may provide connectivity to additional processors, xPU-based switches, or memory resources.

FIG. 51B illustrates an example of a TFD demonstrating two UALink transactions through an xPU-based switch coupled to memory. The first UALink transaction is a GPU-to-GPU transaction, wherein Entity.1 initiates a UPLI request (Req) comprising ReqCmd(Read), ReqSrcPhysAccID(a.1), ReqDstPhysAccID(b.1), ReqAddr(AS.1.1), ReqTag(c.1.1), and ReqLen(d.1.1). RPU.1 receives this request and forwards it via the xPU/Processor Coherent Interconnect to RPU.2. RPU.2 forwards the UPLI request to Entity.2 with essentially the same parameters. The response path includes a UPLI read response/data (RdRsp) from Entity.2/GPU.2/Switch.2 comprising RdRspSrcPhysAccID(b.1), RdRspDstPhysAccID(a.1), RdRspTag(c.1.1), and RdRspData, which traverses back through the xPU/Processor Coherent Interconnect to RPU.1, wherein it is forwarded as a UPLI RdRsp to Entity.1/GPU.1/Switch.1.

The second UALink transaction is a GPU-to-memory transaction, which may be GPU to fabric-attached memory, GPU to switch-attached memory, or GPU to memory pool transaction. Entity.1 initiates a UPLI request comprising ReqCmd(Read), ReqSrcPhysAccID(a.1), ReqDstPhysAccID(b.2), ReqAddr(AS.1.2), ReqTag(c.1.2), and ReqLen(d.1.2). RPU.1 processes this request and forwards it to Memory/DRAM via the xPU/Processor Coherent Interconnect and IO die. The response path includes data being retrieved from Memory/DRAM and sent via the xPU/Processor Coherent Interconnect to RPU.1, which generates a UPLI RdRsp comprising RdRspSrcPhysAccID(b.2), RdRspDstPhysAccID(a.1), RdRspTag(c.1.2), and RdRspData for delivery to Entity.1/GPU.1/Switch.1.

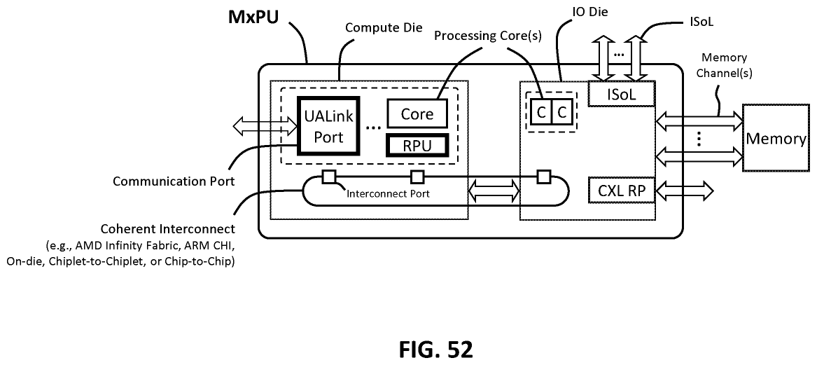

FIG. 52 illustrates an example of a processor, such as a CPU, that includes a UALink port and an RPU. The system includes an I/O die, a Compute Die such as a Core Complex Die (CCD) in AMD terminology, and a coherent interconnect such as AMD Infinity Fabric connecting the two dies.

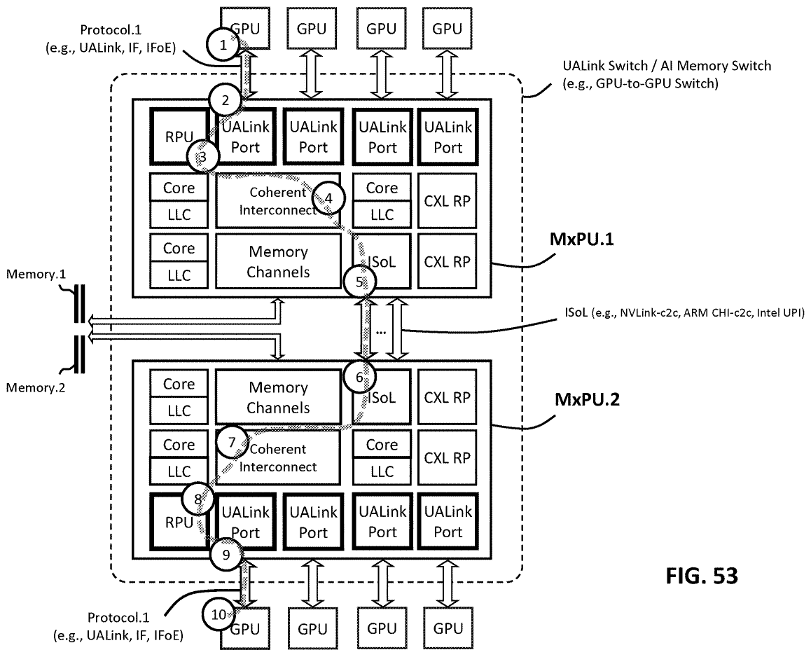

FIG. 53 illustrates an example of a memory switch or AI switch implementation utilizing two IC packages. The GPUs are coupled to UALink ports in a first processor, and another set of GPUs are coupled to UALink ports in a second processor. The processors are coupled via one or more ISoL ports, enabling switching of traffic between the UALink ports through the ISoL interface, such as ARM CHI C2C, Intel UPI, or AMD Infinity-Fabric. The example demonstrates how a switch can be constructed based on modified processor architectures.

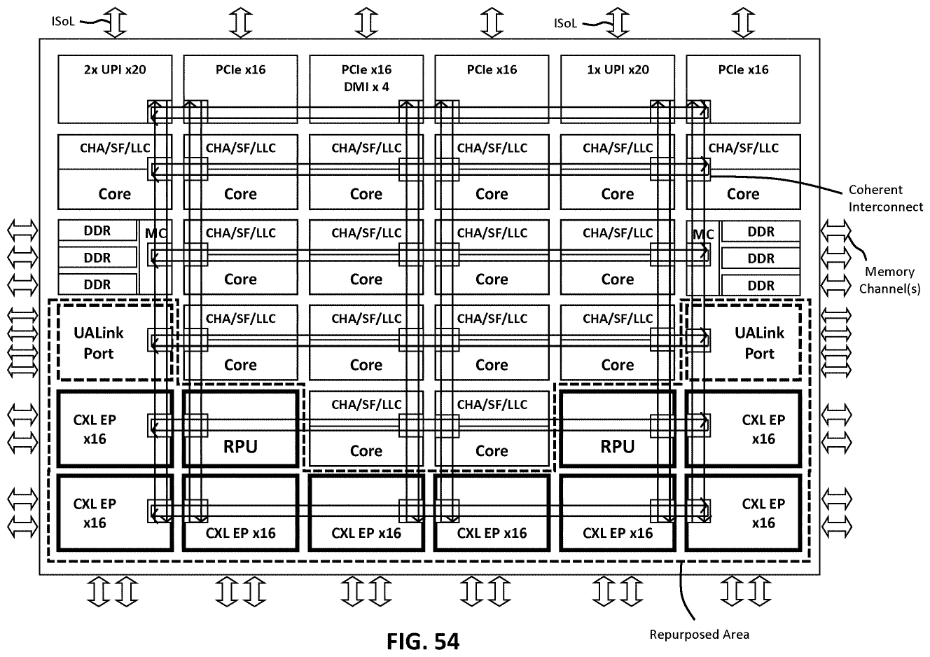

FIG. 54 illustrates an example of a processor comprising CXL endpoint ports and RPUs. The system demonstrates a CXL endpoint focused implementation where a repurposed area for the ports contains CXL endpoints, enabling CXL connectivity and functionality within the processor architecture.

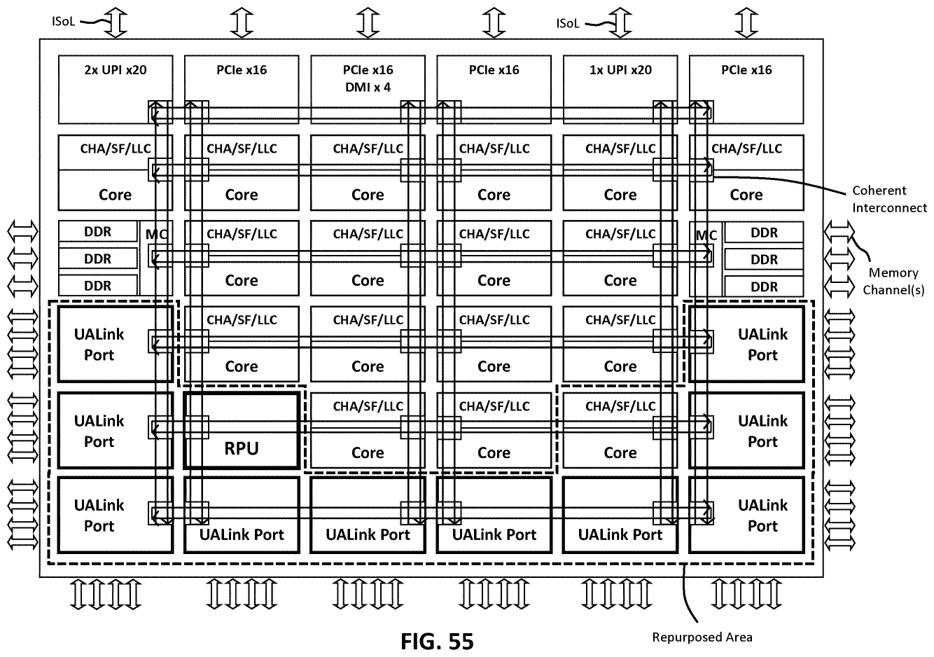

FIG. 55 illustrates an example of a processor comprising UALink ports and RPUs. The system demonstrates a UALink focused implementation where a repurposed area for the ports contains UALink ports, enabling UALink connectivity and functionality within the processor architecture.

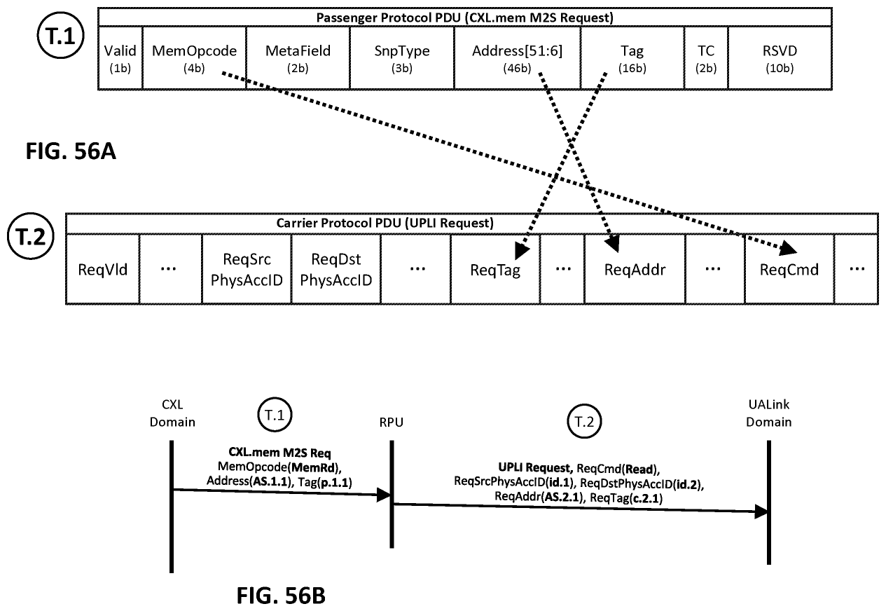

FIG. 56A illustrates an example of passing CXL traffic or CXL-related traffic over a physical layer (PHY) based on IEEE 802.3 PMA utilizing carrier protocol encapsulation. A carrier protocol runs over a PHY based on IEEE 802.3 PMA and a passenger protocol PDU associated with CXL. Optionally, the passenger protocol PDU may be based on CXL.mem. The carrier protocol encapsulates the CXL.mem PDU or portions thereof within carrier protocol structures that are suitable for transmission over the PHY based on IEEE 802.3 PMA. It may enable CXL communications to traverse physical infrastructure based on IEEE 802.3 standards, including but not limited to UALink physical layers, NVLink physical layers, or Ethernet physical layers, wherein UALink may utilize a modified IEEE 802.3 PHY or other types of IEEE 802.3 PHY, and wherein UALink may alternatively utilize a PCIe PHY in some variants.

FIG. 56B illustrates an example of a TFD showing the mapping between a CXL transaction layer and a UPLI transaction layer, wherein TL denotes transaction layer. The figure shows a CXL.mem M2S request at the CXL transaction layer being translated to a UPLI request at the UPLI transaction layer. The mapping comprises translating a MemOpcode field from the CXL request to a ReqCmd field in the UPLI request, translating a Tag field to a ReqTag field, and translating an Address field to a ReqAddr field. These represent the major mappings for the translation process, wherein additional mappings may include traffic class or other fields that are not explicitly illustrated. Some fields may pass through direct mapping while other fields may undergo translation, wherein for example the address may be translated between different address spaces, and the request Tag may be assigned from a pool rather than directly translated from the CXL Tag. The TFD shows the transaction flowing from a CXL.mem M2S Req through the translation process to a UPLI Req, demonstrating the translation at the transaction layer (TL) level.

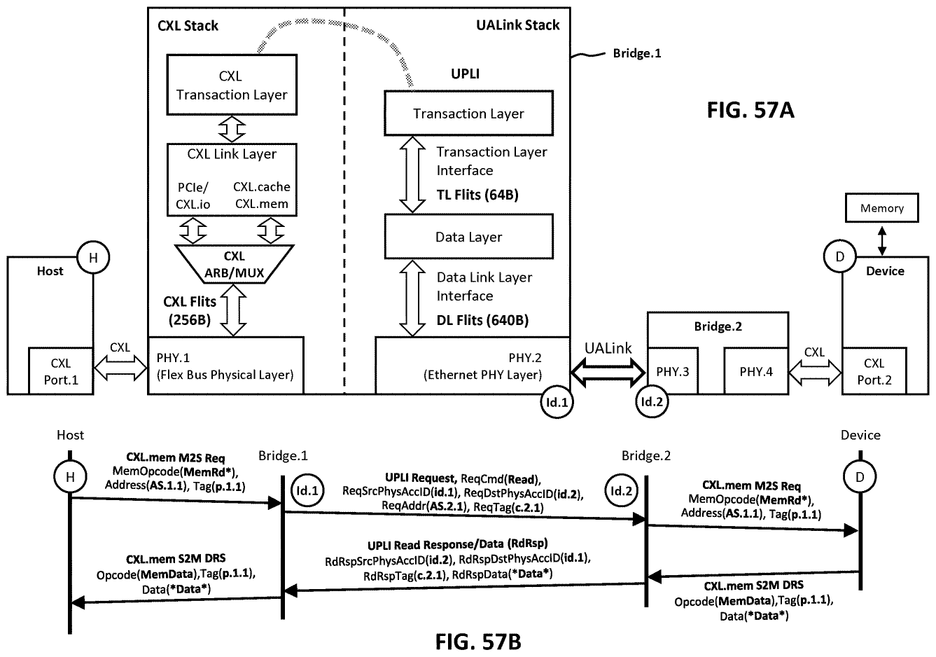

FIG. 57A illustrates an example of a system featuring host and device components coupled via bridges that translate between CXL and carrier protocols that utilize PHYs based on IEEE 802.3 PMA. The system comprises a host on the left side and a device on the right side, reflecting the asymmetry built into CXL wherein specific roles are assigned to each side. The system includes Bridge.1 and Bridge.2, wherein Bridge.1 translates between a Flex bus physical layer (a physical layer utilized by CXL) and an Ethernet PHY Layer (representing some implementations of a PHY based on IEEE 802.3 PMA), and Bridge.2 translates from an Ethernet PHY Layer back to a Flex bus physical layer. The host and device sides comprise CXL ports (designated as CXL Port.1 and CXL Port.2), which utilize a Flex bus physical layer and are unaware of the intermediate UALink or the IEEE 802.3-based physical layer infrastructure. The intermediate link between Bridge.1 and Bridge.2 may utilize UALink, wherein the UALink physical layer may be based on an IEEE 802.3 Ethernet PHY as specified in the UALink specification. The figure shows the detailed protocol stacks for both CXL and UPLI sides, wherein the CXL stack may include a CXL Transaction Layer, a CXL Link Layer with separate paths for PCIe/CXL.io and CXL.cache/CXL.mem, a CXL ARB/MUX that transmits CXL Flits (256 bytes representing an example), and a Flex Bus Physical Layer (denoted as PHY.1). The UPLI stack may include a transaction layer (which may include a transaction layer interface that transmits TL flits of 64 bytes), a Data Layer or a Data Link Layer (which may include a data link layer interface that transmits DL flits of 640 bytes), and an Ethernet PHY layer (denoted as PHY.2). This mapping occurs between transaction layers, specifically between the CXL transaction layer and the UPLI transaction layer, representing the typical translation approach wherein the system receives signals at the physical layer, processes upward to the transaction layer for mapping operations, and then processes downward to the physical layer for transmission. The bridges may be implemented or embedded within switches, such as CXL switches, UALink switches, or hybrid switches, enabling hosts and devices to connect through a switching infrastructure with UALink links between the switches, effectively tunneling CXL.mem transactions over UALink between switches.

FIG. 57B illustrates an example of a TFD corresponding to the system described in FIG. 57A, demonstrating bidirectional CXL communications between a host and a device utilizing UALink as an intermediate protocol. The TFD shows four communication points comprising the Host edge (designated H), Id.1 representing the UALink identity of Bridge.1, Id.2 representing the UALink identity of Bridge.2, and the Device edge (designated D). In the forward path from host to device, the Host H originates a CXL.mem M2S Req with MemOpcode(MemRd*), Address(AS.1.1), and Tag(p.1.1). Bridge.1 translates this CXL request to a UPLI request (Req) with ReqCmd(Read), ReqSrcPhysAccID(Id.1) identifying the source bridge, ReqDstPhysAccID(Id.2) identifying the destination bridge, ReqAddr(AS.2.1) representing the translated address, and ReqTag(c.2.1) representing the translated Tag. The UPLI request is transmitted at Id.1 using the UALink identities for routing between the Id.1 and Id.2 communication points. Bridge.2 at Id.2 receives the UPLI request and translates it back to a CXL.mem M2S Req with MemOpcode(MemRd*), Address(AS.1.1), and Tag(p.1.1) for delivery to the Device D, wherein the original CXL physical address and Tags may be restored.

In the return path from device to host, the Device sends a CXL.mem S2M DRS with Opcode(MemData), Tag(p.1.1), and Data(*Data*). Bridge.2 translates this CXL response to a UPLI read response/data (RdRsp) with RdRspSrcPhysAccID(Id.2) identifying the source bridge, RdRspDstPhysAccID(Id.1) identifying the destination bridge, RdRspTag(c.2.1) representing the translated Tag that matches the original request Tag, and RdRspData(*Data*) carrying the response data. The UPLI response is transmitted at Id.2 using the UALink identities for routing between the Id.2 and Id.1 communication points. Bridge.1 at Id.1 receives the UPLI RdRsp and translates it back to a CXL.mem S2M DRS with Opcode(MemData), Tag(p.1.1), and Data(*Data*) for delivery to Host H, wherein the original Tag enables the host to correlate the response with the original request. A UALink switch or another switching infrastructure may be positioned between Bridge.1 and Bridge.2, wherein the UALink physical accelerator identifiers (ReqSrcPhysAccID, ReqDstPhysAccID, RdRspSrcPhysAccID, RdRspDstPhysAccID) enable routing through such intermediate switching infrastructure. The translation process adapts the protocol format for transport over the UALink infrastructure, wherein Bridge.1 translates between CXL and UPLI requests, and Bridge.2 translates between UPLI and CXL requests. The address translation between AS.1.1 in the CXL domain and AS.2.1 in the UPLI domain, and the Tag translation between p.1.1 in the CXL domain and c.2.1 in the UPLI domain, enable the bridges to maintain proper transaction tracking and response correlation while adapting between different addressing and identification schemes utilized by the respective protocols.

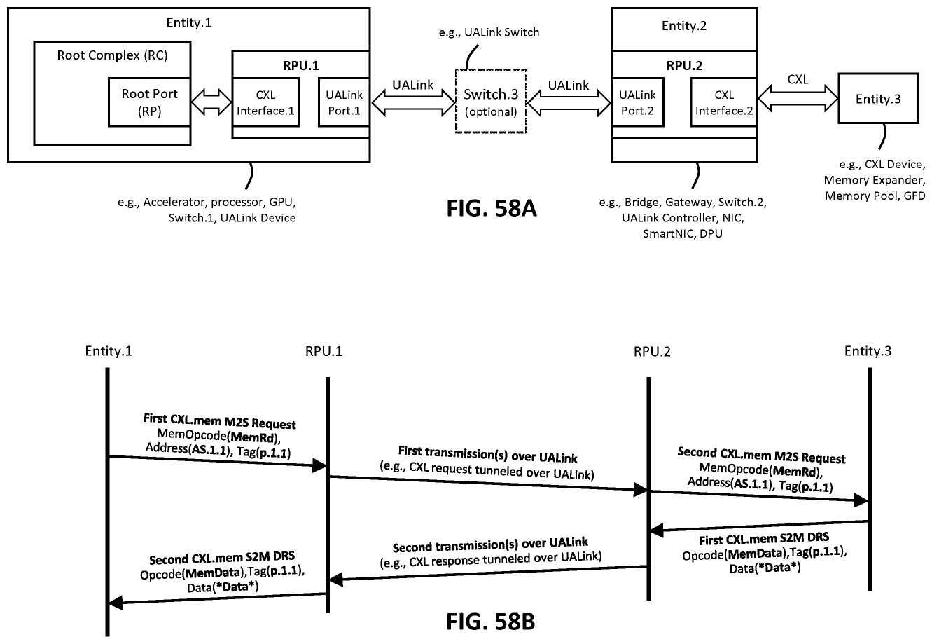

FIG. 58A illustrates an example of a system comprising a first entity (Entity.1), such as an accelerator, a processor, a GPU, a first switch (Switch.1), or a UALink device, wherein the first entity may include a Root Complex (RC) comprising a root port (RP), and may further include a first RPU (RPU.1) comprising a first CXL interface (CXL Interface.1) and a first UALink port (UALink Port.1). The system may further include an optional third switch (Switch.3), such as a UALink switch, and a second entity (Entity.2), such as a bridge, a gateway, a second switch (Switch.2), a UALink controller, a Network Interface Card (NIC), e.g., a UALink NIC, a SmartNIC, e.g., a UALink SmartNIC, or a Data Processing Unit (DPU), e.g., a UALink DPU. The second entity may include a second RPU (RPU.2) comprising a second CXL interface (CXL Interface.2) and a second UALink port (UALink Port.2). The system further includes a third entity (Entity.3), such as a CXL device, a memory expander, a memory pool, or a GFD.

The first and second RPUs may enable the first entity to communicate with the third entity according to a CXL-based protocol, via the second entity and optionally via the third switch (Switch.3), such as by translating between CXL-based PDUs (such as TLPs, requests, messages, or flits) and transmissions comprising data indicative of CXL PDUs, such as transmissions comprising data indicative of CXL opcodes and physical addresses, wherein the transmissions utilize UALink PDUs (such as UPLI messages or UALink flits, e.g., TL Flits, DL Flits, or Payload Flits), which may be sent and received via the first and second UALink ports, optionally enabling the first entity to access resources of the third entity, such as registers or memory. In some examples, translating between the CXL-based PDUs and the transmissions utilizing UALink PDUs may enable CXL over UALink, such as via CXL tunneling over UALink, e.g., tunneling of CXL.mem requests and responses over UALink, tunneling of CXL.io TLPs over UALink, tunneling of CXL-based PDUs over UALink, or tunneling of CXL transactions over UALink.

In some examples, the first UALink port and the second UALink port may utilize the same physical layer technology, such as a physical layer based on IEEE 802.3 PMA (e.g., UALink 200 PHY based on 802.3 Ethernet PHY), or a physical layer based on PCIe (e.g., UALink 128G based on PCIe 6.3). In other examples, the first UALink port and the second UALink port may utilize different physical layer technologies. The first RPU may be implemented in a chiplet inside an IC package of the first entity, as a functional block on the same silicon die with the RP, or may be split between dies or chiplets. Alternatively, the first RPU may be implemented as a discrete component coupled to the second entity. Additionally or alternatively, the first RPU may be included in a switch, such as in a UALink switch.

In some examples, the first entity may be a first switch (Switch.1) comprising the first UALink port, the second entity may be a second switch (Switch.2) comprising the second UALink port, and the CXL traffic between the first and second switches may be tunneled over UALink. Optionally, the first and second switches may be coupled by the third switch (Switch.3), which may be a UALink switch. In other examples, the first entity may be a first switch (Switch.1) comprising the first CXL interface (CLX Interface.1), the second entity may be a second switch (Switch.2) comprising the second CXL Interface (CXL Interface.2), and the CXL traffic between the RP and the third entity (e.g., a CXL device) may be tunneled over UALink via the second switch (Switch.2) and optionally via the third switch (Switch.3), which may be a UALink switch.

FIG. 58B illustrates an example of a TFD demonstrating a CXL communication between a first entity (Entity.1), such as a processor comprising a root port (RP), and a third entity (Entity.3), such as a CXL device, wherein the CXL communication may be tunneled over UALink. The first entity may initiate a read from the third entity, such as by sending a first CXL.mem M2S request comprising MemOpcode(MemRd), Address(AS.1.1), and Tag(p.1.1) via the RP. The first RPU (RPU.1), which may reside in the first entity, may receive the first CXL.mem M2S request and translate it to first transmission(s) comprising data indicative of CXL PDU, such as transmission(s) comprising data indicative of CXL opcodes and physical addresses, wherein the first RPU may send the first transmission(s) which may utilize one or more UALink PDUs (such as UPLI messages or UALink flits, e.g., TL Flits, DL Flits, or Payload Flits), to a second RPU (RPU.2), which may reside in a second entity, such as a bridge or a gateway. The first RPU may further translate the first CXL.mem M2S request to the first transmission(s) in a manner that enables reconstruction of the first CXL.mem M2S request at the second RPU with minimal (or no) modifications, effectively tunneling the first CXL.mem M2S request over UALink. For example, the first RPU may encapsulate the first CXL.mem M2S request into a UPLI write message, and send the UPLI write message to the second RPU, wherein the CXL request may be extracted from the UPLI write message such as by decapsulation. Additionally or alternatively, the first RPU may encapsulate a CXL flit comprising the first CXL.mem M2S request into a UPLI write message, and send the UPLI write message to the second RPU, wherein the CXL flit comprising the first CXL.mem M2S request may be extracted from the UPLI write message such as by decapsulation.

The second RPU may receive the first transmission(s) and translate it to a second CXL.mem M2S request comprising MemOpcode(MemRd), Address(AS.1.1), and Tag(p.1.1), and send the second CXL.mem M2S request to the third entity. In some examples, the first CXL.mem M2S request and the second CXL.mem M2S request may be identical, whereas in other examples the second RPU may construct the second CXL.mem M2S request based on the first CXL.mem M2S request with variations such as utilizing a different opcode (e.g., MemRdData instead of MemRd), utilizing a different Tag namespace, e.g., Tag(q.2.1) instead of Tag (p.1.1), or utilizing address translations, e.g., Address(AS.2.1) instead of Address(AS.1.1). The third entity may respond to the second CXL.mem M2S request by sending a first CXL.mem S2M DRS comprising Opcode(MemData), Tag(p.1.1), and Data(*Data*) to the second RPU, wherein the second RPU may translate the first CXL.mem S2M DRS to second transmission(s) comprising data indicative of CXL PDU, and send the second transmission(s) to the first RPU. The first RPU may further receive the second transmission(s) and translate it to a second CXL.mem S2M DRS comprising Opcode(MemData), Tag(p.1.1), and Data(*Data*), and send the second CXL.mem S2M DRS to the RP.

In some examples, the first CXL.mem S2M DRS and the second CXL.mem S2M DRS may be identical, whereas in other examples the first RPU may construct the second CXL.mem S2M DRS based on the first CXL.mem S2M DRS with variations, such as updating fields, e.g., Device Load (DevLoad), MetaField, MetaValue, TRP, Opcode, or reserved fields. Additionally or alternatively, the first RPU may alter the structure of the second CXL.mem S2M DRS compared to the original first CXL.mem S2M DRS, such as by adding a trailer. In some examples, the second CXL.mem M2S request may be different from the first CXL.mem M2S request due to differences in protocol revisions, such as when the first RPU communicates with the RP according to CXL 1.1, whereas the second RPU communicates with the third entity according to CXL 3.2, or such as when message format conversion is required between HBR and PBR formats, e.g., when the second RPU utilizes PBR mode or PBR messages, whereas, for example, the RP is associated with an HBR host. Similarly, the second CXL.mem S2M DRS may be different from the first CXL.mem S2M DRS due to differences in protocol revisions, or such as when message format conversion is required between HBR and PBR formats. In some examples, the first RPU and the second RPU may be coupled by a switch, such as a UALink switch.

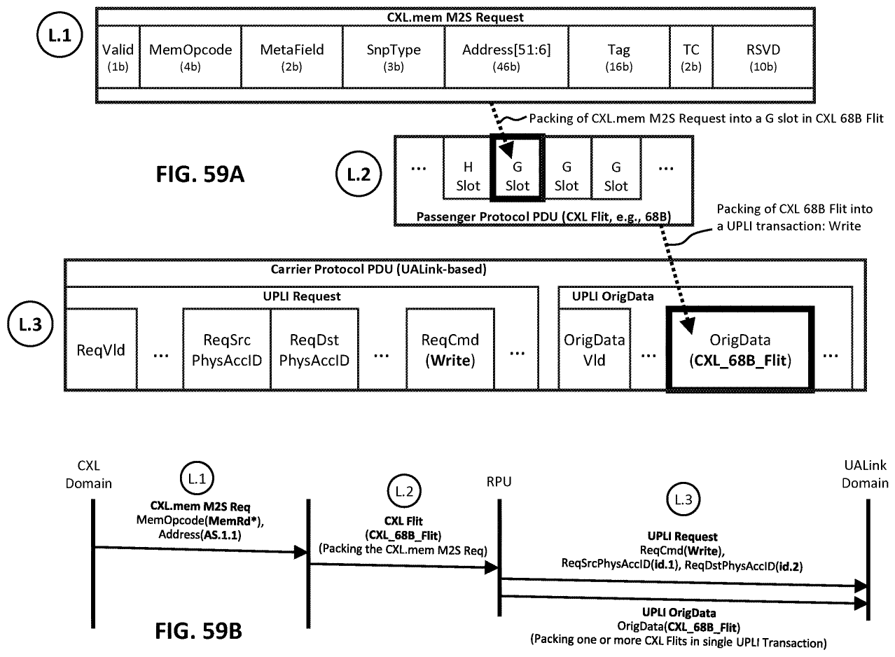

FIG. 59A illustrates an example of encapsulating 68-byte CXL flits into UPLI transactions comprising Write commands. The figure illustrates a CXL Transaction Layer message comprising a CXL.mem M2S request that is packed into a 68-byte CXL flit. The 68-byte CXL flits comprise H slots and G slots for organizing transaction data, wherein 68-byte flits correspond to CXL 1.1 and 2.0 specifications or may be utilized in other CXL versions. The UPLI side shows the encapsulation into a UPLI Write command, which supports variable payload sizes between 1 and 256 bytes, making it suitable for accommodating the 68-byte CXL flit payload. The UPLI Write command structure comprises a UPLI request section with fields including ReqVld, ReqSrcPhysAccID, ReqDstPhysAccID, and ReqCmd (Write), and a UPLI OrigData section wherein the 68-byte CXL flit payload is carried. The illustrated example may pack one or more 68-byte CXL flits into a UPLI transaction, enabling flexible encapsulations wherein 68-byte flits may be combined into a larger UPLI write command that does not necessarily utilize the full 256-byte capacity.

FIG. 59B illustrates an example of a TFD depicting translations utilized for encapsulating a 68-byte CXL flit into a UPLI Write command. The transaction flow shows a CXL.mem M2S request being packed into a 68-byte CXL Flit and subsequently encapsulated into a UPLI Write command. The UPLI Write command supports variable-size payloads and is suitable for encapsulating the 68-byte CXL flit, wherein the write command may specify the data payload size and utilize byte enables to indicate which bytes are being written. The TFD indicates that the OrigData channel of UPLI is utilized to pass the actual data content of the CXL flit. The encapsulation enables CXL communications to be transported over UPLI infrastructure, wherein the UPLI Write command provides sufficient capacity and flexibility to accommodate the 68-byte CXL flit payload that does not align with native UPLI block sizes of 64 bytes or 256 bytes. The byte enable mechanism allows specification of the valid data bytes within the write transaction, accommodating the non-standard 68-byte payload size.

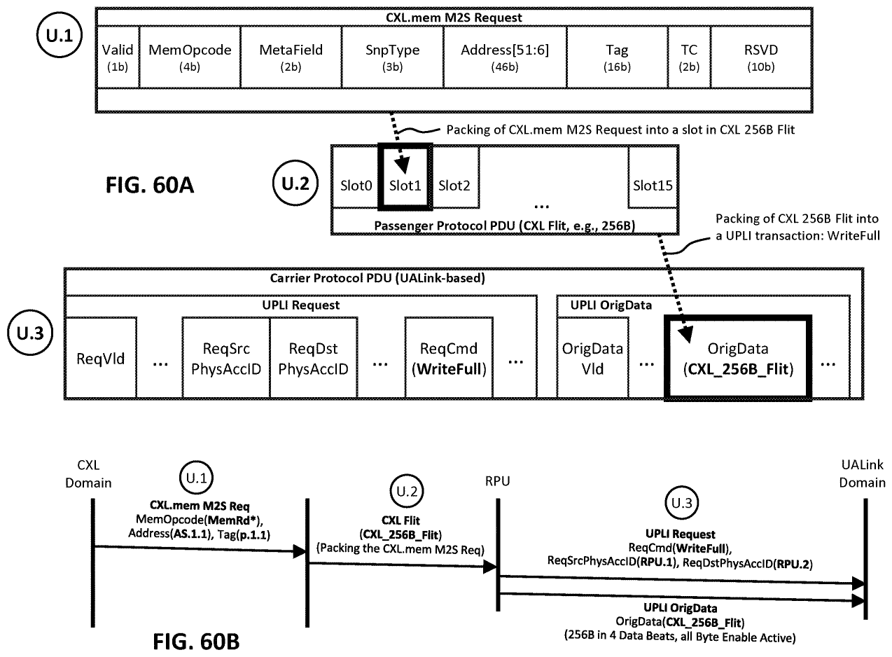

FIG. 60A illustrates an example of encapsulating 256-byte CXL flits into UPLI WriteFull commands. The figure is organized in three levels labeled U.1, U.2, and U.3, demonstrating the transformation from a CXL transaction layer message to UPLI carrier protocol PDU encapsulation. Level U.1 shows the CXL.mem M2S request message structure comprising fields Valid (1 bit), MemOpcode (4 bits), MetaField (2 bits), SnpType (3 bits), Address[51:6] (46 bits), Tag (16 bits), TC (2 bits), and RSVD (10 bits). Level U.2 shows the packing of the CXL.mem M2S request into a slot within a CXL 256-byte flit, wherein the flit structure comprises 16 slots labeled Slot0 through Slot15, representing the Passenger Protocol PDU (CXL Flit, e.g., 256 B). Level U.3 shows the packing of the CXL 256-byte flit into a UPLI transaction utilizing WriteFull command, wherein the Carrier Protocol PDU (UPLI Write) comprises two main sections: a UPLI request (Req) section with fields including ReqVld, ReqSrcPhysAccID, ReqDstPhysAccID, and ReqCmd (WriteFull), and a UPLI OrigData section wherein the CXL_256B_Flit is carried as the OrigData payload. The WriteFull command is specifically designed for 256-byte payloads, matching the 256-byte CXL flit size and enabling efficient encapsulation wherein all bytes are active and all byte enables are set, in contrast to the variable-length Write command that requires byte enable management.

FIG. 60B illustrates an example of a TFD depicting translations utilized for encapsulating or packing of a CXL.mem request message into a 256-byte CXL flit that is further encapsulated into a UPLI WriteFull command. At U.1 in the CXL Domain, a CXL.mem M2S Req structure originates with MemOpcode(MemRd*), Address(AS.1.1), and Tag(p.1.1). At U.2, the RPU receives or generates a CXL Flit (designated as CXL_256B_Flit), which indicates the packing of the CXL.mem M2S Req into the flit structure. At U.3 in the UALink Domain, the transaction is encapsulated into a UPLI request (Req) with ReqCmd(WriteFull), ReqSrcPhysAccID(RPU.1) identifying the source RPU, and ReqDstPhysAccID(RPU.2) identifying the destination RPU. The UPLI OrigData section carries the OrigData(CXL_256B_Flit) payload, wherein the 256-byte payload is transmitted in 4 Data Beats with all Byte Enable Active, reflecting that UPLI transactions utilize 64-byte data beats such that four beats are required to transmit the 256-byte flit (4×64 bytes=256 bytes). The WriteFull command enables all bytes, indicating that the entire 256-byte capacity is utilized without requiring selective byte enable management, providing an efficient match between the 256-Byte CXL flit size and the 256-Byte UPLI WriteFull command capacity.

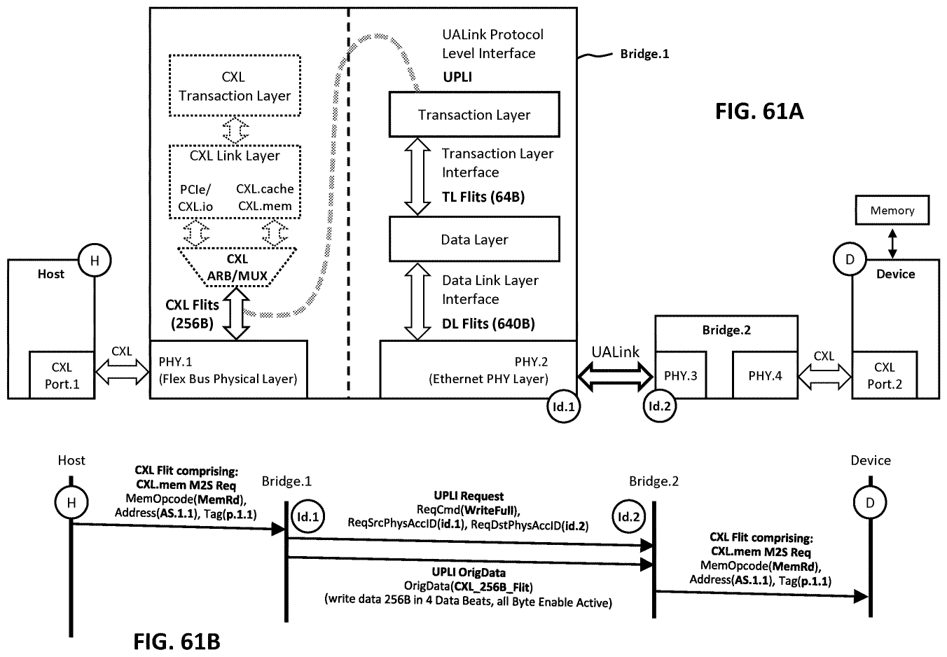

FIG. 61A illustrates an example of a system that translates CXL flits to UPLI transaction layer messages, providing a method for passing CXL protocols over a UALink infrastructure, wherein LL denotes link layer and TL denotes transaction layer. The system captures CXL flits from the interface between the CXL ARB/MUX and the Flex bus physical layer, or from the Flex bus physical layer (denoted as PHY.1), and maps them to the UPLI transaction layer. The upper-layers of the CXL side of the system, that may include the CXL Transaction Layer, the CXL Link Layer, and the CXL ARB/MUX, is illustrated with dotted lines, indicating that the dotted elements may not be utilized in the translation process. The interface between the CXL ARB/MUX and the Flex bus physical layer conveys CXL Flits, such as 256 bytes Flits, which may be captured for mapping to the UPLI transaction layer. The UPLI side shows the UPLI Transaction Layer that transmits TL Flits (of 64 Bytes in one example) to the Data Link Layer that transmits, via the data link layer interface, DL Flits (of 640 Bytes in one example) to the Ethernet PHY layer (denoted as PHY.2). The translation from the CXL link layer to the UPLI transaction layer may provide advantages wherein traffic may already be packed efficiently at the CXL link layer, and may enable support for various protocol types including CXL.mem, CXL.cache, CXL.io, and PCIe, without requiring separate translation schemes for each protocol type, wherein at the CXL link layer the protocols are packed into CXL flits regardless of whether the original traffic is PCIe, CXL.io, CXL.cache, or CXL.mem. The system encapsulates CXL flits entirely into UPLI requests, wherein 256-byte CXL flits may be packed into 256-byte UALink WriteFull transactions, wherein WriteFull utilizes the maximum 256-byte payload size in contrast to regular UALink write commands that support variable length with byte enables. The dotted lines for the CXL Transaction Layer and the CXL Link Layer indicate that these layers are bypassed in the translation process, distinguishing this example from transaction layer to transaction layer translations.

FIG. 61B illustrates an example of a TFD depicting the tunneling of CXL flits over UPLI, wherein the CXL flit structure is preserved during encapsulation and transport. The TFD shows a CXL Flit, which may include a CXL.mem M2S Req or other CXL transactions, being translated to a UPLI WriteFull command. The notation indicates that the CXL Flit comprises CXL transactions that were originally present at the transaction layer but are now packed within the flit structure. The UPLI WriteFull command encapsulates the entire 256-byte CXL flit, maintaining the flit structure intact during transmission over the UALink infrastructure. The TFD demonstrates flit-level tunneling wherein the contents of the flit remains opaque to the intermediate protocol, enabling a universal transport mechanism that may support various types of CXL protocol, possibly including future CXL protocols, without requiring modifications to the translation logic, wherein the CXL link layer packs transactions into CXL flits and the translation process encapsulates these CXL flits into UPLI transactions for transport. The illustrated example may operate point-to-point between known endpoints, wherein switching decisions are made at the transaction layer by edge switches while the tunneling maintains CXL flit integrity between translation points.

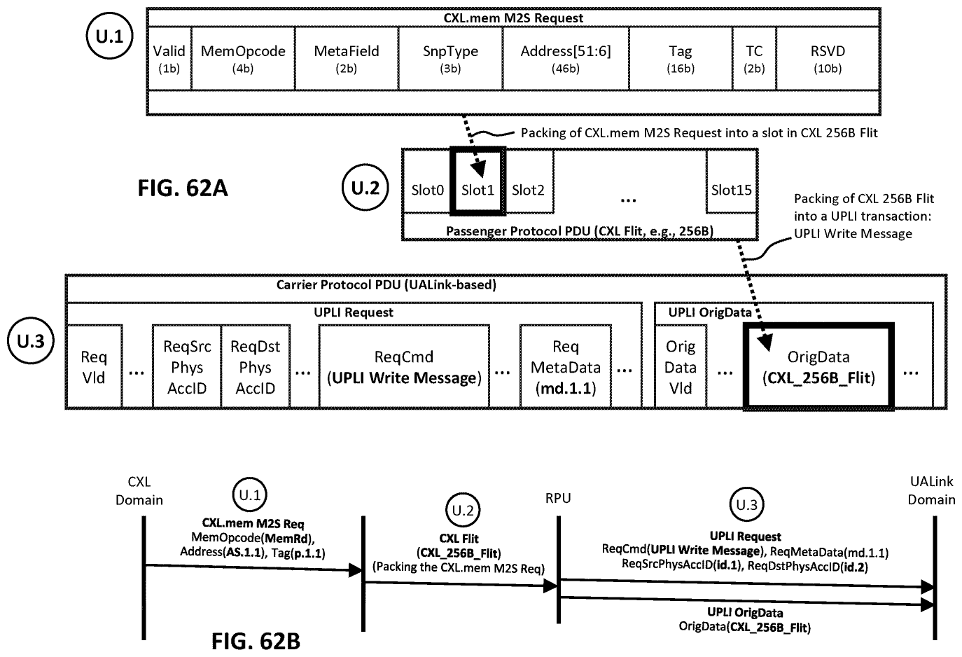

FIG. 62A illustrates an example of utilizing a UPLI write message command for tunneling CXL flits, wherein the UPLI write message command provides both read and write semantics. The UPLI write message command may be suitable for tunneling applications wherein bidirectional data flow is required, enabling both read operations (wherein data flows from the remote side back to the requester) and write operations (wherein data flows from the requester to the remote side). The UPLI write message command may support general-purpose tunneling wherein the flexibility of supporting both read and write patterns within a single command type may simplify the translation logic. The UPLI write message command may be utilized to encapsulate CXL flits regardless of whether the underlying CXL transaction is a read request (wherein response data will flow in the opposite direction) or a write request (wherein data accompanies the request).

FIG. 62B illustrates an example of a TFD depicting utilizing a UPLI write message command for tunneling a CXL transaction, wherein the command's dual semantics enable handling of both read and write transaction patterns. The TFD demonstrates how CXL requests are encapsulated within UPLI write message commands for transport over UPLI infrastructure, such as UALink infrastructure, wherein the UPLI write message command provides the flexibility to support the bidirectional nature of CXL communications. The UPLI write message command enables maintaining the transaction during tunneling operations, wherein read requests generate data responses flowing in the reverse direction and write requests include data flowing in the forward direction, and wherein a single command type accommodates both patterns.

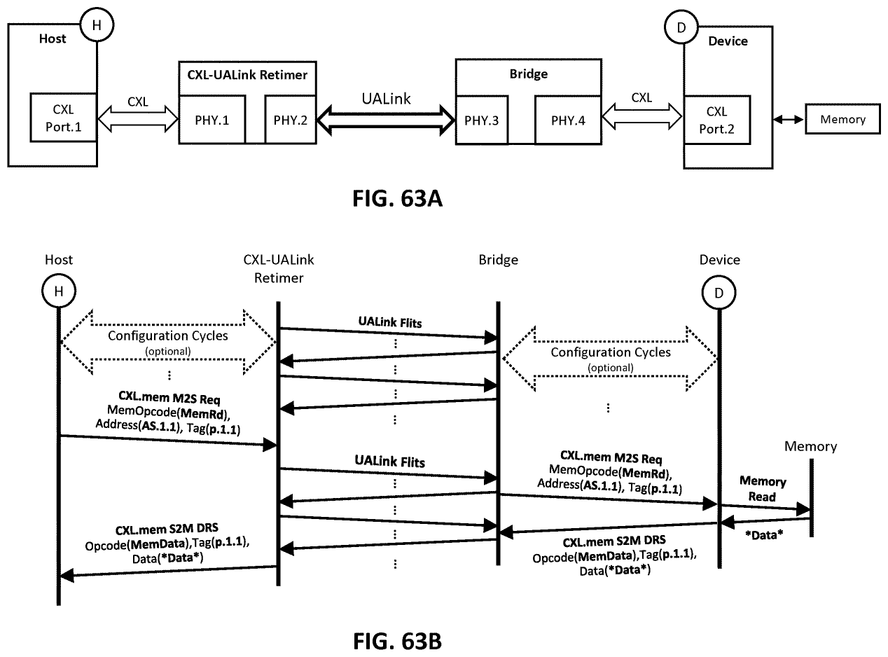

FIG. 63A illustrates an example of a system comprising a host comprising a first CXL port, a retimer (such as a flit-aware CXL-UALink retimer or a hybrid multi-protocol retimer), a bridge (which may be an RPU), and a device comprising a second CXL port. The retimer may communicate with the host via a first physical layer (PHY.1), such as a Flex Bus PHY, a UCIe PHY, or an NVLink-C2C PHY, and may further communicate with the bridge via a second physical layer (PHY.2) based on IEEE 802.3 PMA, such as a UALink PHY, an NVLink PHY, or an Ethernet PHY. The bridge may receive, via a third physical layer (PHY.3) based on IEEE 802.3 PMA (such as a UALink PHY, an NVLink PHY, or an Ethernet PHY), transmissions comprising data indicative of CXL opcodes and physical addresses, wherein the bridge may further translate the data to CXL requests, such as CXL.mem M2SReq, and send the translated CXL request to the device, via a fourth PHY (PHY.4, such as a Flex Bus PHY, a UCIe PHY, or an NVLink-C2C PHY), enabling the host to read the memory coupled to the device.

In some examples, the transmissions comprising data indicative of CXL opcodes and physical addresses may include tunneling or encapsulation of CXL-related traffic, such as tunneling or encapsulation of CXL PDUs, CXL messages, CXL requests, CXL responses, CXL.io TLPs, or CXL flits, over a carrier protocol such as UALink, UPLI, NVLink, or Ethernet, including Scale Up Ethernet (SUE) or Ultra Ethernet Transport (UET). The tunneling or encapsulation of CXL-related traffic over the carrier protocol may be performed from different layers of the CXL protocol stack to different layers of the carrier protocol stack, such as (1) tunneling or encapsulation of CXL transaction layer PDUs, e.g., CXL messages or TLPs, over UALink UPLI layer PDUs, e.g., UPLI write requests or UPLI requests utilizing vendor-defined commands, (2) tunneling or encapsulation of CXL messages or TLPs over UALink Transaction Layer (TL) Flits, such as over 64-Byte UALink TL Flits, (3) tunneling or encapsulation of CXL messages or TLPs over UALink Data Link Layer (DL) Flits, such as 640-Byte UALink DL Flits, or (4) tunneling or encapsulation of CXL flits in/over carrier protocol flits, such as over UALink flits (e.g., UALink TL flits or UALink DL flits), or over NVLink flits.

In some examples, one or more CXL flits may be tunneled over or encapsulated in a carrier protocol flit, such as over a UALink flit or an NVLink flit. In still other examples, the bridge may be implemented in a chiplet inside an IC package of the device, whereas in other examples the bridge may be implemented as a functional block on the same silicon die with the memory controller, or may be split between dies or chiplets. Alternatively, the bridge may be implemented as a discrete component coupled to the device. Additionally or alternatively, the bridge may be included in a switch, such as a UALink switch or a CXL switch.

FIG. 63B illustrates an example of a TFD demonstrating CXL communications between a host and a device utilizing a PHY based on IEEE 802.3 PMA, such as a UALink PHY, an NVLink PHY, or an Ethernet PHY. In some examples, CXL requests sent by the host, may be converted or translated by a retimer, such as a CXL-UALink retimer, to transmissions that may include data indicative of CXL opcodes and physical addresses, which may be packed in UALink flits. In other examples, the data indicative of CXL opcodes and physical addresses may be packed in NVLink flits. CXL responses from the device may be converted or translated by the bridge to transmissions that may be packed in UALink flits and sent towards the host. Optionally, the system may utilize configuration cycles for discovery, enumeration, and initialization of the device.

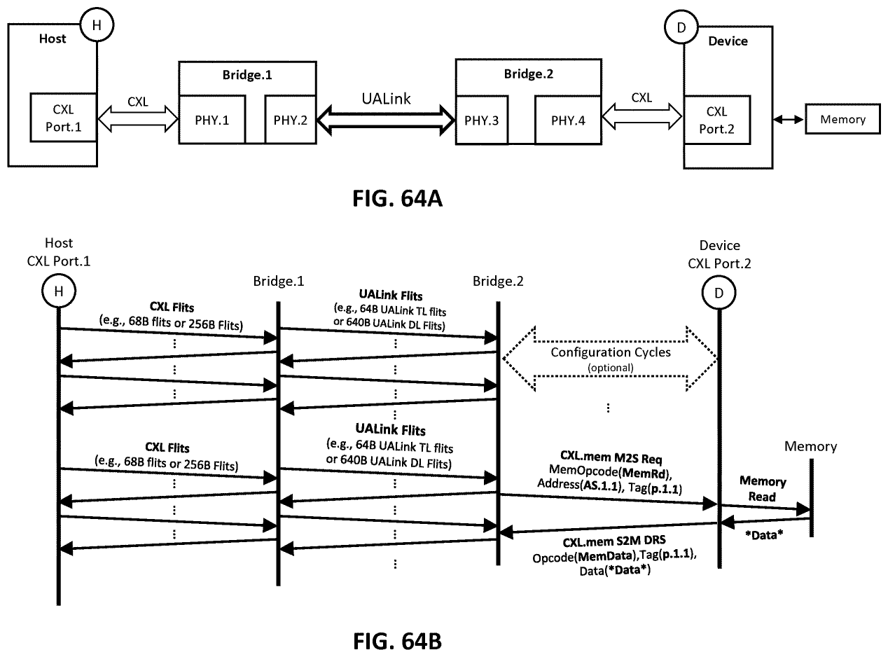

FIG. 64A illustrates an example of a system comprising a host with a first CXL port coupled to Bridge.1 via a first PHY (PHY.1), which may be implemented as a Flex Bus PHY, a UCIe PHY, or an NVLink-C2C PHY. Bridge.1 communicates with Bridge.2 via a second PHY (PHY.2) which may be based on IEEE 802.3 PMA, and may utilize a UALink PHY, an NVLink PHY, or an Ethernet PHY. Bridge.2 is coupled to a device comprising a second CXL port, via a fourth PHY (PHY.4), which may be implemented as a Flex Bus PHY, a UCIe PHY, or an NVLink-C2C PHY. In this example, Bridge.1 may potentially provide bridge-specific features while maintaining the ability to transport CXL protocol data units across the physical layer based on IEEE 802.3 PMA between the bridges.

FIG. 64B illustrates an example of a TFD demonstrating a translation between CXL flits and UALink flits, showing how CXL protocol data units (PDUs) may be packed, encapsulated or translated for transmission over UALink physical layers, such as IEEE 802.3-based UALink physical layers, or PCIe-based UALink physical layers. The figure shows CXL flits, which may include 68-byte flits or 256-byte flits depending on the CXL protocol configuration, being translated to UALink flits without specifying the particular protocol layer at which the translation occurs, as the translation may be performed at the transaction layer, link layer, or flit level depending on the implementation requirements. The translation enables CXL transactions to traverse a UALink infrastructure while maintaining protocol semantics, wherein the specific methodology for translating between the flit formats may vary based on factors such as bandwidth optimization, latency requirements, and protocol compatibility constraints.

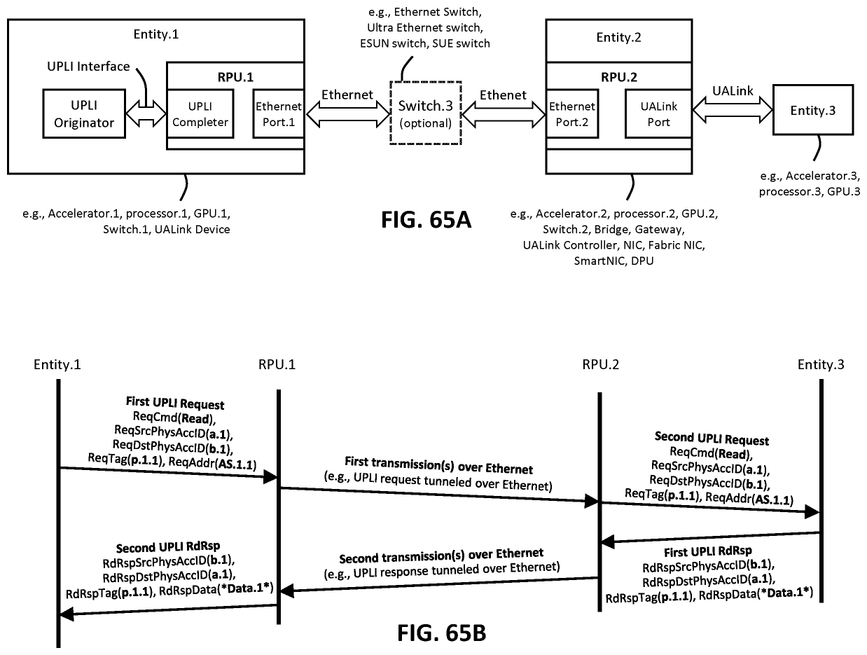

FIG. 65A illustrates an example of a system comprising a first entity (Entity.1), a second entity (Entity.2), and a third entity (Entity.3). The first entity (Entity.1) may include a first accelerator (Accelerator.1), a first processor (Processor.1), a first GPU (GPU.1), a first switch (Switch.1), or a UALink device, a UPLI originator. The first entity may further include a first RPU (RPU.1) comprising a UPLI completer and a first Ethernet port (Ethernet Port.1). The second entity (Entity.2) may include a second accelerator (Accelerator.2), a second processor (Processor.2), a second GPU (GPU.2), a bridge, a gateway, a UALink controller, a Network Interface Card (NIC), a Fabric NIC, a SmartNIC, or a Data Processing Unit (DPU), e.g., a UALink DPU. The second entity may further include a second RPU (RPU.2) comprising a second Ethernet port (Ethernet Port.2) and a UALink port. The third entity (Entity.3) may include a third accelerator (Accelerator.3), a third processor (Processor.3), or a third GPU (GPU.3). Additionally, the system may include an optional third switch (Switch.3), such as an Ethernet switch, an Ultra Ethernet switch, an ESUN switch, or an SUE switch.

The first and second RPUs may enable the first entity to communicate with the third entity according to a UALink-based protocol, such as UPLI, via the second entity and optionally via the third switch (Switch.3), such as by translating between UALink-based messages and transmissions comprising data indicative of UALink-based messages (e.g., transmissions comprising data indicative of UPLI messages, such as UPLI request messages), wherein the transmissions may utilize Ethernet-based frames such as standard Ethernet frames, which may be sent and received via the first and second Ethernet ports, optionally enabling the first entity to access resources of the third entity, such as registers or memory. In some examples, translating between the UALink-based messages and the transmissions utilizing Ethernet-based frames may enable UALink over Ethernet, such as via UALink tunneling over Ethernet, e.g., tunneling of UPLI requests and responses over Ethernet, or tunneling of UPLI transactions over Ethernet. In some examples, the first Ethernet port and the second Ethernet port may utilize the same physical layer technology, such as a physical layer based on IEEE 802.3 PMA (e.g., Ethernet PHY). In other examples, the first Ethernet port and the second Ethernet port may utilize different physical layer technologies. The first RPU may be implemented in a chiplet inside an IC package of the first entity, as a functional block on the same silicon die with the UPLI originator, or may be split between dies or chiplets. Alternatively, the first RPU may be implemented as a discrete component coupled to the second entity. Additionally or alternatively, the first RPU may be included in a switch, such as in an Ethernet switch.

FIG. 65B illustrates an example of a TFD demonstrating UALink-based communication, such as UPLI communication, between a first entity (Entity.1), such as a first accelerator, and a third entity (Entity.3), such as a third accelerator, wherein the UALink-based communication may be tunneled over Ethernet, such as over standard Ethernet, over Ultra Ethernet, over ESUN, or over SUE.

The first entity may initiate a read from the third entity, such as by sending a first UPLI request (Req) comprising ReqCmd(Read), ReqSrcPhysAccID(a.1), ReqDstPhysAccID(b.1), ReqTag(p.1.1), and ReqAddr(AS.1.1). The first RPU (RPU.1), which may reside in the first entity, may receive the first UPLI request (Req) and translate it to first transmission(s) comprising data indicative of UPLI messages, such as transmission(s) comprising data indicative of UPLI requests, wherein the first RPU may send the first transmission(s) which may utilize one or more Ethernet frames, to a second RPU (RPU.2), which may reside in a second entity, such as a bridge or a gateway. The first RPU may translate the first UPLI request (Req) to the first transmission(s) in a manner that enables reconstruction of the first UPLI request (Req) at the second RPU with minimal (or no) modifications, effectively tunneling the first UPLI request (Req) over Ethernet. For example, the first RPU may encapsulate the first UPLI request (Req) into an Ethernet frame, and send the Ethernet frame to the second RPU, wherein the first UPLI request (Req) may be extracted from the Ethernet frame such as by decapsulation. Additionally or alternatively, the first RPU may encapsulate a UALink flit comprising the first UPLI request (Req) into an Ethernet frame, and send the Ethernet frame to the second RPU, wherein the UALink flit comprising the first UPLI request (Req) may be extracted from the Ethernet frame such as by decapsulation.

The second RPU may receive the first transmission(s) and translate it to a second UPLI request (Req) comprising ReqCmd(Read), ReqSrcPhysAccID(a.1), ReqDstPhysAccID(b.1), ReqTag(p.1.1), and ReqAddr(AS.1.1), and send the second UPLI request (Req) to the third entity. In some examples, the first UPLI request (Req) and the second UPLI request (Req) may be identical, whereas in other examples the second RPU may construct the second UPLI request (Req) based on the first UPLI request (Req) with variations such as utilizing a different command (e.g., utilizing a Read class Vendor Defined Command instead of Read), utilizing a different tag namespace, e.g., ReqTag(p.2.1) instead of ReqTag(p.1.1), or utilizing address translations, e.g., ReqAddr(AS.2.1) instead of ReqAddr(AS.1.1).

The third entity may respond to the second UPLI request (Req) by sending a first UPLI read response/data (RdRsp) comprising RdRspSrcPhysAccID(b.1), RdRspDstPhysAccID(a.1), RdRspTag(p.1.1), and RdRspData(*Data.1*) to the second RPU, wherein the second RPU may translate the first UPLI read response/data (RdRsp) to second transmission(s) comprising data indicative of UPLI messages, such as transmission(s) comprising data indicative of UPLI responses, and send the second transmission(s) to the first RPU. The first RPU may further receive the second transmission(s) and translate it to a second UPLI read response/data (RdRsp) comprising RdRspSrcPhysAccID(b.1), RdRspDstPhysAccID(a.1), RdRspTag(p.1.1), and RdRspData(*Data.1*), and send the second UPLI read response/data (RdRsp) to the first entity. In some examples, the first UPLI read response/data (RdRsp) and the second UPLI read response/data (RdRsp) may be identical, whereas in other examples the first RPU may construct the second UPLI read response/data (RdRsp) based on the first UPLI read response/data (RdRsp) with variations, such as updating fields, e.g., RdRspPortID, RdRspAuthTag, RdRspSrcPhysAccID, RdRspDstPhysAccID, RdRspTag, or reserved fields. Additionally or alternatively, the first RPU may alter the structure of the second UPLI read response/data (RdRsp) compared to the original first UPLI read response/data (RdRsp), such as by appending metadata to the original data contents of the first UPLI read response/data (RdRsp). In some examples, the second UPLI request (Req) may be different from the first UPLI request (Req) due to differences in protocol revisions, such as different UALink protocol revisions. Similarly, the second UPLI read response/data (RdRsp) may be different from the first UPLI read response/data (RdRsp) due to differences in protocol revisions. In some examples, the first RPU and the second RPU may be coupled by a switch, such as an Ethernet switch.

### TERMINOLOGY

The term “Compute Express Link” (CXL) refers to currently available and/or future versions, variations and/or equivalents of the standard as defined by the CXL Consortium. CXL Specification Revisions 1.1, 2.0, 3.0, 3.1, 3.2, and 4.0 are herein incorporated by reference in their entirety.

The term “PCI Express” (PCIe) refers to currently available and/or future versions, variations and/or equivalents of the standard as defined by PCI-SIG (Peripheral Component Interconnect Special Interest Group). PCI Express Base Specification Revisions 5.0, 6.0, 6.1, and 6.2 are herein incorporated by reference in their entirety.

The term “Ultra Accelerator Link” (UALink) refers to currently available and/or future versions, variations and/or equivalents of the UALink Specification as defined by the Ultra Accelerator Link Consortium, Inc. UALink_200 Rev 1.0 Specification and its subsequent revisions are herein incorporated by reference in their entirety.

The term “Universal Chiplet Interconnect Express” (UCIe) refers to currently available and/or future versions, variations and/or equivalents of the standard as defined by the UCIe Consortium. UCIe Specification Revisions 1.0, 1.1, 2.0, and 3.0 are herein incorporated by reference in their entirety.

The term “Resource Provisioning Unit” (RPU) refers to a physical and/or logical processing module comprising or coupled to at least two interfaces and/or ports. The RPU may be implemented in various hardware, firmware, and/or software configurations, such as an ASIC, an FPGA, a logical and/or physical module inside a CPU/GPU/TPU/MxPU, a hardware accelerator, a host, a device, a controller, a switch, a memory pool, and/or a network node. The RPU may be implemented as a single module, a single computer, and/or as a distributed computation entity running on a combination of computing machines, such as ASICs, FPGAs, hosts, servers, network devices, CPUs, GPUs, accelerators, fabric managers, and/or switches. Unless the context indicates otherwise, descriptions of the RPU as comprising its interfaces and/or ports, descriptions of the RPU as being coupled to such elements, and descriptions of such elements as being part of or separate from the RPU, may be used herein interchangeably. Furthermore, references to the RPU performing operations may encompass both direct implementation by the RPU and indirect implementation through components coupled to or associated with the RPU, unless specifically distinguished by the context.

Various implementations described herein involve interconnected computers. The term “computer” refers to a device, an integrated circuit (IC), or a system that includes at least a processor or processing element, memory to store instructions or data, and a communication interface. This definition encompasses a wide range of implementations, including but not limited to: traditional computers, mobile devices, embedded systems, specialized computing elements (such as GPUs, FPGAs, ASICs, and DSPs), System-on-Chip (SoC) designs, network nodes, RPUs, MxPUs, and ICs incorporating processing capabilities, memory, and a communication interface. The processor may be of any type, including single-core or multi-core microprocessors, embedded controllers, accelerators, or any combination thereof. The memory may include volatile or non-volatile storage media. The communication interface allows the processor to send and/or receive data, signals, or instructions, and may include memory interfaces, buses, interconnects, network interfaces, or other arrangements facilitating data exchange. References to a “computer” or a “processor” include any collection of one or more computers and/or processors that individually or jointly execute one or more sets of computer instructions, meaning that the singular term “computer” is intended to imply one or more computers, which jointly perform the functions attributed to “the computer”.

It is noted that in an apparatus comprising interconnect interfaces and/or ports, the computer may be implemented as part of one or more of the interconnect interfaces and/or ports, as a separate component, or as a combination thereof. Unless the context indicates otherwise, operations attributed to the computer may be performed by one or more of the interconnect interfaces and/or ports, and conversely, relevant operations attributed to one or more of the interconnect interfaces and/or ports may be performed by the computer. This interchangeability applies to relevant processing operations described in this specification in relation to elements such as the computer, RPU, MxPU, xPU, switch, or the interconnect interfaces and/or ports.

The term “memory pool” refers to a system, an apparatus, a device, and/or a logically or physically distinct collection of resources that may incorporate, manage, or otherwise control memory capacity (such as volatile memory (e.g., DRAM) and/or non-volatile memory), and that may provide the capability to provision, allocate, deallocate, expose, share, map, and/or otherwise make available portions or aspects of its memory capacity for use, access, sharing, allocation, and/or consumption by one or more entities external to the memory pool. Such entities may include, but are not limited to, hosts, servers, processors, accelerators, computing devices, virtual machines, containers, processes, applications, services, operating systems, hypervisors, or other memory pools. Memory pool encompasses relevant implementations that perform functions related to memory resource aggregation, management, provisioning, and/or sharing, irrespective of its commercial designation, physical form factor, architectural design, interconnection method, communication protocol(s), or implementation methodology. A memory pool may also be capable of running workloads, applications, and/or computational tasks, thereby functioning as both a memory entity and a compute entity. Furthermore, a memory pool may be implemented as a logical entity that borrows, aggregates, or otherwise utilizes memory resources from other entities (such as hosts, devices, or other memory pools), rather than solely relying on dedicated physical memory resources under its direct control.

Depending on the context, the term “inter-socket link” (ISoL) may refer to any current or future high-speed communication link, interconnect, protocol, and/or architecture that facilitates data transfer between processors, such as CPUs, GPUs, TPUs, accelerators, DSAs, and/or other types of processing units. The interface points for these technologies may be collectively referred to as “ISoL ports”, though they may have technology-specific designations. ISoL encompasses direct inter-processor links, switched fabric designs, node controller-based topologies, optical interconnects, and/or heterogeneous computing interconnects linking different processor types. These interconnects support various processor arrangements including those soldered to PCBs, installed in motherboard sockets, or integrated as separate dies within chiplet-based designs.

Non-limiting examples of ISoL technologies include Intel's Coherent Processor Interconnect Protocol (ICPIP) for scalable multiprocessors with a shared physical address space, such as Ultra Path Interconnect (UPI); AMD's Infinity Fabric (IF) and its underlying External Global Memory Interconnect (xGMI); ARM's Coherent Hub Interface chip-to-chip (CHI C2C); NVIDIA's NVLink and NVLink chip-to-chip (NVLink-C2C); Ultra Accelerator Link (UALink); Ethernet for Scale-Up Networking (ESUN), and Scale Up Ethernet (SUE), including SUE-based Protocol Data Units (PDUs) such as SUE PDU, SUE Lite PDU, or PDUs based on future revisions of SUE. Each of these technologies, their successors, and other technologies developed in the future, implements specific port, interface, and protocol designs for inter-processor communication. The interface points for these technologies may have technology-specific designations, such as “UPI port” or “UPI link” for Intel processors, “IF link” or “xGMI link” for AMD processors, “NVLink port”, “NVLink link”, or “NVLink interface” for NVIDIA GPUs, or “UALink port”, “UPLI interface”, or “UPLI interface port” for UALink implementations.

A Cache-Coherent Chip-to-Chip Interconnect (CCCI) refers to a subset of ISoL that enables communication between processors while maintaining cache coherency across chips. CCCI may connect various types of processing units, such as CPUs to CPUs, GPUs to GPUs, CPUs to GPUs, or other combinations of processing units, and may implement cache coherency protocols such as MESI (Modified, Exclusive, Shared, Invalid), MOESI (Modified, Owned, Exclusive, Shared, Invalid), or other coherency schemes. The cache coherency support provided by CCCI may enable the processing units to efficiently share data, maintain memory consistency, and coordinate access to shared resources. Examples of ISoL technologies that function as CCCI include Intel's UPI, AMD's xGMI and Infinity Fabric, ARM's CHI C2C, and NVIDIA's NVLink-C2C.

The term “Physical Layer” or “PHY” refers to hardware and protocol responsible for transmission and reception of signals, typically in the context of data communication wherein raw data bits are converted to physical signal representations, and vice versa, to be sent and received over a target medium such as copper twin-axial (Twinax) cabling, fiber optics, PCB traces for chip-to-chip (C2C) communication, or a silicon interposer for die-to-die (D2D) connectivity. The physical layer (PHY) is typically associated with the lower layer, or layer 1, of the Open System Interconnection (OSI) reference model, and may include, but is not limited to, sub-layers such as a Physical Coding Sublayer (PCS), a Physical Medium Attachment (PMA), and a Physical Medium Dependent (PMD). Examples of physical layers may include the Flex Bus Physical Layer as specified in the various CXL specifications, the collection of physical layers defined by the IEEE 802.3 Working Group, sometimes collectively referred to as “802.3 PHY”, “Ethernet PHY”, or “IEEE 802.3 PMA” when referring to sub-layers of the PHY, such as a PMA. Other PHYs may include UALink physical layers, such as UALink_200 Rev 1.0 that is based on IEEE 802.3dj (D1.4), NVIDIA NVLink physical layers, Ultra Ethernet Transport (UET) physical layers, or other appropriate current or future communication technologies.

When referring to fields, operations, or operation types associated with communication protocols, the terms “opcode”, “command”, “TLP type”, “request”, “request type”, “transaction”, and “transaction type” may be used herein interchangeably as long as they refer to the same operation, and unless a particular context specifies otherwise. This interchangeable usage may apply to data indicative of operation types (such as a field or a set of fields) within messages, packets (such as TLPs), flits, phits, frames, protocol data units (PDUs), or other protocol data structures, as well as descriptions of protocol operations, requests, transactions, or communications across different communication protocols. For example, a “CXL.cache DirtyEvict opcode”, a “CXL.cache DirtyEvict command”, and a “CXL.cache DirtyEvict request” may refer to the same operation where a device communicates with a host, such as via a D2H request message, asking the host to evict a full 64-byte modified cacheline from the device. Likewise, an “ARM CHI ReadOnce opcode”, an “ARM CHI ReadOnce command”, an “ARM CHI ReadOnce request”, and an “ARM CHI ReadOnce transaction” may refer to the same operation that specifies a read within the CHI framework, whether referring to the actual field within a CHI message or to the operation itself. Similarly, a “UPLI read command”, a “UPLI read opcode”, a “UPLI read request”, and a “UPLI read transaction” may refer to the same operation, field, or set of fields within a UPLI message that indicates a read within the UPLI framework.

The CXL Specifications use terms such as message, transaction, command, opcode, request, and response in contexts that sometimes overlap. For example, “MemRd message”, “MemRd command”, and “MemRd opcode” may refer to similar or related concepts. Similarly, “CXL.mem message”, “CXL.mem transaction”, “CXL.mem request”, and “CXL.mem response” may be used in overlapping contexts. Accordingly, depending on the context, this specification may use such terms broadly. Additionally, references to CXL messages may encompass CXL transactions, and vice versa. Moreover, the CXL Specifications occasionally describe CXL.cache and CXL.mem using various terms such as protocols, channels, interfaces, or transactional interfaces, which may be used herein interchangeably depending on the context.

Depending on the context and implementation, the terms “UALink requests”, “UALink UPLI requests”, and “UPLI requests” may be used herein interchangeably. The interchangeable use of these terms reflects that UPLI constitutes the protocol layer of UALink communications, and unless a particular context requires distinction between the physical layer aspects and the protocol layer aspects, these terms may refer to the same underlying communication transactions within the UALink ecosystem.

In the context of ARM CHI implementations, the terms “CHI messages”, “CHI packets”, and “CHI flits” may be used herein interchangeably, unless a particular context specifies otherwise. The ARM AMBA CHI Architecture Specification defines communication granularity at different layers, including transactions at the protocol layer, packets at the network layer, and flow control units (flits) at the link layer. For CHI, packets may include a single flit, which may contribute to the interchangeable use of these terms. When referring to CHI communications herein, any of these terms may be used to describe CHI protocol-level communications without implying limitations to a specific layer or format.

The terms “port” and “interface” may be used herein interchangeably unless the context requires distinction between them. Depending on the context, a port may refer to a physical or logical connection point configured to support communication with or within components, devices, or systems. A port may include, be included in, or be coupled to various interface types, may support one or more communication protocols and/or may refer to various specialized port types depending on the context. For example, the following pairs may be used herein interchangeably unless a particular context specifies otherwise: CHI interface and CHI port, CXL interface and CXL port, UALink interface and UALink port, and NVLink interface and NVLink port.

The term “Coherent Hub Interface” (CHI) as used herein is intended to encompass presently available and future versions, variations, revisions, and equivalent implementations of the CHI interconnect architecture, including AMBA 5 CHI and subsequent issues or architectural extensions published or adopted by ARM or by other entities that may extend CHI. Unless stated otherwise, translating between CHI and another protocol, such as translating between CHI and CXL, refers to converting CHI-related protocol data units (PDUs), such as CHI requests, CHI snoop requests, CHI data responses, and CHI snoop responses, to corresponding PDUs of the other protocol, such as to CXL.cache requests and responses, or to CXL.mem requests and responses, and vice versa, optionally including field value translations between the CHI domain and the other protocol domain, such as addresses, transaction identifiers, and/or cache state indications.

The term “NVLink” as used herein is intended to encompass previous, current, and future versions, variations, revisions, and equivalent implementations of NVIDIA's NVLink interconnect, including NVLink-C2C, NVLink used with NVSwitch and/or NVLink Switch fabrics, and other NVLink-related implementations that provide a high-bandwidth, low-latency, scalable interconnect between GPUs, between GPUs and CPUs, and/or between other types of processing units. Unless stated otherwise, translating between NVLink and another protocol, such as translating between NVLink and CXL, refers to converting NVLink-related protocol data units (PDUs), such as NVLink requests and NVLink responses, to corresponding PDUs of the other protocol, such as to CXL.io requests and completions, or to CXL.mem requests and responses, and vice versa, optionally including field value translations between the NVLink domain and the other protocol domain, such as Tags, error indications, and/or addresses.

### GENERAL CONSIDERATIONS

Asterisks (*) may be utilized as wildcard notations within the context of an implementation and/or an example, such as for representing a subset of relevant operations within a broader set of operations that may be indicated by opcodes, TLP types, commands, requests, request types, transactions, or transaction types, collectively referred to in this specific paragraph as “operation types”. The subset of relevant operations may include operation types that are relevant to the revisions or standards being discussed, encompassing both existing operation types and potential future operation types that may be introduced in subsequent versions of the applicable interconnect standards, including CXL, UALink, ESUN, SUE, PCIe, UCIe, ARM CHI, ARM AXI, or protocol implementations based on NVLink technology, provided they are applicable and relevant to the implementation in question. For example, the wildcard operation type ReadOnce* may represent a subset of relevant requests or transactions within the ARM CHI specifications, which may include, but is not limited to: ReadOnce, ReadOnceCleanInvalid, and ReadOnceMakeInvalid. Similarly, the wildcard operation type MemRd* may represent a subset of relevant opcodes within the CXL standard, which may include, but is not limited to: MemRd, MemRdData, MemRdFwd, MemRdTEE, MemRdDataTEE, or other opcodes that may be introduced in future CXL standard revisions, provided they are relevant to the implementation under consideration. Likewise, the wildcard operation type *Rd* may represent a broader subset of relevant operations across different protocols or different standards, which may encompass, but is not limited to: (1) ReadNoSnp, ReadOnce, ReadClean, ReadShared, ReadUnique and MakeReadUnique commands in ARM CHI; (2) UIOMRd and MRd TLP types in CXL.io; (3) RdCurr, RdOwn, RdShared, RdAny, and RdOwnNoData opcodes in CXL.cache; (4) MemRd, MemRdData, MemRdFwd, MemRdTEE, MemRdDataTEE, MemSpecRd, or MemSpecRdTEE opcodes in CXL.mem; (5) read commands in UALink UPLI; (6) memory read TLP types in PCIe; (7) read-class operations in SUE; or (8) read request types in NVLink-based protocol implementations. The examples listed for each protocol are non-limiting and are intended to encompass future operation types that may be introduced in subsequent revisions of the applicable standards, provided they are relevant to the implementations. The wildcard notation does not extend to operation types that are irrelevant to the implementation in question, even if such operation types exist within the broader specifications of the respective standards.

The wildcard form “*Data*” may be utilized for denoting essentially the same underlying information (“the Data”) irrespective of its representation, state, or protocol encoding. *Data* may encompass functionally equivalent forms and transformations of “the Data”, such as encoding, packetization, encapsulation, serialization, scrambling, compression, encryption, segmentation, or splitting, and their respective reverse transformations, represented in a suitable structure, manner, form, or format that may be carried by or interoperate with the applicable interconnect standard specifications, such as CXL, UALink, ESUN, SUE, PCIe, UCIe, ARM CHI, ARM AXI, or NVLink-based protocol implementations. For example, *Data* may refer to the same essential data payload when carried across different hops of a communication path that may each use different encryption, such as when one hop utilizes CXL Integrity and Data Encryption (CXL IDE) and another hop utilizes a different encryption mechanism or no encryption, or when different encryption keys are used on different interconnect links or channels. *Data* may further encompass the same essential data payload when carried in PDUs associated with the same or different protocols, such as: a CXL.mem S2M Data Response (DRS), a CXL.cache H2D Data message, a PCIe Completion with Data (CplD), a PCIe UIO Read Completion with Data (UIORdCplD), a UALink UPLI Data Beat carrying Read Response Data, or an NVLink data transmission. *Data* may also denote PDUs having collectively essentially the same payload, such as when splitting a 128 B cacheline into two 64 B transfers carried in two separate messages, or when an RPU splits a request for a large data block into smaller requests for translation to another protocol that supports a smaller maximum transfer size per request.

Depending on the context, each line, arrow, label, and/or box illustrated in the figures may represent one or more lines, arrows, labels, and/or boxes. For example, a single arrow representing a *Rd* operation in CXL, UALink UPLI, ESUN, SUE, PCIe, or an NVLink-based protocol may encompass one or more read or data messages relevant to the specific implementation and applicable standard, even though each may be represented by a single arrow. Additionally, optional messages, such as completion, acknowledgment, or response messages in the respective standards, may be explicitly depicted or implicitly included within the mandatory messages or their equivalents.

It is specifically noted that the transaction flow diagrams (TFDs) presented herein are schematic representations, which means that the number, order, timings, dimensions, and other properties of the information illustrated in the TFDs are non-limiting examples. Every modification, variation, or alternative allowed by a current or future Specification mentioned in the TFD (such as CXL, UALink, ESUN, SUE, PCIe, UCIe, CHI, AXI, etc.) that is relevant to a diagram, is also intended to be included within the scope of said diagrams. Furthermore, the scope of these diagrams extends to encompass implementations that may deviate from the strict specifications mentioned in the TFDs due to factors such as hardware bugs, relaxed designs, or implementation-specific optimizations.

Herein, terms such as send/sending, receive/receiving, communicate/communicating, or exchange/exchanging when used to describe elements (e.g., computer, RPU, MxPU, processor, semiconductor device, switch, port, interface) involved in data, message, packet, or other information exchanges, may refer to direct or indirect operation(s) that facilitate information transfer to/from/between such elements. When a first element is said to send information to a second element, it is not required to directly transmit the information from the first element to the second element; similarly, when a first element is said to receive information from a second element, the first element is not required to directly obtain the information from the second element. Instead, the elements may initiate, cause, make available, control, direct, participate in, or otherwise facilitate such transfer. The information transfer may occur directly or indirectly utilizing one or more intermediary components, such as switches, retimers, redrivers, bridges, and/or protocol translators, and may include routing, forwarding, encryption, buffering, protocol conversion, or other suitable data transfer mechanisms over a suitable communication path and/or connection. Similarly, sentences in the form of “a port/interface configured to communicate with an entity” refer to direct or indirect coupling between the port/interface and the entity.

As used herein, “mounted to” refers to a physical coupling between components, such as cards, boards, or devices, where a first component is mechanically secured or attached to a second component through a suitable mounting mechanism. The physical mounting may be direct or may involve intermediate mounting structures, and encompasses components that are mounted on, mounted in, mounted within, mounted through, mounted under, mounted alongside, or mounted via a mechanical coupling arrangement. The physical mounting connection may include an electrical connection integrated with the mechanical mounting mechanism, such as when a card is inserted into a slot with integrated electrical contacts. Alternatively, the electrical connection between mounted components may be established through a separate element from the mechanical mounting structure. Non-limiting examples of such separate electrical connection elements may include: cables (such as MCIO cables, SlimSAS cables, or power cables), sockets, card edge connectors, PCIe connectors, CXL connectors, backplane connectors, EDSFF connectors, OCP connectors, QSFP-DD connectors, or other electrical interconnects suitable for establishing electrical communication between the mounted components.

References to a protocol “based on” a specific standard or an industry standard (such as a protocol based on CXL, a CXL-based protocol, a protocol based on UALink, a UALink-based protocol, a protocol based on NVLink, an NVLink-based protocol, a protocol based on CHI, a CHI-based protocol, a protocol based on Ethernet, an Ethernet-based protocol, a protocol based on PCIe, or a PCIe-based protocol) are intended to encompass protocols that conform to the referenced standard, as well as protocols that maintain the fundamental communication logic and essential functional characteristics of the referenced standard while potentially incorporating modifications, extensions, or variations. Non-limiting examples of such variations may include protocols that utilize renamed, reordered, or modified fields while preserving the same or similar message formats; protocols that implement essentially the same logical operations utilizing equivalent command sequences or opcodes; protocols that preserve the essential addressing schemes, routing logic, and coherency models; vendor-specific implementations that add proprietary extensions while maintaining core functionality; protocols that implement subsets of the full standard specification; or protocols that adapt the standard for different physical layers or transport mechanisms while maintaining the essential protocol properties. For example, a CXL-based protocol may encompass implementations that rename CXL.mem opcodes but preserve their memory access properties, add vendor-defined fields to CXL message formats while maintaining backward compatibility, or that implement CXL transaction flows over alternative physical layers such as IEEE 802.3 PMA or UCIe. A UALink-based protocol may encompass implementations that add vendor-defined fields, packets, or commands while preserving the essential accelerator-to-accelerator communication model. A PCIe-based protocol may encompass implementations that utilize non-PCIe physical layers or carrier protocols for transferring PCIe TLPs. An NVLink-based protocol may encompass implementations that extend or modify the command encoding while maintaining the fundamental interconnect functionality.

References to a protocol-based port (such as CXL-based port, UALink-based port, NVLink-based port, or PCIe-based port) are intended to encompass ports that communicate according to the referenced protocol or according to a protocol based on the referenced protocol. A protocol-based port may communicate over the protocol's native physical layer, over alternative physical and/or transport layers, or according to the protocol encapsulated within, tunneled over, or transported over other protocols or interconnect technologies. For example, a CXL-based port may refer to a standard CXL port communicating over PCIe physical layer, a port communicating according to CXL over a physical layer based on IEEE 802.3 PMA, or a port communicating according to CXL over UCIe. A UALink-based port may communicate over its native physical layer, over UCIe, over ESUN, or over SUE. Similarly, an NVLink-based port may communicate over its native physical layer, over UCIe, over ESUN, or over SUE.

The drawings presented herein are schematic representations, meaning that the number, order, timings, dimensions, connections, and other properties of the elements illustrated in the drawings are non-limiting examples. Depending on the context, elements (such as lines, arrows, boxes, blocks, symbols, or labels) illustrated in the drawings may represent one or more actual elements. For example, a single box in a block diagram may represent multiple hardware components or software modules, a single arrow in a flowchart may represent multiple process steps or data transfers, and a single line in a circuit diagram may represent multiple electrical connections. Every modification, variation, or alternative allowed by current or future relevant specifications, standards, or common practices in the field is intended to be included within the scope of said drawings. Furthermore, the scope of the drawings extends to encompass implementations that may deviate from strict specifications due to factors such as hardware bugs, relaxed designs, implementation-specific optimizations, or practical constraints, provided such deviations do not fundamentally alter the underlying principles of the implementation.

A computer program (also referred to as software, firmware, or executable logic) encompasses any set of instructions, logic, or data structures executable or interpretable by a computing device. This includes compiled or interpreted code, scripts, and machine-learning models (e.g., neural network weights, biases, and configurations). The computer program may be deployed as a standalone application, autonomous agent, service, microservice, container, or distributed module, and may be organized within any storage architecture, including file systems, object storage, or memory-mapped configurations. The program may reside locally, in a distributed network, or a cloud environment, and may utilize static or dynamic execution paradigms.

As used herein, “non-transitory computer-readable medium” refers to any tangible medium capable of storing instructions, code, or data for access by a computing device, excluding transitory propagating signals. This encompasses all forms of volatile and non-volatile memory, including semiconductor memory (e.g., RAM, Flash, RRAM, MRAM), magnetic storage, optical storage, and emerging persistent storage technologies. The medium may be integral to a device, removable, or distributed across multiple locations (e.g., a distributed database or cloud storage). The instructions, logic, or data structures may be pre-installed or downloaded to the medium via a communication network, such as the Internet. A computer program product comprises such a non-transitory medium containing content that, when accessed by one or more processors, performs the disclosed methods.

The “computer-implemented methods” described herein refer to method operations executed by processing hardware based on logical instructions, firmware, and/or hardwired logic. The processing hardware may include general-purpose processors, ASICs, FPGAs, or other hardware logic that implements the method operations through software execution, firmware execution, dedicated circuitry, or combinations thereof. The execution environment may be centralized or distributed, encompassing standalone devices, networked systems, cloud-based platforms, edge computing nodes, virtualized or containerized environments, and hybrid combinations thereof. The instructions or logic defining the method may be stored on one or more non-transitory computer-readable media, encoded in hardware description languages, and/or implemented in circuit logic.

Unless specifically requiring a particular implementation form, functionality described as implemented in hardware may alternatively be implemented in software, firmware, or a combination thereof, and vice versa. Similarly, functions described as performed by a single component may be distributed across multiple components, and functions described as distributed may be consolidated into a single component. The allocation of functions between hardware and software, or between centralized and distributed implementations, does not limit the scope of the implementations unless explicitly required.

The methods, algorithms, logics, processes, operations, and system functions described herein are not limited by a particular order, timing, sequence, grouping, or a specific implementation or example described or illustrated unless expressly stated otherwise. Steps, operations, and functions may be performed in any reasonable order, simultaneously or sequentially, in parallel or series, and may be combined, separated, modified, rearranged, omitted, supplemented, or distributed across multiple systems or components based on particular implementation requirements. Any process descriptions, steps, or blocks in flowcharts or other illustrations should be understood as potentially representing modules, segments, portions of code, or operations that may be executed in any reasonable order, combination, or concurrently, and are not necessarily limited to the particular sequence depicted.

Phrases such as “an implementation”, “various implementations”, “some implementations”, “one or more implementations”, “an embodiment”, “some embodiments”, “one embodiment”, “an aspect”, “a configuration”, “an example”, and similar phrases are used herein for convenience and do not imply that a disclosure relating to such phrase(s) is essential to the subject technology or that such disclosure applies to all implementations of the subject technology. Phrases such as “an implementation”, “some implementations”, or “various implementations” may refer to one or more implementations and vice versa, and this applies similarly to other foregoing phrases. Distinct references, including terms such as “one implementation”, “another implementation”, “various implementations”, or “some implementations”, do not necessarily denote separate implementations. Such references may describe the same implementation from different perspectives, highlight various aspects of a single implementation, or pertain to distinct implementations. References to examples or instances are to be understood as non-limiting.

Sentences in the form of “X is indicative of Y” mean that X includes information correlated with Y and/or describing Y, up to the case wherein X equals Y. Sentences in the form of “provide/receive an indication (of whether X happened)” may refer to any indication method. The word “most” of something is defined as above 51% of the something (including 100% of the something). The words “portion”, “subset”, “region”, and “area” of something refer to a value between a non-zero fraction of the something and 100% of the something, inclusive; they indicate an open-ended claim language, thus, for example, sentences in the form of “a portion of the memory” or “a subset of the memory” encompass anything from just a small part of the memory to the entire memory, optionally together with additional memory region(s). Sentences in the form of “access the memory” encompass accessing at least a portion of the memory, where the portion may range from a minimal addressable unit to the entire memory capacity, indicating an open-ended claim language. “Coupled” indicates direct or indirect connection, cooperation, and/or interaction, such as direct or indirect physical contact, electrical connection, and/or software and/or hardware interface; the connection between coupled elements may (or may not) involve one or more of passive components, active components, translations, modulation change, modifications to schemes, message alterations, and/or other conversions to the data or signals being transmitted.

The use of “a” or “an” refers to one or more things. The phrase “based on” indicates an open-ended claim language, and encompasses “based, at least in part, on”. Additionally, stating that a value is calculated “based on X” and following that, in a certain implementation, that the value is calculated “also based on Y”, means that in the certain implementation, the value is calculated based on X and Y. Variations of the terms “utilize” and “use” indicate an open-ended claim language, such that sentences in the form of “detecting X utilizing Y” are intended to mean “detecting X utilizing at least Y”, and sentences in the form of “use X to calculate Y” are intended to mean “calculate Y based on X”. The terms first, second, and so forth serve merely as ordinal designations, and shall not be limited in themselves. The phrases “at least one of A or B” and “at least one of A and B” are intended to be interpreted broadly to encompass A alone, B alone, or a combination of both A and B; this interpretation applies regardless of the number of items in a list, or whether the items are connected by the conjunction ‘and’ or ‘or’. A predetermined, predefined, or preselected value is a fixed value and/or a value determined before performing a calculation that utilizes the predetermined value. When appropriate, the word “value” may indicate a predetermined value. The word “threshold” indicates a threshold whose value, and/or the logic used to determine whether the threshold is reached, is established prior to performing the computation that utilizes the threshold, whether the threshold value is fixed, predefined, or dynamically determined.

In the context of RPUs and/or translations, references to “first” and “second” protocols may denote either distinct protocol types, which are different protocols with differing opcodes and functionalities (such as CXL.mem vs. CXL.cache, PCIe vs. NVLink, or UALink vs. SUE), or different instantiations of the same protocol type operating in separate domains or with distinct configurations (such as a first CXL.mem utilizing a first physical address space vs. a second CXL.mem utilizing a second physical address space).

The implementations of an invention may include a variety of combinations and/or integrations of the features of the implementations. Although some implementations may describe serial operations, the implementations may perform certain operations in parallel and/or in different orders from those described. Moreover, the use of repeated reference numerals and/or letters in the text and/or drawings is for the purpose of simplicity and clarity and does not in itself dictate a relationship between the various implementations and/or configurations discussed. Components and/or modules referred to by different reference numerals may or may not perform the same (or similar) functionality, and the fact they are referred to by different reference numerals and/or letters does not mean that they may not have same or similar functionalities.

Certain features of the implementations, which may have been, for clarity, described in the context of separate implementations, may also be provided in various combinations in a single implementation. Conversely, various features of the implementations, which may have been, for brevity, described in the context of a single implementation, may also be provided separately or in any suitable sub-combination. Implementations described in conjunction with specific examples are presented by way of example, and not limitation. Moreover, it is evident that many alternatives, modifications, and variations will be apparent to those skilled in the art. It is to be understood that other implementations may be utilized and structural changes may be made without departing from the scope of the implementations.

The drawings depict some of the couplings between elements, but not necessarily all. The depiction of elements as separate entities may be done to emphasize different functionalities of elements that may be implemented by the same software and/or hardware. Programs and/or elements illustrated and/or described as being single may be implemented via multiple programs and/or involve multiple hardware elements possibly in different locations. The implementations are not limited in their applications to the details of order, or sequence of method steps, or to details of implementation of the devices, set in the description, drawings, or examples. Individual blocks illustrated in the drawings may be functional in nature and therefore may not necessarily correspond to discrete hardware elements.

In implementations where the first domain and the second domain may be associated with the same physical address space, the translator may utilize the address in the transaction associated with the first protocol for generating the address in the transaction associated with the second protocol, possibly copying the address value as is between the messages, or adjusting for address width differences between the messages by zero-extending or truncating unused upper address bits. For example, when translating between CXL-based traffic and ISoL traffic such as UPI, wherein both requests utilize the same physical address space, an address such as (AS.1.1) in a CXL.mem request may be utilized to generate the corresponding address (AS.2.1) in a UPI request. Similarly, when translating between CHI-based traffic and PCIe traffic that share the same physical address space, or between NVLink traffic and CHI traffic in certain configurations, the translator may perform comparable address formatting operations without changing the underlying memory location being referenced. Hence, in relevant contexts, notations in the form of (AS.1.1) and (AS.2.1) used in the drawings may refer to the same address represented in different protocols, such as the address (AS.1.1)=00-00-CA-FE in a protocol that utilizes 32-bit address fields, which corresponds to the address (AS.2.1)=00-00-00-00-00-00-CA-FE in a protocol that utilizes 64-bit address fields.

Claims in the form of “A non-transitory computer-readable medium comprising instructions which, when executed by a processor, cause the processor to perform the method of claim X” are intended to encompass physical storage media capable of storing instructions, including but not limited to semiconductor memory, magnetic storage, optical storage, and other persistent storage technologies. The instructions may be in any form capable of directing a processor to perform the method, including but not limited to compiled code, interpreted code, bytecode, firmware, as well as other forms of directives such as natural language directives, declarative specifications, model parameters or configurations, and symbolic representations, among other formats that may be suitable for processing by processors, AI modules, neural processing units, or other current or future processing architectures. The processor may include any processing unit capable of executing or interpreting stored instructions, including but not limited to CPUs, microprocessors, microcontrollers, DSPs, GPUs, neural processing units, AI accelerators, and quantum processing units. The stored instructions may cause a single processor to perform the method, or may cause the processor to coordinate with one or more additional processors to collectively perform the method in a distributed manner.

Claims in the form of “One or more integrated circuits configured to perform the method of claim X, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages” are intended to encompass hardware implementations that execute, implement, realize, or carry out method steps through circuitry, programmable circuitry, stored instructions executed by processing elements, or distributed across multiple chiplets. The first alternative covers implementations based on processing units designed to execute arbitrary software instructions, including but not limited to CPUs, microprocessors, and application processors, that execute software or firmware to perform the method, with communication interfaces enabling data exchange with other system components. The second alternative covers implementations where specialized circuitry provides hardware acceleration or dedicated processing capabilities, including but not limited to ASICs, FPGAs, PLDs, and SoC devices, wherein the functionality is implemented using electronic and/or photonic components, programmable logic, or combinations thereof. The third alternative covers chiplet-based implementations where the method is performed by one or more semiconductor dies designed for integration within multi-chip modules or system-in-package configurations. These chiplets may reside within a single package or across multiple packages, communicating via inter-chiplet protocols such as UCIe, AIB, CHI-C2C, or other die-to-die interfaces when within the same package, or via package-to-package interfaces when distributed across different packages. The packages may utilize various integration technologies, including but not limited to 2.5D silicon interposers, 3D stacking, organic substrates, and embedded bridge technologies. The method may be partitioned across multiple chiplets with different chiplets implementing different portions, or a single chiplet may implement the complete method.

Claims in the form of “An active cable comprising first and second pluggable modules coupled by a physical medium; wherein the active cable further comprises hardware circuitry, integrated into the active cable, configured to perform the method of claim X” are intended to encompass cable assemblies that include active electronic components capable of processing and modifying signals during transmission. Such claims cover cables having connectors at each end designed for insertion into corresponding receptacles, connected by a transmission medium that may include copper conductors, optical fibers, or other signal-carrying media. The electronic components performing the method may be incorporated anywhere within the cable assembly, including within either or both of the pluggable connectors, or positioned along the cable between segments of the physical medium. The implementation may utilize fixed circuit arrangements, programmable logic, firmware, or combinations thereof. The electronic components may perform the entire method within the cable or may work in conjunction with other processing elements to implement the complete functionality.

Claims in the form of “An apparatus configured to operate as a switch, wherein the apparatus comprises switching circuitry and is configured to perform the method of claim X” are intended to encompass apparatus that selectively routes signals, data, or communications between ports while also performing the method. Such claims cover traditional switching devices with dedicated switch ports as well as processor-based switches and other architectures that achieve switching functions through alternative port configurations. The ports through which data enters or exits the switching function may include physical ports, logical ports, virtual ports, or other port types appropriate for the switching architecture. The apparatus may include homogeneous ports supporting a single protocol or heterogeneous ports supporting different protocols, speeds, or functionalities. The method operations are performed as part of the switching functionality through hardware, firmware, and/or logic contained within the apparatus.

Accordingly, this disclosure is intended to embrace all such alternatives, modifications, and variations that fall within the spirit and scope of the appended claims and their equivalents.

We claim:

1. A method for translating from Compute Express Link (CXL) requests to Ultra Accelerator Link (UALink) Protocol Level Interface (UPLI) requests, comprising:
communicating with a first entity according to CXL.mem;
communicating with a second entity according to UPLI;
receiving, from the first entity, a CXL.mem Master-to-Subordinate (M2S) request comprising a MemRd* and a first physical address;
translating the CXL.mem M2S request to a UPLI request comprising a read command and a second physical address;
sending the UPLI request to the second entity;
receiving, from the second entity, a UPLI read response (RdRsp) comprising data;
translating the UPLI RdRsp to a CXL.mem Subordinate-to-Master Data Response (S2M DRS) comprising the data; and
sending the CXL.mem S2M DRS to the first entity.

2. The method of claim 1, wherein the CXL.mem M2S request further comprises a MemOpcode field comprising the MemRd*, a Tag field, and an Address field comprising the first physical address; and wherein the UPLI request further comprises a ReqCmd field comprising the read command, a ReqAddr field comprising the second physical address, a ReqSrcPhysAccID field, a ReqDstPhysAccID field, a ReqLen field, and a ReqTag field; and further comprising translating the Tag to the ReqTag.

3. The method of claim 2, wherein the UPLI RdRsp further comprises a RdRspSrcPhysAccID field, a RdRspDstPhysAccID field, a RdRspTag field, and RdRspData comprising the data; and wherein the CXL.mem S2M DRS further comprises an Opcode field comprising MemData and the Tag.

4. The method of claim 3, wherein the UPLI RdRsp further comprises a RdRspDataError field, and the CXL.mem S2M DRS further comprises a Poison field; and further comprising translating the RdRspDataError field of the UPLI RdRsp to the Poison field of the CXL.mem S2M DRS.

5. The method of claim 1, further comprising: storing the data from the UPLI RdRsp in a cache; and sending a CXL.mem Subordinate-to-Master No Data Response (S2M NDR) comprising Cmp-S to the first entity, wherein the Cmp-S indicates a shared cacheline state.

6. The method of claim 5, wherein the CXL.mem M2S request further comprises a SnpType field comprising SnpData, a MetaField field comprising Meta0-State (MS0), and a MetaValue field comprising Shared (S); and wherein the CXL.mem M2S request targets a Host-managed Device Memory (HDM-D) memory region.

7. The method of claim 1, wherein the CXL.mem M2S request further comprises a SnpType field comprising No-Op and a MetaField field comprising No-Op; and wherein the CXL.mem S2M DRS is sent to the first entity without sending a CXL.mem Subordinate-to-Master No Data Response (S2M NDR) to the first entity; and wherein the CXL.mem M2S request targets a Host-managed Device Memory (HDM-H) memory region.

8. The method of claim 1, further comprising sending a CXL.mem Subordinate-to-Master No Data Response (S2M NDR) comprising Cmp-S to the first entity without storing the data in a cache.

9. The method of claim 1, wherein the first physical address is associated with a first address space, the second physical address is associated with a second address space different from the first address space, and the translating further comprises translating the first physical address to the second physical address; and wherein the first address space comprises a Host Physical Address (HPA) space or a System Physical Address (SPA) space, and the second address space comprises a Network Physical Address (NPA) space.

10. The method of claim 1, wherein the first entity comprises a CXL host, the second entity comprises an accelerator or a UALink switch, and the read command comprises a Read command or a Read Class Vendor Defined Command.

11. The method of claim 1, further comprising: receiving, from the first entity, a CXL.mem Master-to-Subordinate Request with Data (M2S RwD) comprising MemWr* and write data; translating the CXL.mem M2S RwD to a UPLI request comprising a write command; sending the UPLI request and the write data to the second entity; receiving, from the second entity, a UPLI write response (WrRsp); translating the UPLI WrRsp to a CXL.mem Subordinate-to-Master No Data Response (S2M NDR) comprising Cmp; and sending the CXL.mem S2M NDR to the first entity.

12. The method of claim 1, further comprising receiving, from the first entity, a CXL.mem M2S request comprising MemSpecRd; and translating the CXL.mem M2S request comprising MemSpecRd to a UPLI request.

13. The method of claim 1, wherein the method is performed by a device that exposes a first memory region utilizing CXL Type-2 device memory flows associated with a Host-managed Device Memory-Device coherent (HDM-D) region, and a second memory region utilizing CXL Type-3 device memory flows associated with a Host-managed Device Memory-Host coherent (HDM-H) region.

14. A non-transitory computer-readable medium comprising instructions which, when executed by a processor, cause the processor to perform the method of claim 1.

15. One or more integrated circuits configured to perform the method of claim 1, wherein the one or more integrated circuits comprise at least one of: (i) a general-purpose processing unit, comprising or connected to communication interfaces, configured to perform the method via software and/or firmware execution, (ii) circuitry comprising firmware and/or hardware logic integrated into an electronic device, wherein the circuitry utilizes operations that benefit from hardware acceleration and/or specialized processing capabilities not typically provided by a general-purpose processing unit, or (iii) one or more chiplets within one or more integrated circuit packages.

16. An apparatus configured to operate as a switch, wherein the apparatus comprises switching circuitry and is configured to perform the method of claim 1.

17. A system comprising:
a resource provisioning unit (RPU) comprising a Compute Express Link (CXL) port configured to communicate with a first entity according to CXL.mem, and an Ultra Accelerator Link (UALink) port configured to communicate with a second entity according to a UALink-based protocol;
wherein the RPU is configured to:
receive, from the first entity via the CXL port, a CXL.mem Master-to-Subordinate (M2S) request;
translate the CXL.mem M2S request to a UPLI request; and
send the UPLI request to the second entity via the UALink port.

18. The system of claim 17, wherein the RPU is further configured to: receive a UPLI read response (RdRsp) from the second entity via the UALink port; translate the UPLI RdRsp to a CXL.mem Subordinate-to-Master Data Response (S2M DRS); and send the CXL.mem S2M DRS to the first entity via the CXL port.

19. The system of claim 18, wherein the RPU further comprises a cache; and wherein the RPU is further configured to store data from the UPLI RdRsp in the cache and send a CXL.mem Subordinate-to-Master No Data Response (S2M NDR) comprising Cmp-S to the first entity.

20. The system of claim 17, wherein the first entity comprises a CXL host, the second entity comprises an accelerator; and wherein the RPU is configured to operate as at least one of a CXL Type-2 device or a CXL Type-3 device.

21. The system of claim 17, further comprising a UALink switch coupled to the UALink port; wherein the RPU is configured to send the UPLI request to the second entity via the UALink switch.

22. The system of claim 17, wherein the RPU is further configured to: receive, from the first entity via the CXL port, a CXL.mem Master-to-Subordinate Request with Data (M2S RwD) comprising MemWr*; translate the CXL.mem M2S RwD to a UPLI request comprising a write command; and send the UPLI request and write data to the second entity via the UALink port.

23. A system comprising:
a host;
a UALink pod comprising a UALink switch and accelerators coupled to the UALink switch,
wherein the accelerators communicate according to a UALink-based protocol;
a resource provisioning unit (RPU) coupled to the host via CXL.mem and coupled to the UALink switch; and
wherein the RPU is configured to receive a CXL.mem Master-to-Subordinate (M2S) request from the host, translate the CXL.mem M2S request to a UPLI request, and send the UPLI request to an accelerator of the accelerators via the UALink switch.

24. The system of claim 23, wherein the RPU is embedded within a first accelerator of the accelerators, and the first accelerator is coupled to the host via CXL.mem; and wherein the UPLI request is sent from the first accelerator to a second accelerator of the accelerators via the UALink switch.

25. The system of claim 23, wherein the RPU is separate from the accelerators and is coupled to the UALink switch via a UALink port.

26. The system of claim 23, further comprising a CXL fabric coupling the host to the RPU; and further comprising a CXL memory device coupled to the host via the CXL fabric, wherein the host is configured to access the CXL memory device via CXL.mem.

27. The system of claim 26, wherein the CXL memory device comprises at least one of: a Global Fabric-Attached Memory Device (GFD), a CXL memory expander, or a CXL memory pool.

28. The system of claim 23, wherein the RPU is further configured to receive a UPLI read response (RdRsp) from the accelerator via the UALink switch, translate the UPLI RdRsp to a CXL.mem Subordinate-to-Master Data Response (S2M DRS), and send the CXL.mem S2M DRS to the host; and wherein the host comprises a central processing unit (CPU), and the accelerators comprise graphics processing units (GPUs) or tensor processing units (TPUs).

29. The system of claim 23, further comprising a second RPU coupled to the host via CXL.mem and coupled to the UALink switch; wherein the RPU is configured to translate CXL.mem M2S requests from the host to UPLI requests targeting a first accelerator of the accelerators, and the second RPU is configured to translate CXL.mem M2S requests from the host to UPLI requests targeting a second accelerator of the accelerators.

30. The system of claim 23, wherein the UALink switch comprises a route table, and the UALink switch routes the UPLI request from the RPU to the accelerator based on a Destination Accelerator ID carried in the UPLI request; and wherein the accelerators communicate with the UALink switch via UPLI request channels and UPLI response channels.
